(19) United States
(12) Patent Application Publication
(10) Pub. No.: US 2026/0120472 A1
(43) Pub. Date: Apr. 30, 2026

(54) SECURITY METHOD, METHOD OF RECOGNIZING THEFT INTENT IN SECURITY SYSTEM, APPARATUS, AND ELECTRONIC DEVICE

(71) Applicant: Anker Innovations Technology Co., Ltd., CHANGSHA (CN)

(72) Inventors: Menglu YAN, SHENZHEN (CN); Wen QI, SHENZHEN (CN); Guanxing ZHOU, SHENZHEN (CN)

(73) Assignee: Anker Innovations Technology Co., Ltd., CHANGSHA (CN)

(21) Appl. No.: 19/373,358

(22) Filed: Oct. 29, 2025

(30) Foreign Application Priority Data
Oct. 31, 2024 (CN) 202411546396.X
Oct. 31, 2024 (CN) 202411549964.1

(51) Int. Cl. G06V 20/52; G06T 7/70; G06V 10/25; G06V 10/74; G06V 20/40

(52) U.S. Cl. CPC G06V 20/52; G06T 7/70; G06V 10/25; G06V 10/761; G06V 20/44

(57) ABSTRACT

A security method includes: obtaining a first security video and predetermined security preference information; performing recognition on the first security video to obtain a video recognition result; determining a security response operation matching the first security video based on the video recognition result and the security preference information, so as to obtain a first security response operation; determining a security device for performing the first security response operation; and controlling the security device to perform the first security response operation.

### CROSS REFERENCE TO RELATED APPLICATIONS

The present application claims the priority of: the Chinese patent application No. 202411549964.1, filed on Oct. 31, 2024; and the Chinese patent application No. 202411546396.X, filed on Oct. 31, 2024, contents of which are incorporated herein by their entireties.

### TECHNICAL FIELD

Embodiments of the present disclosure relate to the technical field of security, and more specifically; to a security method, a method of recognizing a theft intent in a security system, an apparatus, and an electronic device.

### BACKGROUND

In the art, some security systems primarily rely on basic surveillance and alarm devices, lacking intelligent monitoring, and therefore, growing security demands of modern households cannot be met. Furthermore, responding manners in the security systems in the art may be limited, only certain alarm protocols may be applied, and users may be provided with simple alerts based on static security devices.

Therefore, enhancing precision and effectiveness of security measures may be a technical challenge in attention.

### SUMMARY

The present disclosure provides a security method, a method of recognizing a theft intent in a security system, an apparatus, and an electronic device.

In a first aspect, the present disclosure provides a security method, including:
obtaining a first security video and predetermined security preference information;
performing recognition on the first security video to obtain a video recognition result;
determining a security response operation matching the first security video based on the video recognition result and the security preference information, so as to obtain a first security response operation;
determining a security device for performing the first security response operation; and controlling the security device to perform the first security response operation.

In a second aspect, the present disclosure provides a security apparatus, including:
a first obtaining unit, configured to obtain a first security video and predetermined security preference information;
a first determination unit, configured to perform recognition on the first security video to obtain a video recognition result;
a first determination unit, configured to determine a security response operation matching the first security video based on the video recognition result and the security preference information, so as to obtain a first security response operation;
a second determination unit, configured to determine a security device for performing the first security response operation; and
a first control unit, configured to control the security device to perform the first security response operation.

In a third aspect, the present disclosure provides an electronic device, including:

a memory, configured to store a computer program; and

a processor, configured to execute the computer program stored in the memory, and the computer program, when being executed, is configured to perform the security method in any embodiment of the first aspect.

In a fourth aspect, the present disclosure provides a computer-readable storage medium having a computer program stored thereon. When the computer program is executed, the computer program is configured to perform the security method in any embodiment of the first aspect.

According to the security method of the present disclosure, the first security video and predetermined security preference information may be obtained firstly. Subsequently, the first security video may be recognized to obtain a video recognition result for the first security video. Furthermore, the security response operation matching the first security video may be determined, based on the video recognition result and the security preference information, so as to obtain the first security response operation. Furthermore, the security device for performing the first security response operation may be determined. Finally, the security device may be controlled to perform the first security response operation. In this way, the security response operation matching the security video may be dynamically determined and performed based on the specific event represented by the video recognition result and the predetermined security preference information. Each response operation may be determined specifically targeting a current specific situation. Therefore, appropriate measures may be taken for different types of events. In addition, the security device for performing the first security response operation may be dynamically determined based on various situations. Therefore, faster and more accurate responses may be performed for various emergencies, false alarms and missed alarms may be reduced, and overall effectiveness of the security system may be improved.

### BRIEF DESCRIPTION OF THE DRAWINGS

The accompanying drawings are incorporated herein by reference and form a part of the specification. The accompanying drawings illustrate embodiments of the present disclosure. The accompanying drawings and the specification, in combination, explain principles of the present disclosure.

In order to more clearly illustrate the technical solutions in the embodiments of the present disclosure or in the art, the drawings for describing the embodiments or the art will be briefly introduced below. Apparently, any skilled artisan may obtain other drawings based on the drawings without creative work.

One or more embodiments are exemplarily illustrated based on corresponding figures in the drawings. The exemplary illustration does not limit the embodiments. Components labeled by same reference numerals in the drawings are intended to represent similar components. Unless otherwise stated, the drawings are not intended to limit scales of components.

FIG. 1 is a flow chart of a security method according to an embodiment of the present disclosure.

FIG. 2 is a flow chart of another security method according to an embodiment of the present disclosure.

FIG. 3A is a three-dimensional panoramic view of a house according to an embodiment of the present disclosure.

FIG. 3B is a schematic diagram of a knowledge graph according to an embodiment of the present disclosure.

FIG. 3C is a schematic view of an application scenario of the security method according to an embodiment of the present disclosure.

FIG. 3D is an architecture diagram of the security method according to an embodiment of the present disclosure.

FIG. 3E is a schematic diagram of an environmental profile of the security method according to an embodiment of the present disclosure.

FIG. 3F is a schematic diagram of a personal profile and a family relationship graph of the security method according to an embodiment of the present disclosure.

FIG. 3G is a schematic diagram of a multi-modal interaction entry point for the security method according to an embodiment of the present disclosure.

FIG. 3H is a schematic diagram of a visitor reception module for the security method according to an embodiment of the present disclosure.

FIG. 3I is a schematic diagram of a family guardian module for the security method according to an embodiment of the present disclosure.

FIG. 3J is a schematic diagram of a property guard module of the security method according to an embodiment of the present disclosure.

FIG. 3K is a schematic diagram of an artificial intelligence generated service of the security method according to an embodiment of the present disclosure.

FIG. 3L is a schematic diagram of a user generated service of the security method according to an embodiment of the present disclosure.

FIG. 4A is a schematic diagram of the knowledge graph in a dynamic response method for a security video according to an embodiment of the present disclosure.

FIG. 4B is a schematic diagram of a method of generating an instruction for instructing performing a security response operation in the dynamic response method for the security video according to an embodiment of the present disclosure.

FIG. 4C is a schematic diagram of user setting in the dynamic response method for the security video according to an embodiment of the present disclosure.

FIG. 4D is a schematic diagram of event recognition in the dynamic response method for the security video according to an embodiment of the present disclosure.

FIG. 4E is a schematic diagram of behavior prediction in the dynamic response method for the security video according to an embodiment of the present disclosure.

FIG. 4F is a schematic diagram of decision execution in the dynamic response method for the security video according to an embodiment of the present disclosure.

FIG. 4G is a schematic diagram of information sharing in the dynamic response method for the security video according to an embodiment of the present disclosure.

FIG. 5A is a schematic view of an application scenario of an object behavior recognition method according to an embodiment of the present disclosure.

FIG. 5B is a schematic view of image capturing according to an embodiment of the present disclosure.

FIG. 5C is another schematic view of image capturing according to an embodiment of the present disclosure.

FIG. 5D is a structural schematic view of an object behavior recognition system according to an embodiment of the present disclosure.

FIG. 5E is a flow chart of the object behavior recognition method according to an embodiment of the present disclosure.

FIG. 6A is a flow chart of a cross-device cooperation surveillance operation method according to an embodiment of the present disclosure.

FIG. 6B is a flow chart of constructing a three-dimensional model in the cross-device cooperation surveillance operation method according to an embodiment of the present disclosure.

FIG. 6C is a schematic view of an intersection region between a first surveillance region and a second surveillance region in the cross-device cooperation surveillance operation method according to an embodiment of the present disclosure.

FIG. 7 is a flow chart of a method of recognizing a theft intent according to an embodiment of the present disclosure.

FIG. 8 is a flow chart a video frame extraction method according to an embodiment of the present disclosure.

FIG. 9 is an application scenario of an information pushing method according to an embodiment of the present disclosure.

FIG. 10A is an application scenario for a cross-device control strategy generation method according to an embodiment of the present disclosure.

FIG. 10B is a flow chart of the cross-device control strategy generation method according to an embodiment of the present disclosure.

FIG. 11A is a flow chart of a control method for a security device according to an embodiment of the present disclosure.

FIG. 11B is an application scenario of stranger tracking and expulsion involved in the control method for the security device according to an embodiment of the present disclosure.

FIG. 11C is another application scenario of stranger tracking and expulsion involved in the control method for the security device according to an embodiment of the present disclosure.

FIG. 11D is another application scenario of stranger tracking and expulsion involved in the control method for the security device according to an embodiment of the present disclosure.

FIG. 11E is an application scenario of a suspicious vehicle being tracked and expulsed involved in the control method for the security device according to an embodiment of the present disclosure.

FIG. 11F is another application scenario of the suspicious vehicle being tracked and expulsed involved in the control method for the security device according to an embodiment of the present disclosure.

FIG. 11G is another application scenario of the suspicious vehicle being tracked and expulsed involved in the control method for the security device according to an embodiment of the present disclosure.

FIG. 12 is a structural schematic view of a security apparatus according to an embodiment of the present disclosure.

FIG. 13 is a structural schematic view of an electronic device according to an embodiment of the present disclosure.

FIG. 14 is a flow chart a method for recognizing a theft intent according to an embodiment of the present disclosure.

FIG. 15 is a flow chart another method for recognizing the theft intent according to an embodiment of the present disclosure.

FIG. 16 is a structural schematic diagram of a theft intent recognition apparatus provided by an embodiment of the present disclosure.

### DETAILED DESCRIPTIONS

Various exemplary embodiments of the present disclosure will be described in detail by referring to the accompanying drawings. It should be understood that the embodiments described are part of, not all of, the embodiments of the present disclosure. It should be noted that, unless otherwise specifically stated, relative arrangement of components and steps, numerical expressions, and values described in the embodiments do not limit the scope of the present disclosure.

Any skilled artisan shall understand that terms such as “first”. “second”, and the like in the embodiments of the present disclosure are used merely to distinguish different steps, devices, or modules, and do not represent any particular technical meaning or indicate a logical sequence therebetween.

It should also be understood that in the present embodiments. “a plurality of” may refer to two or more, and “at least one” may refer to one, two, or more.

It should also be understood that any component, data, or structure mentioned in the embodiments of the present disclosure may generally be understood to refer to one or more thereof, unless explicitly limited or the context provides contrary indications.

Furthermore, the term “and/or” in the present disclosure merely describes an associative relationship between related objects, indicating that three types of relationships may exist. For example. “A and/or B” may represent: A existing alone. A and B both existing, or B existing alone. Furthermore, the character “/” in the present disclosure generally indicates an object “or” another object.

It should also be understood that description of various embodiments in the present disclosure emphasizes differences therebetween, and similarities or common features may be referenced cross the various embodiments. For brevity, such similarities are not elaborated upon individually.

The following description of at least one exemplary embodiment is merely illustrative and does not limit the scope or application of the present disclosure.

Techniques, methods, and devices known to any skilled artisan may not be discussed in detail, but where appropriate, such techniques, methods, and devices should be considered part of the specification.

It should be noted that similar reference numerals and letters denote similar items in the accompanying drawings below. Therefore, once an item is defined in one drawing, it need not be further discussed in subsequent drawings.

It should be understood that, where not in conflict, the embodiments and features within the embodiments of the present disclosure may be combined with one another. For case of understanding the embodiments of the present disclosure, the following description will detail the present disclosure by referring to the accompanying drawings and the embodiments. Apparently, the described embodiments represent a portion of, not all of, the embodiments of the present disclosure. All other embodiments, which are obtained by any skilled artisan based on the embodiments of the present disclosure without performing creative work, shall fall within the scope of the present disclosure.

Furthermore, it should be noted that users described herein may be distinguished from each other by user identifiers. For example, a user identifier may be a login account. In this case, when different individuals log in using the same login account, the different individuals may be considered as the same user. Conversely, when the same individual logs in using different login accounts, it may be considered as different users. In another case, when a device is not logged in the user identifier may be assigned based on a device identifier. In this case, when different individuals perform operations using devices with the same device identifier, they may be considered as the same user. Conversely, when the same individual performs operations using devices with different device identifiers, it may be considered as different users.

In order to improve targeting and effectiveness of security measures in the art, the present disclosure provides a dynamic response method and apparatus for security videos, such that security targeting and effectiveness may be improved.

The embodiments of the present disclosure may be applied in one or more electronic devices, such as a security device, a smartphone, a laptop computer, a desktop computer, a portable computer, or a server. Furthermore, an execution entity performing the embodiments may be hardware or software. When the execution entity is the hardware, it may be one or more of the above electronic devices. For example, one electronic device may perform the embodiments, or a plurality of electronic devices may cooperatively perform the embodiments. When the execution entity is the software, the embodiments of the present disclosure may be implemented as a plurality of software programs or software modules, or implemented as one software program or software module. The present disclosure does limit the implementations.

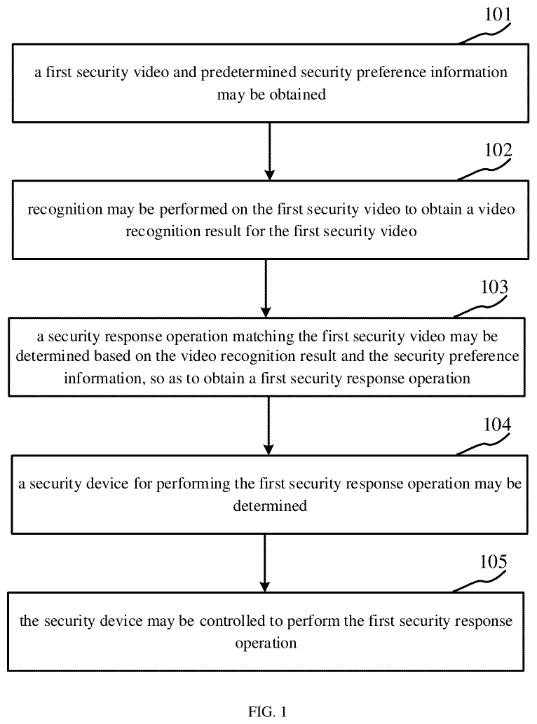

FIG. 1 is a flow chart of a security method according to an embodiment of the present disclosure. As shown in FIG. 1, the method may include following blocks.

In a block 101, a first security video and predetermined security preference information may be obtained.

In the present embodiment, a security video may be a surveillance footage used for ensuring safety and preventing risks. In practice, the security video may be captured via cameras.

The first security video may be any security video.

The security preference information may represent intends and requirements of objectives, such as a user, regarding security.

For example, the security preference information may include at least one of: an event of interest to the user or other objectives, an individual of interest to the user or other objectives, a behavior of interest to the user or other objectives: a manner in which a security response operation may be performed: a frequency at which the security response operation may be performed: time at which the security response operation may be performed; and so on.

In a block 102, recognition may be performed on the first security video to obtain a video recognition result for the first security video.

In the present embodiment, the video recognition result may be a result obtained by recognizing the first security video. For example, the video recognition result may indicate whether a current behavior of a target object belongs to a target behavior type (such as theft, dangerous behavior). In addition, the video recognition result may indicate a person recognition result of the target object, and so on.

In the present embodiment, a support vector machine (SVM), a multimodal model, and the like, may be used to performing the recognition on the first security video, so as to obtain the video recognition result of the first security video.

For example, the video recognition result may indicate events such as theft, fire, or falling.

In a block 103, a security response operation matching the first security video may be determined based on the video recognition result and the security preference information, so as to obtain a first security response operation.

In the present embodiment, the security response operation may be a response operation for the security video.

The first security response operation may be the security response operation determined based on the video recognition result and the security preference information and may match the first security video.

For example, the security response operation corresponding to the video recognition result and the security preference information may be determined based on a predetermined first correspondence table. In this way, the security response operation may then be determined as the security response operation matching the first security video, i.e., the first security response operation. The above first correspondence table may represent a correspondence relationship among the video recognition result, the security preference information, and the security response operation.

In another example, the video recognition result and the security preference information may be input into a pre-trained first model to obtain the security response operation. The security response operation may then be determined as the security response operation matching the first security video, i.e., the first security response operation. The first model may show the correspondence relationship among video recognition results, security preference information, and security response operations. The first model may be a convolutional neural network or a large language model that is trained using machine learning algorithms based on training samples containing the video recognition results, the security preference information, and the security response operations.

In a block 104, a security device for performing the first security response operation may be determined.

In the present embodiment, after determining the first security response operation, the security device for performing the first security response operation may be further determined.

In some cases, the security device may be a smart device, such as a camera, an alarm, an access control system, and so on.

In practice, the security device for performing the first security response operation may be determined based on a correspondence table representing relationships between first security response operations and security devices.

In a block 105, the security device may be controlled to perform the first security response operation.

In the present embodiment, after determining the security response operation matching the first security video, the security device may be further controlled to perform the first security response operation.

In some implementations of the present embodiment, after performing recognition on the first security video to obtain the video recognition result, the following blocks may further be performed.

In a block 1, first feedback information regarding the video recognition result may be obtained. The first feedback information may indicate adjusting a recognition strategy for a second security video. The recognition strategy may include at least one of the following: a recognition efficiency and a recognition manner.

The second security video may refer to: the first security video, or a security video obtained after the first security video.

The recognition strategy refers to a strategy for performing recognition on the second security video to obtain a video recognition result of the second security video. For example, the recognition strategy may be: performing recognition on the second security video at an efficiency A to obtain the video recognition result of the second security video: performing recognition on the second security video at an efficiency B to obtain the video recognition result of the second security video: performing recognition on the second security video by applying a recognition manner A to obtain the video recognition result of the second security video: performing recognition on the second security video by applying a recognition manner B to obtain the video recognition result of the second security video, and so on.

For example, the first feedback information may be represented in forms of, such as, texts or voices. In some cases, the first feedback information may be determined by the user or the objectives.

When the first feedback indicates “the efficiency of performing recognition on the security video is too slow.” the efficiency of performing recognition on the security video may be improved, such that recognition may be performed more efficiently on subsequent security videos, or recognition may be re-performed on a security video that has been recognized (such as the first security video obtained in the block 101). In this case, the recognition strategy may be expressed as: “performing recognition on the second security video at an efficiency than the current efficiency at which recognition is performed on the security video, so as to obtain the video recognition result for the second security video.”

Specifically: before receiving the first feedback information, when an event of “a person approaches an item-bends down to pick up the item-takes the item away” is recognized from the security video, the video recognition result may be determined as “theft”. In this case, after receiving the first feedback information indicating “the efficiency of performing recognition on the security video is too slow”, when an event of “a person approaches an item-bends down to pick up the item” is recognized from the security video, the video 25 recognition result may be determined as “theft”, such that the security video recognition efficiency may be improved.

In addition, when the first feedback indicates “the efficiency of performing recognition on the security video is too slow”, the manner in which recognition is performed on the security video may be changed. For example, a current recognition manner A may be switched to another recognition manner B.

In a block 2, a recognition strategy to be performed after the adjustment instructed by the first feedback information may be determined.

In a block 3, recognition may be performed on the second security video based on the recognition strategy to be performed after the adjustment instructed by the first feedback information, so as to obtain the video recognition result for the second security video.

Any subsequent security videos may be recognized based on the recognition strategy to be performed after the adjustment instructed by the first feedback information, so as to obtain a video recognition result for the subsequent security video. Alternatively, any security video that has been recognized (such as the first security video obtained in the block 101) may be recognized based on the recognition strategy to be performed after the adjustment instructed by the first feedback information, so as to obtain a video recognition result for the already-recognized security video.

In a block 4, a security response operation matching the second security video may be determined based on the video recognition result for the second security video and the security preference information, so as to obtain the second security response operation.

The second security response operation may represent a security response operation that is determined based on the video recognition result of the security video and the security preference information and matches the security video.

In a block 5, the second security response operation may be performed.

The blocks 4 and 5 may be performed, referring to the blocks 103 and 104 in the above. For brevity, performance of the blocks 4 and 5 will not be described here.

It should be understood that in the above embodiments, the recognition strategy for security videos may be dynamically adjusted based on feedback information of the video recognition result. In this way, various recognition demands of various users or a same user at various time periods may be met, such that user may be more satisfied with security effectiveness.

In some embodiments, after determining the security response operation matching the first security video based on the video recognition result and the security preference information to obtain the first security response operation, the following blocks may further be performed.

In a block 1, second feedback information regarding the first security response operation may be obtained. The second feedback information may indicate adjusting a determination strategy for determining the second security response operation. The determination strategy may include at least one of: a determination efficiency and a determination manner.

The second security video refers to: the first security video, or the security video obtained after the first security video.

The determination strategy may be a strategy for obtaining a third security response operation, in which the security response operation matching the second security video may be determined based on the video recognition result and the security preference information. For example, the determination strategy may be: determining, at an efficiency A, the security response operation matching the second security video based on the video recognition result and the security preference information to obtain the third security response operation; determining, at an efficiency B, the security response operation matching the second security video based on the video recognition result and the security preference information to obtain the third security response operation; determining, in a determination manner A, the security response operation matching the second security video, based on the video recognition result and the security preference information, to obtain the third security response operation strategy: determining, in a determination manner B, the security response operation matching the second security video, based on the video recognition result and the security preference information, to obtain the third security response operation strategy.

For example, the second feedback information may be represented in texts, voices, or other formats. In some cases, the second feedback information may be determined by the user or other objectives.

When the second feedback information indicates that “the efficiency of determining the security response operation is too slow.” the efficiency of determining the security response operation may be increased, such that subsequent security response operations may be determined more efficiently. Alternatively, a security response operation that has been determined (such as the security response operation determined in the block 103) may be re-determined. Specifically, when security response operations are determined sequentially before obtaining the second feedback information, after receiving the feedback information indicating “the efficiency of determining the security response operation is too slow”, in-parallel determination of security response operations may be performed. In this case, the determination strategy may be expressed as “determining the third security response operation at an efficiency higher than a current efficiency of determining the security response operation matching the first security video based on the video recognition result and the security preference information”.

Furthermore, when the second feedback information indicates that “the efficiency of determining the security response operation is too slow” the manner of determining the security response operation may be changed, such as a current determination manner A may be switched to another determination manner B.

In a block 2, a determination strategy to be performed after the adjustment indicated by the second feedback information may be determined.

In a block 3, the security response operation matching the second security video may be determined, based on the determination strategy to be performed after the adjustment indicated by the second feedback information and based on the video recognition result and the security preference information, so as to obtain the third security response operation.

Any subsequent security response operation may be determined according to the determination strategy the determination strategy to be performed after the adjustment indicated by the second feedback information. Alternatively, any security response operation that has been determined (such as the security response operation determined in the block 103) may be re-determined, according to the determination strategy the determination strategy to be performed after the adjustment indicated by the second feedback information.

The third security response operation represents the security response operation, which is determined, based on the determination strategy the determination strategy to be performed after the adjustment indicated by the second feedback information and based on the video recognition result and the security preference information, and matches the security video.

In a block 4, the third security response operation may be performed.

It should be understood that in the above embodiments, the determination strategy for determining the security response operation may be dynamically adjusted based on the feedback information from the security response operation. In this way: various demands of various users or the same user at various time periods may be met, such that the user may be more satisfied with security effectiveness.

In some embodiments, after performing the first security response operation, the following blocks may further be performed.

In a block 1, third feedback information regarding the first security response operation may be performed. The third feedback information indicates adjusting a performing strategy for performing the security response operation. The performing strategy may include at least one of: a performing efficiency and a performing manner.

The performing strategy represents a strategy for performing a fourth security response operation. The fourth security response operation may be a security response operation performed after the first security response operation. For example, the performing strategy may be: performing the fourth security response operation at an efficiency A; performing the fourth security response operation at an efficiency B; and so on.

For example, the third feedback information may be represented in texts, voices, or other formats. In some cases, the third feedback information may be determined by the user or other objectives.

When the third feedback indicates that “a performing efficiency of performing the security response operation is too slow”, then the performing efficiency of performing the security response operation may be increased, such that any subsequent security response operation may be performed more efficiently. Specifically, before obtaining the third feedback information, when the security response operation is performed at a 10th second after the security response operation is determined, after obtaining the third feedback information indicating “the performing efficiency of performing the security response operation is too slow”, the security response operation may be performed at an 8th second after the security response operation being determined. In this case, the performing strategy may be expressed as “performing the fourth security response operation at an efficiency than the current efficiency of performing the first security response operation”.

Furthermore, when the third feedback indicates “the performing efficiency of performing the security response operation is too slow”, the performing manner of performing the security response operation may be changed, such as switching from a current performing manner A to another performing manner B.

In a block 2, the performing strategy to be performed after the adjustment indicated by the third feedback information may be determined.

In a block 3, the fourth security response operation may be performed based on the performing strategy to be performed after the adjustment indicated by the third feedback information.

The fourth security response operation may be the security response operation performed after the first security response operation.

Any security response operation that is determined subsequently may be performed based on the performing strategy to be performed after the adjustment indicated by the third feedback information.

It should be understood that in the above embodiments, the performing strategy for performing the security response operation may be dynamically adjusted based on the feedback information from the security response operation. In this way, various demands of various users or the same user at various time periods may be met, such that the user may be more satisfied with security effectiveness.

In some embodiments, the security response operation matching the first security video may be determined based on the video recognition result and the security preference information as follows.

In a block 1, a response probability of the first security video may be determined based on the video recognition result.

For example, the response probability corresponding to the video recognition result may be determined based on a predetermined fourth correspondence table, such that the response probability may be determined as the response probability for the first security video. The fourth correspondence table may represent correspondence relationships between video recognition results and response probabilities.

In another example, the video recognition result may be input into a pre-trained fourth model to obtain a response probability, which may be determined as the response probability for the first security video. The fourth model may represent correspondence relationships between recognition results and response probabilities. The fourth model may be a convolutional neural network or a large language model trained, using machine learning algorithms based on training samples containing the recognition results and the response probabilities.

In a block 2, it may be determined whether the response probability is greater than or equal to a predetermined threshold.

In a block 3, when the response probability is greater than or equal to the predetermined threshold, the security response operation matching the first security video may be determined based on the security preference information.

It should be understood that in the above embodiments, the security response operation matching the first security video may be determined based on the security preference information, only when the response probability is greater than or equal to the predetermined threshold, and then the security response operation may be performed. In this way, the security response operation may not be excessively frequently performed.

In certain application scenarios of the above embodiments, after performing the first security response operation, the predetermined threshold may be adjusted as follows.

In a block 1, fourth feedback information regarding the first security response operation may be obtained.

The fourth feedback information may indicate adjusting the predetermined threshold.

For example, the fourth feedback information may be represented in texts, voices, or other formats. In some cases, the fourth feedback information may be determined by the user or other objectives.

In a block 2, the predetermined threshold may be adjusted according to an adjustment manner indicated by the fourth feedback information, so as to obtain a post-adjustment predetermined threshold.

Furthermore, following blocks may be performed.

In a block 3, when the response probability is greater than or equal to the post-adjustment predetermined threshold, the security response operation matching the second security video may be determined based on the security preference information, so as to obtain a fifth security response operation.

The second security video refers to: the first security video, or the security video obtained after the first security video.

In a block 4, the fifth security response operation may be performed.

It is understood that in the above embodiments, the predetermined threshold may be dynamically adjusted based on the feedback information of the security response operation. In this way: various demands of various users or the same user at various time periods may be met, such that the user may be more satisfied with security effectiveness.

In some embodiments, the video recognition result may include a first person in the first security video, and the security preference information may indicate a predetermined relationship with the first person.

The predetermined relationship may be a familial relationship, such as father-son, mother-son, father-daughter, or mother-daughter. The first person may be a person appearing in the first security video.

Accordingly, the security response operation matching the first security video may be determined based on the video recognition result and the security preference information as follows.

In a block 1, a second person having the predetermined relationship with the first person in the first security video may be determined.

The second person may be a person having the predetermined relationship with the first person in the first security video.

In a block 2, determining the security response operation matching the first security video may indicate: sending a security prompt message to a terminal of the second person.

The terminal of the second person may be a terminal logged in with an account of the second person or a terminal bound to identity information of the second person.

The security prompt message may be configured to provide a security notification. A content of the security prompt message may be set by the user or other objectives, or may be generated based on predetermined policies.

The first security response operation may represent: sending the security prompt message to the terminal of the second person. Furthermore, the first security response operation may be the security response operation that is determined based on the video recognition result and the security preference information and matches the first security video.

It should be understood that in the above embodiments, when a specific person is recognized in the security video, the security prompt message may be sent, in time, to the terminal of the person having the predetermined relationship to the recognized person. In this way, the relevant person acknowledge movements of the recognized person in time.

In some application scenarios of the above embodiments, the second person having the predetermined relationship to the first person in the first security video may be determined as follows.

In a block 1, it may be determined whether a first node representing the first person is included in a pre-constructed knowledge graph.

Each node in the knowledge graph may represent a person, and an edge in the knowledge graph may represent a relationship between two persons.

The first node may represent the first person.

The knowledge graph may include nodes and edges. Each of the edges may represent a relationship between two of the nodes connected by the edge.

Persons represented by the nodes in the knowledge graph may be pre-registered. For example, personal information may be collected for registration. Relationships represented by the edges in the knowledge graph may be determined by the user or other objectives.

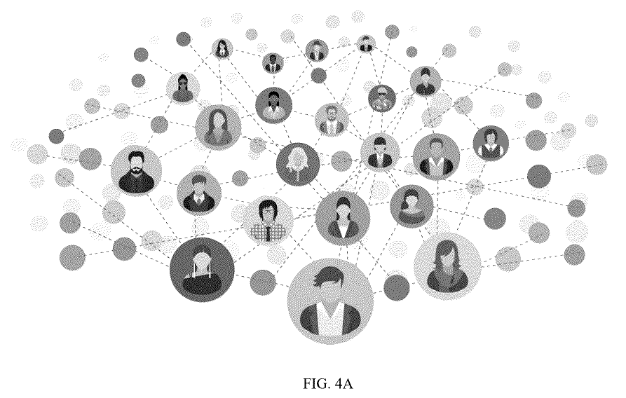

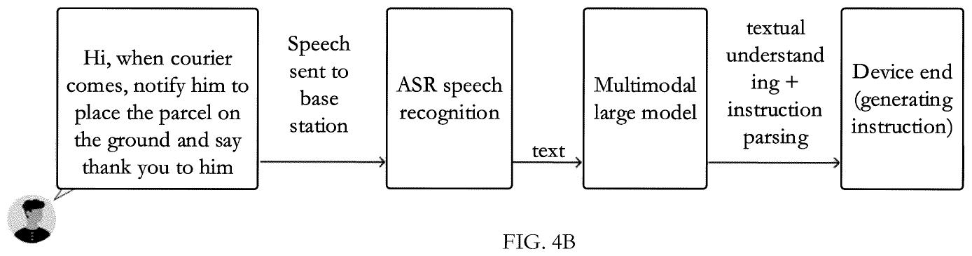

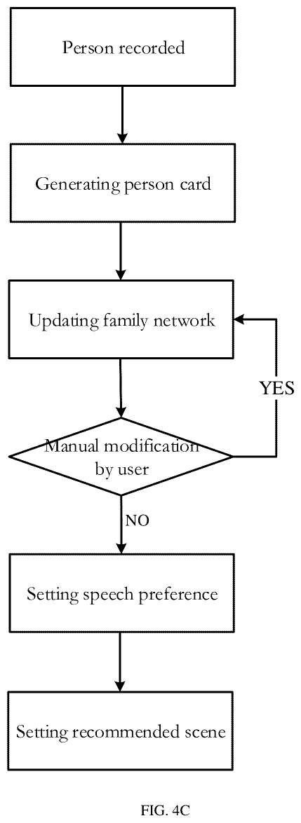

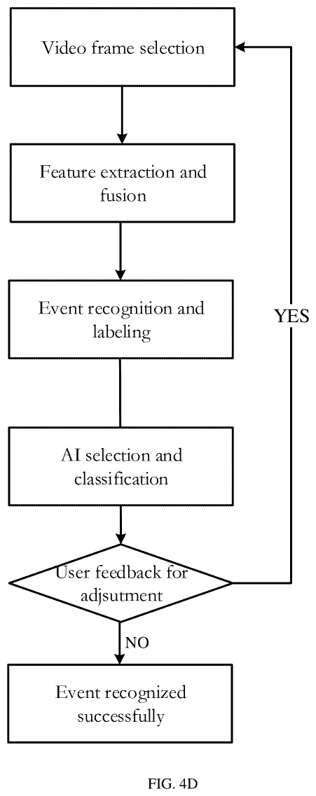

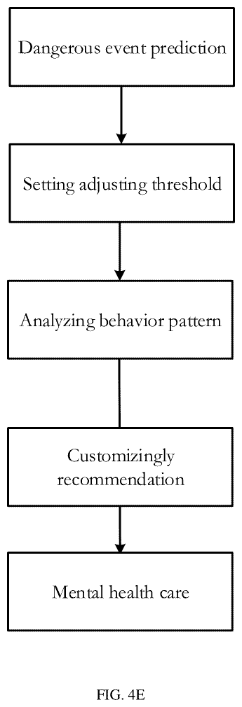

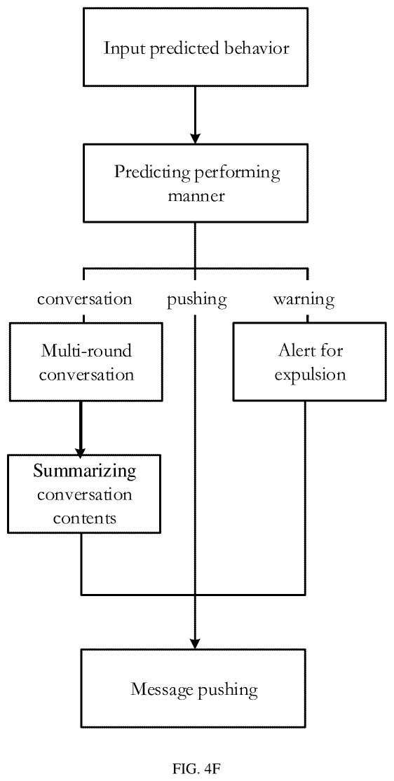

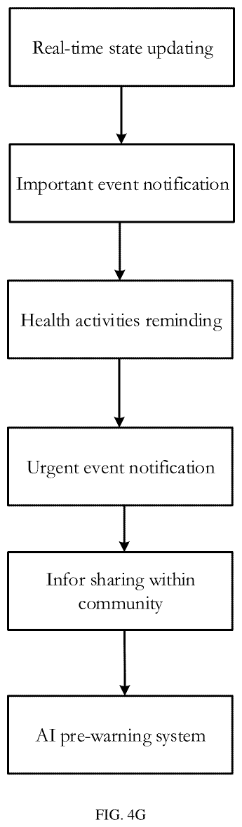

For example, as shown in FIG. 4A. FIG. 4A is a schematic diagram of the knowledge graph in a dynamic response method for the security video according to an embodiment of the present disclosure.

In a block 2, when the knowledge graph includes the first node, an edge representing the predetermined relationship may be determined from all edges connected to the first node in the knowledge graph.

In a block 3, a second node connected by the edge representing the predetermined relationship may be determined.

The second node may refer to the other node connected by the edge representing the predetermined relationship, other than the first node.

In a block 4, a person represented by the second node may be determined as the second person having the predetermined relationship with the first person in the first security video.

It can be understood that in the above application scenario, the second person having the predetermined relationship with the first person in the first security video may be more accurately determined based on the knowledge graph.

In order to address technical problems in which a behavior cannot be accurately recognized in a domestic security system, leading to mis-determination or failure to determining actions, thereby affecting user experience, in the present disclosure, a movement distance of a target object in an image and an endpoint of the target object after movement may be determined, so as to determine whether a predetermined target behavior type is met. In this way, it may be determined whether a behavior performed by the target object belongs to target behavior type. The determination does not rely on an external device, and a movement trajectory of the object outside a predetermined region may not needed to be obtained. Since the predetermined region is a region that is traversed by the object during performing a behavior corresponding to the target behavior type, a situation where a behavior of the target object cannot be determined due to a movement trajectory of the target object being changed. Therefore, it may be rapidly and accurately determined whether the behavior of the target object belongs to the target behavior type.

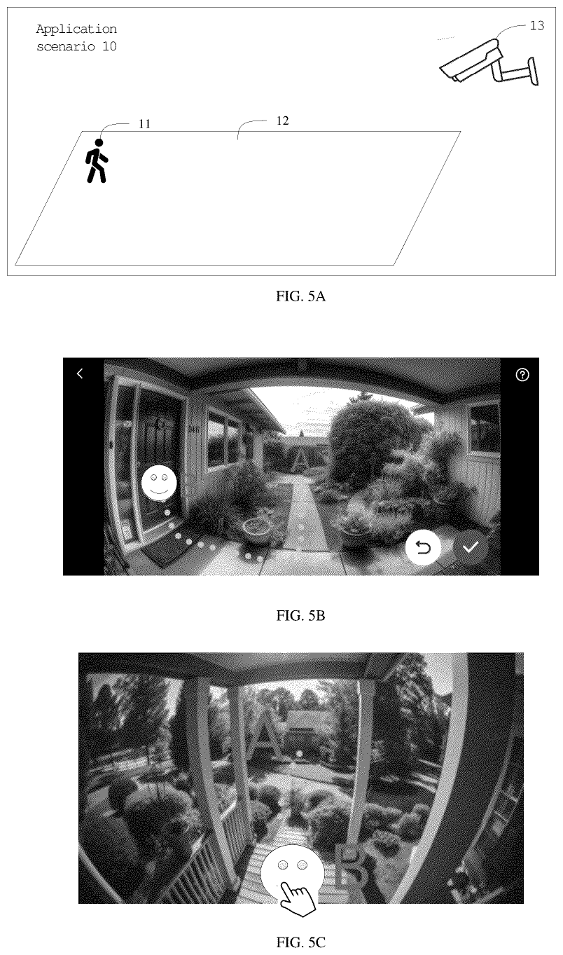

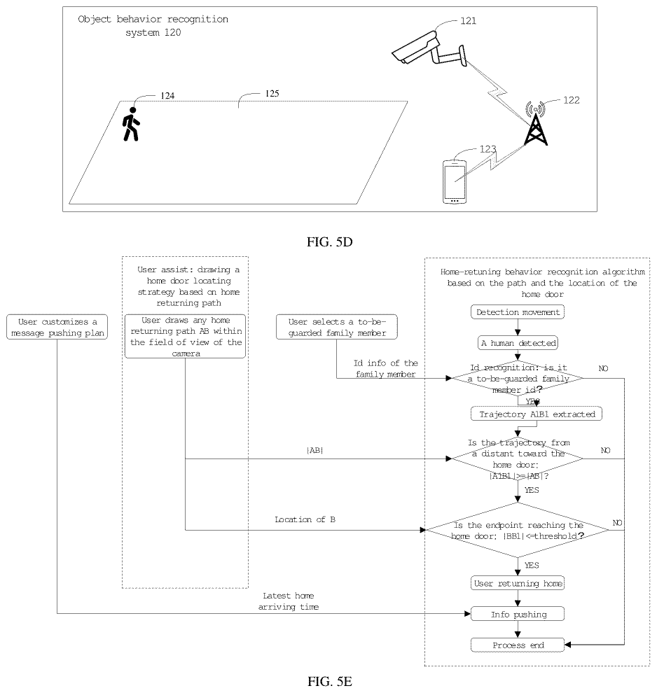

As shown in FIG. 5A. FIG. 5A is a schematic view of an application scenario of the object behavior recognition method according to an embodiment of the present disclosure. As shown in FIG. 5A, the application scenario 10 may include: an object 11, a predetermined region 12, and a camera module 13.

The above-mentioned object 11 may refer to an object, who enters the predetermined region 12 and has a behavior to be recognized. The above-mentioned object 11 may be a predetermined target object. For example, when the application scenario 10 is being at home, the target object may be a family member. Alternatively, when the application scenario 10 is being at a workplace, the target object may be a company employee. The present disclosure does not limit the object and the application scenario.

The predetermined region 12 may refer to a predetermined region, which is traversed by the object when performing the behavior belong to the target behavior type. The target behavior type may include: the object arriving home, the object departing from home, the object arriving at work, or the object delivering parcels. Correspondingly, the predetermined region may be a region at which the object passes through when entering the home, a region at which the object passes through when entering a company, or a region at which a courier passes through when delivering parcels. The present disclosure does not limit the predetermined region.

Taking the object arriving home as an example, when the subject intends to return home, the object may pass through a region in front of a door. Alternatively, when residence of the object has a front yard, the predetermined region may be a region of the front yard. When the object is returning home, the object may pass from entrance of the front yard to entrance of a house, such that the object returns home.

The camera module 13 may be a camera or any other device having an image capturing capability, which will not be limited herein. The camera module 13 may be configured to capture images of the predetermined region. The camera module 13 may be mounted within the predetermined region or outside the predetermined region, which will not be limited herein.

Specifically, the camera module 13 may capture images for the entire predetermined region 12 or for a primary portion of the predetermined region 12. That is, the entirety or the primary portion of the predetermined region 12 may be located within a field of view of the camera module 13. The primary portion may represent a portion of the predetermined region 12 that is traversed by the target object when performing the behavior corresponding to the target behavior type.

In an embodiment, the subject for performing the method of the present disclosure may be the camera module 13 or a base station corresponding to the camera module 13, which will not be limited herein.

In the present disclosure, the subject for performing the method of the present disclosure may obtain the images captured by the camera module 13 for the predetermined region and perform image recognition, so as to determine, based on the object behavior recognition method provided herein, whether the movement performed by the target object in the predetermined region belongs to the target behavior type.

In some embodiments, the first security video may include the images of the target object within the predetermined region.

Accordingly, the first security video may be recognized based on the following method to obtain the video recognition result for the first security video.

In a block 1, the movement distance and the endpoint of the target object after the movement within the predetermined region may be determined based on the images.

The target object may refer to a predetermined object having a behavior to be recognized, such as a pre-registered family member.

The predetermined region may refer to a predetermined region traversed by the target object when the target object performs the behavior belong to the target behavior type. For example, when the target object is performing a “returning home” action, an entrance region or a front yard region of a home region that is passed by the target object may be the predetermined region. In another example, when the target object is performing a “parcel delivery” action, a region in front of a parcel locker passed by the target object may be the predetermined region.

The movement distance may refer to a straight linear distance between a starting point and an endpoint of the movement of the target object within the predetermined region.

The starting point of the movement may be a position at which the target object begins moving upon entering the predetermined region. The endpoint of the movement may be a position at which the target object completes the movement in the predetermined region or disappears from the predetermined region.

When the images contain a regional object within the predetermined region (such as a house door, a parcel locker), the endpoint of the movement may be the position at which the target object completes the movement within the predetermined region; or may be a position at which the target object reaches a designated position. However, when the images do not contain the regional object with the predetermined region, for example, when the camera module is disposed above the door and cannot capture the door within the images, the camera module cannot capture termination of the movement of the target object. Therefore, the endpoint of the movement may be the position at which the target object disappears out of the predetermined region.

In an embodiment, at least one camera module (such as the camera module 13 shown in FIG. 5A) may be arranged to capture images for the predetermined region. Accordingly, the subject for performing the method of the present disclosure may take the camera module to detect the predetermined region in real time.

When detecting an object being present within the predetermined region, the subject for performing the method may recognize the object within the predetermined region. In some embodiments, when the object within the predetermined region is recognized as the target object, an image of the target object within the predetermined region may be obtained.

As an embodiment, the subject for performing the method of the present disclosure may detect presence of the target object within the predetermined region based on following means. Firstly, upon detecting an object being present within the image captured by the camera module, an object feature of the object may be extracted. The object feature may refer to a feature that can be used for recognizing the target object and may include, but not limited to, a physiological feature, an appearance feature, and a posture feature. The biometric feature may be: a facial feature or an iris feature, and so on. The appearance feature may be a clothing feature. The posture feature may include a gait feature or a pose feature. For example, when the object is a courier, the subject for performing the method of the present disclosure may recognize clothes of the object or a delivery ID of the object, so as to further determine that the object is the target object, i.e., the courier.

Subsequently, based on the above object feature, it may be determined whether the target object matching the object feature is stored in a predetermined database. In some embodiments, after the target object being matched, it may be determined that the target object is present within the predetermined region.

In an embodiment, upon determining the presence of the target object within the predetermined region, the image of the target object within the predetermined region may be obtained, and the movement distance and the endpoint of the target object after the movement within the predetermined region may be determined based on the image.

The image may include a plurality of image frames capturing the target object from the starting point of the movement to completion of the movement (or disappearance out of the predetermined region captured by the camera module). Accordingly, the subject for performing the method of the present disclosure may determine the movement distance and the endpoint of the target object after the movement within the predetermined region.

Specific operations by which the subject for performing the method of the present disclosure determines the movement distance and the endpoint of the target object after the movement within the predetermined region will be described in detail at a later section.

In a block 2, it may be determined whether the movement distance is greater than or equal to a predetermined first distance threshold and whether the endpoint after the movement is located within a predetermined endpoint region.

In a block 3, when the movement distance is determined to be greater than or equal to the first distance threshold and the endpoint after the movement is determined to be within the predetermined endpoint region, it may be determined that the video recognition result for the first security video indicates a current behavior of the target object belonging to the target behavior type.

The blocks 2 and 3 will be illustrated in combination in the following.

The first distance threshold may refer to a minimum distance required for the behavior corresponding to the target behavior type to move within the predetermined region.

The predetermined endpoint region may refer to a region within the predetermined region in which the target object, who performs the behavior corresponding to the target behavior type, finishes the movement or disappears from the captured images.

The target behavior type may refer to a type corresponding to a predetermined action, which may include, but not limited to: returning home, leaving home, going to a workplace, parcel delivery, and so on.

In the present disclosure, in order to more accurately determine whether the current behavior of the target object belongs to the target behavior type, the subject for performing the method of the present disclosure may recognize the behavior of the target object within the predetermined region from two aspects. In a first aspect, it may be determined whether the movement distance of the target object within the predetermined region is greater than or equal to the predetermined first distance threshold. In a second aspect, it may be determined whether the endpoint of the movement of the target object within the predetermined region is located within the predetermined endpoint region. It should be understood that, a sequence of determining whether the movement distance is greater than or equal to the first distance threshold and determining whether the endpoint of the movement is located within the predetermined endpoint region may not be limited herein.

In regard to the movement distance, as described above, the movement distance may refer to the straight linear distance between the starting point and the endpoint of the movement of the target object within the predetermined region. Therefore, when the movement distance is greater than or equal to the first distance threshold, scenarios where the target object temporarily moves, lingers, stays, or returns to the target area (such as home) after playing around may be precluded.

Furthermore, the first distance threshold may be determined as follows. The minimum distance between the predetermined starting point and the predetermined endpoint region may be determined as the first distance threshold. The predetermined starting point may be determined by configuring a starting point for the target behavior type, i.e., the user may predetermine the starting point for the behavior corresponding to the target behavior type.

In regard to the endpoint, since the target object may move in various directions, various endpoints may be reached. A type to which the behavior of the user belongs may be determined based on the endpoint of the target object. For example, when the user performs the “returning home” action, the endpoint may be located near the entrance of home. When the user performs the “leaving home” action, the endpoint may be located in a region farther from the entrance of home.

Accordingly, the endpoint region of the behavior corresponding to the target behavior type may be predetermined. When the endpoint of the target object is located within the predetermined endpoint region, it may be determined that the current behavior of the target object belongs to the target behavior type.

Specific operations for determining whether the endpoint of the movement of the target object is located within the predetermined endpoint region will be illustrated at a later section.

In an embodiment, the target behavior type may include the target object entering a target region. The target region may represent a behavior intension region of the target object (such as a region in which the house of the target object is located, or a region in which the parcel locker for holding parcels delivered by the courier is located). In this way, after determining that the current behavior of the target object belongs to the target behavior type, videos related to the target behavior type within a predetermined time period may be generated into a behavior log record.

Furthermore, in an embodiment, in order to more efficiently and accurately determine whether the current behavior of the target object belongs to the target behavior type, the subject for performing the method of the present disclosure may may define a first circle, taking a center of the endpoint region as a center of the first circle and taking the first distance threshold as a radius of the first circle. When it is determined that the target object moves from a point on a circumference of the first circle or from an outside of the circumference to enter the endpoint region, it may be determined that the current behavior of the target object belongs to the target behavior type.

Furthermore, in order to ensure accuracy of recognizing the target object by the subject for performing the method of the present disclosure, after the target object enters the endpoint region, the subject for performing the method of the present disclosure may perform identity recognition on the target object again.

In an embodiment, a target camera module for recognizing the biometric feature may be arranged inside the endpoint region. For example, when the endpoint region includes the door, the target camera module may be a doorbell camera. When it is determined that the object enters the endpoint region, the target camera module may recognize the biometric feature of the object (such as the facial feature or the iris feature).

Subsequently, based on the biometric feature, it may be determined whether the target object matching the biometric feature is stored in the predetermined database. In some embodiments, when it is determined that the target object is matched, it may be determined that the target object is located within the predetermined region. According to the above method, since the target camera module can detect the biometric feature of the object at a close range, the obtained biometric feature may be more accurate. Therefore, the target camera module may serve as an auxiliary device for further recognizing identify of the target object, to ensure accuracy of recognizing the identity of the object.

In addition, after the subject for performing the method of the present disclosure determines that the current behavior of the target object belongs to the target behavior type, the subject for performing the method of the present disclosure may send images and/or prompt information corresponding to the target behavior type to an external terminal. The prompt information may include at least one of: failure to detect other predetermined target objects within a predetermined time period, presence of a non-target object entering the predetermined region, and so on. The prompt information may alternatively be a notification of the recognized target behavior type, such as a child returning home or the courier from a specific delivery company delivering a parcel.

The external terminal may be a terminal, such as a smartphone, capable of establishing communication connection with a camera or a base station. In some embodiments, the external terminal may be installed with a corresponding application or may receive emails to view the behavior of the target object in real time.

For example, when the target object is the child of the family and the behavior corresponding to the target behavior type is returning home, and when the camera or the base station detects that the child returns home, a prompt information indicating the child arriving home may be generated and may be sent as a pop-up notification to the application installed in the external terminal or sent via an email to the external terminal.

In an embodiment, the user may set an end time point for each target object to perform the behavior corresponding to the target behavior type for each day (such as setting a latest home arrival time point for each target object). When the subject for performing the method of the present disclosure determines that the behavior of the target object belongs to the target behavior type, the subject for performing the method of the present disclosure may record the target object in a predetermined user table.

Subsequently, the end time point for each target object to enter the predetermined region may be obtained, when the end time point for each target object is reached, it may be checked whether the target object corresponding to the end time point is present in the user table.

In some embodiments, when the target object corresponding to the end time point is not present in the user table, the prompt information may be sent to the predetermined terminal to notify that the end time point has passed, and the target object has not yet performed the behavior corresponding to the target behavior type.

In an embodiment, when determining that the current behavior of the target object belongs to the target behavior type, it may be determined whether the target object is a first predetermined object. The first predetermined object may be a predetermined object at an age younger than a predetermined age, such as the child of the family.

In some embodiments, when the target object is determined as the first predetermined object, it may be determined whether another object is present in an image of the target object within the predetermined region. If the another object is present, a predetermined prompt information may be sent to the predetermined terminal. The another object may refer to an object that is not predetermined and may be recognized as a stranger. In this case, it may be determined that the stranger follows the child to return home. Therefore, in order to ensure safety of the child, an alert information may be sent to the terminal corresponding to the target object, to notify that the child is being followed and requiring special attention.

It should be understood that in the above embodiments, by obtaining the image of the target object within the predetermined region, the movement distance of the target object and the endpoint of the target object within the predetermined region may be determined based on the image. It may be determined whether the movement distance is greater than or equal to the predetermined first distance threshold and whether the endpoint is located within the predetermined endpoint region. When the movement distance is greater than or equal to the first distance threshold and the endpoint is located within the predetermined endpoint region, it may be determined that the current behavior of the target object belongs to the target behavior type. In the above embodiment, it may be determined whether the behavior of the target object belongs to the target behavior type by obtaining the image recording the movement within the predetermined region and by determining whether the movement distance and the endpoint of the movement satisfy conditions for the predetermined target behavior type. The determination does not rely on external devices, and the movement trajectory of the object outside the predetermined region may not be needed. Due to the region being passed by the behavior corresponding to the target behavior type, situations where the behavior of the target object cannot be detected when the movement trajectory is changed may be avoided, it may be rapidly and precisely determined whether the behavior of the object belongs to the target behavior type.

In some application scenarios of the above embodiments, the movement distance of the target object and the endpoint of the movement of the target object within the predetermined region may be determined based on the image by performing following blocks.

In a block 1, the starting point of the movement and the endpoint of the movement of the target object within the predetermined region may be determined.

In a block 2, a first straight linear distance between the starting point of the movement and the endpoint of the movement may be determined, and the first straight linear distance may be determined as the movement distance of the target object within the predetermined region.

The blocks 1 and 2 will be illustrated in combination in the following.

The starting point of the movement may refer to a location at which the target object begins moving within the predetermined region. Correspondingly, the endpoint of the movement may refer to a location at which the target object terminates the movement within the predetermined region or disappears from the captured image of the predetermined region.

The first straight linear distance may refer to a straight linear distance between the starting point and the endpoint of the movement, and that is, a shortest distance between the starting point and the endpoint.

In the present embodiment, the starting point and the endpoint of the movement of the target object within the predetermined region may be determined by recognizing the image of the target object within the predetermined region. The first straight linear distance between the starting point and the endpoint may be taken as the movement distance of the object within the predetermined region.

In an embodiment, the subject for performing the method of the present disclosure may obtain a depth of field captured by the camera at the starting point and determine a starting point capture distance between the camera and the starting point based on the depth of field. Similarly, the subject for performing the method of the present disclosure may obtain a depth of field captured by the camera at the endpoint and determine an endpoint capture distance between the camera and the endpoint based on the depth of field. In this way, the first straight linear distance may be determined based on the starting point capture distance and endpoint capture distance.

In another embodiment, the camera may be arranged with a distance sensor (including but not limited to: an optical distance sensor, an infrared distance sensor, an ultrasonic distance sensor, and so on). In this way, a first distance between the camera and the starting point of the movement and a second distance between the camera and the endpoint of the movement may be determined based on the distance sensor. Subsequently, a distance different between the first distance and the second distance may be determined to serve as the first straight linear distance.

In another embodiment, the subject for performing the method of the present disclosure may obtain starting coordinates of the starting point of the movement and endpoint coordinates of the endpoint of the movement and may perform calculation on the starting coordinates and the endpoint coordinates to obtain the first straight linear distance.

In an embodiment, the subject for performing the method of the present disclosure may obtain a movement trajectory of the target object within the predetermined region and determine the starting point and the endpoint of the target object along the movement trajectory. The starting point along the movement trajectory may be served as the starting point of the movement of the target object within the predetermined region, and the endpoint along the movement trajectory may be served as the endpoint of the movement of the target object within the predetermined region.

In an embodiment, an image of the target object within the predetermined region (which may be a video of the target object moving within the predetermined region) may be input to a pre-trained movement trajectory extraction model. In this way, the movement trajectory extraction model may extract the movement trajectory of the target object within the target region from the image.

Furthermore, the movement trajectory extraction model may include: N spatial-temporal graph convolutional layers and at least one classifier. The spatial-temporal graph convolutional layers may include graph convolution and spatial-temporal convolution. When the pre-trained movement trajectory extraction model is used to extract the movement trajectory of the target object within the predetermined region, the N spatial-temporal graph convolutional layers may be used to extract spatial features of key points of the target object within the image and temporal features of the key points of the target object across various frames. Specifically, the graph convolution may be used to extract the spatial features, and the spatial-temporal convolution may be used to extract the temporal features. During extracting the spatial features via the graph convolution, key points of limbs of the target object may be uniformly processed.

In particular, uniformly processing the key points of the limbs of the target object may refer to eliminating an edge weight in the model. That is, when determining an object model of the target object, based on the model in the art, the edge weight may be assigned to a limb model of the target object, such that the generated object model may more closely match the target object. However, in the present disclosure, the movement trajectory extraction model substantially aims to extract the movement trajectory of the target object, and therefore, when generating the object model of the target object, fuzzy processing may be performed. That is, the edge weight of the edge of the model corresponding to the limb may be eliminated, and a simpler object model corresponding to the target object may be generated (such as a stick figure). In this way, the model may be simplified, a time length for processing the model may be reduced, and the movement trajectory of the target object within the predetermined region may be determined more quickly.

Subsequently, at least one classifier may be configured to classify the spatial features and the temporal features, so as to obtain the movement trajectory of the object model within a target blank image. The object model may be a shape model corresponding to the target object. The target blank image may be a blank image without any background corresponding to the captured image.

Furthermore, the movement trajectory extraction model may be trained as follows. Firstly, a plurality of sample images containing movement processes of the target object may be obtained, and a standard movement trajectory of the object corresponding to each of the plurality of sample images may be obtained. Subsequently, each sample image may be input into an initial movement trajectory extraction model to obtain a predicted movement trajectory for each sample image output by the initial movement trajectory extraction model. Furthermore, for each sample image, a loss value corresponding to the sample image may be determined based on the standard movement trajectory and the predicted movement trajectory.

Subsequently, it may be determined, based on the loss value corresponding to each sample image, whether a predetermined convergence condition is met currently. In some embodiments, when the predetermined convergence condition is satisfied, the pre-trained movement trajectory extraction model may be obtained. In some embodiments, when the predetermined convergence condition is not satisfied, the initial movement trajectory extraction model may be continually trained based on the sample images.

The predetermined convergence condition may be that the loss value of each sample image is less than a first predetermined threshold, or may be that the number of sample images having the loss value less than the first predetermined threshold is greater than a second predetermined threshold. The present disclosure does not limit the predetermined convergence condition.

Furthermore, the initial movement trajectory extraction model may include: N initial spatial-temporal convolutional layers and at least one initial classifier. The initial spatial-temporal convolutional layers may include initial graph convolution and initial spatial-temporal convolution. Accordingly, when each sample image is input into the initial movement trajectory extraction model to obtain the predicted movement trajectory for each sample image output by the initial movement trajectory extraction model, each sample image may be sequentially input into the N initial spatial-temporal convolutional layers. In this way, the initial graph convolution of each of the N initial spatial-temporal convolutional layers may extract the initial spatial features of key points of the object in the sample image, and initial spatial-temporal convolution of each of the N initial spatial-temporal convolutional layers may extract the initial temporal features of key points of the object in various frames within the sample image. When extracting the initial spatial features of the key points of the object, the key points of the limb of the object may be uniformly processed.

Subsequently, the initial spatial features and the initial temporal features may be input into the at least one initial classifier to obtain the predicted movement trajectory of the initial object model within a sample blank image, as output by the initial classifier. The initial object model may be a shape model corresponding to the object, and the sample blank image may be a blank image without any background corresponding to the sample image.

It should be noted that the image and the sample images input to the movement trajectory extraction model and the sample images and the sample blank images that are output are all multi-frame images, the movement process of the shape model of the target object within a blank image can be clearly observed from a video segment composed of the multi-frame images.

It should be understood that, in the aforementioned application scenario, by determining the starting point and the endpoint of the movement of the target object within the predetermined region, the first straight linear distance between the starting point and the endpoint of the movement may be determined. The first straight linear distance may be determined as the movement distance of the target object within the predetermined region. In this way, the movement distance of the target object within the predetermined region may be determined by determining the starting point and the endpoint of the movement of the target object within the predetermined region. The movement distance may be the straight linear distance between the starting point and the endpoint and may directly reflect displacement of the target object within the predetermined region. In this way: it may be more accurately determined whether the behavior of the target object within the predetermined region belongs to the target behavior type. The movement distance of the target object within the predetermined region may be precisely determined, such that it may be more accurately determined whether the current behavior of the target object belongs to the target behavior type.

In some application scenarios of the above embodiments, it may be determined whether the endpoint of the movement is located within the predetermined endpoint region by performing the following.

In a block 1, an endpoint distance between the endpoint of the movement and a predetermined endpoint may be determined. The predetermined endpoint may be determined based on an endpoint corresponding to the target behavior type.

In a block 2, when the endpoint distance is less than or equal to a second distance threshold, it may be determined that the endpoint of the movement is located within the predetermined endpoint region. When the endpoint distance is greater than the second distance threshold, it may be determined that the endpoint of the movement is located outside the predetermined endpoint region.

Technical solutions described in the aforementioned application scenarios will be described in the following.

The predetermined endpoint may refer to an endpoint, which is set by the user for the behavior corresponding to the target behavior type and must be passed by the target object. When the image captured by the camera module includes the regional object (such as the door), the predetermined endpoint may be a location at which the user terminates the movement. When the image captured by the camera module does not include the reginal object, the predetermined endpoint may be a location at which the user disappears from the image of the predetermined region.

In the present embodiments, the user may predetermine an endpoint of the behavior corresponding to the target behavior type. Furthermore, the subject for performing the method of the present disclosure may determine the endpoint region within the predetermined region based on the predetermined endpoint. Furthermore, the subject for performing the method of the present disclosure may compare the determined endpoint of the movement of the target object with the predetermined endpoint to determine whether the target object has reached the endpoint region within the predetermined region.

In an embodiment, the endpoint distance between the endpoint of the movement and the predetermined endpoint, i.e., the straight linear distance therebetween, may be determined.

Subsequently, it may be determined whether the endpoint distance is less than or equal to the second distance threshold. In some embodiment, when the endpoint distance is determined to be less than or equal to the second distance threshold, the endpoint of the movement may be determined as being located within the predetermined endpoint region. Conversely: when the endpoint distance is determined to be greater than the second distance threshold, the endpoint of the movement may be determined as being located outside the predetermined endpoint region.

The second distance threshold may be determined based on the endpoint of at least one previous movement of at least one target object during previous time periods.

In an embodiment, the endpoint of the previous movement may be obtained, and a historical distance between the endpoint of the previous movement and the predetermined endpoint may be determined, and the predetermined endpoint may be determined in response to setting the target behavior type, and that is, the predetermined endpoint may be set by the user.

Subsequently, the second distance threshold may be determined based on the historical distance.

In some embodiment, when one historical distance is present, the one historical distance may be directly taken as the second distance threshold. When a plurality of historical distances are present, an average or a maximum of the plurality of historical distances may be taken as the second distance threshold.

According to the above, it can be inferred that the endpoint region may be a circle or a semicircle, taking the predetermined endpoint as a center of the circle or the semicircle and taking the second distance threshold as a radius of the circle or the semicircle.

Accordingly, when the subject for performing the method of the present disclosure determines whether the endpoint of the movement of the target object is located within the endpoint region of the predetermined region, the subject for performing the method of the present disclosure may determine the second distance threshold and then define a target circle or a target semicircle, taking the predetermined endpoint as a center of the target circle or the target semicircle and taking the second distance threshold as a radius of the target circle or the target semicircle.

Subsequently, it may be determined whether the endpoint of the movement is located within the target circular or the semicircular. When the endpoint of the movement is determined as being located within the target circular or the semicircular, it may be determined that the endpoint of the movement of the target object is within the endpoint region. When the endpoint of the movement is determined as not being located within the target circular or the semicircular, it may be determined that the endpoint of the movement of the target object is located outside the endpoint region.

In another embodiment, the subject for performing the method of the present disclosure may determine coordinates of the endpoint region, as coordinates of the determined target circle or target semicircle, based on the coordinates of the predetermined endpoint.

Subsequently, when determining whether the endpoint of the movement of the target object is located within the predetermined endpoint region, coordinates of the endpoint of the movement of the target object may be obtained, and it may be determined whether the coordinates of the endpoint of the movement of the target object is located within the coordinates of the endpoint region. When the coordinates of the endpoint of the movement of the target object is determined as being located within the coordinates of the endpoint region, the endpoint of the movement of the target object may be determined as being located within the predetermined endpoint region.

It may be understood that, for the technical solution of the above application scenario, it may be determined whether the distance between the endpoint of the movement and the predetermined endpoint is less than or equal to the second distance threshold. When the distance between the endpoint of the movement and the predetermined endpoint is less than or equal to the second distance threshold, the endpoint of the movement may be determined as being located within the predetermined endpoint region. When the distance between the endpoint of the movement and the predetermined endpoint is not less than or equal to the second distance threshold, the endpoint of the movement may be determined as being located outside the predetermined endpoint region. In this way, by comparing the distance between the endpoint of the movement of the target object within the predetermined region and the predetermined endpoint with the second distance threshold, it may be simply and accurately determined whether the endpoint of the movement of the target object is within the predetermined endpoint region. In this way, it may be simply and accurately determined whether the current behavior of the target object belongs to the target behavior type.

In some embodiments, the first security video may include images of the target object located within the predetermined region.

Accordingly, the first security video may be recognized by performing the following to obtain the video recognition result.

In a block 1, the starting point and the endpoint of the movement of the target object within the predetermined region may be determined based on the images.

The target object refers to an object, who is preset and has a behavior to be recognized. For example, the target object may be a predetermined family member.

The predetermined region refers to a predetermined region, which is traversed by target object when the target object is performing the behavior belonging to the target behavior type. For example, when the target object is performing the “returning home” behavior, the entrance region or the front yard region of the home region may be the predetermined region. When the target object is performing the “parcel delivery” behavior, a region in front of the parcel locker passed by the target object may be the predetermined region.

The starting point of the movement may be the location at which the target object begins moving upon entering the predetermined region, and the endpoint of the movement may be the location at which the target object completes the movement or disappears out of the predetermined region.

When the images include the regional object within the predetermined region (such as the house door, the parcel locker), the endpoint of the movement may be the location at which the target object completes the movement within the predetermined region, or the location at which the target object reaches a designated location.

However, when the images do not include the regional object of the predetermined region, for example, when the camera module is located above the door and cannot capture an image of the door, the camera module cannot capture an image showing the target object terminates the movement. Therefore, the endpoint of the movement may be the location at which the target object disappears out of the predetermined region. In addition, the endpoint of the movement may be a designated location region, such as a region predetermined by the user within the predetermined region.

In an embodiment, at least one camera module (such as the camera module 13 shown in FIG. 5A) may be arranged to capture the image for the predetermined region. In this way, the subject for performing the method of the present disclosure may take the camera module to detect the predetermined region in real time. When detecting an object being present within the predetermined region, the subject for performing the method of the present disclosure may recognize the object within the predetermined region. In some embodiment, when the object within the predetermined region is recognized as the target object, an image of the target object within the predetermined region may be obtained.

In an embodiment, the subject for performing the method of the present disclosure may detect presence of the target object within the predetermined region by performing the following. Firstly, when the object is detected as being present in the image captured by the camera module, an object feature of the detected object may be extracted from the captured image. The object feature may refer to a feature that can be used to recognize the target object and may include, but not limited to, the biometric feature, the appearance feature, and the posture feature. The biometric feature may include the facial feature or the iris feature of the object. The appearance feature may include a clothing feature. The posture feature may include a gait feature or the posture feature of the object. For example, when the object is the courier, the subject for performing the method of the present disclosure may recognize clothes or a courier identity number the object, so as to determine that the object is the target object, i.e., the courier.

Subsequently, it may be determined, based on the object feature, whether the target object matching the feature is stored in the predetermined database. In some embodiments, upon matching the target object, it may be determined that the target object is present within the predetermined region.

In an embodiment, when it is determined that the target object is present within the predetermined region, an image of the target object within the predetermined region may be obtained, and the starting point and the endpoint of the movement of the target object within the predetermined region may be determined based on the image.

The image may include a plurality of frames capturing the movement of the target object from starting the movement to completion of the movement (or disappearance out of a camera view of the predetermined region). Accordingly, the subject for performing the method of the present disclosure may determine the starting point and the endpoint of the movement of the target object within the predetermined region.

In a block 2, when it is determined that the starting point of the movement is located within a predetermined starting point region and the endpoint of the movement is located within the predetermined endpoint region, it may be determined that the video recognition result for the first security video indicates the current behavior of the target object belonging to the target behavior type.

The starting point region refers to a region in which a starting point of the behavior corresponding to the predetermined target behavior type is located.

The predetermined endpoint region refers to a region in which the movement of the behavior corresponding to the predetermined target behavior type is terminated, or a region in which the target object, who performs the behavior corresponding to the predetermined target behavior, disappears.

In the embodiments, the subject for performing the method of the present disclosure may determine whether the target object moves from the starting point region to the endpoint region, so as to determine whether the current behavior of the target object belongs to the target behavior type.

In an embodiment, it may be determined whether the starting point of the movement is located within the starting point region, and whether the endpoint of the movement is located within the endpoint region. In some embodiments, when it is determined that the starting point of the movement is located within the starting point region and the endpoint of the movement is located within the endpoint region, it may be determined that the current behavior of the target object belongs to the target behavior type.

In an embodiment, a starting point distance between the starting point of the movement and a predetermined starting point may be determined, and an endpoint distance between the endpoint of the movement and the predetermined endpoint may be determined. The predetermined starting point may be determined in response to setting the starting point of the target behavior type, and the predetermined endpoint may be determined in response to setting the endpoint of the target behavior type. Specific operations for predetermining the starting point and the endpoint will be described at a later section.

Subsequently, when it is determined that the starting point distance is less than a third distance threshold and the endpoint distance is less than a fourth distance threshold, it may be determined that the starting point of the movement is located within the predetermined starting point region and the endpoint of the movement is located within the predetermined endpoint region.

Each of the third distance threshold and the fourth distance threshold may be a predetermined distance threshold, or may be determined by the subject for performing the method of the present disclosure based on a plurality of historical starting points and a plurality of historical endpoints generated when the object performs behaviors corresponding to the target behavior type during a historical time period. For example, a maximum distance among the plurality of historical starting points may be determined as the third distance threshold, and a maximum distance among the plurality of historical endpoints may be determined as the fourth distance threshold.

In addition, the subject for performing the method of the present disclosure may determine the movement distance of the target object within the predetermined region based on the starting point and the endpoint of the movement.

Subsequently, it may be determined whether the movement distance is greater than or equal to the predetermined first distance threshold, and whether the endpoint of the movement is located within the predetermined endpoint region. In some embodiments, when the movement distance is greater than or equal to the predetermined first distance threshold, and when the endpoint of the movement is located within the predetermined endpoint region, it may be determined that the current behavior of the target object belongs to the target behavior type.

Details for determining the movement distance and determining the endpoint of the movement being located within the predetermined endpoint region may be referred to the above description, which will not be repeated herein.

It may be understood that in the above embodiments, by obtaining the images of the target object within the predetermined region, the starting point and the endpoint of the movement of the target object within the predetermined region may be determined based on the images. When the starting point is determined as being located within the starting point region and the endpoint of the movement is determined as being located within the endpoint region, the current behavior of the target object may be determined as belonging to the target behavior type. In this way, by capturing images of the target object moving within the predetermined region and by determining whether the starting point and the endpoint of the movement of the target object are located within the starting point region and within the endpoint region respectively, it may be determined whether the behavior of the object belongs to the target behavior type. The determination does not rely on external devices, and the movement trajectory of the object outside the predetermined region may not need to be obtained. Since the predetermined region is the region traversed by the target object during the target object performing the behavior corresponding to the target behavior type, situations where the behavior of the target object cannot be determined due to the movement trajectory being changed may be avoided. In this way, it may be rapidly and accurately determined whether the behavior of the object belongs to the target behavior type. In some embodiments, the behavior of the object may be recognized as follows.

In a block 1, the image of the target object within the predetermined region may be obtained, and movement information of the target object within the predetermined region may be determined based on the image.

The target object refers to the object, who is predetermined and has the behavior to be recognized, such as a predetermined family member.

The predetermined region refers to the predetermined region traversed by the target object when the target object is performing the behavior belonging to the target behavior type. For example, when the target object is performing the “returning home” behavior, the entrance region or the front yard region of the home region may be the predetermined region. When the target object is performing the “parcel delivery” behavior, a region in front of the parcel locker passed by the target object may be the predetermined region.

The movement information refers to movement information of the target object within the predetermined region and may include, but not limited to: the movement distance, the starting point of the movement, and the endpoint of the movement. The movement distance may be the straight linear distance between the starting point and the endpoint of the movement of the target object within the predetermined region. The starting point of the movement is the location at which the target subject begins moving upon entering the predetermined region. The endpoint of the movement is the location at which the target subject terminates the movement or disappears out of the predetermined region.

When the image includes the regional object within the predetermined region (such as the house door, the parcel locker), the endpoint of the movement may be the location at which the target object terminates the movement within the predetermined region, or the location at which the target object reaches a designated location. However, when the image does not include the regional object of the predetermined region, for example, when the camera module is located above the door and cannot capture an image of the door, the camera module cannot capture an image showing the target object terminates the movement. Therefore, the endpoint of the movement may be the location at which the target object disappears out of the predetermined region.

In an embodiment, at least one camera module (such as the camera module 13 shown in FIG. 5A) may be arranged to capture the image for the predetermined region. In this way, the subject for performing the method of the present disclosure may take the camera module to detect the predetermined region in real time. When detecting an object being present within the predetermined region, the subject for performing the method of the present disclosure may recognize the object within the predetermined region. In some embodiment, when the object within the predetermined region is recognized as the target object, an image of the target object within the predetermined region may be obtained.

In an embodiment, the subject for performing the method of the present disclosure may detect presence of the target object within the predetermined region by performing the following. Firstly, when the object is detected as being present in the image captured by the camera module, an object feature of the detected object may be extracted from the captured image. The object feature may refer to a feature that can be used to recognize the target object and may include, but not limited to, the biometric feature, the appearance feature, and the posture feature. The biometric feature may include the facial feature or the iris feature of the object. The appearance feature may include a clothing feature. The posture feature may include a gait feature or the posture feature of the object. For example, when the object is the courier, the subject for performing the method of the present disclosure may recognize clothes or a courier identity number the object, so as to determine that the object is the target object, i.e., the courier.

Subsequently, it may be determined, based on the object feature, whether the target object matching the feature is stored in the predetermined database. In some embodiments, upon matching the target object, it may be determined that the target object is present within the predetermined region.

In an embodiment, after determining presence of the target object within the predetermined region, the image of the target object within the predetermined region may be obtained, and the movement information of the target object within the predetermined region may be determined based on the image.

The image may include a plurality of frames capturing the movement of the target object from starting the movement to completion of the movement (or disappearance out of a camera view of the predetermined region). Accordingly, the subject for performing the method of the present disclosure May determine, based on the plurality of frames, the movement information of the target object within the predetermined region.

In a block 2, it may be determined, based on the movement information of the target object, whether the current behavior of the target object belongs to the target behavior type.

In an embodiment, the subject for performing the method of the present disclosure may determine whether the current behavior of the target object belongs to the target behavior type based on the movement information.

In an embodiment, the movement information may include the movement distance and the endpoint of the movement of the target object within the predetermined region. Accordingly, the subject for performing the method of the present disclosure may determine whether the current behavior of the target object belongs to the target behavior type based on the movement distance and the endpoint of the movement.

Details for determining whether the current behavior of the target object belongs to the target behavior type based on the movement distance and the endpoint of the movement, may be referred to the above description, which will not be repeated herein.

In an embodiment, the movement information may include the starting point and the endpoint of the movement of the target object within the predetermined region. Accordingly, the subject for performing the method of the present disclosure may whether the current behavior of the target object belongs to the target behavior type based on the starting point and the endpoint of the movement.

Details for determining whether the current behavior of the target object belongs to the target behavior type based on the starting point and the endpoint of the movement, may be referred to the above description, which will not be repeated herein.

It can be understood that in the above embodiment, the image of the target object within the predetermined region may be obtained, the movement information of the target object within the predetermined region may be determined based on the image, and it may be determined whether the current behavior of the target object belongs to the target behavior type based on the movement information. In this way, by capturing images of the target object moving within the predetermined region and by determining whether the movement information of the target object in the image meets predetermined conditions for the target behavior type, it may be determined whether the current behavior of the target object belongs to the target behavior type. The determination does not rely on external devices, and the movement trajectory of the object outside the predetermined region may not need to be obtained. Since the predetermined region is the region traversed by the target object during the target object performing the behavior corresponding to the target behavior type, situations where the behavior of the target object cannot be determined due to the movement trajectory being changed may be avoided. In this way: it may be rapidly and accurately determined whether the behavior of the object belongs to the target behavior type.

In some embodiments, the first security video may include images captured for the predetermined region.

Accordingly, the first security video may be obtained by: obtaining images captured for the predetermined region and displaying the captured images.

The predetermined region refers to the predetermined region traversed by the object when performing the behavior corresponding to the target behavior type.

The captured images refer to the images captured by the camera module for the predetermined region.

In an embodiment, the subject for performing the method of the present disclosure may be a predetermined terminal (which may be a terminal device or an application installed on the terminal device, which is not limited herein). The predetermined terminal may be a terminal connected to the camera module or the base station. The terminal may obtain in real time the images captured for the predetermined region from the camera module and display the images on a visual interface, so as to enable the user to make settings based on the images.

In an embodiment, since a plurality of camera modules may be used to capture the images for the predetermined region in practice, the subject for performing the method of the present disclosure, when obtaining the captured images, may obtain a list of camera modules used for capturing the images for the predetermined region and display the list.

The user may select a target camera module from the list. Accordingly, the subject for performing the method of the present disclosure may determine, in response to the selection performed on the list of camera modules, the target camera module from the list and obtain the images captured for the predetermined region through the target camera module.

Accordingly, the video recognition result for the first security video may be obtained as follows.

In a block 1, the captured images may be recognized to determine the predetermined starting point and the predetermined endpoint of the target behavior type that is set for the captured images.

The predetermined starting point refers to the starting point at which movement of the behavior corresponding to the user-set target behavior type begins within the predetermined region.

The predetermined endpoint refers to the endpoint at which the movement of the behavior corresponding to the user-set target behavior type is terminated within the predetermined region or disappears out of the images for the predetermined region.

When the captured images include the regional object (such as the door), the predetermined endpoint may be the location at which the user terminates the movement. When the captured images do not include the regional object, the predetermined endpoint may be the location at which the user disappears out of the images for the predetermined region.

The target behavior type refers to a type corresponding to a predetermined behavior, and the predetermined behavior may include: returning home, going to the workplace, or parcel delivery.

In the embodiments of the present disclosure, the subject for performing the method of the present disclosure may obtain and output the captured images for the predetermined region. Accordingly, the user may set the predetermined starting and the predetermined endpoint corresponding to the target behavior type for the captured images.

Accordingly, the subject for performing the method of the present disclosure may determine the predetermined starting and the predetermined endpoint of the target behavior type set for the captured images.

In an embodiment, the user may trigger (such as double-click, single-click, or long-press) a display screen of the subject for performing the method of the present disclosure. In response to the trigger performed by the user, the subject for performing the method of the present disclosure may output a predetermined icon within the captured image. The predetermined icon may be a user image of the user logged into the subject for performing the method of the present disclosure. Alternatively, the predetermined icon may be a default icon such as an arrow; a dot, a circle, and so on, which will not be limited herein.

Accordingly, the subject for performing the method of the present disclosure may recognize, in response to setting for the predetermined icon in the captured image, the predetermined starting point and the predetermined endpoint.

In an embodiment, the setting for the predetermined icon may include a clicking operation. Specifically, at each time when the user clicks the captured image, the subject for performing the method of the present disclosure may set, in response to the clicking operation of the user, one predetermined icon at a position corresponding to the clicking operation. Accordingly, the user may perform at least two clicking operations on the captured image. The subject for performing the method of the present disclosure may set, in response to the at least two clicking operations on the captured image, one predetermined icon at the position corresponding to each of the at least two clicking operations.

Subsequently, the subject for performing the method of the present disclosure may obtain positions clicked by the user for at least two predetermined icons and determine the predetermined starting point and the predetermined endpoint based on the positions of the at least two predetermined icons.

In some embodiments, the subject for performing the method of the present disclosure may determine the predetermined starting point and the predetermined endpoint based on a sequence of the at least two clicking operations. For example, a position that is clicked firstly may be designated as the predetermined starting point, and a position that is clicked later may be designated as the predetermined endpoint.

In some embodiments, the subject for performing the method of the present disclosure may output a selection box at each position to indicate whether the instant position is the predetermined starting point or the predetermined endpoint. The user may use the selection box to determine whether the instant position is designated as the predetermined starting point or as the predetermined endpoint. Accordingly, the subject for performing the method of the present disclosure may finally determine the predetermined starting point and the predetermined endpoint according to the selection performed by the user.

In another embodiment, the setting for the predetermined icon may include a dragging operation.

Specifically, after triggering the captured image and displaying the predetermined icon in the captured image, the user may drag the predetermined icon to draw the movement trajectory corresponding to the target behavior type within the captured image. The subject for performing the method of the present disclosure may determine a dragging trajectory corresponding to the dragging operation performed on the predetermined icon within the captured image and may determine a dragging starting point and a dragging endpoint of the dragging trajectory.

Subsequently, the dragging starting point may be designated as the predetermined starting point of the target behavior type set for the captured image, and the dragging endpoint may be designated as the predetermined endpoint of the target behavior type set for the captured image.

For example, when the behavior of the target behavior type is the “returning home” behavior of the target object, the camera module connected to the subject for performing the method of the present disclosure may be a camera that is mounted at a higher position by the user, and the captured image obtained by the subject for performing the method of the present disclosure may be as shown in FIG. 5B. As shown in FIG. 5B. FIG. 5B is a schematic view of the captured image according to an embodiment of the present disclosure. When the camera module connected to the subject for performing the method of the present disclosure is a camera installed on the door, the captured image obtained by the subject for performing the method of the present disclosure may be as shown in FIG. 5C, which is another schematic view of the captured image according to an embodiment of the present disclosure. As shown in FIGS. 5B and 5C, a difference therebetween is that the camera module can or cannot capture the door within the image.

As shown in FIG. 5B or FIG. 5C, when the subject for performing the method of the present disclosure detects the trigger performed by the user, the subject for performing the method of the present disclosure may output the predetermined icon in the captured image. The user may drag the predetermined icon to draw the movement trajectory of the behavior corresponding to the target behavior type within the captured image, and that is, the movement trajectory from a point A to a point B as shown in FIG. 5C. Accordingly, the dragging starting point A of the recognized movement trajectory may be designated as the predetermined starting point, and the dragging endpoint B of the recognized movement trajectory may be designated as the predetermined endpoint.

In another embodiment, the user may capture a video independently. The video may include a movement process of any target object performing the behavior corresponding to the target behavior type within the predetermined region, such as the “returning home” behavior. Subsequently, the user may send the captured video to the subject for performing the method of the present disclosure.

Accordingly, the subject for performing the method of the present disclosure may obtain the input captured video, and the input captured video may include the behavior in the target behavior type performed by the predetermined object within the predetermined region. Subsequently, the captured video may be analyzed to determine an appearance point and a disappearance point of the predetermined object within the captured video. The appearance point may then be designated as the predetermined starting point of the target behavior type set for the captured image, and the disappearance point may be designated as the predetermined endpoint of the target behavior type set for the captured image.

Furthermore, in order to enhance accuracy of the predetermined starting point and the predetermined endpoint, after recognizing the appearance point and the disappearance point, the subject for performing the method of the present disclosure may mark the appearance point and the disappearance point within the captured image and may output prompt information indicating whether to set the appearance point as the predetermined starting point and whether to set the disappearance point as the predetermined endpoint. When the user clicks a confirmation button in the prompt information, the subject for performing the method of the present disclosure may determine the appearance point as the predetermined starting point and determine the disappearance point as the predetermined endpoint.

In a block 2, a distance threshold corresponding to the target behavior type may be determined based on the predetermined starting point and the predetermined endpoint, and it may be determined whether the behavior of the object belongs to the target behavior type based on the distance threshold and the predetermined endpoint. In this way, the video recognition result for the first security video may be obtained.

The distance threshold refers to a minimum movement distance within the predetermined region of the behavior corresponding to the target behavior type. That is, when the current behavior of the object belongs to the target behavior type, the movement distance of the object within the predetermined region may be greater than or equal to the distance threshold.

In an embodiment, the subject for performing the method of the present disclosure may determine the distance threshold based on the predetermined starting point position and the predetermined endpoint, so as to determine whether the behavior of the target object belongs to the target behavior type based on the distance threshold and the predetermined endpoint.

In an embodiment, the straight linear distance between the predetermined starting point and the predetermined endpoint may be determined as the distance threshold.

Furthermore, after determining the distance threshold, the distance threshold and the predetermined endpoint may be transmitted to the camera module or the base station of the camera module. In this way, the camera module or the base station may determine, based on the distance threshold and the predetermined endpoint, whether the behavior of the target object belongs to the target behavior type.

Furthermore, the endpoint region corresponding to the target behavior type may be determined based on the predetermined endpoint, and the distance threshold and the endpoint region may be transmitted to the camera module or the base station of the camera module. In this way, the camera module or the base station may determine whether the behavior of the target object belongs to the target behavior type based on the distance threshold and the endpoint region.

In an embodiment, when the camera module is located outside the regional object, the captured image may include the region object (for example, when the behavior corresponding to the target behavior type is the returning home behavior, the regional object refers to the door of the home of the user; and when the behavior corresponding to the target behavior type is delivering a parcel, the regional object refers to the delivery locker), the predetermined endpoint may be located on the regional object. When the camera module is located on the regional object, the captured image may not contain the regional object, and the predetermined endpoint may not be located on the regional object.

Accordingly: when determining the endpoint region for the behavior corresponding to the target behavior type based on the predetermined endpoint, it may be firstly determined whether the predetermined endpoint is located on the predetermined regional object.

In some embodiments, when determining that the predetermined starting point is located on the regional object, the endpoint region of the behavior corresponding to the target behavior type may be determined taking the regional object as a center of the endpoint region. For example, the endpoint region may be a circle, taking the regional object as a center of the circle and taking the first predetermined distance threshold as a radius of the circle.

Conversely: when the predetermined starting point is determined as being not located on the regional object, the endpoint region of the behavior corresponding to the target behavior type may be determined by taking the predetermined endpoint as the center of the endpoint region. For example, the endpoint region may be a circle, taking the predetermined endpoint as the center of the circle and taking the second predetermined distance threshold as a radius of the circle. The first predetermined distance threshold and the second predetermined distance thresholds may be the same as or different from each other.

Furthermore, a plurality of target objects may exist in practice. Therefore, the subject for performing the method of the present disclosure may output an object list, and the user may select the target object having the behavior to be recognized. Subsequently, the target object selected by the user and the object feature of the target object may be transmitted to the camera module or the base station. The camera module or the base station may determine, during recognizing the behavior of the object, whether the behavior of the target object selected by the user belongs to the target behavior type.

In an embodiment, the object list may be obtained and displayed. Subsequently, the user may select the target object, having the behavior to be recognized, from the object list.

Accordingly, the subject for performing the method of the present disclosure may determine, list in response to the object selection operation performed on the object list, the target object from the object and may recognize whether the behavior of the target object belongs to the target behavior type.

In the above embodiments, by obtaining and displaying the captured image for the predetermined region, the predetermined starting point and the predetermined endpoint of the target behavior type set for the captured image may be determined. The distance threshold corresponding to the target behavior type may be determined based on the predetermined starting point and the predetermined endpoint. It may be determined, based on the distance threshold and the predetermined endpoint, whether the behavior of the object belongs to the target behavior type. In this way: by displaying the captured image for the predetermined region on the predetermined terminal, the user may set, when the target object is performing the behavior corresponding to the target behavior type, the predetermined starting point and the predetermined endpoint for the captured image. The distance threshold of the behavior corresponding to the target behavior type may be determined based on the predetermined starting point and the predetermined endpoint. In this way, the camera module or the base station may recognize the behavior of the target object based on the distance threshold and the predetermined endpoint. An “immersive” user experience and an animated feeling may be provided, taking the user to enter a familiar homecoming scenario, a rapid and precise homecoming trajectory may be drawn, such that the efficiency and accuracy of recognizing the behavior of the object may be improved.

In some embodiments, the first security video may include the captured image for the predetermined region.

Accordingly, the first security video may be obtained by: obtaining the captured image for the predetermined region and displaying the captured image.

Furthermore, the first security video may be recognized to obtain the video recognition result as follows.

In a block 1, the captured image may be recognized to determine the movement trajectory of the target behavior type set for the captured image.

In a block 2, the distance threshold and the endpoint region corresponding to the target behavior type may be determined based on the movement trajectory; and it may be determined whether the behavior of the object belongs to the target behavior type based on the distance threshold and the endpoint region, such that the video recognition result for the first security video may be obtained.

The blocks 1 and 2 are explained in combination in the following.

The movement trajectory refers to a trajectory along which the user moves within the predetermined region when performing the behavior corresponding to the target behavior type.

The target behavior type refers to a type corresponding to the predetermined behavior, and the predetermined behavior may include returning home, going to the workplace, or delivering the parcel.

The distance threshold may be the minimum movement distance of the behavior corresponding to the target behavior type within the predetermined region. That is, when the current behavior of the object belongs to the target behavior type, the movement distance within the predetermined region may be greater than or equal to the distance threshold.

The endpoint region refers to the region in which the user, when performing the behavior corresponding to the target behavior type, terminates the movement or disappears out of the predetermined region.

In the embodiments of the present disclosure, the subject for performing the method of the present disclosure may obtain and output the captured image for the predetermined region. Accordingly, the user may set the movement trajectory corresponding to the target behavior type for the captured image.

Subsequently, the distance threshold and the endpoint region corresponding to the target behavior type may be determined based on the movement trajectory. The distance threshold and the endpoint region may be transmitted to the camera module or the base station, such that the camera module or the base station may determine whether the behavior of the an object belongs to the target behavior type based on the distance threshold or the endpoint region.

In an embodiment, the user may trigger (such as double-click, single-click, or long-press) a display screen of the subject for performing the method of the present disclosure. In response to the trigger performed by the user, the subject for performing the method of the present disclosure may output the predetermined icon within the captured image. The predetermined icon may be a user image of the user logged into the subject for performing the method of the present disclosure. Alternatively, the predetermined icon may be a default icon such as an arrow, a dot, a circle, and so on, which will not be limited herein.

Accordingly, the subject for performing the method of the present disclosure may recognize, in response to setting for the predetermined icon in the captured image, the movement trajectory of the target behavior type.

In an embodiment, the setting for the predetermined icon may include the dragging operation. Specifically, after triggering the captured image and displaying the predetermined icon in the captured image, the user may drag the predetermined icon to draw the movement trajectory corresponding to the target behavior type within the captured image. The subject for performing the method of the present disclosure may determine, in response to the dragging operation performed on the predetermined icon within the captured image, the dragging trajectory corresponding to the dragging operation.

Subsequently, the subject for performing the method of the present disclosure may determine the predetermined starting point and the predetermined endpoint based on the movement trajectory and may determine the distance threshold and the endpoint region based on the predetermined starting point and the predetermined endpoint.

In an embodiment, the dragging starting point and the dragging endpoint of the dragging trajectory may be determined. The dragging starting point may be determined as the predetermined starting point of the target behavior type set for the captured image, and the dragging endpoint may be determined as the predetermined endpoint of the target behavior type set for the captured image.

For example, when the behavior of the target behavior type is the “returning home” behavior of the target object, the camera module connected to the subject for performing the method of the present disclosure may be the camera that is mounted at a higher position by the user, and the captured image obtained by the subject for performing the method of the present disclosure may be as shown in FIG. 5B. As shown in FIG. 5B. FIG. 5B is the schematic view of the captured image according to an embodiment of the present disclosure. When the camera module connected to the subject for performing the method of the present disclosure is the camera installed on the door, the captured image obtained by the subject for performing the method of the present disclosure may be as shown in FIG. 5C, which is another schematic view of the captured image according to an embodiment of the present disclosure. As shown in FIGS. 5B and 5C, a difference therebetween is that the camera module can or cannot capture the door within the image.

As shown in FIG. 5B or FIG. 5C, when the subject for performing the method of the present disclosure detects the trigger performed by the user, the subject for performing the method of the present disclosure may output the predetermined icon in the captured image. The user may drag the predetermined icon to draw the movement trajectory of the behavior corresponding to the target behavior type within the captured image, and that is, the movement trajectory from the point A to the point B as shown in FIG. 5C. Accordingly, the dragging starting point A of the recognized movement trajectory may be designated as the predetermined starting point, and the dragging endpoint B of the recognized movement trajectory may be designated as the predetermined endpoint.

In an embodiment, the subject for performing the method of the present disclosure may determine the distance threshold and the endpoint region based on the predetermined starting point and the predetermined endpoint, so as to determine whether the behavior of the target object belongs to the target behavior type based on the distance threshold and the endpoint region in the context.

In an embodiment, the straight linear distance between the predetermined starting point and the predetermined endpoint may be determined as the distance threshold.

Furthermore, when the camera module is located outside the regional object, the captured image may include the region object (for example, when the behavior corresponding to the target behavior type is the returning home behavior, the regional object refers to the door of the home of the user; and when the behavior corresponding to the target behavior type is delivering a parcel, the regional object refers to the delivery locker), the predetermined endpoint may be located on the regional object. When the camera module is located on the regional object, the captured image may not contain the regional object, and the predetermined endpoint may not be located on the regional object.

Accordingly, when determining the endpoint region for the behavior corresponding to the target behavior type based on the predetermined endpoint, it may be firstly determined whether the predetermined endpoint is located on the predetermined regional object.

In some embodiments, when determining that the predetermined endpoint is located on the regional object, the endpoint region of the behavior corresponding to the target behavior type may be determined, taking the regional object as a center of the endpoint region. For example, the endpoint region may be a circle, taking the regional object as a center of the circle and taking the first predetermined distance threshold as a radius of the circle.

Conversely, when the predetermined end point is determined as being not located on the regional object, the endpoint region of the behavior corresponding to the target behavior type may be determined by taking the predetermined endpoint as the center of the endpoint region. For example, the endpoint region may be a circle, taking the predetermined endpoint as the center of the circle and taking the second predetermined distance threshold as a radius of the circle. The first predetermined distance threshold and the second predetermined distance thresholds may be the same as or different from each other.

In another embodiment, the endpoint region may be formed by taking the predetermined starting point as the center of the circle and taking the first distance threshold as the radius. The distance threshold may be a distance from the predetermined starting point to any edge of the endpoint region. The aforementioned first distance threshold may be a distance value preset by the user.

It should be understood that in the above embodiment, by obtaining and displaying the captured image for the predetermined region, the movement trajectory of the target behavior type set for the captured image may be determined. The distance threshold and the endpoint region corresponding to the target behavior type may be determined based on the movement trajectory, such that it is further determined whether the behavior of the object belongs to the target behavior type based on the distance threshold and the endpoint region. In this way: by displaying the captured image for the predetermined region on the predetermined terminal, the user may set the movement trajectory for the captured image when the target object is performing the behavior corresponding to the target behavior type. The distance threshold and the endpoint region of the behavior corresponding to the target behavior type may be determined based on the movement trajectory. In this way, the camera module or the base station may recognize the behavior of the target object based on the distance threshold and the endpoint region. The movement trajectory of the returning home behavior may be rapidly and precisely drawn, and the efficiency and accuracy of recognizing the behavior of the object may be improved.

In some embodiments, the first security video may include the captured image for the predetermined region.

Accordingly, the first security video may be obtained by: obtaining the captured image for the predetermined region and displaying the captured image.

Furthermore, the first security video may be analyzed as follows to obtain video recognition result.

In a block 1, the captured image may be recognized to determine the predetermined starting point and the predetermined endpoint of the target behavior type set for the captured image.

In a block 2, the starting point region and the endpoint region may be determined respectively based on the predetermined starting point and the predetermined endpoint, and it may be determined whether the behavior of the object belongs to the target behavior type based on the starting point region and the endpoint region, such that the video recognition result for the first security video may be obtained.

The blocks 1 and 2 will be illustrated in combination in the following.

The target behavior type refers to the type corresponding to the predetermined behavior, and the predetermined behavior may include behaviors such as returning home, leaving home, going to the workplace, or delivering a parcel.

The predetermined starting point may be a location at which the behavior corresponding to the user-set target behavior type begins moving within the predetermined region.

The predetermined endpoint may be a location at which the behavior corresponding to the user-set target behavior type terminates the movement within the predetermined region or disappears out of the image for the predetermined region.

The starting point region refers to a region in which the starting point of the behavior corresponding to the predetermined target behavior type is located.

The endpoint region refers to a region in which the movement in the behavior corresponding to the predetermined target behavior type is terminated, or a region in which the target object disappears.

In the embodiments of the present disclosure, the subject for performing the method of the present disclosure may obtain and output the captured image for the predetermined region. Accordingly, the user may set the starting point of the movement and the endpoint of the movement corresponding to the target behavior type for the captured image.

Accordingly, the subject for performing the method of the present disclosure may determine the predetermined starting point and the predetermined endpoint of the target behavior type set for the captured image: may determine the starting point region and the endpoint region respectively based on the predetermined starting point and the predetermined endpoint; and may send the starting point region and the endpoint region to the capture module or the base station. In this way, the capture module or the base station may determine whether the behavior of the object belongs to the target behavior type based on the starting point region or the endpoint region.

In an embodiment, the subject for performing the method of the present disclosure may determine the predetermined starting point and the predetermined endpoint based on the movement trajectory of the target behavior type set for the captured image.

In an embodiment, the user may trigger (such as double-click, single-click, or long-press) the display screen of the subject for performing the method of the present disclosure. In response to the trigger performed by the user, the subject for performing the method of the present disclosure may output the predetermined icon within the captured image. The predetermined icon may be a user image of the user logged into the subject for performing the method of the present disclosure. Alternatively, the predetermined icon may be a default icon such as an arrow, a dot, a circle, and so on, which will not be limited herein.

Accordingly, the subject for performing the method of the present disclosure may recognize, in response to setting for the predetermined icon in the captured image, the movement trajectory of the target behavior type.

In an embodiment, the setting for the predetermined icon may include the dragging operation. Specifically, after triggering the captured image and displaying the predetermined icon in the captured image, the user may drag the predetermined icon to draw the movement trajectory of the behavior corresponding to the target behavior type within the captured image. The subject for performing the method of the present disclosure may determine, in response to the dragging operation performed on the predetermined icon within the captured image, the dragging trajectory corresponding to the dragging operation and may determine the dragging trajectory as the movement trajectory for the target behavior type set for the captured image.

Subsequently, the subject for performing the method of the present disclosure may recognize the starting point and the endpoint of the movement trajectory; and may determine the starting point as the predetermined starting point of the target behavior type set for the captured image and determine the endpoint as the predetermined endpoint of the target behavior type set for the captured image.

In an embodiment, the subject for performing the method of the present disclosure may determine the third distance threshold and the fourth distance threshold: determine the starting point region based on the predetermined starting point and the third distance threshold; and determine the endpoint region based on the predetermined endpoint and the fourth distance threshold.

Each of the third distance threshold and fourth distance threshold may be a predetermined distance threshold or may be determined by the subject for performing the method of the present disclosure based on a plurality of historical starting points and a plurality of historical endpoints generated when the object performs behaviors corresponding to the target behavior type during a historical time period. For example, the maximum distance among the plurality of historical starting points may be determined as the third distance threshold, and the maximum distance among the plurality of historical endpoints may be determined as the fourth distance threshold.

In an embodiment, the starting point region may be defined by taking the predetermined starting point as the center and taking the third distance threshold as a radius; and the endpoint region may be defined by taking the predetermined endpoint as the center and taking the fourth distance threshold as a radius.

It is understood that in the above embodiments, by obtaining and displaying the captured image for the predetermined region, the predetermined starting point and the predetermined endpoint of the target behavior type set for the captured image may be determined. The starting point region and the endpoint region may be respectively determined based on the predetermined starting point and the predetermined endpoint, such that it may be determined whether the behavior of the object belongs to the target behavior type based on the starting point region and the endpoint region. In the present embodiment, by displaying the captured image for the predetermined region on the predetermined terminal, the user may set the predetermined starting point and the predetermined endpoint for the captured image when the targe object is performing the behavior belonging to the target behavior type. The starting point region and the endpoint region of the behavior corresponding to the target behavior type may be determined respectively based on the predetermined starting point and the predetermined endpoint. In this way, the camera module or the base station may recognize the behavior of the target object based on the starting point region and the endpoint region, the movement trajectory of the behavior of returning home may be rapidly and precisely drawn, and the efficiency and accuracy of recognizing the behavior of the object may be improved.

In some embodiments, the first security video may include a target image. The target image may include an article description and a person description. The article description may represent a target article, and the person description may represent a target person.

The target image may be any image including the article description and the person description. For example, the target image may be a video frame extracted from a video containing both the article description and the person description. In another example, the target image may be a video frame extracted from a video containing both the article description and the person description, where the target article represented by the article description and the target person represented by the person description are both located within the predetermined region.

The predetermined region may be set by the user or other objectives. Alternatively, the predetermined region may be a region, which is determined by the subject for performing the method of the present disclosure or other electronic devices, satisfying a predetermined condition. For example, the predetermined condition may be that the predetermined region includes a predetermined article. In this case, the predetermined article may be the same as the target article.

The predetermined region may be a fixed region or a region which is variable in position. For instance, when the predetermined condition is that the region contains the predetermined article, and when the predetermined article (such as a robotic cleaner, a pet, and so on) may be movable, then the predetermined region may be variable in position.

The target article may be the article represented by the article description, and the target person may be the person represented by the person description.

Accordingly, the first security video may be recognized as follows, so as to obtain the video recognition result for the first security video.

In a block 1, the first security video may be recognized to determine a first detection box and a second detection box within the target image. The first detection box may be a detection box for the article description, and the second detection box may be a detection box for the person description.

A target detection algorithm may be applied to perform target detection on the target image, so as to determine the first detection box and the second detection box in the target image.

The target detection algorithm may be an algorithm used in computer vision to recognize and locate a specific target (such as the target article or the target person) within an image (including the aforementioned target image). The algorithm may determine a position of the target (typically by drawing a rectangular box or a box in a more complex shape) and may include classification of targets.

In the present disclosure, open vocabulary object detection (OVOD) may be applied to perform the target detection. The OVOD may enable a model to detect and recognize a new object category that is not encountered during training, such that generalized target detection may be achieved.

In a block 2, an extent of overlapping between the first detection box and the second detection box may be determined.

The extent of overlapping may represent a proportion or a level of an overlapping portion between the first detection box and the second detection box in an overall image. For example, the extent of overlapping may be represented by at least one of the following: the number of overlapping pixels between an image region corresponding to the first detection box and an image region corresponding to the second detection box: a ratio of an overlapping area between the image region corresponding to the first detection box and the image region corresponding to the second detection box: an intersection-over-union ratio between the image region corresponding to the first detection box and the image region corresponding to the second detection box.

In a block 3, theft determination information may be generated based on the extent of overlapping, and the theft determination information may indicate whether the target person has an intent to steal the target article.

The theft determination information may be generated based on the extent of overlapping in various ways.

In an example, when the extent of overlapping is greater than or equal to a predetermined threshold, theft determination information indicating that the target person has the intent to steal the target article may be generated. When the extent of overlapping is less than the predetermined threshold, theft determination information indicating that the target person does not have the intent to steal the target article may be generated. The predetermined threshold may be set by the user or other objectives, or may be determined by analyzing correlation between the extent of overlapping and the theft determination information.

In another example, when the extent of overlapping is greater than or equal to the predetermined threshold and both the target person and the target article are located within the predetermined region, the theft determination information indicating that the target person has the intent to steal the target article may be generated. When the extent of overlapping is less than the predetermined threshold, or when at least one of the target person or the target article is not located within the predetermined region, the theft determination information indicating that the target person does not have the intent to steal the target article may be generated.

In a block 4, the video recognition result for the first security video may be determined based on the theft determination information.

The theft determination information may be used as the video recognition result for the first security video, so as to determine whether the first security video indicates presence of a theft behavior. Alternatively, the video recognition result may be determined by assessing whether a subject performing the theft behavior indicated by the theft determination information has a predetermined features (such as whether or not wearing a courier clothing, being a family member or not, or being a stranger or not).

It should be understood that in some cases, the extent of overlapping between the detection box of the article description and the detection box of the person description in one image may be used to determine whether the target person has the intent to steal the target article, such that the efficiency and accuracy of recognizing the theft intent may be improved.

In some scenarios of the aforementioned embodiments, the theft determination information may be generated based on the extent of overlapping as follows:

In a block 1, it may be determined whether the extent of overlapping is greater than or equal to the predetermined threshold.

The predetermined threshold may be set by the user or other objectives, or determined by analyzing the correlation between the extent of overlapping and the theft determination information.

In a block 2, when the extent of overlapping is greater than or equal to the predetermined threshold, it may be determined whether a behavior of the target person represented by the person description is the theft behavior, so as to obtain a first determination result.

The first determination result indicates whether the behavior of the target person represented by the person description is the theft behavior.

The theft behavior may be one or more actions indicative of theft.

For example, the theft behavior may include: a person bending over, a hand reaching out and glancing sideways, or walking quickly or running after reaching out and glancing sideways.

In a block 3, the theft determination information may be generated based on the first determination result.

The theft determination information may be generated in various ways based on the first determination result.

For example, when the first determination result indicates that the behavior of the target person represented by the person description is the theft behavior, the theft determination information indicating that the target person has the intent to steal the target article may be generated. When the first determination result indicates that the behavior of the target person represented by the person description is not the theft behavior, the theft determination information indicating that the target person does not have the intent to steal the target article may be generated.

In addition, the theft determination information may be generated based on the first determination result in other ways, which will be described at a later section.

It should be understood that in the above application scenario, the theft determination information may be generated by determining whether the behavior of the target person represented by the person description is the theft behavior. In this way: accuracy of recognizing the theft intent may be improved.

In certain application scenarios of the above embodiments, the theft determination information may be generated based on the extent of overlapping as follows.

In a block 1, it may be determined whether the extent of overlapping is greater than or equal to the predetermined threshold.

The predetermined threshold may be set by the user or other objectives, or may be determined by analyzing the correlation between the extent of overlapping and the theft determination information.

In a block 2, when the extent of overlapping is greater than or equal to the predetermined threshold, an associated video frame sequence of the target image may be extracted from the first security video. The associated video frame sequence may be formed by video frames of the first security video that have association with the target image.

For example, the associated video frame sequence may include: the target image. N video frames before the target image, and M video frames after the target image

In another example, the associated video frame sequence may alternatively include: N video frames before the target image, and M video frames after the target image.

In the above examples, each of the N and the M may be a positive integer. The N may be equal or unequal to the M. The video frames before the target image are video frames of the first security video that appear prior to the target image, and the video frames after the target image are video frames in the first security video that appear after the target image.

In another example, the associated video frame sequence may alternatively include: video frames in the first security video containing images of the target article, and/or video frames in the first security video containing images of the target person.

In a block 3, the theft determination information may be generated based on the associated video frame sequence.

The theft determination information may be generated in various ways based on the associated video frame sequence.

For example, the associated video frame sequence may be input into a pre-trained large language model (LLM) to generate the theft determination information. The large language model may represent correspondence among prompt words, the associated video frame sequence, and the theft determination information.

The LLM may be a natural language processing model based on deep learning, and may have an extremely high number of parameters and a robust language comprehension and generation capability.

In an example, the LLM may be a multimodal large language model (MLLM). The MLLM combines the language comprehension capability of the LLM with an ability to understand information from other modalities, such that the MLLM may comprehend and generate content having a plurality of types of data. The “modalities” refer to different types of data being input, such as data in texts, data in images, data in audios, and data in videos. Through training based on massive datasets, the MLLM may learn complementarity and correlations between different modalities. For example, input data of the MLLM may include the aforementioned associated video frame sequence and prompt words, and output data of the MLLM may be the theft determination information.

In addition, the theft determination information may be generated based on the associated video frame sequence in other ways, which will be described at a later section.

It can be understood that in the aforementioned application scenario, when the extent of overlapping between the first detection box and the second detection box is greater than or equal to the predetermined threshold, the theft determination information may be generated based on the associated video frame sequence of the target image. In this way, the efficiency and accuracy of recognizing the theft intent may be improved.

In some cases of the above application scenario, the embodiment may be applied to a first device, a data processing volume of the target image may be smaller than that of the video frames in the associated video frame sequence.

Accordingly, the theft determination information may be generated based on the associated video frame sequence as follows.

In a block 1, the associated video frame sequence may be sent to a second device.

The second device may generate the theft determination information based on the associated video frame sequence. A computing power of the second device may be greater than that of the first device.

For example, the first device may be an edge computing device. The first device may process video data (such as the target image) obtained from a smart camera. The first device may have a certain computing capability to perform customized target property detection and human figure detection in real time. The first device may include a microphone and some audio-visual components capable of deterring threats to property security and playing welcome messages for family members or whitelisted individuals.

The second device may be a home smart control system (a server). The second device may serve as a computing and intelligence center, arranged with a high-performance computing chip. A plurality of video streams may be established in the second device, and behaviors in the plurality of video streams may be processed in real-time in the second device.

The second device may input the associated video frame sequence into the pre-trained large language model to generate the theft determination information. Alternatively, the second device may generate the theft determination information based on the associated video frame sequence, state information of the target article in the video frames before the target image, and state information of the target article in the video frames after the target image.

In a block 2, the theft determination information returned from the second device may be received to generate the theft determination information.

It should be understood that in the above case, the first device having a lower computing power may process video frames having a smaller data processing volume. The second device having a higher computing power may process the plurality of video frames sequences having a larger data processing volume. In this way, the first device and the second device may work cooperatively to improve the efficiency of recognizing the theft intent.

In some cases of the above application scenario, the associated video frame sequence may include: the video frames before the target image and the video frames after the target image. The video frames before the target image may be the video frame in the first security video that occur prior to the target image. The video frames after the target image may be the video frames in the first security video that occur after the target image.

Accordingly, the theft determination information may be generated based on the associated video frame sequence as follows.

In a block 1, first state information of the target article in the video frames before the target image may be determined.

The first state information may represent a state of the target article in the video frames before the target image. For example, the first state information may indicate a position of the target article in the video frames before the target image, or indicate whether the article in the video frames before the target image is located within a predetermined region.

In a block 2, second state information of the target article in the video frames after the target image may be determined.

The second state information may represent a state of the target article in the video frames after the target image. For example, the second state information may indicate a position of the target article in the video frames after the target image, or indicate whether the target article in the video frames after the target image is located within a predetermined region.

In a block 3, the theft determination information may be generated based on the first state information, the second state information, and the associated video frame sequence.

The theft determination information may be generated in various ways based on the first state information, the second state information, and the associated video frame sequence.

For example, the first state information indicates the position of the target article in the video frames before the target image, and the second state information indicates the position of the target article in the video frames after the target image. When a distance between the position indicated by the first state information and the position indicated by the second state information is greater than or equal to a predetermined distance threshold, the theft determination information may be generated based on the associated video frame sequence. When the distance between the position indicated by the first state information and the position indicated by the second state information is less than the predetermined distance threshold, the theft determination information indicating that the target person does not have the intent to steal the target article may be generated.

In addition, the theft determination information may be generated in other ways based on the first state information, the second state information, and the associated video frame sequence, which will be described in detail at a later section.

It should be understood that in the above scenarios, the theft determination information may be generated based on the first state information, the second state information, and the associated video frame sequence. In this way, the accuracy of recognizing the theft intent may be further improved.

In some examples of the above scenario, the first state information may indicate whether the target article represented by the article description in the video frames before the target image is located within a first region, and the second state information may indicate whether the target article represented by the article description in the video frames after the target image is located within the first region.

The first region may represent the aforementioned predetermined region. Alternatively, the first region may be a region having a predetermined size and a predetermined shape, and a location of the first region may be variable.

Accordingly, the theft determination information may be generated as follows, based on the first state information, the second state information, and the associated video frame sequence.

In a block 1, when the first state information indicates that the target article represented by the article description in the video frames before the target image is located within the first region, initial theft determination information may be generated based on the associated video frame sequence.

The initial theft determination information may be generated based on the associated video frame sequence in various ways.

For example, the associated video frame sequence may be input into the pre-trained LLM to generate the initial theft determination information. The LLM may represent the correspondence among the prompt words, the associated video frame sequence, and the initial theft determination information.

In another example, the initial theft determination information may be generated based on the associated video frame sequence and whether both the target person and the target article are located within the predetermined region.

The initial state information may indicate whether the target person has the intent to steal the target article.

In a block 2, when the initial theft determination information indicates that the target person has the intent to steal the target article, and when the second state information indicates that the target article represented in the article description in the video frames after the target image is not located within the first region, final theft determination information indicating that the target person has the intent to steal the target article may be generated.

It should be understood that in the above example, the final determination that the target person has the intent to steal the target article may be made only when the target article changes from being located in the first region to not being located in the first region, and when the initial theft determination information indicates that the target person has the intent to steal the target article. In this way, accuracy of recognizing the theft intent may be improved.

In some cases of the above embodiments, the theft determination information may be generated based on the extent of overlapping as follows.

In a block 1, it may be determined whether both the target person and the target article are located within the predetermined region, so as to obtain a second determination result.

The second determination result may indicate whether both the target person and the target article are located within the predetermined region.

The predetermined region may be configured by the user or other objectives. Alternatively, the predetermined region may be a region determined by the subject for performing the method of the present disclosure or other electronic devices that satisfies a predetermined condition. For example, the predetermined condition may be that the region contains a predetermined article. In this case, the predetermined article may represent the same article as the target article.

The predetermined region may be a fixed region or a region that is variable in position. For example, when the predetermined condition is that the region contains the predetermined article, and when the predetermined article (such as a robotic cleaner, a pet, and so on) that is movable, the predetermined region may be variable in position.

In a block 2, the theft determination information may be generated based on the second determination result and the extent of overlapping.

The theft determination information may be generated in various ways based on the second determination result and the extent of overlapping.

For example, when the second determination result indicates that both the target person and the target article are within the predetermined region, and when the extent of overlapping is greater than or equal to the predetermined threshold, the theft determination information indicating that the target person has the intent to steal the target article may be generated. When the second determination result indicates that at least one of the target person and the target article is not located within the predetermined region, or when the extent of overlapping is less than the predetermined threshold, the theft determination information indicating that the target person does not have the intent to steal the target article may be generated.

In another example, when the second determination result indicates that both the target person and the target article are within the predetermined region, and when the extent of overlapping is greater than or equal to the predetermined threshold, it is further determined whether the behavior of the target person represented by the person description is the theft behavior, so as to obtain the first determination result. The first determination result may indicate whether the behavior of the target person represented by the person description is the theft behavior. Subsequently, the theft determination information may be generated based on the first determination result.

In addition, the theft determination information may be generated in other ways based on the second determination result and the extent of overlapping, which will be described in detail at a later section.

Understandably, in the aforementioned scenarios, the theft determination information may be generated based on both the second determination result and the extent of overlapping. In this way, the accuracy of recognizing the theft intent may be improved.

In some cases of the above embodiments, following blocks may be performed before determining the extent of overlapping between the first detection box and the second detection box.

In a block 1, a pre-recorded collection of personnel information may be obtained.

Personnel information in the collection of personnel information may represent a certain family member and relatives or friends of the family member.

In practice, the personnel information may be recorded by capturing images thereof.

In a block 2, it may be determined whether target personnel information of the target person is included in the collection of personnel information.

Accordingly, the extent of overlapping between the first detection box and the second detection box may be determined when the target personnel information is not included in the collection of personnel information.

In some embodiments, when the target personnel information is included in the collection of personnel information, the extent of overlapping between the first detection box and the second detection box may not need to be obtained. Furthermore, the theft determination information indicating that the target person does not have the intent to steal the target article may be generated.

It may be understood that, in the above cases, it may be determined whether the target person has the intent to steal the target article based on the extent of overlapping between the detection box for the article description and the detection box for the person description within the target image, only when the personnel information of the target person is not included in the collection of personnel information. In this way, accuracy of recognizing the theft intent may be improved. Furthermore, in the case that the target person is determined as having the intent to steal the target article and an alarm notification is required, disturbance caused by frequent alarm notifications to the user and other objectives may be reduced.

In some cases of the above embodiments, after generating the theft determination information, and when the theft determination information indicates the target person having the theft intent, an expulsion device may be controlled to perform an expulsion operation, and/or a prompt message may be sent to the predetermined terminal.

The expulsion device may be an audio output device, a mobile robot, and so on.

When the expulsion device is the audio output device, the expulsion operation may be outputting an alarm prompt audio. The audio may be set by the user or other objectives.

When the expulsion device is the mobile robot, the expulsion operation may be moving toward the target person.

The predetermined terminal may be a device that is associated, in advance, with the subject for performing the method of the present disclosure. For example, the predetermined terminal may be a device logged into with an administrator account.

It can be understood that in the above cases, controlling the expulsion device to perform the expulsion operation may reduce probability of the target article being stolen. Sending the prompt information to the predetermined terminal may promptly notify the user of the predetermined terminal that the target article may be or may be about to be stolen.

In some embodiments, the first security video may be a frame extraction result of the target video. Accordingly, the frame extraction result may be generated as follows.

In a block 1, an image description data set and the target video may be obtained. Image description data in the image description data set may be configured to describe a content of the target image, and the target video may be formed by an image sequence.

The image description data set may include at least one image description data. In some cases, a cardinality of the image description data set may be less than or equal to a predetermined value, such as 30. The cardinality of the image description data set may be the number of image description data included therein.

The image description data in the image description data set may be determined in various ways. For example, the image description data in the image description data set may be an event description content input by the user or other objectives, or may be a feature vector of the event description content input by the user or other objectives.

The event description content may be a text, a voice, or an image, and may be configured to describe an event within the image. For example, the event description content may be configured to describe at least one of the following events in the image: elderly person falling, child leaving home, stranger intrusion, pet damaging property, window being opened.

In another example, the image description data in the image description data set may alternatively be image feature data of one or more image frames

One image description data in the image description data set may be configured to describe one or more events in an image. For example, one image description data may be configured to describe both the child leaving home and the stranger intrusion.

The image description data set may be fixed and unchanged, or may be updated and modified according to a predetermined strategy.

In a block 2, a similarity between an image in the image sequence and each image description data in the image description data set may be calculated to obtain a target similarity corresponding to the image in the image sequence.

The target similarity corresponding to the image may be: a weighted sum of similarities between the image in the image sequence and each image description data in the image description data set. Alternatively, the target similarity corresponding to the image may be: one similarity, which is selected from a plurality of similarities between the image and each of a plurality of image description data in the image description data set, satisfying a first similarity condition. The first similarity condition may be configured to determine the target similarity corresponding to each image in the image sequence.

For each frame of image in the image sequence, the similarity between the image and each image description data in the image description data set may be calculated to obtain the target similarity corresponding to the image.

The target similarity corresponding to the image may be: one similarity, which is selected from the plurality of similarities between the image and each of the plurality of image description data in the image description data set, satisfying the first similarity condition.

The first similarity condition may be a predetermined similarity condition.

For example, the first similarity condition may be: a maximum similarity of the plurality of similarities between the image and each of the plurality of image description data in the image description data set. In this case, the target similarity corresponding to the image may be: the similarity of the plurality of similarities between the image and each of the plurality of image description data in the image description data set.

In another example, the first similarity condition may alternatively be: one similarity, which is selected from the plurality of similarities between the image and each of the plurality of image description data in the image description data set, being greater than or equal to a first similarity threshold. In this case, the target similarity corresponding to the image may be: one similarity, which is selected from the plurality of similarities between the image and each of the plurality of image description data in the image description data set, being greater than or equal to the first similarity threshold.

In still another example, the first similarity condition may alternatively be: a similarity ranked at a top third-numbered position (such as the first, the third, the fifth, and so on) from a rank where all similarities between the image and each of the plurality of image description data in the image description data set are placed from a maximum value to a minimum value. In this case, the target similarity corresponding to the image may be: the similarity ranked at the top third-numbered position from the rank where all similarities between the image and each of the plurality of image description data in the image description data set are placed from the maximum value to the minimum value.

For example, when the image sequence includes two frames of images: an image 1 and an image 2, and the image description data set includes three image description data: an image description data 1, an image description data 2, and an image description data 3. The first similarity condition may be: the maximum similarity among all similarities between the image and each image description data in the image description data set. That is, the third number may be 1.

In this way, a similarity between the image 1 and the image description data 1, a similarity between the image 1 and the image description data 2, and a similarity between the image 1 and the image description data 3 may be calculated, generating three similarities for the image 1; a similarity 1, a similarity 2, and a similarity 3. The maximum similarity among the similarity 1, the similarity 2, and the similarity 3 may be determined as the target similarity corresponding to the image 1.

Similarly: a similarity between the image 2 and the image description data 1, a similarity between the image 2 and the image description data 2, and a similarity between the image 2 and the image description data 3 may be calculated, generating three similarities corresponding to the image 2; a similarity 4, a similarity 5, and a similarity 6. A maximum similarity among the similarity 4, the similarity 5, and the similarity 6 may be determined as the target similarity corresponding to the image 2.

In some cases, the target similarity corresponding to the image includes the maximum similarity between the image and each image description data in the image description data set.

It can be understood that, by performing the block 2 in the above, each frame of image in the image sequence may obtain at least one corresponding target similarity. Therefore, each target similarity may correspond to one frame of image.

In a block 3, a first quantity of target similarity may be selected from all target similarities that are obtained from calculation.

The first quantity of target similarity satisfying a second similarity condition may be selected from the all target similarities that are obtained from calculation.

The second similarity condition may be configured to select at least a portion from the all target similarities that are obtained from calculation.

The first quantity may be any number. The first quantity may be only configured to indicate the number of selected target similarities. For example, the first quantity may be a predetermined number or a non-predetermined number. When the first quantity may be the non-predetermined number, the block 103 may be performed as: selecting a plurality of target similarities from all target similarities that are obtained from calculation. In this case, the number of selected target similarities may be the first quantity.

The second similarity condition may be another similarity condition that is predetermined and different from the first similarity condition as described above.

For example, the second similarity condition may be: a maximum similarity of all target similarities that are obtained from calculation. In this case, the first quantity may be 1.

In another example, the second similarity condition may alternatively be: a similarity, which is selected from all target similarities that are obtained from calculation, being greater than or equal to a second similarity threshold. In this case, the first quantity may be the number of similarities having values greater than or equal to the second similarity threshold.

In still another example, the second similarity condition may alternatively be: a similarity ranked at a top first-numbered position (such as the first, the third, the fifth, and so on) from a rank of all obtained target similarities. In this case, the first quantity may be a predetermined positive integer.

The first quantity of target similarity meeting the second similarity condition may include the maximum similarity of all target similarities that are obtained from calculation.

In a block 4, a first image set corresponding to the first quantity of target similarity may be obtained. Each image in the first image set may correspond to a respective one target similarity in the first quantity.

Since each target similarity corresponds to one frame of image, the first image set corresponding to the first quantity of target similarity may be determined. Each image in the first image set may correspond to a respective one target similarity in the first quantity.

The number of images in the first image set may be the first quantity.

In a block 5, the frame extraction result of the target video may be determined based on the first image set.

The frame extraction result may be at least one frame of image from the target video. For example, the first image set may be determined as the frame extraction result of the target video.

In addition, the frame extraction result of the target video may be determined based on the first image set in other ways, which will be described at a later section.

It should be understood that in the above embodiments, the image description data may be configured to describe the target image content of interest to the user or other objectives. For example, the user or other objectives may be in interest in behaviors or events appearing in the image. Therefore, the target similarity corresponding to each frame of image may be determined firstly, and the first quantity of frames of images may be subsequently selected, based on the similarity corresponding to each frame of image, from all images included in the target video. In this way, the frame extraction result may be determined accordingly. Matching between the frame extraction result and the target image content may be improved.

In certain application scenarios of the above embodiments, the frame extraction result for the target video may be determined based on the first image set as follows.

In a block 1, the first image set may be displayed.

The subject for performing the video frame extraction may be a terminal, such as a smartphone, a tablet computer, or a computer.

After determining the first image set, the first image set may be displayed.

For example, each frame of image in the target video may be displayed. The image in the first image set may be highlighted to be displayed in the target video.

In a block 2, it may be determined whether an adjustment operation for the image in the first image set is detected.

The adjustment operation may be configured to: adjust the image in the first image set to obtain a second image set.

The second image set may be an image set obtained after adjusting the image in the first image set. The number of images in the second image set may be a second quantity. The second quantity may be a predetermined number or a number determined through the adjustment operation. The second quantity may be greater than, less than, or equal to the first quantity.

The second image set may represent images obtained after performing the adjustment operation on the image in the first image set.

For example, when the adjustment operation represents replacing an image A in the first quantity of frames of images with an image B from the target video, the first quantity may be equal to the second quantity.

In another example, when the adjustment operation represents deleting the image A from the first quantity of frames of images, the first quantity may be greater than the second quantity.

In still another example, when the adjustment operation represents adding an image C to the first quantity of frames of images, the first quantity may be less than the second quantity.

In a block 3, after detecting the adjustment operation, the second image set may be determined as the frame extraction result for the target video.

Understandably: in the above application scenarios, the final frame extraction result may be adjusted by the adjustment operation, and in this way: matching between the final frame extraction result and the target image content of interest to the user and other objectives may be improved.

In certain scenarios of the above application scenarios, after detecting the adjustment operation, the image description data set may be updated as follows:

In a block 1, an image feature of each image in the second image set may be determined, so as to obtain an image feature set. Each image feature in the image feature set may correspond a respective one image in the second image set. Each frame of image in the second image set may correspond to one image feature, and in this way, the image feature set may be obtained.

The image feature may include at least one of: a color feature, a texture feature, a corner point feature, and so on.

In a block 2, the image description data may be determined based on the image feature set.

For example, the above-mentioned image feature set may be determined as the image description data.

In another example, when the image feature is represented by a vector, an average of a second quantity of vectors representing the image feature set may be determined as the image description data.

In a block 3, the image description data set may be updated based on the determined image description data.

For example, the determined image description data may be added to the image description data set to update the image description data set.

In addition, the block 3 may be performed in other ways, which will be described at a later section.

It should be understood that in the above scenarios, the image description data set may be automatically and iteratively updated based on adjustment operations performed by the user or other objectives at various time points. In this way, the image description data set may better align with a current preference of the user or other objectives. Therefore, matching between frame extraction results at various time periods and target image contents of interest to the user or other objectives at various time periods may be dynamically maintained or even enhanced.

In some examples of the aforementioned scenarios, the image description data set may be updated based on the determined image description data as follows.

In a block 1, a cardinality of the image description data set prior to updating may be determined.

The cardinality of the image description data set represents the quantity of image description data within the image description data set.

In a block 2, it may be determined whether the cardinality is less than a predetermined value.

The predetermined value may be a predetermined integer. For example, the predetermined value may be 10, 20, 30, 40, and so on.

In a block 3, when the cardinality is less than the predetermined value, the determined image description data may be added to the image description data set to obtain a post-updating image description data set. When the cardinality is greater than or equal to the predetermined value, any image description data included in the image description data set prior to the updating may be replaced with the determined image description data to obtain the post-updating image description data set.

It should be understood that in the above example, when the cardinality of the image description data set is small, the determined image description data may be added to the image description data set to increase the cardinality of the post-updating image description data set. When the cardinality of the image description data set is large, the image description data set may be updated based on replacement. In this way, the cardinality of the image description data set may remain within a certain range, avoiding resource waste caused by the cardinality being excessively large.

In some embodiments, the image description data included in the image description data set prior to the updating may be replaced with the determined image description data as follows.

In a block 1, an image description data with an earliest addition time point may be determined from the image description data set prior to the updating.

The addition time point refers to a time point at which the image description data is added to the image description data set.

During a process of adding the image description data to the image description data set, the time point at which the image description data is added to the image description data set may be recorded. In this way, the image description data with the earliest addition time point may be determined from the image description data set prior to the updating.

In a block 2, the image description data with the earliest addition time point in the image description data set prior to the updating may be replaced with the determined image description data.

It can be understood that in the above embodiment, by replacing the image description data with the earliest addition time point in the image description data set prior to the updating with the determined image description data, the poste-updating image description data set may more accurately reflect the current preference of the user and other objectives with respect to the frame extraction result.

In some application scenarios of the above embodiment, the image description data set may include at least one image description data.

Accordingly, the image description data may be determined as follows.

In a block 1, the event description content input by the objective may be obtained, and the event description content may be configured to describe one or more events.

The event description content may be input by the user or other objectives.

In a block 2, a feature data of the event description content may be determined.

The feature data of the event description content may represent a semantic feature, a lexical feature, and so on.

In a block 3, the feature data may be determined as the image description data.

It should be understood that in the above application scenario, since the image description data set includes the feature data of the event description content input by the user, the user or other objectives may independently determine, by inputting the event description content, the event of interest in. In this way, the subsequent frame extraction result may be configured to determine whether the event of interest to the user or other objectives occurs.

The target video may be any video. For example, the target video may be a video captured by a camera.

In some application scenarios of the above embodiment, the similarity between the image in the image sequence and each image description data in the image description data set may be calculated as follows, so as to obtain the target similarity corresponding to the image.

In a block 1, similarities between the image in the image sequence and each of the plurality of image description data in the image description data set may be calculated to obtain a similarity set corresponding to the image.

In a block 2, a maximum similarity in the similarity set corresponding to the image in the image sequence may be determined as the target similarity corresponding to the image.

For example, when the image sequence includes two frames of images: an image 1 and an image 2, and the image description data set includes three image description data: an image description data 1, an image description data 2, and an image description data 3.

A similarity between the image 1 and the image description data 1, a similarity between the image 1 and the image description data 2, and a similarity between the image 1 and the image description data 3 may be calculated, generating three similarities corresponding to the image 1: a similarity 1, a similarity 2, and a similarity 3. In this case, the similarity set corresponding to the Image 1 may include the three similarities: the similarity 1, the similarity 2, and the similarity 3, subsequently, a maximum similarity among the similarity 1, the similarity 2, and the similarity 3 may be determined as the target similarity corresponding to the image 1.

Similarly: a similarity between the image 2 and the image description data 1, a similarity between the image 2 and the image description data 2, and a similarity between the image 2 and the image description data 3 may be calculated, generating three similarity values corresponding to the image 2: a similarity 4, a similarity 5, and a similarity 6. In this case, the similarity set corresponding to the image 2 may include the three similarities: the similarity 4, the similarity 5, and the similarity 6. Subsequently, a maximum similarity among the similarity 4, the similarity 5, and the similarity 6 may be determined as the target similarity corresponding to the image 2.

It can be understood that in the above application scenario, the target similarity corresponding to each frame of image in the image sequence may be the maximum similarity from all calculated similarities for the image. In this way, the target similarity corresponding to each image may more accurately reflect the extent of matching between the image and the image description data. Therefore, when the image description data is configured to describe the event of interest to the user or other objectives, by performing the above-mentioned method, the frame extraction result that better reflects the interest of the user or other objectives may be determined.

In addition, the similarity between the image and the image description data may be determined in various ways.

For example, convolutional neural networks (CNNs), an autoencoder, and generative adversarial networks (GANs) may be used to extract a feature vector from the image and a feature vector from the image description data. Subsequently, an Euclidean distance, a cosine similarity, or a Pearson correlation coefficient between the feature vector of the image and the feature vector of the image description data may be determined as the similarity between the image and the image description data.

In certain application scenarios of the embodiments, after generating the frame extraction result, the following blocks may be performed.

In a block 1, push information to be sent to the predetermined terminal may be determined based on the frame extraction result.

The first block may be performed in various ways.

The predetermined terminal may be a terminal that is determined in advance. For example, the predetermined terminal may be the terminal performing the adjustment operation as described in the above. In some cases of the above application scenarios, the push information to be sent to the predetermined terminal based on the frame extraction result may be determined as follows:

In a block 1, a video segment of the target video may be generated based on the frame extraction result.

For example, the frame extraction result may be used as the video segment of the target video. Alternatively, a plurality of frames of images represented by the frame extraction result may be processed, such as adding background music, providing voiceovers, or applying filters, so as to obtain the video segment for the target video.

In a block 2, video information of the video segment may be determined as the push information to be sent to the predetermined terminal.

The video information may represent at least one of: a cover image of the video segment, a title of the video segment, or a summary of the video segment.

It should be understood that in the above scenarios, after generating the video segment, the video information of the video segment may be promptly pushed to the predetermined terminal, enabling the user of the terminal to promptly understand the video information of the video segment.

In certain cases of the above application scenarios, the push information to be sent to the predetermined terminal may be determined based on the frame extraction result as follows.

In a block 1, behavior recognition may be performed on the frame extraction result to obtain a recognition result.

The recognition result represents a result of performing the behavior recognition on the frame extraction result. For example, the recognition result may indicate a behavior occurring within an image represented by the frame extraction result, such as a stranger loitering or an elderly individual falling.

In a block 2, the push information to be sent to the predetermined terminal may be generated based on the recognition result.

The recognition result may serve as the push information to be sent to the predetermined terminal. Alternatively, a hazard level corresponding to the recognition result may be used as the push information sent to the predetermined terminal.

It should be understood that in the above scenarios, the behavior recognition may be performed on the frame extraction result, and the push information may be pushed to the predetermined terminal based on the recognition result. In this way, the user of the predetermined terminal may promptly know whether the behavior of interest occurs.

In some embodiments, after obtaining the recognition result, one or more devices matching the recognition result and one or more control methods matching the recognition result may be determined. Subsequently, the one or more devices may be controlled by the control methods.

For example, when the recognition result indicates a stranger loitering, the one or more devices matching the recognition result may include a camera, and the one or more control methods may include tracking and filming the stranger.

In a block 2, push data may be pushed to the predetermined terminal.

It should be understood that in the above application scenario, the frame extraction result of the target video may be obtained. The frame extraction result may be determined based on the video frame extraction method described in the first aspect. Subsequently, the push information to be sent to the predetermined terminal may be determined based on the frame extraction result. Furthermore, the push data may be pushed to the predetermined terminal. In this way, the push information may be determined based on the frame extraction result obtained through the video frame extraction method, and the push information may be pushed to the predetermined terminal. In this way: timeliness of pushing the push information matching the target image content to the predetermined terminal may be improved.

In some embodiments, the security preference information may be a natural language.

The natural language may be configured to determine a to-be-pushed video.

The natural language may be a language that has evolved naturally with culture. For example, the natural language may be Chinese. English, and so on.

In certain cases, the natural language may be collected via the terminal. In a case that the subject for performing the method of the present disclosure is a server, after the terminal collects the natural language, the terminal may transmit the natural language to the subject for performing the method of the present disclosure. The above terminal may be communicatively connected with the subject for performing the method of the present disclosure. In the case that the subject for performing the method of the present disclosure is the terminal, the natural language may be directly collected via the subject for performing the method of the present disclosure.

The terminal may be either hardware or software. For example, the terminal may be an electronic device such as a mobile phone or a computer, or may be an application running on the electronic device.

The natural language may be represented in forms of, such as, texts or audios. For example, the natural language may be an audio or a text of “starting from tomorrow, notify me when the child comes home.” or an audio or a text of “notify me when the cat wakes up tomorrow.”

The camera may be used to monitor a predetermined region, so as to generate the video of the predetermined region, i.e., the first security video. The predetermined region may be a region monitored by the camera.

In practice, the subject for performing the method of the present disclosure may firstly obtain the natural language and then obtain the first security video: or may firstly obtain the first security video and then obtain the natural language: or may obtain both the natural language and the first security video simultaneously. The present disclosure does not limit an order of obtaining the natural language and the first security video. Accordingly, the following blocks may be performed.

In a block 1, a feature data of the natural language may be determined, so as to obtain a first feature data.

The first feature data may be the feature data of the natural language. For example, the first feature data may be the semantic feature of the natural language.

In a block 2, a first video may be determined based on the first security video, and it may be determined whether the first video matches the natural language based on at least two types of feature data of the first video and the first feature data.

The first video may be any video captured by the camera, or may be a video generated after processing the video captured by the camera.

The at least two types of feature data of the first video may be data features obtained by extracting features from the first video using at least two different data feature extraction methods.

In practice, it may be determined, based on the at least two types of feature data of the first video and the first feature data, whether the first video matches the natural language in various ways.

For example, the first video and the natural language may be input into a pre-trained artificial intelligence model. The artificial intelligence model may extract at least two types of feature data from the first video and the first feature data of the natural language. In this way, determination information indicating whether the first video matches the natural language may be determined. The artificial intelligence model may be trained based on supervised learning, taking sample videos, sample natural languages, and sample determination information as training samples. The sample determination information may indicate whether a sample video matches a sample natural language.

In addition, it may be determined whether the first video matches the natural language in other ways, which will be described at a later section.

In a block 3, when the first video matches the natural language, the first video may be used as a to-be-pushed video, and video information of the to-be-pushed video may be pushed. The video information represents information of the to-be-pushed video.

When the subject for performing the method of the present disclosure is the terminal, the subject for performing the method of the present disclosure may push the video information of the to-be-pushed video to the user or other objectives by displaying the video information of the to-be-pushed video. For example, the subject for performing the method of the present disclosure may be a smartphone, a computer, and so on.

When the subject for performing the method of the present disclosure is the server, the subject for performing the method of the present disclosure may send the video information of the to-be-pushed video to the terminal used by the user (such as the smartphone, the computer) in order to push the video information of the to-be-pushed video to the terminal. After receiving the video information of the to-be-pushed video, the terminal may display the video information of the to-be-pushed video.

The to-be-pushed video may be used for pushing to the terminal or to the user or other objectives.

The video information may include prompt information, an address, and so on, of the to-be-pushed video: or may be the to-be-pushed video itself.

In practice, when the first video matches the natural language, the first video may be pushed as the to-be-pushed video. Alternatively, the video information (such as the prompt information) of the to-be-pushed video may be pushed firstly. After detecting a predetermined operation (such as a video playing operation) performed via the video information, the first video may be determined as to-be-pushed video to be pushed to the terminal.

It should be understood that in the above embodiments, the natural language may be set in advance, so as to enable an automatic prompt when an event represented by the language is triggered in the first security video. In this way, video information triggered by the corresponding event may be more accurately and/or timely pushed, and the user and other objectives may more accurately and/or timely determine whether the event of interest occurs.

In certain application scenarios of the above embodiment, it may be determined, based on the at least two types of feature data of the first video, whether the first video matches the first feature data in the following manner.

In a block 1, at least two types of feature data may be determined from image feature data of the first video, text feature data of the first video, and audio feature data of the first video, so as to obtain a second feature data.

The second feature data may include at least two of: the image feature data of the first video, the text feature data of the first video, and the audio feature data of the first video.

In some cases, the second feature data may include the image feature data of the first video, the text feature data of the first video, and the audio feature data of the first video.

In a block 2, it may be determined whether the first video matches the natural language based on the first feature data and the second feature data.

A similarity between the first feature data and the second feature data may be calculated. It may be determined whether the first video matches the natural language based on the similarity being greater than or less than a predetermined similarity threshold. For example, when the similarity is greater than or equal to the predetermined similarity threshold, the first video may be determined as matching the natural language. When the similarity is less than the predetermined similarity threshold, the first video may be determined as not matching the natural language.

It should be understood that in the above application scenario, it may be determined whether the first video matches the natural language based on a multimodal fusion feature data, combining the feature data of the natural language with at least two dimensions of the image feature data of the first video, the text feature data of the first video, and the audio feature data of the first video. In this way, accuracy of determining whether the first video matches the natural language may be improved.

) In some application scenarios of the above embodiments, the first video may be generated as follows.

In a block 1, an event frame may be extracted from the first security video.

The event frame may be one or more video frames representing the event.

The event frame may be extracted from the first security video

The event frame may be extracted from the first security video in various ways, which will be described at a later section.

In a block 2, a plurality of event frames representing the same event extracted from the first security video may be determined as the first video.

A similarity between the plurality of event frames representing the same event may be greater than or equal to a predetermined first threshold, and a similarity between a plurality of event frames representing different events may be less than the predetermined first threshold.

The obtained video may include video frames representing a plurality of distinct events. In this way, the plurality of event frames corresponding to one event may be determined as one first video. That is, each event may correspond to one first video. For example, the obtained video may include a plurality of video frames representing an event 1, which are a video frame 5, a video frame 6, and a video frame 7. The obtained video may further include a plurality of video frames representing an event 2, which are a video frame 15, a video frame 16, a video frame 17, and a video frame 19. In this case, a video formed by the video frame 5, the video frame 6, and the video frame 7 may be determined as one first video, and a video formed by the video frame 15, the video frame 16, the video frame 17, and the video frame 19 may be determined as another first video.

Understandably, in the above application scenarios, the first video may be extracted, taking one event as a unit, from continuously captured videos. In this way, once the event represented by the natural language is triggered in the videos captured by the camera, the video information of the video of the event may be pushed. In this way, the user may receive the video information triggered by the event of interest of the user in a more timely manner.

In some embodiments of the above application scenarios, the event frame may be extracted from the first security video as follows.

An event extraction model may be used to extract the event frame from the first security video.

Accordingly; the event extraction model may be trained as follows.

In a block 1, a training sample set may be obtained.

Training samples in the training sample set may include videos (i.e., sample videos), event time (sample event time), and event labels (i.e., sample event labels).

The event time may represent a start time point and an end time point of the event. Alternatively, the event time may represent a position of the event frame corresponding to the event within the video.

Each event label may be an event name, such as “electrocution”, “approaching a safety box”, and so on.

In a block 3, a machine learning algorithm may be applied to train the event extraction model, taking videos of the training samples in the training sample set as input data and taking the event time and the event labels as desired output data.

It should be understood that in the above embodiment, the event extraction model may be trained using the videos, the event time, and the event labels. Subsequently, the event extraction model may be used to extract the event frame from the video. In this way, the event labels may be used to assist extracting the event frame, such that accuracy of extracting the event frame extraction may be improved.

In some embodiments of the aforementioned application scenarios, the following blocks may also be performed.

In a block 1, a playing speed of a non-target video segment of the obtained video may be determined as a first speed.

In a block 2, a playing speed of a target video segment of the obtained video as a second speed.

The target video segment may be formed by the event frame: in other words, the target video segment may be the event video.

The second speed may be less than the first speed.

It can be understood that in the above embodiment, the target video segment may be played at a speed lower than the non-target video segment. In this way, an immersive usage experience may be provided, and costs of recording daily life may be reduced.

In some embodiments of the aforementioned application scenarios, the following blocks may further be performed. A description text of the first video may be generated.

The description text may be configured to describe a content of the first video.

In practice, an artificial intelligence model (such as the large language model) may be used to generate the description text for the first video.

For example, by inputting the first video (formed by one frame or a plurality of frames) into the AI model and setting a text length, the AI model may generate the description text for the first video. For example, the first video showing a child and a mother returning home may be input into the AI model, and a description text of no more than 30 words may be set as the output of the AI model. The description text may include time, a location, persons, and attributes and behaviors of the persons. In this case, the AI model may output: “At 11:30 today, a little boy wearing blue clothes returning home with his mother at the door”.

In some cases, the description text may be configured to be displayed by the terminal. For example, when the subject for performing the method of the present disclosure is the server, the subject for performing the method of the present disclosure may transmit the description text to the terminal to be displayed. When the subject for performing the method of the present disclosure is the terminal, the subject for performing the method of the present disclosure may directly display the description text.

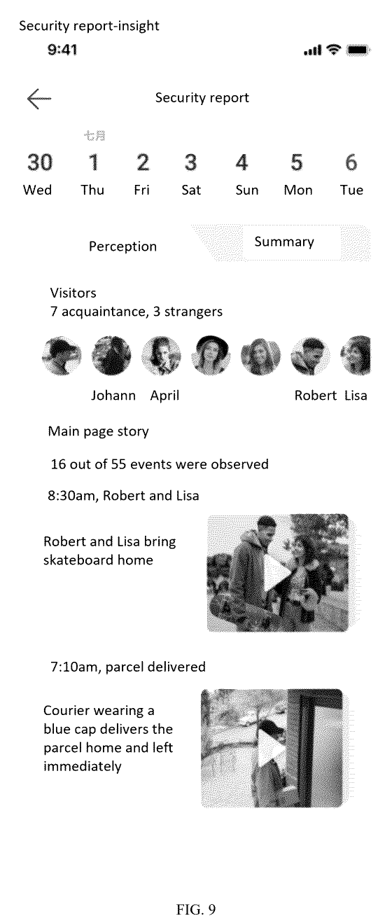

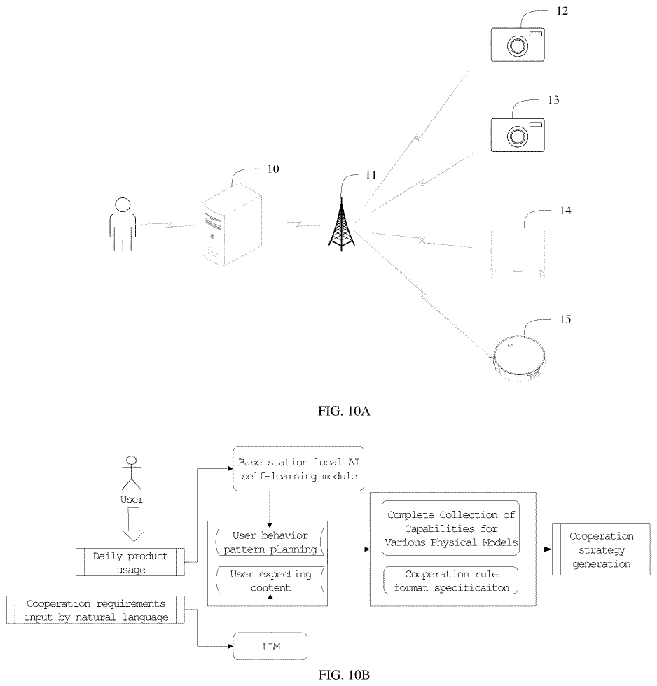

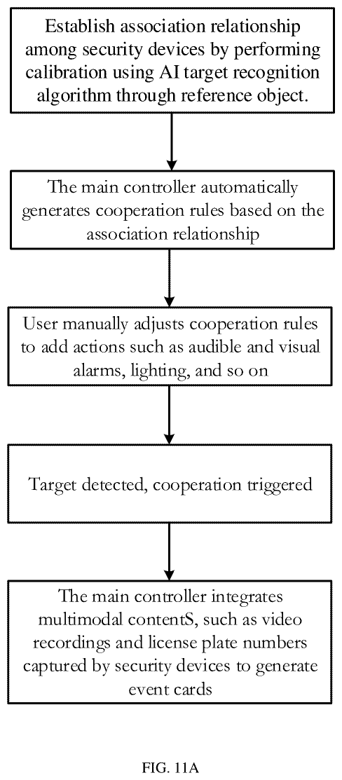

For example, as shown in FIG. 9, the terminal displays a description text: “At 08:30 AM. Robert and Lisa. Robert and Lisa returning home with a skateboard” and “At 07:10 AM. Delivery, a courier wearing a blue cap delivered a parcel to the house and immediately left.”

It should be understood that in the above embodiment, the user of the terminal may obtain the content of the first video through the description text without playing the video. In this way, the user may obtain the content of the first video more quickly.

In some application scenarios of the above embodiments, the following blocks may also be performed.

In a block 1, at least one of a text and a music matching the first video may be obtained, so as to obtain matching information of the first video.

The matching information may include at least one of: the text matching the first video and the music matching the first video.

In a block 2, the matching information may be merged with the first video, so as to obtain a second video.

The second video may be a result of merging the matching information with the first video. For example, the second video may be obtained by adding the text matching the first video to the first video, or the second video may be obtained by adding the music matching the first video to the first video.

In practice, an association between a first video in each of various types and a corresponding text and/or a corresponding music may be generated. In this way: by determining the text and/or the music associated with the first video, the matching information of the first video may be determined.

In a block 3, when a target operation performed on the second video is detected, the target operation may be performed on the second video.

The target operation may include at least one of: sharing, downloading, storing, sending.

It should be understood that in the above application scenarios, the matching information for the first video may be automatically determined, and the second video may be generated by merging the matching information with the first video. In this way, sharing the second video, downloading the second video, storing the second video, sending the second video, and other operations for the second video may be performed more quickly.

In some application scenarios of the above embodiments, the following blocks may also be performed.

In a block 1, one or more target video frames may be determined from the first video.

A similarity between the target video frame and a preceding video frame may be less than or equal to a predetermined second threshold, and a similarity between the target video frame and a subsequent video frame may be less than or equal to the predetermined second threshold. The preceding video frame may be a video frame occurring immediately before the target video frame in the first video. The subsequent video frame may be a video frame occurring after the target video frame in the first video.

The predetermined second threshold may be equal to or different from the predetermined first threshold. In some cases, the predetermined second threshold may be greater than the first similarity threshold, and in this way, a highlight video frame may be more accurately determined.

In some cases, a machine learning model may be used to determine the target video frame from the first video.

Unsupervised contrastive learning may be applied in the machine learning model to measure an inter-frame similarity within an image encoder (e.g., similarity between images and an audio across a time sequence). A video frame having significant differences with the preceding video frame and with the subsequent video frame may be determined as target video frame, i.e., the highlight video frame.

In a block 2, the target video frame may be determined as the highlight video frame in the first video.

In some cases, the highlight video frame may be one video frame or a plurality of consecutive video frames within the first video. For a video frame before the highlight video frame in the first video, the number of video frames between the video frame (the video frame before the highlight video frame) and the highlight video frame may be positively correlated with a playing speed of the video frame (the video frame before the highlight video frame). That is, as the number of video frames between the video frame (the video frame before the highlight video frame) and the highlight video frame is greater, the playing speed of the video frame (the video frame before the highlight video frame) may be faster. For a video frame after the highlight video frame in the first video, the number of video frames between the video frame (the video frame after the highlight video frame) and the highlight video frame may be negatively correlated with a playing speed of the video frame (the video frame after the highlight video frame). That is, as the number of video frames between the video frame (the video frame after the highlight video frame) and the highlight video frame is greater, the playing speed of the video frame (the video frame after the highlight video frame) may be slower.

It can be understood that in the aforementioned application scenario, the highlight video frame may be determined from the first video.

In some application scenarios of the above embodiments, the method may be performed by a first device terminal.

The first device terminal may represent a terminal or a server. For example, the first device terminal may be a camera.

Accordingly, the video information of the to-be-pushed video may be pushed as follows.

In a block 1, location information of the second device terminal may be obtained.

The second device terminal may be another device terminal different from the first device terminal. For example, the second device terminal may represent another terminal or another server different from the first device terminal. For example, when the first device terminal is the camera, the second device terminal may be a smartphone, a computer, and so on.

The location information may represent a location of the second device terminal.

In a block 2, the video information of the to-be-pushed video may be determined based on the location information.

After establishing, in advance, correspondence between the location information and the video information, the video information corresponding to the location information obtained in the block 1 may be determined and used as the video information for the to-be-pushed video.

For example, location information 1 may correspond to video information 1 of the to-be-pushed video, and location information 2 may correspond to video information 2 of the to-be-pushed video.

In a block 3, the video information may be pushed to the second device terminal.

It should be understood that in the above application scenario, as the second device terminal is located at various locations, different video information of the to-be-pushed video may be sent to the second device terminal.

In some embodiments, the following blocks may be performed: generating description text for the first video.

The above block in the present application scenario may be achieved by referring to the above application scenario. Details may be referred to the above description, which will not be repeated herein.

In some cases, the description text may be configured to determine whether the first video is a search result for a video search request sent by the terminal. For example, when the subject for performing the method of the present disclosure is the server, the subject for performing the method of the present disclosure may receive the video search request sent by the terminal and may determine, based on the description text, whether the first video is the search result for the video search request. Alternatively, when the subject for performing the method of the present disclosure is the terminal, the subject for performing the method of the present disclosure may obtain the video search request entered by the user or other objectives and may determine, based on the description text, whether the first video is the search result for the video search request.

The video search request may be configured to perform video searching.

In practice, a similarity between the description text and the first video may be calculated to determine whether the first video is the search result for the video search request.

It can be understood that in the above embodiment, the video searching may be achieved faster by using the description text of the first video.

In some embodiments of the above application scenarios, the video information of the to-be-pushed video may be determined based on the location information as follows.

Firstly: a location of the camera may be determined, so as to obtain a target location.

The target location may represent a location of the camera.

Subsequently, a distance between the location indicated by the location information and the target location may be determined, so as to obtain a target distance.

The target distance may represent the distance between the location indicated by the location information and the target location.

Furthermore, it may be determined whether the target distance is greater than or equal to a predetermined distance threshold.

Furthermore, when the target distance is greater than or equal to the predetermined distance threshold, the video information of the to-be-pushed video may be determined as first information. When the target distance is less than the predetermined distance threshold, the video information of the to-be-pushed video may be determined as second information.

The first information may indicate: a request to control the camera to monitor the target region. The second information indicates a location of a target region.

The target region is a region that is monitored to generate the to-be-pushed video.

When the second device terminal is the smartphone, and when the target distance is greater than or equal to the predetermined distance threshold, it may be determined that a user using the second device terminal may not be at home. When the target distance is less than the predetermined distance threshold, it may be determined that the user using the second device terminal may be at home.

It should be understood that in the above example, when the camera is far from the second device terminal (for example, when the user is not at home), the user may be requested to control the camera to capture a video of an event-triggered region, enabling the user to perform remote monitoring. When the camera is located near the second device terminal (for example, when the user is at home), the second device terminal may notify the user of the location of the event-triggered region, enabling the user to promptly reach a scene of the event.

In order to address technical problems where a process of manually generating a cross-device control strategy is time-consuming and may have errors, affecting the usage experience, the present disclosure provides a method and an apparatus for generating the cross-device control strategy. In the present disclosure, after receiving configuration requirement information input by the user, by integrating a capability set of a security device and a behavior pattern of the security device, the cross-device control strategy for a plurality of target security devices may be generated, and the plurality of target security devices meet requirements of target scenes and configuration requirements included in the configuration requirement information. In this way: time may be saved, and the cross-device control strategy may be generated efficiently and accurately; and the user experience may be improved.

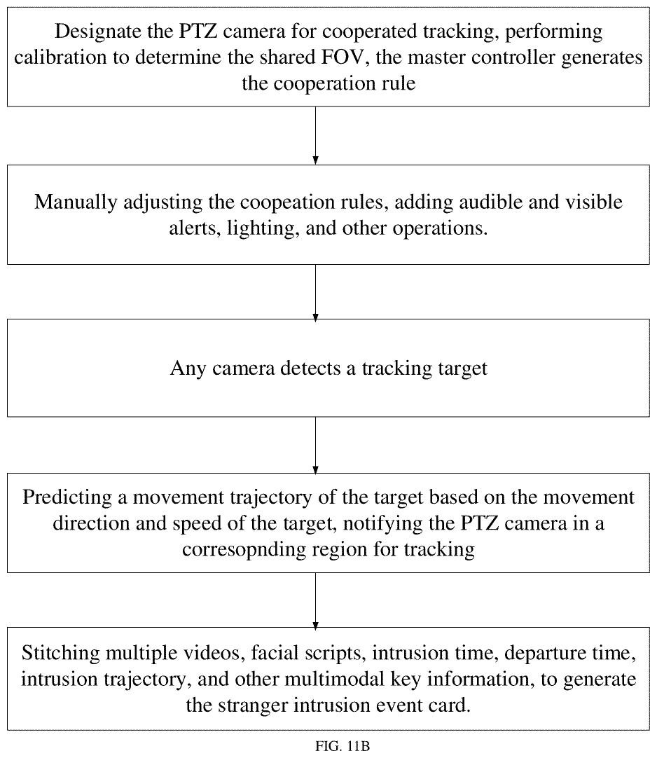

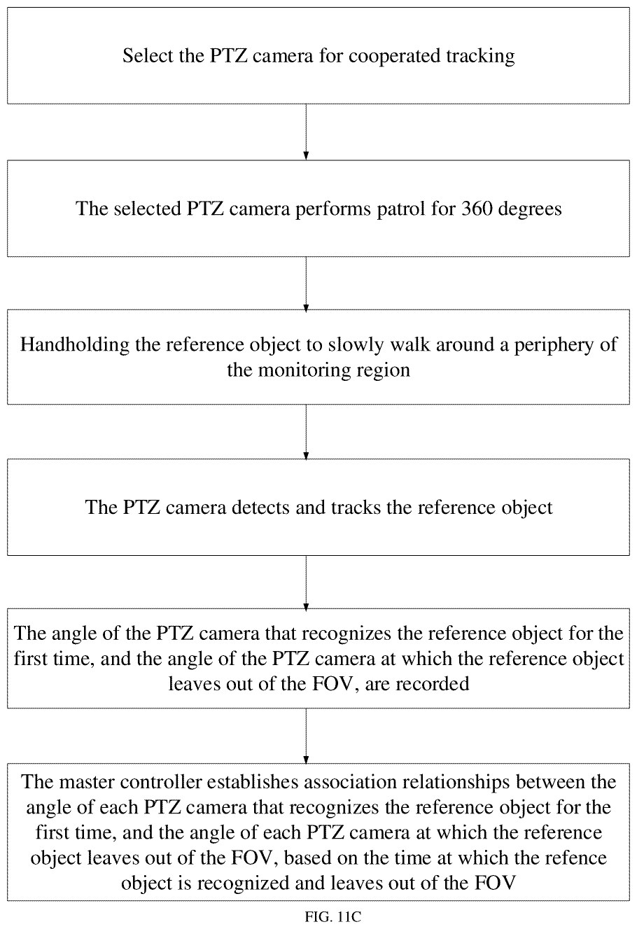

As shown in FIG. 10A, an application scenario is provided for the embodiments of the present disclosure. As shown in FIG. 10A, the application scenario may include: a control terminal 10, a base station 11, a security device 12, a security device 13, a security device 14, and a security device 15.

The control terminal 10 may include an input module, and the input module may be a speech input module or a text input module. The user may speak the configuration requirement information to the control terminal 10 through the input module: or may input a text content corresponding to the configuration requirement information to the control terminal 10 through the input module. The present disclosure does not limit details of inputting.

The control terminal 10 may be hardware or software supporting network connectivity to provide various network services. When the control terminal is hardware, the control terminal may be any electronic device having a display screen, including but not limited to a smartphone, a tablet computer, a laptop computer, a desktop computer, and so on. When the control terminal is software, the control terminal may be installed on the above electronic device. FIG. 10A illustrates the control terminal 10 as a computer for illustrative purposes.

The input module may be a speech capturing device connected to the control terminal 10, such as a microphone: or may be the display screen of the control terminal. The display screen may include a text input field, allowing the user to enter textual information.

The base station 11 may be a home central control device within a home security category, and may be a central hub for a product family to. The base station 11 may manage connected devices, such as cameras and sensors. The base station 11 may perform self-learning on behavioral information within a predetermined region (such as a domestic region of the user) to obtain a daily behavior pattern for the security devices.

Furthermore, the base station 11 may include a controller. This controller may include a receiving module. The receiving module may serve as a data receiving device that is connected to the controller within the base station 11. That is, the user may upload the configuration requirement information via the control terminal 10, and the control terminal may transmit the configuration requirement information to the receiving module. Therefore, the receiving module may obtain the configuration requirement information input by the user.

The security device 12, the security device 13, the security device 14, and the security device 15 may be security devices within the home security system, such as cameras or projectors. The security device 12, the security device 13, the security device 14, and the security device 15 may alternatively be smart home devices installed in the house, such as a smart refrigerator, a smart air conditioner, and a smart television, which will not be limited herein. In the present embodiment, the security device 12 and the security device 13 may be cameras, and the security device 14 and the security device 15 may be smart televisions. The above security devices may be deployed in different scenes or within a same scene. For example, the security device 12 may be a camera in a living room, and the security device 13 may be a camera in a front yard. Arrangement of the security devices may not be limited herein.

In an embodiment, the subject for performing the method of the present disclosure may be the control terminal 10 and may interact with the base station 11 to obtain data (such as the daily behavior pattern of the security device). In this way, the method of generating the cross-device control strategy in the present disclosure may be achieved.

In another embodiment, the subject for performing the method of the present disclosure may be the controller in the base station 11. The controller may receive data (such as the configuration requirement information entered by the user on the control terminal 10) transmitted from the control terminal 10 via the receiving module. In this way, the method of generating the cross-device control strategy in the present disclosure may be achieved.

In an embodiment, when the user desires to perform cross-device cooperative control on the security devices within the home region, the user may input a speech corresponding to the configuration requirement information via the input module to the control terminal 10.

In another embodiment, when the user desires to perform the cross-device cooperative control on the security devices within the home region, the user may input a text corresponding to the configuration requirement information via the input module to the control terminal 10.

Accordingly: when the subject for performing the method of the present disclosure is the control terminal 10, after receiving the configuration requirement information, the control terminal 10 may obtain the daily behavior pattern within the home region of the user from the base station 11. Accordingly, the control terminal 10 may perform the method for generating the cross-device control strategy provided by the present disclosure to determine a cross-device control strategy corresponding to requirements of the user. The control terminal 10 may perform the cross-device cooperative control on all or part of the security device 12, the security device 13, the security device 14, and the security device 15.

In some embodiments, when the subject for performing the method of the present disclosure is the controller within base station 11, after the control terminal 10 receives the configuration requirement information, the control terminal 10 may send the configuration requirement information to the controller of base station 11. Subsequently, the controller may use the receiving module of the controller itself to receive the configuration requirement information sent from the control terminal 10 and may perform the method for generating the cross-device control strategy provided by the present disclosure to determine the cross-device control strategy corresponding to the requirement of the user. The controller may perform the cross-device cooperative control on all or part of the security device 12, the security device 13, the security device 14, and the security device 15.

In some embodiments, the security device for performing the first security response operation may be determined as follows.

In a block 1, the configuration requirement information may be received.

The configuration requirement information may be configured to represent the user having requirements for a plurality of security devices to work cooperatively, or may be understood as a desired effect to be achieved when the plurality of security devices work cooperatively. The configuration requirement information may be a speech input by the user. For example, when the user desires the security device to intelligently monitor safety of a backyard of the house, the user may input the following speech: “Help me protect safety of the backyard on weekdays.” Alternatively, the configuration requirement information may be a text input by the user. The present disclosure does not limit a form of the configuration requirement information.

In an embodiment, the subject for performing the method of the present disclosure may receive the speech or the text in real time and may determine the captured speech or the captured text as the configuration requirement information.

In an embodiment, the input module of the present disclosure may include a cross-device cooperative scenario setting page, and a cross-device cooperative button is arranged in the cross-device cooperative scenario setting page. Accordingly, when the user desires to perform cross-device cooperative control of the security devices, the user may enter the cross-device cooperative scenario setting page, long-press a speech input button, and then speak the corresponding configuration requirement information to the speech input module of the present disclosure, such as “Help me protect the safety of the backyard on workdays”. “When a stranger lingers at my door, help me warn and expels them away”. “I need the house to be cleaned every day when 1 return home.” or other configuration request speeches.

In another embodiment, the input module of the present disclosure may include the cross-device cooperative scenario setting page, arranged with the cross-device cooperative button. Accordingly, when the user desires to perform the cross-device cooperative control on the plurality of security devices, the user may enter the cross-device cooperative scenario setting page and may input the text corresponding to the configuration requirement information in the input field, such as a text of “Help me protect the safety of the backyard on workdays”, or the like.

In a block 2, the configuration requirement information may be parsed by a predetermined model. The configuration requirement information may include a target scene and a configuration requirement.

The above predetermined model may be a pre-trained information analysis model capable of parsing the configuration requirement information. The predetermined model may analyze the input text or the input speech to derive a scenario and a configuration requirement corresponding to the input text or the input speech.

The target scene refers to a scene in which the user desires to perform the cross-device cooperative control on the plurality security devices, and that is, the scene corresponding to the configuration requirement information. The target scene may be any sub-scene of daily work, study: or living of the user, such as the living room, the front yard, or a bedroom in the house of the user. For example, when the configuration requirement information of the user is to monitor activities of an infant in an infant room and in the living room, the target scene may be the infant room and the living room.

The configuration requirement may refer to specific requirements of the user for the plurality of security devices when the user desires to perform the cross-device cooperative control on the plurality security devices. For example, the specific requirements may be a requirement for cooling, a requirement for capturing a video, or requirement for lighting, and so on.

In an embodiment, after receiving the configuration requirement information, in order to more accurately understand an intent of the user for the cross-device cooperative control, the subject for performing the method of the present disclosure may parse the received configuration requirement information using a pre-trained predetermined model, such that the target scene and the configuration requirement included in the configuration requirement information may be obtained.

In order to more accurately determine, from the configuration requirement information, the target scene and the configuration requirement for the cross-device cooperative control, the predetermined model provided by the embodiments of the present disclosure may be a predetermined model that is further trained based on an existing model. For example, the predetermined model may be a large language model configured to parse the input speech and the input text. The large language model may be available in the art. Therefore, in the present disclosure, the large language model available in the art may further be trained, so as to obtain the predetermined model described herein.

Accordingly: when training the aforementioned predetermined model, the subject for performing the method of the present disclosure may obtain a sample set of the configuration requirement information. The sample set of the configuration requirement information may include a plurality of configuration requirement information samples, and each of the plurality of configuration requirement information samples may correspond to one standard scene and one standard configuration requirement.

Furthermore, in order to enable the predetermined model to comprehensively recognize the speech or the text across diverse scenes, the aforementioned sample set of the configuration requirement information may include configuration requirement information samples of different scenes. The different scenes may correspond to different speech configuration requirement information samples, and the different speech configuration requirement information samples may have different accents or different languages but expressing an identical semantic meaning. Alternatively, the different scenes may correspond to different text configuration requirement information samples, and the different text configuration requirement information samples may have different expressions but the identical semantic meaning.

Accordingly, the subject for performing the method of the present disclosure may utilize the aforementioned configuration requirement information sample set to train a predetermined initial model, so as to obtain a predicted scene and a predicted configuration requirement corresponding to each configuration requirement information sample output by the initial model. The initial model may be a model that is available in the art or may be a newly constructed model, which will not be limited herein.

Subsequently, for each configuration requirement information sample, a first loss value between the predicted scene corresponding to the configuration requirement information sample and the standard scene corresponding to the configuration requirement information sample may be determined, and a second loss value between the predicted configuration requirement corresponding to the configuration requirement information sample and the standard configuration requirement corresponding to the configuration requirement information sample, may be obtained.

Furthermore, it may be determined, based on the first loss value and the second loss value corresponding to each configuration requirement information sample, whether a predetermined training termination condition is met.

In some embodiments, when it is determined that the predetermined training termination condition is met, a fully-trained predetermined model may be obtained.

Conversely, when it is determined that the predetermined training termination condition is not met, the initial model may further be trained using the sample set of the configuration requirement information, until a post-training model satisfies the predetermined training termination condition, such that the fully-trained predetermined model may be obtained.

In an embodiment, the subject for performing the method of the present disclosure may determine whether each of the first loss value and the second loss value corresponding to each configuration requirement information sample is less than a predetermined loss value threshold. In some embodiments, when each of the first loss value and the second loss value corresponding to each configuration requirement information sample is less than the predetermined loss value threshold, or when the number of configuration requirement information samples having the first loss value and the second loss value both less than the predetermined loss value threshold is greater than a predetermined quantity threshold, it may be determined that the predetermined training termination condition is met.

In a block 3, the target security device related to the configuration requirement may be determined from the device capability set of the plurality of security devices, so as to obtain the security device for performing the first security response operation.

A behavior pattern of the target security device in the target scene may be determined. Furthermore, the cross-device cooperative control strategy may be determined based on the aforementioned behavior pattern and the device capability set of each target security device. In this way, the target security device may be controlled according to the cross-device cooperative control strategy within the target scene to achieve the configuration requirement.

The aforementioned device capability set corresponds to a function of the security device, and that is, what the security device may be used to perform, and what function the security device may achieve.

The aforementioned behavior pattern may refer to a routine behavior pattern that the target security device performs in the target scene, such as an operating time periods and an operating mode of an air conditioner in the bedroom when air conditioner being routinely operating.

In the embodiments of the present disclosure, in order to more accurately generate the cross-device cooperative strategy corresponding to the configuration requirement of the user, the subject for performing the method of the present disclosure may determine the device capability set of each security device in the predetermined scene, so as to further determine the target security devices related to the configuration requirement. The subject for performing the method of the present disclosure may further determine the behavior pattern of the target security device in the target scene, and may determine the cross-device cooperative strategy based on the aforementioned behavior pattern and the device capability set of each target security device.

In an embodiment, the subject for performing the method of the present disclosure may determine a device identifier for each security device of the plurality of security devices; and may determine the device capability set corresponding to each security device based on the device identifier.

In an embodiment, the subject for performing the method of the present disclosure may store, in advance, an object model of each security device under the predetermined scene. Accordingly, the device capability set for each security device may be determined, and the target security device relevant to the configuration requirement may be determined from the plurality of device capability sets. The predetermined scene may include at least the target scene.

The aforementioned object model refers to a digital representation of a physical entity (such as a camera, a sensor) corresponding to each type of security devices within a physical space. The aforementioned object model may describe the entity from three dimensions: what the entity is (an attribute), what the entity can do (a service), what information the entity can provide externally (an event). Each entity model may correspond to one type of security devices, and the entity model for the one type may include security devices of one type but in different models.

Accordingly: for each security device of the plurality of security devices within the predetermined scene, the subject for performing the method of the present disclosure may determine a target object model corresponding to the security device from a predetermined object model set. The aforementioned object model set may include a plurality of object models, each of the plurality of object models corresponds to one type of security devices.

Accordingly, the device identifier of each security device may be determined. The device capability set corresponding to each security device may be determined from the target object model based on the device identifier of each security device.

In an embodiment, within the predetermined scene containing the target scene, at each time one security device is installed, the subject for performing the method of the present disclosure may interact with the security device to obtain the device identifier of the security device and may store correspondence between the security device and the device identifier thereof in a database.

Accordingly, the subject for performing the method of the present disclosure may directly retrieve the device identifier of each security device from the database.

Subsequently, an installation location of each security device may be determined.

In an embodiment, within the predetermined scene containing the target scene, at each time the user installs one security device, the installation location of the security device may be stored in the predetermined database via a display interface. Accordingly, the subject for performing the method of the present disclosure may directly retrieve the installation location of each security device from the database.

The display interface may include a three-dimensional scene diagram of the predetermined scene. By clicking the installation location of a newly-installed security device within the three-dimensional scene diagram and inputting information such as a device type of the newly-installed security device, the user may store the installation location of the newly-installed security device in the database.

In another embodiment, the subject for performing the method of the present disclosure may invoke a predetermined image capturing device to capture scene images corresponding to the plurality of security devices and may recognize the captured scene images to determine the installation location of each security device.

Finally, it may be determined, based on the aforementioned device capability set and the installation location, whether the security device is the target security device relevant to the configuration requirements.

In an embodiment, a target function included in the configuration requirements of the user may firstly be determined. It may be determined, based on the device capability set of each security device, whether a corresponding security device may achieve the aforementioned target function.

In some embodiments, when it is determined that the security device can achieve the target function, it may be indicated that the security device satisfies functional requirements in the configuration requirements of the user. In this case, in order to further determine whether the security device is the target security device that is completely related to the configuration requirements, the subject for performing the method of the present disclosure may determine whether the installation location of the security device is located within the target scene of the configuration requirements.

In some embodiments, when it is determined that the security device is located within the target scene of the configuration requirements, it may be indicated that the security device satisfies the scene requirement of the configuration requirements. Therefore, it may be determined that the security device is the target security device related to the aforementioned configuration requirements.

For example, the configuration requirements of the user may be “Turn on lights in the living room and set a temperature of the living room to 27 degrees when the child returns home”. The target scene of the configuration requirement information may be the living room, and the configuration requirements may be: providing lighting and cooling upon the child returning.

In another case, the security devices in the house of the user may include: an air conditioner, a television, a refrigerator, a washing machine, a smart lighting (living room), and a smart lighting (bedroom).

The air conditioner, the television, and the refrigerator may be located in the living room. In this case, the aforementioned configuration requirement information may be parsed, and it may be determined that the target function of the configuration requirements may be: lighting and cooling. It may be determined, based on the device capability set of each security device, that the air conditioner and all smart lightings may satisfy the target function. Therefore, the air conditioner and the smart lightings may be determined as initial target security devices meeting the functional requirements of the configuration requirements.

Furthermore, in order to determine whether the initial target security devices meet the scene requirement of the configuration requirements, an installation location of the air conditioner and an installation location of each smart lighting may be determined separately. Any one of the initial target security devices installed in the living room may then be determined as the target security device relevant to the configuration requirements, and that is, the air conditioner and the smart lighting installed in the living room may be the target security devices.

In an embodiment, in order to determine the cross-device cooperative control strategy that better aligns with the routine behavior pattern of the user and devices, the subject for performing the method of the present disclosure may further determine the behavior pattern of the target security device within the target scene. In this way, the cross-device cooperative control strategy may be determined based on the behavior pattern and the device capability set of each target security device, such that the target security device may be controlled, based on the cross-device cooperative control strategy within the target scene, so as to fulfill the configuration requirements.

In an embodiment, when determining the behavior pattern of the target security device in the target scene, the subject for performing the method of the present disclosure may obtain a routine behavior pattern of the target security device in the predetermined scene during a predetermined historical time period. The routine behavior pattern may be obtained from the base station, and the base station may obtain, through local self-learning, the routine behavior pattern. The predetermined scene may include at least the target scene: for example, when the target scene is the living room, the predetermined scene may be the house of the user, and the house may include bedrooms, the living room, and so on.

Subsequently, the behavior pattern of the target security device in the target scene may be determined based on the routine behavior pattern in the predetermined scene.

In an embodiment, the subject for performing the method of the present disclosure may directly take the routine behavior pattern of each target security device within the predetermined historical time period in the predetermined scene as the behavior pattern of the target security device in the target scene.

In order to obtain the routine behavior pattern in the predetermined scene in real time, the subject for performing the method of the present disclosure may perform AI self-learning via the base station to learn the routine behavior pattern in the predetermined scene. In regard to performing AI self-learning via the base station to learn the routine behavior pattern, since data does not need to leave the device for learning and improvement, privacy of the user may be protected. Furthermore, during performing AI self-learning via the base station to learn the routine behavior pattern, network transmission may not be needed, and therefore, network latency may be reduced, and a response speed may be improved.

Accordingly: when obtaining the routine behavior pattern in the predetermined scene, the subject for performing the method of the present disclosure may obtain the routine behavior pattern from the base station, and the base station may obtain the routine behavior pattern in the predetermined scene through local self-learning.

The base station may obtain the routine behavior pattern for the predetermined scene as follows. Firstly: when detecting a behavior event occurring in the predetermined scene, it may be determined whether a subject performing the behavior event is the security device within the predetermined scene.

In some embodiments, when the subject performing the behavior event is the security device within the predetermined scene, device behavior information corresponding to the behavior event may be obtained. The behavior event refers to an event that the security device, after being triggered within the predetermined scene, performs a corresponding function to cause a device state of the security device to be changed, such as a monitoring direction of a camera being changed, or an operating state of an air conditioner being changed.

Subsequently, the device behavior information may be stored in a predetermined database. When no behavior event is detected, self-learning may be performed based on the device behavior information stored in the database, such that the routine behavior pattern of the security device in the predetermined scene may be obtained.

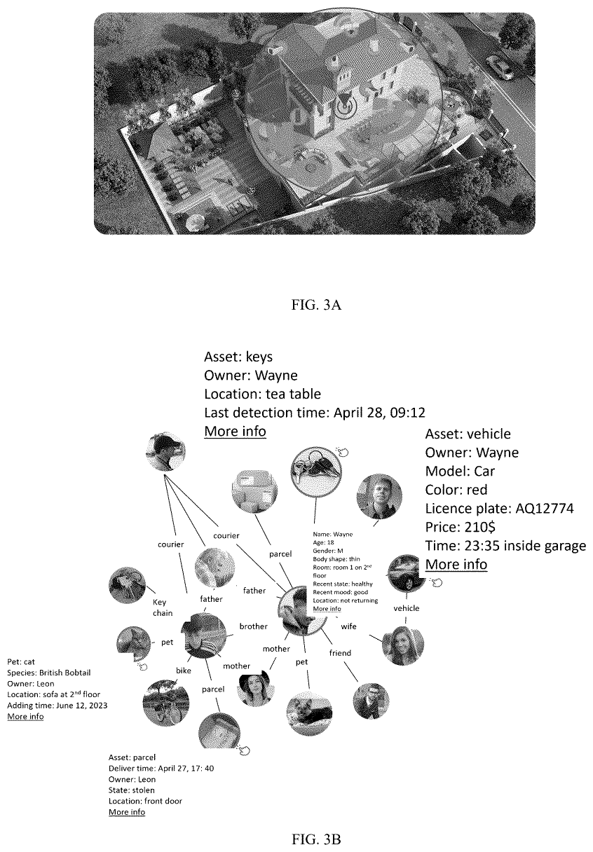

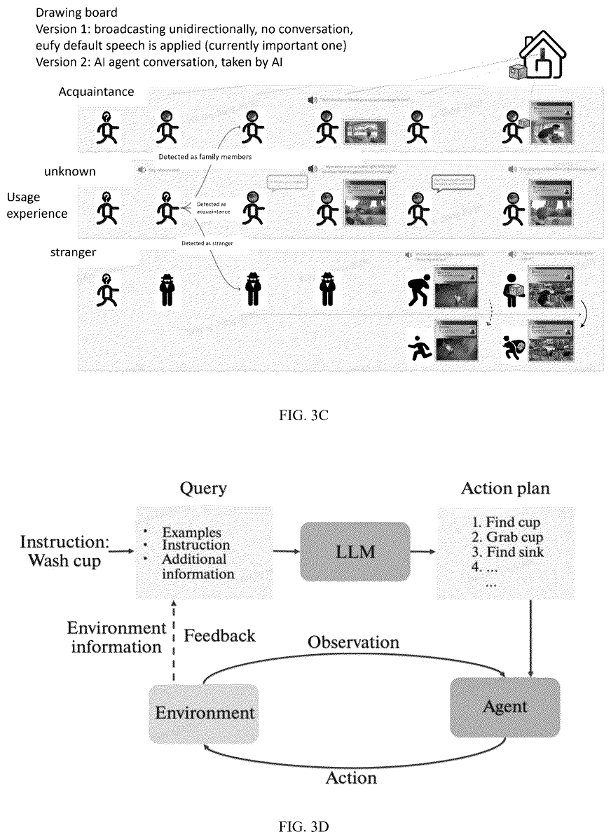

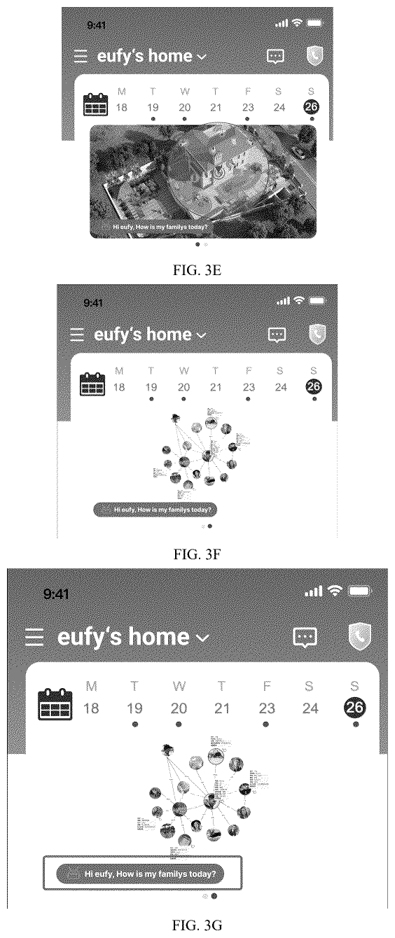

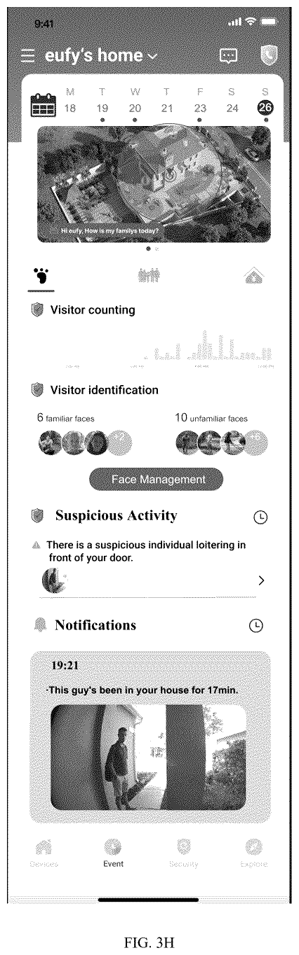

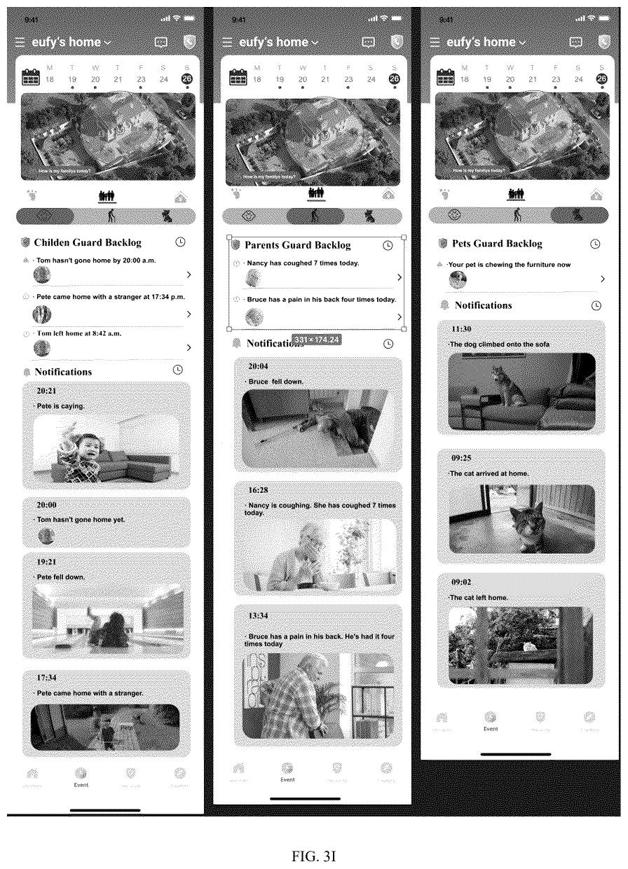

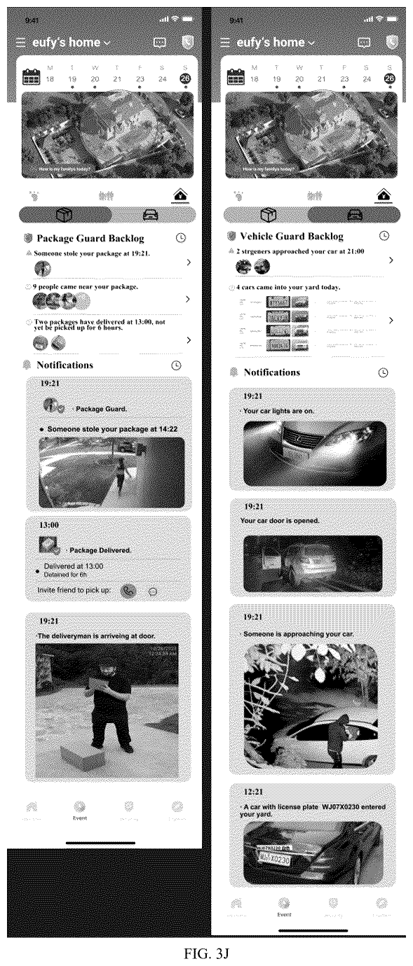

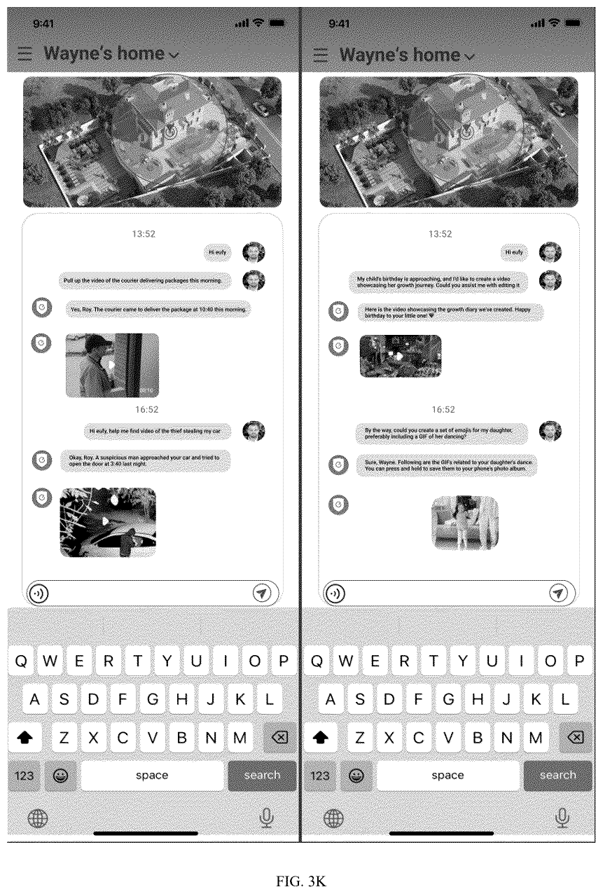

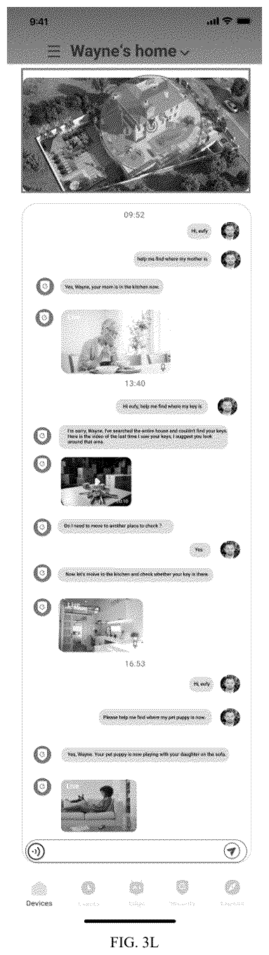

Details about how the subject for performing the method of the present disclosure determines the cross-device cooperative control strategy based on the behavior pattern and the device capability set of each target security device will be explained in detail at a later section by referring to a flow chart shown in FIG. 3.

Furthermore, in order to ensure the determined cross-device cooperative control strategy to better align with cross-device cooperative control requirements of the user, after determining the cross-device cooperative control strategy based on the behavior pattern and the device capability set of each target security device, the subject for performing the method of the present disclosure may output the cross-device cooperative control strategy via a visual interface. Accordingly, the user may modify the cross-device cooperative control strategy. After receiving a modification operation performed, by the user, on the device cooperative control strategy: the subject for performing the method of the present disclosure may obtain a post-modification target cross-device cooperative control strategy and may update the cross-device cooperative control strategy to the post-modification target cross-device cooperative control strategy.

Accordingly, the subject for performing the method of the present disclosure may perform cross-device cooperative control on the plurality of security devices in the predetermined scene based on the aforementioned updated target cross-device cooperative control strategy.

For example, a cross-device intent of the user may be tracking and expelling a stranger.

The cross-device cooperative control strategy may be generated as follows.
1. The user may enter an ID of the user into a master controller to initiate a calibration process in which the house may be toured for one round.
2. The master controller may recognize, via each camera, a time sequence of movement of the user and a pan-tilt angle of each camera, so as to determine a relative position between cameras.
3. The user may open an application, activate a speech input function, and state the configuration requirements: “I want notifications when any stranger lingers around my house on weekdays, and expel the stranger, and then provide a complete video data to me”.
4. After processing, the application may automatically generate the following information displayed on an interface: “When the sensor and the camera in the yard (front/back yard) detects any unfamiliar target, push an alert message, activate video capturing devices in the yard (front/back yard) to capture a video, apply a person tag, and initiate alarm processing; and the cross-device operation remains active for whole days from Monday to Friday”.
5. The user may may manually adjust active time for the weekdays to be from 9:00 AM to 6:00 PM, and “save” may be clicked. In this way: complete rules of the cross-device operation for tracking and expelling the strange may be formed.

Furthermore, the above cross-device cooperative control strategy may achieve the following effects.
1. When the stranger enters a periphery of the house, and when any camera detects the trigger, the cross-device operation for tracking and expelling the strange may be triggered, and the notification may be pushed to the user.
2. The master controller may collect images from all cameras. A region to which the stranger intends to enter may be determined based on an AI image algorithm and based on a movement direction and a movement speed of the stranger. Cameras in a designated region may be activated to initiate video tracking and to provide audio-visual alarms.
3. When the stranger moves away from the periphery of the house, the camera may stop the video recording and stop making the alarm.
4. The master controller may collect videos from a plurality of cameras: extract, by an AI facial detection algorithm, a clear facial portrait from a plurality of video segments; and draw an intrusion trajectory of the stranger based on a chronological order of appearance of the stranger in images of the plurality of cameras.
5. The master controller may combine multi-modal key information, which may include the videos, the facial portrait, the intrusion trajectory: a first appearance time, a first appearance location, a departure time, and a departure location, so as to generate an event card to be revied by the user.

It is understood that in the above embodiments, the configuration requirement information may be received, and the configuration requirement information may be parsed by the predetermined model. The configuration requirement information may include the target scene and the configuration requirements. In this way, the target security device relevant to the configuration requirements may be determined from the device capability set of the plurality of security devices, and the behavior pattern of the target security device within the target scene may be determined. The cross-device cooperative control strategy may be determined based on the behavior pattern and the device capability set of each target security device. In this way, the target security device may be controlled, based on the cross-device cooperative control strategy within the target scene, to achieve the configuration requirements. In this way: when the configuration requirement information is received, the cross-device cooperative control strategy for a plurality of target security devices that meet the target scene and the configuration requirements specified in the input configuration requirement information may be automatically generated by combining the device capability set and the behavior pattern of each security device. Automatic generation of the cross-device cooperative control strategy that satisfies cross-device cooperation requirements of the user may be achieved. Time is saved, and the cross-device cooperative control strategy may be generated efficiently and accurately, and the user experience may be improved.

In some application scenarios of the aforementioned embodiments, the security device may be controlled to perform the first security response operation as follows.

In a block 1, the behavior pattern of the target security device within the target scene may be determined.

In a block 2, the cross-device cooperative control strategy may be determined based on the behavior pattern and the device capability set of each target security device, such that the target security device may be controlled to perform the first security response operation according to the cross-device cooperative control strategy within the target scene to achieve the configuration requirements.

Detailed implementation of the above blocks may be referred to the above description, which will not be repeated herein.

In certain scenarios of the aforementioned application scenarios, the cross-device cooperative control strategy may be determined based on the behavior pattern and the device capability set of each target security device as follows.

In a block 1, the configuration requirements may be parsed to determine the a trigger condition for each target security device.

The aforementioned trigger condition may refer to a condition for triggering each target security device in the target scene. For example, when the configuration requirements of the user are monitoring activities of an infant in the infant room and in the living room, the target scene may be the infant room and the living room, and the target security devices may be a camera installed in the infant room and a camera installed in the living room. The trigger conditions of the cameras may be the activities of the infant being detected.

In an embodiment, after inputting the configuration requirement information, the user may incorporate the cross-device cooperative control requirements into the configuration requirement information. The cross-device cooperative control requirements may include the target scene, the target security device with the target scene, and the trigger condition for each target security device. Accordingly, the subject for performing the method of the present disclosure may parse the configuration requirements to determine the trigger condition for each target security device.

In a block 2, an initial cross-device cooperative control strategy may be determined based on the trigger condition and the device capability set of each target security device.

The initial cross-device cooperative control strategy may be the cross-device cooperative control strategy that is initially set for the plurality of target security devices. For example, when the target security devices are the camera in the infant room and the camera in the living room, the initial cross-device cooperative control strategy may be as follows. When a camera having a recognition capability detects the activities of the infant, the camera having the recognition capability may capture a video for the infant.

In an embodiment, when determining the initial cross-device cooperative control strategy among the plurality of target security devices, the subject for performing the method of the present disclosure may determine the initial cross-device cooperative control strategy based on the trigger condition and the device capability set for each target security device.

In an embodiment, a function that can be achieved by each target security device may be determined based on the device capability set. The trigger condition for each security device in the target scene may be determined based on the aforementioned trigger condition.

Accordingly, a target function that each target security device is to achieve in the target scene may be determined according to the trigger condition for each target security device and the function that can be achieved by each target security device. Furthermore, the initial cross-device cooperative control among one or more target security devices may be generated.

For example, the configuration requirements may be “Cool the living room and turn on lights when detecting any family member returning home”. The predetermined scene corresponding to the configuration requirements may include two air conditioners in the living room, a television in the living room, a plurality of smart lights in the living room, a washing machine in the living room, and a refrigerator in the living room. In regard to the configuration requirements, the target security devices may be determined as the two air conditioners in the living room and the plurality of smart lights in the living room.

When an air conditioner 1 and an air conditioner 2 are determined as being capable of performing cooling based on the device capability set of each of the air conditioner 1 and the air conditioner 2, and when the plurality of smart lights are determined as being capable of performing lighting, it may be determined that the air conditioner 1 may perform cooling, and the plurality of smart lights may perform lighting. According to the configuration requirements, each of the trigger condition for the air conditioner 1 and the trigger condition for the plurality of smart lights may be the family member arriving home. Therefore, the initial cross-device cooperative control strategy may be determined as: when any family member arrives home, turning on the air conditioner 1 and the plurality of smart lights in the living room.

In a block 3, the cross-device cooperative control strategy may be determined based on the initial cross-device cooperative control strategy and the behavior pattern.

After determining the initial cross-device cooperative control strategy for the plurality of target security devices, the cross-device cooperative control strategy may be determined based on the initial cross-device cooperative strategy and the behavior pattern of each target security device.

In an embodiment, the subject for performing the method of the present disclosure may determine at least one predetermined dimension of cross-device cooperative control conditions, based on the initial cross-device cooperative control strategy and the behavior pattern. The predetermined dimension may include, but not limited to: a time dimension, a device dimension, a user dimension, a trigger movement, and an execution movement.

Subsequently, the cross-device cooperative control conditions may be input into a predetermined cross-device cooperative control strategy model to obtain the cross-device cooperative control strategy output by the model. The aforementioned cross-device cooperative control strategy model may be a pre-stored cross-device cooperation rule format specification model, through which the cross-device cooperative control strategy conforming to a predetermined format condition may be generated.

For example, the received configuration requirement information may be “Monitor the backyard when the user is at work, and issue a warning upon detecting a stranger”. Furthermore, the target security devices corresponding to the above configuration requirement information may include: a human motion sensor at the backyard, a camera A at the backyard, a camera B at the backyard, and a speaker at the backyard. Following the blocks above, the initial cross-device cooperative control strategy may be determined as follows. When the human motion sensor at the backyard is triggered or any camera is triggered for detection, the camera A at the backyard may record a video, and the camera B may perform patrol and provide a light flash. When determining the object is a stranger, the speaker may be triggered to provide a warning.

In an example, the behavior pattern for each target security device may be as follows. The human motion sensor at the backyard may detect and recognize the user from Monday to Friday at 9:00 AM. 6:00 PM, and 9:00 PM. The camera A may record a video when receiving signals from the human motion sensor. The camera B may perform patrol and provide the light flash when receiving signals from the human motion sensor. The speaker may issue the warning when receiving a stranger signal from the human motion sensor.

Combining the aforementioned initial cross-device cooperative control strategy with the behavior pattern of each target security device, following cross-device cooperative control conditions may be obtained, including but not limited to: the time dimension: from Monday to Friday, daily from 9:00 AM to 6:00 PM or 9:00 PM; the device dimension: the human motion sensor at the backyard, the camera A, the camera B, and the speaker: the user dimension: each family member that goes to work; the trigger movement: the human motion sensor detecting an object and triggering the speaker when determining the object as the stranger; the execution movement: the human motion sensor detecting the object and determining whether the detected object is the stranger; the camera A recording the video: the camera B performing patrol and providing the light flash: the speaker issuing the warning.

Subsequently, the above cross-device cooperative control conditions may be input into the predefined cross-device cooperative control strategy model. The model may generate the cross-device cooperative control strategy conforming to the predetermined format condition. In this way, the obtained cross-device cooperative control strategy may be as follows. When the human motion sensor at the backyard is triggered to detect an object, the camera A at the backyard may be activated to record the video, and the camera B may perform patrol and provide the light flash. The human motion sensor may determine whether the object is the stranger. When the object is determined as the stranger, the speaker may be activated to issue the warning. The above strategy may be effective from Monday to Friday, from 9:00 AM to 6:00 PM or 9:00 PM daily, and may be applied cyclically for each week.

Furthermore, since the configuration requirement information of the user may be set based on the user and family members of the user, each configuration requirement information may correspond to at least one target user. The target user may be a family member or a stranger. Accordingly, the subject for performing the method of the present disclosure may further adjust the obtained cross-device cooperative control strategy based on a user behavior pattern of the target user, such that the cross-device cooperative control strategy may better align with routine behavior pattern of the user. The target user refers to a user involved in the configuration requirement information and may be a family member having a historical behavior pattern or a stranger without the historical behavior pattern, which will not be limited herein.

In an embodiment, when the target user is a pre-registered family member, and that is, when the target user has the historical behavior pattern in the target scene, the user behavior pattern of the target user in the target scene may be obtained. The cross-device cooperative control strategy may be adjusted based on the user behavior pattern.

In an embodiment, when determining the user behavior pattern of the target user in the target scene, the subject for performing the method of the present disclosure may firstly obtain, from the base station, the routine behavior pattern of the target user in the predetermined scene during a predetermined historical time period. The base station may obtain the routine behavior pattern in the predetermined scene through local self-learning. The predetermined scene may include at least the target scene. For example, when the target scene is the living room, the predetermined scenes may be the house of the user, which may include bedrooms, the living room, and so on.

Subsequently, the user behavior pattern of the target user within the target scene may be determined based on the routine behavior pattern of the target user within the predetermined scene.

In order to enable the routine behavior pattern in the predetermined scene to be obtained in real time, the subject for performing the method of the present disclosure may perform AI self-learning through the base station to learn the routine behavior pattern in the predetermined scene. In regard to obtaining the routine behavior pattern via local self-learning at the base station, data does not need to leave the device for learning and improvement, and therefore, the privacy of the user may be protected. Furthermore, network transmission may not be performed during obtaining the routine behavior pattern via local self-learning at the base station, and therefore, network latency may be reduced, and the response speed may be improved. Accordingly, when obtaining the routine behavior pattern in the predetermined scene, the subject for performing the method of the present disclosure may obtain the routine behavior pattern from the base station corresponding to the predetermined scene. The base station corresponding to the predetermined scene may obtain the routine behavior pattern for each user within the predetermined scene through local self-learning.

The aforementioned base station corresponding to the predetermined scene may obtain the routine behavior pattern for each user within the predetermined scene as follows. Firstly: upon detecting a behavior event occurring within the predetermined scene, it may be determined whether a subject performing the behavior event is a user within the predetermined scene. In some embodiments, when the subject performing the behavior event is the user within the predetermined scene, user behavior information corresponding to the behavior event may be obtained. The behavior event may refer to an event corresponding to a behavior when a user state in the predetermined scene is changed, such as an event of the user entering a field of view of the camera.

Subsequently, the user behavior information may be stored in a predetermined database. When no behavior event is detected, self-learning may be performed based on the user behavior information stored in the database, such that the routine behavior pattern of the user in the predetermined scene may be obtained.

Furthermore, in an embodiment, after determining the cross-device cooperative control strategy for the plurality of target security devices, the cross-device cooperative control strategy may be adjusted based on the user behavior pattern.

In an embodiment, the subject for performing the method of the present disclosure may redefine, based on the cross-device cooperative control strategy and the user behavior pattern, at least one predetermined dimension of the cross-device cooperative control conditions. The predetermined dimension may include, but not limited to: the time dimension, the device dimension, the user dimension, the trigger movement, and the execution movement.

Subsequently, the cross-device cooperative control conditions may be input into the predetermined cross-device cooperative control strategy model to obtain the cross-device cooperative control strategy output by the model. The aforementioned cross-device cooperative control strategy model may be a pre-stored cross-device cooperation rule format specification model, through which the cross-device cooperative control strategy conforming to the predetermined format condition may be generated.

For example, the received configuration requirement information may be “Monitor the backyard when the user is at work, and issue a warning upon detecting a stranger”. Furthermore, the target security devices corresponding to the above configuration requirement information may include: a human motion sensor at the backyard, a camera A at the backyard, a camera B at the backyard, and a speaker at the backyard. Following the blocks above, the initial cross-device cooperative control strategy may be determined as follows. When the human motion sensor at the backyard is triggered or any camera reached by a person is triggered for detection, the camera A at the backyard may record a video, and the camera B may perform patrol and provide a light flash. When determining the object is a stranger, the speaker may be triggered to provide a warning.

In an example, the behavior pattern for each target security device may be as follows. The human motion sensor at the backyard may detect and recognize the user from Monday to Friday at 9:00 AM. 6:00 PM, and at 9:00 PM. The camera A may record a video when receiving signals from the human motion sensor. The camera B may perform patrol and provide the light flash when receiving signals from the human motion sensor. The speaker may issue the warning when receiving a stranger signal from the human motion sensor.

Combining the aforementioned initial cross-device cooperative control strategy with the behavior pattern of each target security device, following cross-device cooperative control conditions may be obtained, including but not limited to: the time dimension: from Monday to Friday, daily from 9:00 AM to 6:00 PM or 9:00 PM; the device dimension: the human motion sensor at the backyard, the camera A, the camera B, and the speaker: the user dimension: each family member that goes to work; the trigger movement: the human motion sensor detecting an object and triggering the speaker when determining the object as the stranger; the execution movement: the human motion sensor detecting the object and determining whether the detected object is the stranger; the camera A recording the video: the camera B performing patrol and providing the light flash: the speaker issuing the warning.

Subsequently, the above cross-device cooperative control conditions may be input into the predefined cross-device cooperative control strategy model. The model may generate the cross-device cooperative control strategy conforming to the predetermined format condition. In this way, the obtained cross-device cooperative control strategy may be as follows. When the human motion sensor at the backyard is triggered to detect an object, the camera A at the backyard may be activated to record the video, and the camera B may perform patrol and provide the light flash. The human motion sensor may determine whether the object is the stranger. When the object is determined as the stranger, the speaker may be activated to issue the warning. The above strategy may be effective from Monday to Friday, from 9:00 AM to 6:00 PM or 9:00 PM daily, and may be applied cyclically for each week.

When the obtained behavior pattern of the target user is: working from Monday to Friday: leaving home daily at 9:00 AM, leaving work at 6:00 PM, and taking an evening walk in the backyard at 9:00 PM.

According to the behavior pattern. 9:00 PM may be determined as a walking time of the target user and determined as a non-working hour. Therefore, the cross-device cooperative control strategy may be adjusted as follows. When the human motion sensor at the backyard detects an object, the camera A may be triggered to record a video, and the camera B may be triggered to perform patrol and provide the light flash. Simultaneously, the human motion sensor may determine whether the object is the stranger. When the object is the stranger, the speaker may be triggered to issue the warning. The adjusted strategy may be effective from Monday to Friday, from 9:00 AM to 6:00 PM daily, and may be applied cyclically for each week.

It may be understood that, in the above cases, the configuration requirements may be parsed to determine the trigger condition for each target security device. The initial cross-device cooperative control strategy may be determined based on the trigger condition and the device capability set of each target security device. The cross-device cooperative control strategy may be determined based on the behavior pattern to the initial cross-device cooperative control strategy. In this way, the initial cross-device cooperative control strategy corresponding to the function of the target security device may be determined firstly, and the corresponding cross-device cooperative control strategy may be generated based on the behavior pattern and the initial cross-device cooperative control strategy of the target security device. In this way, the cross-device cooperative control strategy that meets the configuration requirements of the user may be generated rapidly and accurately. Time may be saved, the cross-device cooperative control strategy may be efficiently and accurately generated, and the user experience may be improved.

In some application scenarios of the aforementioned embodiments, the security device for performing the first security response operation may be determined as follows.

In a block 1, a target image set corresponding to the security device set may be obtained.

The security device set may include at least two security devices. The security devices may include at least one of: a camera, an alarm device, a sensor, and so on.

For example, one security device in the security device set may be: a camera, an alarm device, or a sensor. Alternatively, one security device in the security device set may include: a camera and an alarm device.

The target image set corresponding to the security device set may be a set of images captured for the security devices in the security device set (hereinafter referred to as a manner 1). For example, one or more cameras may capture images for each security device in the security device set, so as to obtain the target image set corresponding to the security device set.

Alternatively, the target image set corresponding to the security device set may be a set of images captured by cameras in the security device set (hereinafter referred to as a manner II). For example, each security device in the security device set may include a camera. In this way, each camera included in the security device set may capture an image for a region within the field of view of the camera, so as to obtain the target image set corresponding to the security device set.

In a block 2, a reference object may be extracted from the target image set.

The reference object may be an image of one predetermined physical entity or images of a plurality of physical entities with known spatial relationships therebetween. For example, the reference object may be an image of a predetermined tree near the house of the user. In another example, the reference object may be images of a gate of the house and the predetermined tree. In another example, the reference object may be images of the user or an object held by the user that are captured in the target image set by the security device set, during the user moving around the security device set.

In a block 3, an associative relationship among the security devices may be established based on the reference object.

The association relationship may include at least one of: a positional relationship (such as whether two security devices are adjacent to each other, a relative position between two security devices, and so on); whether the security devices work cooperatively: whether the security devices share one field of view, and so on. For example, two security devices include a camera A and a camera B. When the camera A is configured to capture a telephoto image for a subject A and the camera B is configured to capture a wide-angle image for the subject A, the association relationship between the two security devices may be determined as the two security devices working cooperatively: The association relationship may include an association relationship among all or a portion of all security devices in the security device set.

In an example, when the target image set is obtained by performing the manner 1 as described above, a relative position of every two security devices in the security device set may be determined based on the target image set, such that the determined relative position may be determined as the association relationship.

In another example, when the target image set is obtained by performing the manner II as described above, the association relationship may be derived by: determining a positional relationship (such as being adjacent to, or the relative position) among the security devices in the security device set based on the target image set: determining whether the security devices work cooperatively based on the target image set; and determining whether the security devices share one field of view based on the target image set.

In a block 4, when a target object is detected as being located within a security region monitored by the security device set, one or more cooperative security devices may be determined from the security device set based on the association relationship and target information of the target object. In this way, the security device for performing the first security response operation may be obtained.

The security region may be a security region of the security devices in the security device set. For example, the security region may be the field of view of the camera included in the security device set.

The target object may be an object located in the security region. In an example, the target object may be an image of an object that is in a moving state within the security region at a historical or at a current time point. In addition, the target object may include an image of at least one of the following: a person, a vehicle, an animal, and so on.

The target information may include at least one following information about the target object: pose information, focal length information, contour feature information, a movement speed, and so on.

For example, when the target information indicates that the movement speed of the target object is less than or equal to a predetermined speed, the security region of a single security device A in which the target object is located may firstly be determined. Subsequently, another security device, which has the association relationship of working cooperatively with the security device A (a type of the association relationship, such as a telephoto camera and a wide-angle camera may work cooperatively), may be determined from the security device set. The determined security device may serve as a cross-device cooperative security device.

In another example, when the target information indicates that the movement speed of the target object is greater than the predetermined speed, the security region of the single security device A in which the target object is located may firstly be determined. Subsequently, another security device, which has the association relationship of sharing the field of view with the security device A (a type of the association relationship, such as two adjacent cameras sharing one field of view), may be determined from the security device set. The determined security device may serve as a cross-device cooperative security device.

In another example, it may be determined whether objects indicated by two images are one same object, based on the pose information and/or the contour feature information. When the objects indicated by two images are one same object, it may be determined that two security devices capturing images for the one same object share the field of view (a type of the association relationship, such as adjacent cameras sharing one field of view). When the target object is located within the security region monitored by one of the two security devices, the other one of the two security devices may be determined as a cross-device cooperative security device.

In another example, it may be determined whether objects indicated by two images are one same object, based on the pose information and/or the contour feature information. When the objects indicated by two images are one same object, and when focal lengths represented by the focal length information of the two images are different from each other, it may be determined that the two security devices capturing the two images may have the association relationship of working cooperatively with each other (a type of the association relationship, such as a telephoto camera and a wide-angle camera may work cooperatively). When the target object is located within the security region monitored by one of the two security devices, the other one of the two security devices may be determined as a cross-device cooperative security device.

It may be understood that when the security device A has a first relationship (i.e., sharing the field of view) with the security device B and has a second relationship (i.e., working cooperatively) with a security device C, determination of whether the security device B or the security device C as the cross-device cooperative security device may be made based on the movement speed of the object within the security region monitored by the security devices.

Accordingly, the security device may be controlled to perform the first security response operation as follows. One or more cross-device cooperative security devices may be controlled to monitor the target object, such that the first security response operation may be performed.

Each security device in the above security device set may be associated with one or more monitoring operations. In this way, a monitoring operation that is to be performed by the cross-device cooperative security device may be determined based on the association relationship.

The monitoring operation may include at least one of: an image capturing operation, a warning operation. For example, when the security device is the camera, the security device may perform the image capturing operation. When the security device is the alarm device, the security device may perform the warning operation.

Each security device in the aforementioned security device set may be associated with one or more monitoring operations. The monitoring operation that is to be performed by the cross-device cooperative security device may be determined based on the association relationship.

In addition, a cross-device cooperation rule may be predetermined. The monitoring operation that is to be performed by the cross-device cooperative security device may be determined based on the cross-device cooperation rule. For example, the cross-device cooperation rule may be determined based on requirements of the user and/or the aforementioned association relationship. The cross-device cooperation rule may be configured to instruct the cross-device cooperative security device to perform the monitoring operation. For example, when the camera at the front yard detects a courier at a front gate, the camera at the front door (the cross-device cooperative security device) may be triggered to perform detection on a delivered parcel. Any operation performed by any device during the above process may be the monitoring operation. For example, the camera at the front gate determining a detected face as the courier: the camera inside the yard performing associated video capturing, once the courier entering the front yard: once reaching the front door, the camera at the front door performing parcel detection and issuing a signal announcement, may all be determined as the monitoring operations.

Furthermore, after determining the cross-device cooperative security device and the monitoring operations to be performed by the cross-device cooperative security device, the cross-device cooperative security device may be controlled to perform the monitoring operation.

It should be understood that in the above embodiments, the association relationship among the security devices within the security device set may be automatically determined based on the corresponding target image set, and the cross-device cooperative security device may be controlled to perform the monitoring operation. In this way, the extent of automation in which the user uses the security devices for monitoring may be improved, complexity of the user uses the security devices for monitoring may be reduced.

In certain cases of the above application scenarios, the security devices may include cameras.

Accordingly, the target image set corresponding to the security device set may be obtained as follows. The images captured by the security devices in the security device set may be obtained, so as to obtain the target image set. The security devices and target images in the target image set may be in one-to-one correspondence to each other.

At least two security devices may be included in the security device set. The security devices may include at least one of: the camera, the alarm device, the sensor, and so on.

For example, one security device in the security device set may be: the camera, the alarm device, or the sensor. Alternatively, one security device in the security device set may include: the camera and the alarm device.

The target image set corresponding to the security device set may be a set of images captured for the security devices in the security device set. For example, one or more cameras may capture an image of each security device in the security device set to generate the corresponding target image set.

Alternatively, the target image set corresponding to the security device set may be a set of images captured by cameras in the security device set. For example, each security device in the security device set may include the camera. Accordingly, each camera in the security device may capture an image of a region within the field of view of the camera, so as to obtain the target image set corresponding to the security device set.

Specifically, the security device set includes a security device A, a security device B, and a security device C; and the security device A captures an image A, the security device B captures an image B, and the security device C captures an image C. In this case, the target image set may include the image A, the image B, and the image C.

In the present embodiment, correspondence between the security devices and the target images May be as follows. Each target image may be captured by the security device corresponding to the target image.

Furthermore, the association relationship between the security devices may be established based on the reference object as follows.

In a block 1, a capturing time point at which the target image in the target image set is captured may be determined.

When capturing the target image, the capturing time point thereof may be recorded.

In a block 2, the association relationship between the security devices in the security device set may be established based on the determined capturing time point and the reference object.

After obtaining the capturing time point and the reference object, the association relationship between the security devices in the security device set may be determined based on the obtained capturing time point and the reference object.

For example, the target object simultaneously appears in a target image captured by the camera A and in a target image captured by a camera B. At another time point, the target object simultaneously appears in the target image captured by the camera A and in a target image captured by a camera C. It may be indicated that, at a first location where the target object appears, the camera A and the camera B are cameras sharing one field of view (i.e., the aforementioned association relationship). At a second location where the target object appears, the camera A and the camera C are cameras sharing one field of view (i.e., the aforementioned association relationship).

According to the above association relationship, tracking without any blind spot may be achieved. For example, when the target object is about to exit the field of view of the camera A and the target information thereof shows that the target object is about to enter the monitoring region of the camera B, the camera B takes over video recording for the target object, and at this moment, the camera C is in a sleep mode to save power. When the target object is about to exit the field of view of the camera A and the target information thereof shows that the target object is about to enter the monitoring region of the camera C, the camera C may be awakened for recording a video, and the camera B may enter the sleep mode.

For example, the camera A and the camera B both capture a vehicle target (i.e., the aforementioned target object), the camera A may capture a clear license plate image, and the camera B only captures a contour of the vehicle target. In this case, the camera A and the camera B may be two security devices that work cooperatively: where the camera A serves as the telephoto camera, and the camera B serves as the wide-angle camera at the above viewing angle. By working cooperatively: vehicle tracking may be achieved, the telephoto camera A may recognize the license plate, and the wide-angle camera B may capture the contour feature of the vehicle target.

It can be understood that in the above cases, the association relationship between the security devices in the security device set may be determined based on the capturing time point and the reference object. In this way, accuracy of determining the association relationship may be improved.

In some examples of the above cases, the association relationship between the security devices in the security device set can be determined based on the capturing time point and the reference object as follows.

Firstly: it may be determined, based on the capturing time point and the reference object, whether the target image set includes a second target image subset.

The second target image subset may include a telephoto image and a wide-angle image of one subject.

Subsequently, when the target image set includes the second target image subset, an association relationship among security devices in a second security device subset may be determined to represent a second relationship.

The security devices in the second security device subset may capture the telephoto image or the wide-angle image. The second relationship represents the telephoto camera and the wide-angle camera, which work cooperatively.

For example, the camera A and the camera B simultaneously capture the vehicle target (i.e., the aforementioned target object), the camera A captures the clear license plate image, and the camera B only captures the contour of the vehicle target. In this case, the camera A and the camera B are working cooperatively, the camera A serves as the telephoto camera, and the camera B serves as the wide-angle camera at this viewing angle. The camera A and the camera B are working cooperatively to achieve vehicle tracking, where the telephoto camera recognizes the license plate, and the wide-angle camera records the contour feature of the vehicle target.

It can be understood that in the above example, it may be automatically determined whether two security devices (cameras) are working cooperatively based on the determined capturing time point and the reference object.

In some embodiments, one or more cross-device cooperative security devices may be determined from the security device set based on the association relationship and the target information of the target object.

When the association relationship represents the first relationship and the target object is located within the security region monitored by the first security device subset, the security device corresponding to the security region where the target object is about to enter may be determined as the cross-device cooperative security device.

The cross-device cooperative security device may be the security device, which corresponds to and monitors the security region that the target object is about to enter.

Accordingly: one or more cross-device cooperative security devices may be controlled to perform the monitoring operation on the target object as follows. After waking up the cross-device cooperative security device, the cross-device cooperative security device may be controlled to capture an image for the target object, such that the monitoring operation is performed.

It should be understood that in the above embodiment, the first security device subset includes the security device A and the security device B, and the security device A and the security device B have the aforementioned first relationship (i.e., sharing one field of view). When the target object is currently located within the security region of the security device A, the security device B may be in a sleep mode. As the target object moves, the security device B (i.e., the cross-device cooperative security device) may be awakened, and the security device B may be controlled to capture an image for the target object, such that the monitoring operation is performed. In this way, security monitoring may be achieved more intelligently.

In some examples of the aforementioned cases, the association relationship between security devices in the security device set may be determined based on the capturing time point and the reference object as follows.

Firstly: it may be determined whether the target image set includes a first target image subset based on the capturing time point and the reference object.

All target images in the first target image subset may have an identical capturing time point, and at least a portion of the reference object in each target image in the first target image subset indicates a same captured object.

Subsequently, when the target image set includes the first target image subset, the association relationship of the security devices in the first security device subset may be determined to have the first relationship.

The security devices in the first security device subset may capture the target images in the first target image subset, and the first relationship indicates that the security devices share one field of view.

For example, when the target object appears simultaneously in the target image of the camera A and in the target image of the camera B, it may be indicated that the camera A and the camera B share the field of view (i.e., the aforementioned association relationship).

It should be understood that in the above example, it may be automatically determined, based on the capturing time point and the reference object, whether the security devices (cameras) share one field of view.

In some embodiments of the above example, one or more cross-device cooperative security devices may be determined from the security device set based on the association relationship and the target information of the target object as follows.

When the association relationship is the second relationship, security devices in the second security device subset may be determined as cross-device cooperative security devices.

Accordingly, the one or more cross-device cooperative security devices may be controlled to perform the monitoring operation on the target object as follows.

In a block 1, the telephoto camera may be controlled to capture the telephoto image for the target object.

In a block 2, the wide-angle camera may be controlled to capture the wide-angle image for the target object.

It should be understood that in the above disclosure, the second security device subset includes a security device C and a security device D, and the security device C and the security device D have the aforementioned second relationship (i.e., the telephoto camera and the wide-angle camera working cooperatively). When the target object is currently located within the security region of the security device C, the security device D may be determined as the cross-device cooperative security device. Subsequently, the security device D may be controlled to capture an image for the target object to perform the monitoring operation. In this way: an image showing an entirety of the target object and an image showing detailed features of the target object may be obtained, such that security monitoring may be achieved more intelligently, and a security level may be improved.

In certain application scenarios of the above embodiments, the target information may include at least: an object type of the target object and the security device that detects the target object.

Accordingly, the one or more cross-device cooperative security devices may be controlled to perform monitoring operations on the target object as follows.

In a block 1, an event triggered by the target object may be recognized based on the target information.

The event triggered by the target object may include at least one of: indoor intrusion, visit by relatives or friends, and so on.

In a block 2, the cross-device cooperative security device may be controlled to perform the monitoring operation for monitoring the event.

Each type of event may be pre-associated with one or more monitoring operations. The monitoring operation pre-associated with the event may be the monitoring operation for monitoring the event. Therefore, the cross-device cooperative security device may be controlled to perform the monitoring operation for monitoring the event.

It should be understood that in the above application scenario, the monitoring security device may be controlled to perform the monitoring operation correspondingly based on the event triggered by the target object. In this way: different monitoring operations may be performed for different events, such that specificity and security of security measures may be improved.

In some application scenarios of the aforementioned embodiments, one or more cross-device cooperative security devices may be determined from the security device set based on the association relationship and the target information of the target object, as follows.

In a block 1, it may be determined whether the target object is located within the security region monitored by a target camera.

The target camera may be any camera in the aforementioned security device set. The target camera may be any one security device in the security device set.

In a block 2, when the target object is located within the security region monitored by the target camera, the cross-device cooperative security device associated with the target camera may be determined from the security device set based on the association relationship.

Sine the association relationship may indicate the security device in the security device set that is associated with the target camera, the cross-device cooperative security device associated with the target camera may be determined from the security device set based on the association relationship, and the determined security device may serve as the cross-device cooperative security device.

Furthermore, the one or more cross-device cooperative security devices may be controlled to perform the monitoring operation on the target object as follows. When the cross-device cooperative security device includes an audio output device, the audio output device may be controlled to output a prompt audio corresponding to the target object, such that the monitoring operation is performed.

The prompt audio may be a predetermined audio corresponding to the target object, such as an audio of “You have entered a security region.” In addition, the prompt audio may be determined based on the object type of the target object captured by the target camera. For example, when the image captured by the target camera includes an image of the courier (i.e., object type), the prompt audio may be “Please place the parcel at a location XX.”

It should be understood that in the aforementioned application scenarios, when the cross-device cooperative security device includes the audio output device (such as an intercom), the prompt audio corresponding to the target object may be automatically output by the audio output device, such that the monitoring operation is performed. In this way, the security may be achieved more intelligently.

In some application scenarios of the aforementioned embodiments, when the monitoring operation is used for image capturing, the following blocks may also be performed.

In a block 1, a video, which is obtained by the cross-device cooperative security device performing the monitoring operation may be obtained, so as to obtain a security video.

The security video may be the video obtained by the cross-device cooperative security device performing the monitoring operation.

In a block 2, at least one of the following feature information of the target object may be extracted from the security video: a facial image, a license plate number, a movement trajectory: a first appearance time point, a first appearance location, a departure time point, a departure location.

In a block 3, the feature information may be sent to a predetermined user terminal to enable the user terminal to display event information determined based on the feature information: or event information may be determined based on the feature information and may be sent to the predetermined user terminal to enable the user terminal to display the event information. The event information represents the event triggered by the target object.

The event information may include at least one of the following: indoor intrusion, visit by relatives or friends, and so on.

It should be understood that in the above application scenario, the aforementioned feature information may be automatically extracted from the security video for secondary processing, such that an efficiency in which the user obtains security state information may be improved.

In some embodiments, the security device performing the first security response operation may include a first security device and a second security device.

The security device refers to both equipment and systems for ensuring safety of persons, property, and an environment within and around buildings. In an embodiment, the security device may include, but not limited to: surveillance cameras, intrusion detectors, alarm systems, and so on.

The first security device and the second security device may be two distinct security devices installed on a building. For example, the first security device and the second security device may be two pan-tilt cameras mounted on the building.

Accordingly, before controlling the security device to perform the first security response operation, a three-dimensional model of the building may be obtained, and the building is arranged with the first security device and the second security device.

The building may be a venue for various human activities such as residence, working, studying, and recreation. For example, the building may include, but not limited to: a residential structure, such as an apartment and a house: a commercial building, such as a shopping mall and an office tower: a public facility, such as a library, a museum, and a stadium; and an industrial facility, such as a factory and a warehouse.

The three-dimensional model may be a digital three-dimensional representation of the aforementioned building. The obtained three-dimensional model may be a three-dimensional model that includes only the building. Alternatively, the obtained three-dimensional model may include the three-dimensional model of the building, a three-dimensional model of the first security device, and a three-dimensional model of the second security device.

For example, the three-dimensional model may be constructed as follows.

Firstly: the user may be guided to capture images (such as a video) around the building (such as the house) and installation points of the first security device and the second security device, such that images for an interior and a surrounding of the building may be obtained.

Subsequently, three-dimensional reconstruction, such as Simultaneous Localization and Mapping (SLAM), may be performed, such that the three-dimensional model for the building may be constructed.

Specifically, feature extraction may be performed firstly. Features, such as corners and edges, may be extracted from captured image data. Subsequently, data association and matching may be performed. Current to-be-associated-and-matched data features may be associated and matched with features in a portion of the constructed three-dimensional model, so as to determine a relative position and orientation of an image capturing device within a space. Furthermore, pose estimation may be performed. A position and an orientation (including position coordinates and rotation angles) of the image capturing device at each moment may be estimated based on a result of the data association and matching. Finally, the three-dimensional model may be constructed. Newly obtained data may be integrated into the existing three-dimensional model, such that the existing three-dimensional model may be progressively refined and updated.

Furthermore, the security device may be controlled to perform the first security response operation as follows.

In a block 1, a first mapping pose of the first security device within the three-dimensional model may be determined, and a second mapping pose of the second security device within the three-dimensional model may be determined. The first mapping pose represents a pose of the first security device mapped onto the three-dimensional model, and the second mapping pose represents a pose of the second security device mapped onto the three-dimensional model.

The first mapping pose of the first security device mapped onto the three-dimensional model may be determined based on the relative pose between the first security device and the aforementioned building. The second mapping pose of the second security device onto the three-dimensional model may be determined based on the relative pose between the second security device and the aforementioned building.

Furthermore, when the obtained three-dimensional model includes the three-dimensional model of the building, the three-dimensional model of the first security device, and the three-dimensional model of the second security device, a coordinate system in which the obtained three-dimensional model is located may first be constructed. Subsequently, a pose of the three-dimensional model of the first security device within the aforementioned coordinate system may be determined to obtain a first mapping position. A pose of the three-dimensional model of the second security device within the aforementioned coordinate system may be determined to obtain a second mapping position.

Alternatively, the aforementioned block 1 may be performed in other ways, which will be described at a later section.

In a block 2, it may be determined, based on the first mapping pose and the second mapping pose, whether a first monitoring region of the first security device and a second monitoring region of the second security device have an overlapping region, so as to obtain a determination result.

The first monitoring region may represent a monitoring region obtained by mapping the actual monitoring region of the first security device onto the three-dimensional model: or may represent the actual monitoring region of the first security device.

The second monitoring region may represent a monitoring region obtained by mapping the actual monitoring region of the second security device onto the three-dimensional model: or may represent the actual monitoring region of the second security device.

When the first monitoring region represents the monitoring region obtained by mapping the actual monitoring region of the first security device onto the three-dimensional model, the second monitoring region represents the monitoring region obtained by mapping the actual monitoring region of the second security device onto the three-dimensional model. When the first monitoring region represents the actual monitoring region of the first security device, the second monitoring region represents the actual monitoring region of the second security device.

It may be determined, in various ways, whether the first monitoring region of the first security device and the second monitoring region of the second security device have the overlapping region based on the first mapping pose and the second mapping pose.

For example, the first mapping pose and the second mapping pose may be input into a pre-trained determination model to determine whether the first monitoring region and the second monitoring region have the overlapping region.

The determination model may represent correspondence among the first mapping pose, the second mapping pose, and determination information. The determination information may indicate whether the first monitoring region and the second monitoring region have the overlapping region.

The determination model may be a model such as a convolutional neural network, which is trained using training samples including first mapping poses, second mapping poses, and determination information. Alternatively, the determination model may be a formula or a table representing the correspondence among the first mapping pose, the second mapping pose, and the determination information.

In addition, it may be determined, based on the first mapping pose and the second mapping pose, whether the first monitoring region of the first security device and the second monitoring region of the second security device have the overlapping region, in other ways. Specific details will be described at a later section.

In a block 3, it may be determined, based on the determination result, whether the first security device and the second security device are cross-device cooperative devices.

The based on the determination result devices may be capable of working cooperatively with each other to achieve the monitoring operation.

It may be determined whether the first security device and the second security device are the cross-device cooperative devices based on the first mapping pose and the second mapping pose, in various ways.

In some application scenarios of the aforementioned embodiments, the first mapping pose includes a first position and a first orientation of the first security device mapped onto the three-dimensional model. The second mapping pose includes a second position and a second orientation of the second security device mapped onto the three-dimensional model.

The first position may represent a position of the first security device mapped onto the three-dimensional model. For example, the first position may be represented by coordinates.

The first orientation may represent an orientation of the first security device mapped to the three-dimensional model. For example, the first position may include, but not limited to: a pitch angle, a yaw angle, and the like of the first security device mapped to the three-dimensional model.

The second position may represent a position of the second security device mapped to the three-dimensional model. For example, the second position may be represented by coordinates.

The second orientation may represent an orientation of the second security device mapped to the three-dimensional model. For example, the second position may include, but not limited to: a pitch angle, a yaw angle, and the like, of the second security device mapped to the three-dimensional model.

Accordingly, it may be determined whether the first security device and the second security device are the cross-device cooperative devices based on the first mapping pose and the second mapping pose, as follows.

In a block 1, the first monitoring region, which is obtained by the first security device being mapped onto the three-dimensional model, may be determined based on the first position, the first orientation, and a first monitoring parameter of the first security device.

The first monitoring parameter may include, but not limited to: a monitoring distance, a monitoring viewing angle, and so on.

When the first security device is a camera, the first monitoring parameter may include a focal length, a resolution, and so on.

In a block 2, the first monitoring region, which is obtained by the second security device being mapped onto the three-dimensional model, may be determined based on the second position, the second orientation, and a second monitoring parameter of the second security device.

The second monitoring parameter may include, but not limited to: a monitoring distance, a monitoring viewing angle, and so on.

When the second security device is a camera, the second monitoring parameter may include a focal length, a resolution, and so on.

In a block 3, it may be determined whether the first monitoring region and the second monitoring region have the overlapping region.

In a block 4, when the first monitoring region and the second monitoring region have the overlapping region, it may be determined that the first security device and the second security device are the cross-device cooperative devices. When the first monitoring region and the second monitoring region do not have the overlapping region, it may be determined that the first security device and the second security device are not the cross-device cooperative devices.

It can be understood that in the aforementioned application scenario, it may be determined whether two security devices are the cross-device cooperative devices, by determining whether two monitoring regions, which are obtained by the two security devices being respectively mapped onto the three-dimensional model, have the overlapping region. In this way: it may be more accurately determine whether the two security devices are the cross-device cooperative devices. Consequently, when the two security devices are the cross-device cooperative devices, cross-device cooperative control may be performed more precisely on the two security devices.

In certain scenarios of the aforementioned application scenarios, it may be determined whether the first monitoring region and the second monitoring region have the overlapping region as follows.

In a block 1, a first projection of the first monitoring region onto a predetermined plane may be determined.

The first projection may be a projection of the first monitoring region onto the predetermined plane.

In a block 2, a second projection of the second monitoring region onto a predetermined plane may be determined.

The second projection may be a projection of the second monitoring region onto the predetermined plane.

In a block 3, it may be determined whether the first projection and the second projection have an overlapping region.

In a block 4, when the first projection and the second projection have the overlapping region, it may be determined that the first monitoring region and the second monitoring region have the overlapping region. When the first projection and the second projection do not have the overlapping region, it may be determined that the first monitoring region and the second monitoring region do not have the overlapping region.

The predetermined plane may be a plane that is parallel to a horizontal plane mapped onto the three-dimensional model.

In some cases, the first security device and the second security device are of a same type, for example, each of the first security device and the second security device may be a camera. A device parameter (such as the focal length, the field of view) of the first security device may be identical to a device parameter of the second security device. An installation height difference between the first security device and the second security device may be less than or equal to a predetermined height threshold.

It should be understood that in the above cases, it may be determined whether the two monitoring regions in the three-dimensional model have the overlapping region, by determining whether the projections of the two monitoring regions onto the predetermined plane have the overlapping region. In this way: an efficiency of determining whether the two monitoring regions in the three-dimensional model have the overlapping region, may be improved.

In some embodiments, it may be determined whether the two monitoring regions in the three-dimensional model have the overlapping region, based on boundary box detection or spatial segmentation.

In addition, the first mapping pose and the second mapping pose may be input into the pre-trained determination model to determine whether the first security device and the second security device are the cross-device cooperative devices.

The aforementioned determination model may represent the correspondence among the first mapping pose, the second mapping pose, and the determination information. The determination information indicates whether the first security device and the second security device are the cross-device cooperative devices. The aforementioned determination model may be a convolutional neural network that is trained using training samples that include the first mapping pose, the second mapping pose, and the determination information.

In a block 4, when the first security device and the second security device are the cross-device cooperative devices, it may be determined that the first security device detects movement information of the target object.

The target object may be any target (object) detected by the first security device. For example, the first security device may detect a person, a vehicle, an animal, and so on.

The movement information may represent a movement of the target object. For example, the motion information may include, but not limited to: a movement trajectory, a movement speed, a movement position, a movement direction, and so on.

In a block 5, the second security device may be controlled, based on the movement information, to perform the monitoring operation on the target object.

The second security device may be controlled, based on the movement information, to perform the monitoring operation on the target object, in various ways.

In some application scenarios of the above embodiments, the second security device may be the pan-tilt camera, and the movement information may include the movement trajectory of a monitored object.

Accordingly, the second security device may be controlled, based on the movement information, to perform the monitoring operation on the target object, as follows.

In a block 1, an initial position of the target object within the monitoring region of the second security device may be determined based on the movement trajectory included in the movement information.

The initial position refers to a first location at which the target object enters the monitoring region of the second security device.

A movement trajectory of the monitored object at a future time point may be predicted based on a historical movement trajectory that is formed at a past time point. Consequently, a first intersection point between the predicted movement trajectory at the future time point and the monitoring region of the second security device may serve as the initial position of the target object within the monitoring region.

In a block 2, the field of view of the second security device may be controlled to move (such as to rotate or shift for a certain distance) to cover the initial position, enabling the second security device to monitor the target object.

It should be understood that in the aforementioned application scenario, the initial position of the target object within the monitoring region of the second security device may be determined in advance based on the movement trajectory. In this way, the field of view of the second security device may be controlled, in advance, to move to cover the initial position. Compared to controlling the field of view to move only after the target object entering the monitoring region, the above approach enhances timeliness of the second security device performing the monitoring operation on the target object.

In some embodiments, the movement information may include a position and the movement direction of the monitored object. Accordingly, the second security device may be controlled, based on the movement information, to perform the monitoring operation on the target object, as follows.

In a block 1, the first intersection point between a movement path, starting from the position and moving along the movement direction, and the monitoring region of the second security device, may be determined.

In a block 2, the field of view of the second security device may be controlled to move to a position where the first intersection point is located, enabling the second security device to monitor the target object.

In some cases of the above application scenario, the movement information may further include the movement speed of the monitored object.

Accordingly: before controlling the field of view of the second security device to move to cover the initial position, and after determining the initial position of the target object within the monitoring region of the second security device based on the movement trajectory included in the movement information, a first time point at which the target object moves to reach the initial position may be determined based on the movement trajectory and the movement speed included in the movement information.

The first time point may represent a time point at which the target object moves to reach the initial position.

Accordingly, the field of view of the second security device may be controlled to move to cover the initial position, as follows. The field of view of the second security device may be controlled to move to cover the initial position at a second time point that is earlier than the first time point, or at the first time.

The second time point may be a time point earlier than the first time point.

It should be understood that in the above case, the field of view of the second security device may be moved to cover the initial position simultaneously with or prior to the target object reaching the initial position. In this way, the timeliness of the second security device performing the monitoring operation on the monitored object may be improved.

It should be understood that in the above embodiments, it may be determined, based on the mapping pose of the first security device and the mapping pose of the second security device on the three-dimensional model of the building, whether the two security devices are the cross-device cooperative devices. When the two security devices are the cross-device cooperative devices, the two security devices may be cross-device interconnectively controlled to perform the monitoring operation. In this way, complexity of performing the cross-device cooperation control in scenarios of monitoring operations may be reduced.

In some application scenarios of the above embodiments, the first mapping pose of the first security device and the second mapping pose of the second security device in the three-dimensional model may be determined as follows.

In a block 1, the three-dimensional model may be displayed.

The subject of performing the cross-device cooperative monitoring operation method may include a display screen. In this way, the three-dimensional model may be displayed on the display screen to be viewed and operated by the user.

In a block 2, a first operation and a second operation performed on the displayed three-dimensional model may be detected. The first operation may be configured to determine the mapping pose of the first security device within the three-dimensional model, and the second operation may be configured to determine the mapping pose of the second security device within the three-dimensional model.

For example, the first operation may may be a user or other objectives inputting the mapping pose of the first security device within the three-dimensional model. The second operation may be the user or other objectives inputting the mapping pose of the second security device within the three-dimensional model.

In some cases of the aforementioned application scenario, the first operation may be configured to mark the mapping pose of the first security device within the three-dimensional model. The second operation may be configured to mark the mapping pose of the second security device within the three-dimensional model.

Accordingly, the following may be performed. The mapping pose indicated by the first operation may be determined as the first mapping pose of the first security device within the three-dimensional model; and the mapping pose indicated by the second operation may be determined as the second mapping pose of the second security device within the three-dimensional model.

It should be understood that in the above case, by marking the first mapping pose and the second mapping pose within the three-dimensional model, the mapping pose of the first security device and the mapping pose of the second security device may be determined more rapidly and more accurately.

In some embodiments, the first operation may be inputting first coordinates and a first angle. The first coordinates may represent coordinates of the first security device mapped to the coordinate system of the three-dimensional model. The first angle may represent an orientation angle of the first security device mapped to the three-dimensional model. The second operation may be inputting second coordinates and a second angle. The second coordinates may represent coordinates of the second security device mapped to the coordinate system of the three-dimensional model. The second angle may represent an orientation angle of the second security device mapped to the three-dimensional model.

In addition, the first operation may be inputting a first speech. The first speech may represent a pose of the first security device mapped to the three-dimensional model. The second operation may be inputting a second speech. The second speech may represent a pose of the second security device mapped to the three-dimensional model. For example, the first operation may be inputting a speech of “The first security device is located at an exact center of the roof, a security region of the first security device is located directly at a north of the first security device.” The second operation may be inputting the speech of “The second security device is located at an exact center of the roof, a security region of the second security device is located directly at a north of the second security device.”

In some cases of the above application scenario, the three-dimensional model may include: a first initial pose of the first security device and a second initial pose of the second security device. The first operation may be configured to adjust the first initial pose in the three-dimensional model. The second operation may be configured to adjust the second initial pose in the three-dimensional model.

The first initial pose may be a mapping pose of the first security device determined during constructing the three-dimensional model, or may be a mapping pose of the first security device determined before the user or other objectives performing the first operation. The second initial pose may be a mapping pose of the second security device determined during constructing the three-dimensional model, or may be a mapping pose of the second security device determined before the user or other objectives performing the second operation.

Accordingly, the mapping pose indicated by the first operation may be determined as the first mapping pose of the first security device within the three-dimensional model, as follows.

In a block 1, the first initial pose may be adjusted based on an adjustment manner indicated by the first operation.

For example, the first operation may be achieved by: dragging a position represented by the first initial pose on the three-dimensional model; and/or rotating the orientation represented by the first initial pose; or modifying a parameter value of the first initial pose.

In a block 2, the post-adjustment first initial pose may be determined as the first mapping pose of the first security device within the three-dimensional model.

Furthermore, the mapping pose indicated by the second operation instruction may be determined as the second mapping pose of the second security device within the three-dimensional model, as follows.

In a block 1, the second initial pose may be adjusted based on an adjustment manner indicated by the second operation.

The second operation may be achieved by: dragging a position represented by the second initial pose on the three-dimensional model; and/or rotating the orientation represented by the second initial pose; or modifying a parameter value of the second initial pose.

In a block 2, the post-adjustment second initial pose may be determined as the second mapping pose of the second security device within the three-dimensional model.

It should be understood that in the above embodiments, after obtaining the initial pose, the initial pose may further be adjusted to enhance accuracy of the first mapping pose and the second mapping pose. In a block 3, after detecting the first operation, the mapping pose indicated by the first operation may be determined as the first mapping pose of the first security device within the three-dimensional model.

In a block 4, after detecting the second operation, the mapping pose indicated by the second operation may be determined as the second mapping pose of the second security device within the three-dimensional model.

It should be understood that in the above cases, by performing the first operation and the second operation on the displayed three-dimensional model, the first mapping pose and the second mapping pose may be obtained, so as to enhance the accuracy of the first mapping pose and the second mapping pose, and in this way, accuracy in controlling devices to work cooperatively in the scenario of monitoring operations may be improved.

It should be noted that, when without conflicts, technical features described in different embodiments may be included in one same embodiment. For brevity, the technical features may not be repeated.

For the security method provided by the embodiments of the present disclosure, the first security video and the predetermined security preference information may be obtained. Subsequently, the first security video may be recognized to obtain a video recognition result for the first security video. Furthermore, the security response operation matching the first security video may be determined, based on the video recognition result and the security preference information, so as to obtain the first security response operation. The security device for performing the first security response operation may be determined. Finally, the security device may be controlled to perform the first security response operation. In this way, the security response operation matching the security video may be determined and performed dynamically; based on the event represented by the video recognition result and the predetermined security preference information. Each response operation may be specifically designed for a current specific situation. In this way: an appropriate measure may be taken for each type of events. Additionally: the security device for performing the first security response operation may be dynamically determined based on various situations. In this way: faster and more accurate responses may be performed to various emergencies, false alarms and missed alarms may be reduced, and overall effectiveness of the security system may be improved.

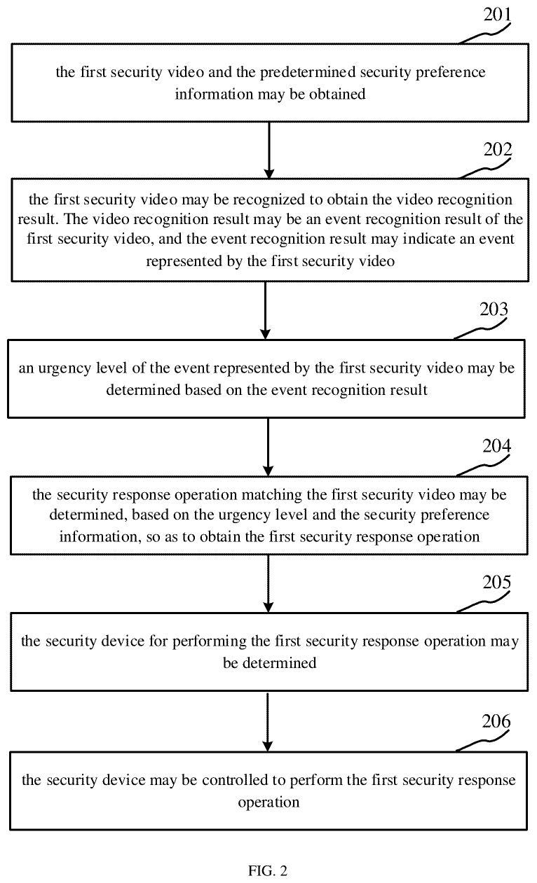

FIG. 2 is a flow chart of another security method according to an embodiment of the present disclosure. As shown in FIG. 2, the method specifically includes the following blocks.

In a block 201, the first security video and the predetermined security preference information may be obtained.

In the present embodiment, the block 201 may be substantially consistent with the block 101 in the corresponding embodiment of FIG. 1 and will not be repeated herein.

In a block 202, the first security video may be recognized to obtain the video recognition result. The video recognition result may be an event recognition result of the first security video, and the event recognition result may indicate an event represented by the first security video.

In the present embodiment, the video recognition result may be the event recognition result obtained by recognizing the first security video.

In the present embodiment, a support vector machine, a multimodal model, or the like, may be applied to recognize the first security video and obtain the video recognition result.

For example, the video recognition result may indicate an event, such as theft, fire, or falling off.

In a block 203, an urgency level of the event represented by the first security video may be determined based on the event recognition result.

In the present embodiment, the urgency level may characterize the extent of urgency and/or timeliness in which the event requires treatment. For example, the urgency level may be categorized into a plurality of levels, such as a high urgency level, a medium urgency level, and a low urgency level.

For example, the urgency level corresponding to the video recognition result may be determined based on a predefined second correspondence table. In this way, the urgency level may be determined as the urgency level of the event represented by the first security video. The second correspondence table may represent correspondence between video recognition results and urgency levels.

In another example, the video recognition result may be input into a pre-trained second model to obtain the urgency level, and the urgency level may be determined as the urgency level for the event represented by the first security video. The second model may represent the correspondence between the video recognition results and the urgency levels. The second model may be a convolutional neural network or a large language model which is trained using machine learning algorithms based on training samples containing the video recognition results and the urgency levels.

In a block 204, the security response operation matching the first security video may be determined, based on the urgency level and the security preference information, so as to obtain the first security response operation.

In the present embodiment, as an example, a security response operation corresponding to the urgency level and the security preference information may be determined based on a predefined third correspondence table. Furthermore, the security response operation may be determined as the security response operation matching the first security video. The third correspondence table may represent correspondence among the urgency levels, the security preference information, and the security response operations.

In another example, the urgency level and the security preference information may be input into the pre-trained third model to obtain the security response operation, and the obtained security response operation may be determined as the security response operation matching the first security video. The third model may represent the correspondence among the urgency levels, the security preference information, and the security response operations. The third model may be a convolutional neural network or a large language model, which is trained using machine learning algorithms based on training samples containing the urgency levels, the security preference information, and the security response operations.

In a block 205, the security device for performing the first security response operation may be determined.

In the present embodiment, the block 205 is substantially consistent with the block 106 in the embodiment corresponding to FIG. 1 and will not be repeated herein.

In a block 206, the security device may be controlled to perform the first security response operation.

In the present embodiment, the block 206 is substantially consistent with the block 107 in the embodiment corresponding to FIG. 1 and will not be repeated herein.

It should be noted that, in addition to the above-described content, the present embodiment may further include corresponding technical features described in the embodiment shown in FIG. 1, so as to achieve the technical effects of the security method shown in FIG. 1. Specific details may be referred to the relevant description in FIG. 1. For brevity: the technical features and the technical effects are not repeated herein.

For the security method provided by the embodiments of the present disclosure, the security response operation corresponding to the first security video may be determined based on the urgency level of the event. In this way, the determined and performed security response operation may be more closely matching urgency of a situation.

In the present application, the following embodiments may be implemented independently of the aforementioned embodiments or may be implemented based on the technologies disclosed above. Furthermore, the subject for performing the following embodiments may be the same as or different from that in the above embodiments.

The three-dimensional model of the building may be obtained, and the building is arranged with the first security device and the second security device.

The first mapping pose of the first security device within the three-dimensional model and the second mapping pose of the second security device within the three-dimensional model may be determined. The first mapping pose represents the pose of the first security device mapped onto the three-dimensional model, and the second mapping pose represents the pose of the second security device mapped onto the three-dimensional model.

It may be determined, based on the first mapping pose and the second mapping pose, whether the first monitoring region of the first security device and the second monitoring region of the second security device have an overlapping region so as to obtain a determination result.

It may be determined, based on the determination result, whether the first security device and the second security device are the cross-device cooperative devices.

When the first security device and the second security device are the cross-device cooperative devices, the movement information of the target object detected by the first security device may be determined.

The second security device may be controlled, based on the movement information, to perform the monitoring operation on the target object.

In some embodiments, the first mapping pose includes the first position and the first orientation of the first security device mapped onto the three-dimensional model, the second mapping pose includes the second position and the second orientation of the second security device mapped onto the three-dimensional model.

The block of determining, based on the first mapping pose and the second mapping pose, whether the first monitoring region of the first security device and the second monitoring region of the second security device have the overlapping region, may include the following.

The first monitoring region of the first security device mapped to the three-dimensional model based on the first position, the first orientation, and the first monitoring parameter of the first security device.

The second monitoring region of the second security device mapped to the three-dimensional model based on the second position, the second orientation, and the second monitoring parameter of the second security device.

It may be determined whether the first monitoring region and the second monitoring region have the overlapping region.

The block of determining, based on the determination result, whether the first security device and the second security device are the cross-device cooperative devices, may include the following.

When the determination result indicates that the first monitoring region and the second monitoring region have the overlapping region, it may be determined that the first security device and the second security device are the cross-device cooperative devices.

When the determination result indicates that the first monitoring region and the second monitoring region do not have the overlapping region, it may be determined that the first security device and the second security device are not the cross-device cooperative devices.

In some embodiments, the block of determining whether the first monitoring region and the second monitoring region have the overlapping region may include the following.

The first projection of the first monitoring region in the predetermined plane may be determined.

The second projection of the second monitoring region in the predetermined plane may be determined.

It may be determined whether the first projection and the second projection have an overlapping region

When the first projection and the second projection have the overlapping region, it may be determined that the first monitoring region and the second monitoring region have the overlapping region. When the first projection and the second projection do not have the overlapping region, it may be determined that the first monitoring region and the second monitoring region do not have the overlapping region.

The predetermined plane may be a plane that is parallel to the ground horizontal plane mapped onto the three-dimensional model.

In some embodiments, the block of determining the first mapping pose of the first security device in the three-dimensional model and the second mapping pose of the second security device in the three-dimensional model, may include the following.

The three-dimensional model may be displayed.

The first operation and the second operation performed on the displayed three-dimensional model may be detected. The first operation may be configured to determine the mapping pose of the first security device in the three-dimensional model, and the second operation may be configured to determine the mapping pose of the second security device in the three-dimensional model.

When the first operation is detected, the mapping pose indicated by the first operation may be determined as the first mapping pose of the first security device within the three-dimensional model.

When the second operation is detected, the mapping pose indicated by the second operation may be determined as the second mapping pose of the second security device within the three-dimensional model.

In some embodiments, the first operation may be configured to mark the mapping pose of the first security device in the three-dimensional model, and the second operation may be configured to mark the mapping pose of the second security device in the three-dimensional model.

The block of determining the mapping pose indicated by the first operation as the first mapping pose of the first security device in the three-dimensional model, may include the following.

The mapping pose indicated by the first operation may be determined as the first mapping pose of the first security device in the three-dimensional model.

The block of determining the mapping pose indicated by the second operation as the second mapping pose of the second security device in the three-dimensional model, may include the following.

The mapping pose indicated by the second operation may be determined as the second mapping pose of the second security device in the three-dimensional model.

In some embodiments, the three-dimensional model includes: the first initial pose of the first security device and the second initial pose of the second security device. The first operation may be configured to adjust the first initial pose in the three-dimensional model, and the second operation may be configured to adjust the second initial pose in the three-dimensional model.

The block of determining the mapping pose indicated by the first operation as the first mapping pose of the first security device in the three-dimensional model, may include the following.

The first initial pose may be adjusted according to the adjustment manner indicated by the first operation.

The post-adjustment first initial pose may be determined as the first mapping pose of the first security device within the three-dimensional model.

The block of determining the mapping pose indicated by the second operation as the second mapping pose of the second security device in the three-dimensional model, may include the following.

The second initial pose may be adjusted according to the adjustment manner indicated by the second operation.

The post-adjustment second initial pose may be determined as the second mapping pose of the second security device within the three-dimensional model.

In some embodiments, the second security device may be the pan-tilt camera, and the movement information includes the movement trajectory of the monitored object.

The block of controlling, based on the movement information, the second security device to perform the monitoring operation on the target object, may include the following.

The initial position of the target object within the monitoring region of the second security device may be determined based on the movement trajectory included in the movement information.

The field of view of the second security device may be controlled to move to the initial position, enabling the second security device to perform the monitoring operation on the target object.

In some embodiments, the movement information further includes the movement speed of the monitored object.

Before controlling the field of view of the second security device to move to the initial position, and after determining the initial position of the target object within the monitoring region of the second security device based on the movement trajectory included in the movement information, the method further includes the following.

The first time point at which the target object moves to the initial position may be determined based on the movement trajectory and the movement speed included in the movement information.

The block of controlling the field of view of the second security device to move to the initial position, may include the following.

The field of view of the second security device may be controlled to move to the initial position at the second time point earlier than the first time point or at the first time point.

In the present disclosure, the target object may be the monitored target. The monitoring operation may be security monitoring. In a scenario of security: the above disclosure may be the cross-device cooperative monitoring operation method.

In the present disclosure, the following embodiments may be implemented independently of the above embodiments or may be implemented based on the technical solutions disclosed above. Furthermore, the subject for achieving the following embodiments may be the same as or different from that in the above security method.

The image description data set and the target video may be obtained.

The image description data in the image description data set may be configured to describe the target image content, and the target video includes the image sequence.

Similarities between the image in the image sequence and each image description data in the image description data set may be calculated, so as to obtain the target similarities corresponding to the image.

The first number of target similarities may be selected from all obtained target similarities.

The first image set corresponding to the first number of target similarities may be determined. The images in the first image set may be in one-to-one correspondence with the first number of target similarities.

The frame extraction result for the target video may be determined based on the first image set.

In some embodiments, determining the frame extraction result for the target video based on the first image set may include the following.

The first image set may be displayed.

It may be determined whether an adjustment operation is performed on the images in the first image set. The adjustment operation may be configured to adjust the images in the first image set to obtain a second image set.

When the adjustment operation is detected, determining the second image set as the frame extraction result for the target video.

In some embodiments, when detecting the adjustment operation, the image description data set may be updated as follows.

Image features for each image in the second image set may be determined, so as to obtain an image feature set. The image features in the image feature set may be in one-to-one correspondence with the images in the second image set.

The image description data may be determined based on the image feature set.

The image description data set may be updated based on the determined image description data.

In some embodiments, updating the image description data set based on the determined image description data may include the following.

The cardinality of the image description data set before the updating may be determined.

It may be determined whether the cardinality is less than the predetermined value.

When the cardinality is less than the predetermined value, the determined image description data may be added to the image description data set to obtain the post-updating image description data set.

When the cardinality is greater than or equal to the predetermined value, the image description data included in the image description data set before the updating may be replaced with the determined image description data, so as to obtain the post-updating image description data set.

In some embodiments, replacing the image description data included in the image description data set before the updating with the determined image description data, may include the following.

The image description data with the earliest addition time point may be determined from the image description data set before the updating. The addition time point is the time point when the image description data is added to the image description data set.

The image description data with the earliest addition time point in the image description data set before the updating may be replaced with the determined image description data.

In some embodiments, the image description data set includes at least one image description data.

The image description data may be determined as follows.

The event description content input by the objective may be determined. The event description content may be configured to describe one or more events.

Feature data of the event description content may be determined.

The feature data may be determined as the image description data.

In some embodiments, calculating the similarities between the image in the image sequence and each image description data in the image description data set to obtain the target similarities corresponding to the image, may include the following.

The similarity between the image in the image sequence and each image description data in the image description data set may be calculated, so as to obtain a similarity set corresponding to the image.

The maximum similarity in the similarity set corresponding to the image in the image sequence may be determined as the target similarity corresponding to the image.

In some embodiments, the method further includes the following.

The frame extraction result of the target video may be obtained. The frame extraction result may be determined by performing the video frame extraction method of any one of claims 1-6.

The push information to be pushed to the predetermined terminal may be determined based on the frame extraction result.

The push data may be pushed to the predetermined terminal.

In some embodiments, the block of determining the push information to be pushed to the predetermined terminal based on the frame extraction result, may include at least one of the following.

The video segment of the target video may be generated based on the frame extraction result. The video information of the video segment may be determined as the push information to be pushed to the predetermined terminal.

Behavior recognition may be performed on the frame extraction result to obtain the recognition result. The push information to be pushed to the predetermined terminal may be generated based on the recognition result.

In a security scenario, the above embodiments may be a video frame extraction method.

In the present disclosure, the following embodiments may be implemented independently of the above embodiments or may be implemented based on the embodiments disclosed above. Furthermore, the subject for achieving the following embodiments may be the same as or different from that of the above security method.

The first security video and the predetermined security preference information may be obtained.

Recognition may be performed on the first security video to obtain the event recognition result, and the event recognition result may indicate the event represented by the first security video.

The security response operation matching the first security video may be determined, based on the event recognition result and the security preference information, so as to obtain the first security response operation.

The first security response operation may be performed.

In some embodiments, the block of determining the security response operation matching the first security video based on the event recognition result and the security preference information may include the following.

The urgency level of the event represented by the first security video may be determined based on the event recognition result.

The security response operation matching the first security video may be determined based on the urgency level and the security preference information.

In some embodiments, after performing the recognition on the first security video to obtain the event recognition result of the first security video, the method further includes the following.

The first feedback information in regard to the event recognition result may be obtained. The first feedback information indicates adjusting the recognition strategy for the second security video. The second security video may be either the first security video or any security video obtained after the first security video. The recognition strategy may include at least one of: the recognition efficiency: the recognition manner.

The recognition strategy to be adjusted as indicated by the first feedback information may be determined.

Recognition may be performed on the second security video according to the recognition strategy that is adjusted as indicated by the first feedback information, so as to obtain the event recognition result for the second security video.

The security response operation matching the second security video may be determined based on the event recognition result for the second security video and the security preference information, so as to obtain the second security response operation.

The second security response operation may be performed.

In some embodiments, after determining the security response operation matching the first security video based on the event recognition result and the security preference information to obtain the first security response operation, the method further includes the following.

The second feedback information for the first security response operation may be obtained. The second feedback information indicates adjusting the determination strategy for the second security response operation. The determination strategy includes at least one of the following: the determination efficiency and the determination manner. The second security video may be: the first security video, or any security video obtained after the first security video.

The determination strategy that is adjusted as indicated by the second feedback information.

The security response operation matching the second security video may be determined based on the event recognition results and the security preference information, and based on the determination strategy that is adjusted as indicated by the second feedback information, so as to obtain the third security response operation. The third security response operation may be performed.

In some embodiments, after performing the first security response operation, the method further includes the following.

The third feedback information in regard to the first security response operation may be obtained. The third feedback information indicates adjusting the performing strategy for the security response operation, the performing strategy may include at least one of: the performing efficiency; and the performing manner.

The performing strategy that is adjusted as indicated by the third feedback information may be determined.

The fourth security response operation may be performed according to the performing strategy that is adjusted as indicated by the third feedback information. The fourth security response operation may be the security response operation that is performed after the first security response operation.

In some embodiments, determining the security response operation matching the first security video based on the event recognition result and the security preference information, may include the following.

A response probability for the first security video may be determined based on the event recognition result.

It may be determined whether the response probability is greater than or equal to a predetermined threshold.

When the response probability is greater than or equal to the predetermined threshold, the security response operation matching the first security video may be determined based on the security preference information.

In some embodiments, after performing the first security response operation, the predetermined threshold may be adjusted as follows.

The fourth feedback information in regard to the first security response operation may be obtained. The fourth feedback information indicates adjusting the predetermined threshold.

The predetermined threshold may be adjusted according to the adjustment manner indicated by the fourth feedback information to obtain the post-adjustment predetermined threshold.

The method further includes the following.

When the response probability is greater than or equal to the post-adjustment predetermined threshold, the security response operation matching the second security video may be determined based on the security preference information, so as to obtain the fifth security response operation. The second security video may be: the first security video, or the security video obtained after the first security video.

The fifth security response operation may be performed.

In some embodiments, the event recognition result includes the first person in the first security video, and the security preference information indicates a predetermined relationship with the first person.

The block of determining the security response operation matching the first security video based on the event recognition result and the security preference information, may include the following.

The second person having the predetermined relationship with the first person in the first security video may be determined.

Determining the security response operation matching the first security video indicates: sending the security prompt information to the terminal of the second person.

In some embodiments, determining the second person having the predetermined relationship with the first person in the first security video, may include the following.

It may be determined whether the first node representing the first person is included in the pre-constructed knowledge graph. Each node in the knowledge graph represents a person, and each edge represents a relationship between persons.

When the first node is included in first knowledge graph, the edge representing first predetermined relationship may be selected from all edges connected to the first node.

The second node connected by the edge representing the predetermined relationship may be determined. The second node may be the other one of two nodes connected by the edge representing the predetermined relationship, other than the first node.

The person represented by the second node may be determined as the second person having the predetermined relationship with the first person in the first security video.

The event recognition result of the first security video may be the aforementioned video recognition result.

The video recognition result represents the event represented by the first security video. In security scenarios, the above embodiments may be a dynamic response method for security videos.

In this application, the following embodiments may be implemented independently of the aforementioned embodiments or may be achieved based on the technologies disclosed in the above.

Furthermore, the subject for achieving the following embodiments may be the same as or different from that of the aforementioned security method.

The target image may be obtained. The target image includes the article description and the person description, the article description represents the target article, and the person description represents the target person.

The first detection box and the second detection box within the target image may be determined. The first detection box may be the detection box for the article description, and the second detection box may be the detection box for the person description.

The extent of overlapping between the first detection box and the second detection box may be determined.

The theft determination information may be determined based on the extent of overlapping. The theft determination information indicates whether the target person has the intent to steal the target article.

In some embodiments, generating theft determination information based on the extent of overlapping may include the following.

It may be determined whether the extent of overlapping is greater than or equal to a predetermined threshold.

When the extent of overlapping is greater than or equal to the predetermined threshold, it may be determined whether the behavior of the target person represented by the person description is theft, so as to obtain the first determination result.

The theft determination information may be generated based on the first determination result.

In some embodiments, the target image may be the video frame from the first security video.

Generating the theft determination information based on the extent of overlapping may include the following.

It may be determined whether the extent of overlapping is greater than or equal to the predetermined threshold.

When the extent of overlapping is greater than or equal to the predetermined threshold, an associated video frame sequence for the target image may be extracted from the first security video.

The theft determination information may be generated based on the associated video frame sequence.

In some embodiments, the method may be performed by the first device, and the data processing volume of the target image may be less than the data processing volume of the video frames in the associated video frame sequence.

Generating the theft determination information based on the associated video frame sequence may include the following.

The associated video frame sequence may be sent to the second device. The second device may be configured to generate the theft determination information based on the associated video frame sequence. The computing power of the second device may be greater than that of the first device.

The theft determination information returned from the second device may be received, so as to generate the theft determination information.

In some embodiments, the associated video frame sequence includes: the preceding video frame of the target image and the subsequent video frame of the target image. The preceding video frame may be the video frame in the first security video occurring before the target image, and the subsequent video frame may be the video frame in the first security video occurring after the target image.

Generating the theft determination information based on the associated video frame sequence may include the following.

The first state information of the target article in the preceding video frame may be determined.

The second state information of the target article in the subsequent video frame may be determined.

The theft determination information may be generated based on the first state information, the second state information, and the associated video frame sequence.

In some embodiments, the first state information indicates whether the target article represented by the article description in the preceding video frame is located within the first region, and the second state information indicates whether the target article represented by the article description in the subsequent video frame is located within the first region.

The block of generating the theft determination information based on the first state information, the second state information, and the associated video frame sequence, may include the following.

When the first state information indicates that the target article represented by the article description in the preceding video frame is located within the first region, initial theft determination information may be generated based on the associated video frame sequence.

Final theft determination information indicating that the target person has the intent to steal the target article may be generated, when the initial theft determination information indicates that the target person has the intent to steal the target article and when the second state information indicates that the target article represented by the article description in the subsequent video frame is not located in the first region.

In some embodiments, the block of generating the theft determination information based on the extent of overlapping may include the following.

It may be determined whether both the target person and the target article are located within the predetermined region, so as to obtain the second determination result.

The theft determination information may be generated based on the second determination result and the extent of overlapping.

In some embodiments, before determining the extent of overlapping between the first detection box and the second detection box, the method further includes the following.

The collection of personnel information that is pre-recorded may be obtained.

It may be determined whether the collection of personnel information includes the target personnel information representing the target person.

The block of determining the extent of overlapping between the first detection box and the second detection box may include the following.

When the collection of personnel information does not include the target personnel information, the extent of overlapping between the first detection box and the second detection box may be determined.

In some embodiments, after generating the theft determination information, the method further includes at least one of the following.

When the theft determination information indicates that the target person has the theft intent, the expulsion device may be controlled to perform the expulsion operation.

When the theft determination information indicates that the target person has the theft intent, the prompt information may be sent to the predetermined terminal.

In the security scenarios, the above disclosure may be a method for recognizing the theft intent.

In the present disclosure, the following embodiments may be implemented independently of the above embodiments or may be performed based on the above embodiments. Furthermore, the subject for achieving the following embodiments may be the same as or different from that for the above embodiments.

The target image set corresponding to the security device set may be obtained.

The reference object may be extracted from the target image set.

The association relationship among the security devices may be established based on the reference object.

When the target object is detected within the security region monitored by the security device set, one or more cross-device cooperative security devices may be determined from the security device set based on the association relationship and the target information of the target object.

The one or more cross-device cooperative security devices may be controlled to perform the monitoring operation on the target object.

In some embodiments, the security device includes the camera.

The block of obtaining the target image set corresponding to the security device set may include the following.

Images captured by the security devices in the security device set may be obtained, so as to obtain the target image set. The security devices in the security device set is in one-to-one correspondence with the target images in the target image set.

The block of establishing the association relationship between the security devices based on the reference object may include the following.

The capturing time point at which each target image in the target image set is captured may be determined.

The association relationship among the security devices in the security device set may be determined based on the determined capturing time point and the reference object.

In some embodiments, the block of determining the association relationship among the security devices in the security device set, based on the determined capturing time point and the reference object, may include the following.

It may be determined, based on the determined capturing time point and the reference object, whether the target image set includes the first target image subset. All target images in the first target image subset may have the same capturing time point. At least a portion of the reference object in each target image of the first target image subset indicates the same captured object.

When the target image set includes the first target image subset, it may be determined that the association relationship among the security devices in the first security device subset represents the first relationship. The first relationship indicates that the security devices share one field of view, and the security devices in the first security device subset capture the target images in the first target image subset.

In some embodiments, the block of determining the one or more cross-device cooperative security devices from the security device set, based on the association relationship and the target information of the target object, may include the following.

When the association relationship represents the first relationship and the target object is located within the security region monitored by the first security device subset, the security device, which is configured to monitor the security region to which the target object is about to enter, may be determined from the first security device subset as the cross-device cooperative security device.

The one or more cross-device cooperative security devices may be controlled to perform the monitoring operation on the target object, may include the following.

After waking up the cross-device cooperative security device, the cross-device cooperative security device may be controlled to capture an image for the target object, such that the monitoring operation is performed.

In some embodiments, the block of establishing the association relationship among the security devices in the security device set, based on the determined capturing time point and the reference object, may include the following.

It may be determined whether the target image set includes the second target image subset based on the determined capturing time point and the reference object. The second target image subset includes the telephoto image and the wide-angle image for the same subject.

When the target image set includes the second target image subset, it may be determined that the association relationship among the security devices in the second security device subset represents the second relationship. The second relationship indicates that the telephoto camera and the wide-angle camera work cooperatively: the telephoto camera is configured to capture the telephoto image, and the wide-angle camera is configured to capture the wide-angle image.

In some embodiments, the block of determining the one or more cross-device cooperative security devices from the security device set based on the association relationship and the target object information, may include the following.

When the association relationship represents the second relationship, each security device within the second security device subset may be determined as the cross-device cooperative security device.

The block of controlling the one or more cross-device cooperative security devices to perform the monitoring operation on the target object, may include the following.

The telephoto camera may be controlled to capture the telephoto image for the target object.

The wide-angle camera may be controlled to capture the wide-angle image for the target object.

In some embodiments, the target information includes at least the following: the object type of the target object: the security device that detects the target object.

The block of controlling the one or more cross-device cooperative security devices to perform the monitoring operation on the target object, may include the following.

The even triggered by the target object may be recognized based on the target information.

The one or more cross-device cooperative security devices may be controlled to perform the monitoring operation for monitoring the event.

In some embodiments, the block of determining the one or more cross-device cooperative security devices from the security device set based on the association relationship and the target information of the target object, may include the following.

It may be determined whether the target object is located within the security region monitored by the target camera. The target camera may be any one of the security devices in the security device set.

When the target object is located within the security region monitored by the target camera, the cross-device cooperative security device associated with the target camera may be determined from the security device set based on the association relationship.

The block of controlling the one or more cross-device cooperative security devices to perform the monitoring operation on the target object, may include the following.

When the cross-device cooperative security device includes the audio output device, the audio output device may be controlled to emit a prompt audio corresponding to the target object, such that the monitoring operation is performed.

In some embodiments, when the monitoring operation is for image capturing, the method further includes the following.

The image obtained by the cross-device cooperative security device performing the monitoring operation may be obtained, so as to obtain the monitoring image.

At least one of the following feature information of the target object may be extracted from the monitoring image: the facial image, the license plate number, the movement trajectory: the first appearance time point, the first appearance location, the departure time point, the departure location.

The feature information may be sent to the predetermined user terminal to enable the user terminal to display the event information determined based on the feature information. Alternatively, the event information may be determined based on the feature information, and the event information may be sent to the predetermined user terminal to enable the user terminal to display the event information. The event information represents the event triggered by the target object.

In the security scenarios, the above embodiments may be a control method for security devices.

In the present disclosure, the following embodiments may be implemented independently of the aforementioned embodiments or may be performed based on the above embodiments. Furthermore, the subject for achieving the following embodiments may be the same as or different from that for the above embodiments.

The embodiments of the present disclosure may be applied to scenarios involving the collaborative operation of a plurality of security devices. The method may include the following.

The configuration requirement information may be received.

The configuration requirement information may be parsed using the predetermined model, and the configuration requirement information includes the target scene and the configuration requirements.

The target security device relevant to the configuration requirements may be determined from the device capability sets of the plurality of security devices, and the behavior pattern of the target security device within the target scene may be determined.

The cross-device cooperative control strategy may be determined based on the behavior pattern and the device capability set of each target security device, so as to control the target security device based on the cross-device cooperative control strategy within the target scene to achieve the configuration requirements.

In some embodiments, the block of determining the target security device relevant to the configuration requirements from the device capability sets of the plurality of security devices, may include the following.

The device identifier for each security device of the plurality of security devices may be determined.

The device capability set corresponding to each security device may be determined based on the device identifier.

The installation location of the security device may be determined.

It may be determined whether any security device is the target security device relevant to the configuration requirements based on the device capability set and the installation location.

In some embodiments, the block of determining whether any security device is the target security device relevant to the configuration requirements based on the device capability set and the installation location, may include the following.

The target function included in the configuration requirements may be determined.

It may be determined whether the security device can achieve the target function based on the device capability set.

When it is determined that the security device can achieve the target function, it may be determined whether the installation location of the security device is within the target scene.

When it is determined that the installation location of the security device is within the target scene, it may be determined that the security device is the target security device relevant to the configuration requirements.

In some embodiments, determining the behavior pattern of the target security device within the target scene may include the following.

The routine behavior pattern of the target security device within the predetermined historical time period under the predetermined scene may be obtained. The predetermined scene includes at least the target scene.

The behavior pattern of the target security device within the target scene may be determined based on the routine behavior pattern in the predetermined scene.

In some embodiments, the routine behavior pattern for each security device in the predetermined scene may be obtained as follows.

When a behavior event is detected in the predetermined scene, it may be determined whether the subject for performing the behavior event is the security device within the predetermined scene.

When the subject for performing the behavior event is the security device within the predetermined scene, the device behavior information corresponding to the behavior event may be obtained.

The device behavior information may be stored in the predetermined database.

When no behavior event is detected, self-learning may be performed based on the device behavior information stored in the database, so as to obtain the routine behavior pattern for each security device under the predetermined scene.

In some embodiments, determining the cross-device cooperative control strategy based on the behavior pattern and the device capability set of each target security device may include the following.

The configuration requirements may be parsed to determine the trigger condition for each target security device.

The initial cross-device cooperative control strategy may be determined based on the trigger condition and the device capability set of each target security device.

The cross-device cooperative control strategy may be determined based on the initial cross-device cooperative control strategy and the behavior pattern.

In some embodiments, determining the cross-device cooperative control strategy based on the initial cross-device cooperative control strategy and the behavior pattern, may include the following.

The cross-device cooperative control condition in at least one predetermined dimension may be determined based on the initial cross-device cooperative control strategy and the behavior pattern. The predetermined dimension includes one or more of the following: the time dimension, the device dimension, the user dimension, the trigger movement, and the execution movement.

The cross-device cooperative control condition may be input into the predetermined cross-device cooperative control strategy model to obtain the cross-device cooperative control strategy.

In some embodiments, after determining the cross-device cooperative control strategy based on the behavior pattern and the device capability set of each target security device, the method further includes the following.

The cross-device cooperative control strategy may be output via the visual interface.

After receiving the modification operation performed by the user on the cross-device cooperative control strategy: the post-modification target cross-device cooperative control strategy may be obtained.

The cross-device cooperative control strategy may be updated to the target cross-device cooperative control strategy.

In some embodiments, the predetermined model is trained as follows.

The sample set of the configuration requirement information may be obtained. The sample set includes a plurality of configuration requirement information samples, each of the plurality of configuration requirement information samples corresponds to one standard scene and one standard configuration requirement.

The predetermined initial model may be trained using the sample set of configuration requirement information to obtain the predicted scene and the predicted configuration requirement corresponding to each configuration requirement information sample output by the initial model.

For each configuration requirement information sample, the first loss value between the predicted scene corresponding to the sample and the corresponding standard scene may be obtained, and the second loss value between the predicted configuration requirement corresponding to the sample and the standard configuration requirement may be obtained.

It may be determined whether the predetermined training termination condition is satisfied, based on the first loss value and the second loss value corresponding to each configuration requirement information sample.

When it is determined that predetermined training termination condition is satisfied, the trained predetermined model may be obtained.

In the security scenarios, the above embodiments may be a method for generating the cross-device cooperative control strategy.

In the present disclosure, the following embodiments may be implemented independently of the above embodiments or may be implemented based on the embodiments disclosed above. Furthermore, the subject for achieving the following embodiments may be the same as or different from that for the above embodiments.

The natural language and the first security video may be obtained, and the natural language may be configured to determine the to-be-pushed video.

The feature data of the natural language may be determined to obtain first feature data.

The first video may be determined based on the first security video. It may be determined whether the first video matches the natural language, based on at least two types of feature data of the first video and the first feature data.

When the first video matches the natural language, the first video may be determined as the to-be-pushed video, and the video information of the to-be-pushed video may be pushed. The video information represents the information of the to-be-pushed video.

In some embodiments, the block of determining whether the first video matches the first feature data based on at least two types of the feature data of the first video, may include the following.

At least two types of the feature data among the image feature data of the first video, the text feature data of the first video, and the audio feature data of the first video may be determined, so as to obtain the second feature data.

It may be determined whether the first video matches the natural language based on the first feature data and the second feature data.

In some embodiments, the first video may be generated as follows: The event frame may be extracted from the first security video.

A plurality of event frames representing the same event may be determined and extracted as the first video. The similarity among the plurality of event frames representing the same event may be greater than or equal to the predetermined first threshold, and the similarity between event frames representing different events may be less than the predetermined first threshold.

In some embodiments, the block of extracting the event frames from the first security video may include the following.

The event extraction model may be used to extract the event frames from the first security video.

The event extraction model may be trained as follows.

The training sample set may be obtained. The training samples in the training sample set may include videos, event time, and event labels.

The machine learning algorithm may be applied to train the event extraction model. The videos included in the training samples in the training sample set may be used as input data, and the event time and the event labels may be used as the desired output data. In this way; the event extraction model is trained and obtained.

In some embodiments, the method further includes the following.

The playing speed of the non-target video segment in the obtained video may be determined as the first speed.

The playing speed of the target video segment in the obtained video may be determined as the second speed.

The target video segment may be formed of the event frames, and the second speed is less than the first speed.

In some embodiments, the method further includes the following.

The description text for the first video may be generated.

The description text may be configured to be displayed by the terminal; and/or to determine whether the first video is the search result for the video search request sent by the terminal.

In some embodiments, the method further includes the following.

At least one of the text and the music matching the first video may be determined, so as to obtain the matching information for the first video.

The matching information may be fused with the first video to obtain the second video.

When the target operation performed on the second video is detected, performing the target operation on the second video. The target operation includes at least one of the following: a sharing operation, a downloading operation, a storing operation, or a sending operation.

In some embodiments, the method further includes the following.

The target video frame may be determined from the first video.

The similarity between the target video frame and the preceding video frame may be less than or equal to the predetermined second threshold, and the similarity between the target video frame and the subsequent video frame may be less than or equal to the predetermined second threshold. The preceding video frame is the video frame occurring before the target video frame in the first video, and the subsequent video frame is the video frame occurring after the target video frame in the first video.

The target video frame may be determined as the highlight video frame in the first video.

In some embodiments, the method may be performed by the first device.

Pushing the video information of the to-be-pushed video may include the following.

The location information of the second device may be obtained.

The video information of the to-be-pushed video may be determined based on the location information.

The video information may be pushed to the second device.

In some embodiments, the block of determining the video information of the to-be-pushed video based on the location information, may include the following.

The location of the camera may be determined, so as to obtain the target location.

The distance between the location indicated by the location information and the target location may be determined, so as to obtain the target distance.

It may be determined whether the target distance is greater than or equal to the predetermined distance threshold.

When the target distance is greater than or equal to the predetermined distance threshold, the video information of the to-be-pushed video may be determined as the first information. The first information indicates a request to control the camera to monitor the target region. The target region is the region that is monitored to generate the to-be-pushed video.

When the target distance is less than the predetermined distance threshold, the video information of the to-be-pushed video may be determined as representing the first information. The second information indicates the location of the target region. The target region is the region that is monitored to generate the to-be-pushed video.

The first security video may be the video generated by the camera. In the security scenarios, the above embodiments may be an information pushing method.

In the present disclosure, the following embodiments may be implemented independently of the above embodiments or may be achieved based on the above disclosed embodiments. Furthermore, the subject for achieving the following embodiments may be the same as or different from that for the above embodiments.

The image of the target object within the predetermined region may be obtained. The movement distance and the endpoint of the movement of the target object within the predetermined region may be determined based on the image.

It may be determined whether the movement distance is greater than or equal to the predetermined first distance threshold, and it may be determined determine whether the endpoint of the movement is located within the predetermined endpoint region.

When the movement distance is determined as being greater than or equal to the first distance threshold and the endpoint of the movement is determined as being located within the predetermined endpoint region, it may be determined that the current behavior of the target object belongs to the target behavior type. In some embodiments, the block of determining the movement distance and the endpoint of the movement of the target object within the predetermined region based on the image, may include the following.

The starting point of the movement and the endpoint of the movement of the target object within the predetermined region may be determined.

The first straight linear distance between the starting point of the movement and the endpoint of the movement may be determined, and the first straight linear distance may be determined as the movement distance of the target object within the predetermined region.

In some embodiments, determining the starting point of the movement and the endpoint of the movement of the target object within the predetermined region, may include the following.

The movement trajectory of the target object within the predetermined region may be determined.

The corresponding starting point of the movement and the corresponding endpoint of the movement of the target object on the movement trajectory may be determined.

The starting point of the movement on the movement trajectory may be determined as the starting point of the movement of the target object within the predetermined region, and the endpoint of the movement on the movement trajectory may be determined as the endpoint of the movement of the target object within the predetermined region.

In some embodiments, the first distance threshold may be determined as follows.

The minimum distance between the predetermined starting point and the predetermined endpoint region may be determined, and the minimum distance may be determined as the first distance threshold. The predetermined starting point may be determined in response to setting the starting point corresponding to the target behavior type.

In some embodiments, determining whether the endpoint of the movement is located within the predetermined endpoint region, may include the following.

The endpoint distance between the endpoint of the movement and the predetermined endpoint may be determined, and the predetermined endpoint may be determined in response to setting the endpoint corresponding to the target behavior type.

When the endpoint distance is less than or equal to the second distance threshold, it may be determined that the endpoint of the movement is within the predetermined endpoint region.

In some embodiments, the second distance threshold may be determined as follows.

Historical endpoints of the movement may be obtained.

The historical distance between each historical endpoint of the movement and the predetermined endpoint may be obtained, and the second distance threshold may be determined based on the historical distance.

In some embodiments, presence of the target object within the predetermined region may be determined by performing the following.

When the object is detected within the captured image, the object feature of the object may be extracted from the captured image.

It may be determined whether the target object matching the object feature is stored in the predetermined database based on the object feature.

It may be determined that the target object is present in the predetermined region when the target object matching the object feature is detected in the predetermined database.

In some embodiments, the target camera module for recognizing the biometric feature is present within the endpoint region, the presence of the target object in the predetermined region may be performed as follows.

When determining that the object enters the endpoint region, the target camera module may recognize the biometric feature of the object.

It may be determined whether the target object matching the biometric feature is stored in the predetermined database based on the biometric feature.

When determining that the target object matching the biometric feature is detected in the predetermined database, it may be determined that the target object is present within the predetermined region.

In some embodiments, after determining that the current behavior of the target object belongs to the target behavior type, the method further includes the following.

The image and/or the prompt information corresponding to the target behavior type of the target object may be sent to the external terminal. The prompt information includes at least one of the following: notification of the target behavior type, failure to detect other predetermined target objects within the predetermined time period, or presence of the non-target object entering the predetermined region.

In some embodiments, the target behavior type includes any one or more of the following: returning home, leaving home, going to the workplace, or parcel delivery.

In some embodiments, after determining that the current behavior of the target object belongs to the target behavior type, the method further includes the following.

A behavior log record may be generated from the video related to the target behavior type within the predetermined time period.

In some embodiments, the method further includes the following.

The image of the target object within the predetermined region may be obtained, and the starting point of the movement of the target object and the endpoint of the movement of the target object within the predetermined region may be determined based on the image.

When the starting point of the movement of the target object is determined to be within the predetermined starting point region and the endpoint of the movement of the target object is determined to be within the predetermined endpoint region, it may be determined that the current behavior of the target object belongs to the target behavior type.

In some embodiments, the block of determining that the starting point of the movement of the target object is within the predetermined starting point region and determining that the endpoint of the movement of the target object is within the predetermined endpoint region, may include the following.

The starting point distance between the starting point of the movement and the predetermined starting point may be determined, and the endpoint distance between the endpoint of the movement and the predetermined endpoint may be determined. The predetermined starting point may be determined in response to setting the starting point corresponding to the target behavior type, and the predetermined endpoint may be determined in response to setting the endpoint corresponding to the target behavior type.

When the starting point distance is less than the third distance threshold and the endpoint distance is less than the fourth distance threshold, it may be determined that that the starting point of the movement of the target object is within the predetermined starting point region and that the endpoint of the movement of the target object is within the predetermined endpoint region

In some embodiments, the block of determining the starting point of the movement and the endpoint of the movement of the target object within the predetermined region based on the image, may include the following.

The movement trajectory of the target object within the predetermined region may be obtained from the image.

The corresponding starting point of the movement and the corresponding endpoint of the movement of the target object on the movement trajectory may be obtained.

The corresponding starting point of the movement on the movement trajectory may be determined as the starting point of the movement of the target object within the predetermined region, and the corresponding endpoint of the movement on the movement trajectory may be determined as the endpoint of the movement of the target object within the predetermined region.

Alternatively, the present disclosure further includes the following.

The captured image for the predetermined region may be obtained, and the captured image may be displayed.

The predetermined starting point and the predetermined point of the target behavior type set for the captured image may be determined.

The distance threshold corresponding to the target behavior type may be determined based on the predetermined starting point and the predetermined endpoint. It may be determined whether the behavior of the object belongs to the target behavior type based on the distance threshold and the predetermined endpoint.

In some embodiments, the block of determining the predetermined starting point and the predetermined point of the target behavior type set for the captured image, may include the following.

The predetermined starting point and the predetermined endpoint may be recognized in response to setting for the predetermined icon within the captured image.

In some embodiments, the setting for the predetermined icon includes a click operation, and the block of recognizing the predetermined starting point and the predetermined endpoint in response to the setting for the predetermined icon within the captured image, may include the following.

In response to at least two click operations performed on the captured image, one predetermined icon may be set at the position corresponding each of the at least two click operations.

The predetermined starting point and the predetermined endpoint may be determined based on the position of each predetermined icon.

In some embodiments, the setting for the predetermined icon includes the dragging operation. The block of recognizing the predetermined starting point and the predetermined endpoint in response to the setting for the predetermined icon within the captured image, may include the following.

The dragging trajectory corresponding to the dragging operation may be determined.

The dragging starting point and the dragging endpoint of the dragging trajectory may be recognized.

The dragging starting point may be determined as the predetermined starting point of the target behavior type set for the captured image, and the dragging endpoint may be determined as the predetermined endpoint of the target behavior type set for the captured image.

In some embodiments, determining the predetermined starting point and the predetermined endpoint of the target behavior type set for the captured image may include the following.

The input captured video may be obtained. The captured video includes the behavior of the target behavior type performed by the predetermined object within the predetermined region.

The appearance point and the disappearance point of the predetermined object within the captured video may be determined.

The appearance point may be determined as the predetermined starting point of the target behavior type set for the captured image, and the disappearance point may be determined as the predetermined endpoint of the target behavior type set for the captured image.

In some embodiments, after determining the distance threshold corresponding to the target behavior type, the method further includes the following.

The endpoint region of the behavior corresponding to the target behavior type may be determined based on the predetermined endpoint. It may be determined whether the behavior of the object belongs to the target behavior type based on the distance threshold and the endpoint region.

In some embodiments, the block of determining the endpoint region of the behavior corresponding to the target behavior type based on the predetermined endpoint, may include the following.

It may be determined whether the predetermined endpoint is located on the predetermined regional object.

When the predetermined endpoint is determined as being located on the regional object, the endpoint region of the behavior corresponding to the target behavior type may be determined taking the regional object as the center of the endpoint region.

When the predetermined endpoint is determined as not being located on the regional object, the endpoint region of the behavior corresponding to the target behavior type may be determined taking the predetermined endpoint as the center of the endpoint region.

In some embodiments, the method further includes the following.

The object list may be obtained and displayed.

In response to the object selection operation performed on the object list, the target object may be determined from the object list. In this way: during recognizing the behavior of the object, it may be recognized whether the behavior of the target object belongs to the target behavior type.

In some embodiments, obtaining the captured image for the predetermined region may include the following.

The list of camera modules for capturing the predetermined region may be obtained and displayed.

The target camera module may be determined, in response to the camera module selection operation performed on the list of camera module, from the list of camera modules.

The captured image for the predetermined region may be obtained through the target camera module.

Alternatively, the disclosure further includes the following.

The captured image for the predetermined region may be obtained and displayed.

The movement trajectory of the target behavior type set for the captured image may be determined.

The distance threshold and the endpoint region corresponding to the target behavior type may be determined based on the movement trajectory. It may be recognized, based on the distance threshold and the endpoint region, whether the behavior of the object belongs to the target behavior type.

In some embodiments, the block of determining the distance threshold and the endpoint region corresponding to the target behavior type based on the movement trajectory, may include the following.

The predetermined starting point and the predetermined endpoint may be determined based on the movement trajectory.

The distance threshold and the endpoint region may be determined based on the predetermined starting point and the predetermined endpoint.

In some embodiments, the block of determining the distance threshold and the endpoint region based on the predetermined starting point and the predetermined endpoint, may include the following.

The endpoint region may be formed by taking the predetermined endpoint as the center of the endpoint region and taking the first distance threshold as the radius of the endpoint region. The distance from the predetermined starting point to any edge of the endpoint region may be the distance threshold.

Alternatively, the disclosure includes the following.

The captured image for the predetermined region may be obtained and displayed.

The predetermined starting point and the predetermined endpoint of the target behavior type set for the captured image may be obtained.

The starting point region and the endpoint region may be determined based on the predetermined starting point and the predetermined endpoint, respectively. It may be recognized whether the behavior of the object belongs to the target behavior type based on the starting point region and the endpoint region.

In some embodiments, the block of determining the starting point region and the endpoint region based on the predetermined starting point and the predetermined endpoint may include the following.

The third distance threshold and the fourth distance threshold may be determined.

The starting point region may be determined based on the predetermined starting point and the third distance threshold, and the endpoint region may be determined based on the predetermined endpoint and the fourth distance threshold.

In some embodiments, the block of determining the predetermined starting point and the predetermined endpoint of the target behavior type set for the captured image, may include the following.

The movement trajectory of the target behavior type set for the captured image may be determined.

The starting point of the movement and the endpoint of the movement on the movement trajectory may be determined.

The starting point of the movement on the movement trajectory may be determined as the predetermined starting point of the target behavior type set for the captured image. The endpoint of the movement on the movement trajectory may be determined as the predetermined endpoint of the target behavior type set for the captured image.

In the security scenarios, the above embodiments may be a method for recognizing the behavior of the object.

In some cases, the target video, the first security video, and the video generated by the camera in the above embodiments may have the identical meaning. Furthermore, any of the above embodiments may serve as foundation for other embodiments, such that a new embodiment including at least any two of the above embodiments may be formed and may be achieved as an independent embodiment. In addition, specific implementation of the above embodiment may refer to the preceding description and will not be repeated.

The following embodiments of the present disclosure will be described exemplarily. However, it should be noted that the embodiments may have the features described below, but the described features do not limit the scope of the embodiments.

Before describing the embodiments of the present disclosure, concepts involved in the embodiments are explained as follows.
1. Large Model: In the field of artificial intelligence, the large model typically refers to a large-scale machine learning model, particularly a deep learning model. The term “large” denotes that the model has a substantial number of parameters and a complex network architecture. The model generally requires a large amount of data for training and has strong learning and generalization capabilities. For example, the Generative Pre-trained Transformer 3 (GPT-3) is a typical large model having 175 billion parameters. The large model may include a large language model (LLM).
2. Multimodal: The multimodal refers to a method that integrates and analyzes a plurality of types of data or signals. In AI, multimodal learning often involves combining diverse data types, such as texts, images, audios, and videos, to enhance model performance and understanding capabilities. For instance, a multimodal machine learning model may simultaneously analyze visual information in an image and analyze textual information that describes a content of the image.
3. Knowledge Graph: The knowledge graph is a structured format for organizing and representing knowledge. The knowledge graph typically appears as a graph where each node represents an entity (such as a person, a place, an object, and so on), and each edge represents a relationship between entities. The knowledge graph may be widely applied in semantic searching, recommendation systems, natural language processing, and other fields. The knowledge graph may assist a machine in better understanding and processing complex information.
4. Behavior Recognition: The behavior recognition is a task in computer vision and aims to recognize and understand actions and movements of a person or an object in a video. The behavior recognition involves extracting features from video data and using a machine learning model to classify various types of behaviors. The behavior recognition is widely applied in security surveillance, human-computer interaction, sports analysis, and other fields.
5. Visual Language Model (VLM): The visual language model is a technology that combines image processing and natural language processing. A primary purpose of the visual language model is to understand and interpret a relationship between images and texts, and to generate accurate and vivid natural language description based on an image. By analyzing a content in the image and a context thereof, the visual language model may generate relevant textual description, enabling a computer to have visual comprehension capabilities closer to human understanding.
6. Vision-Language-Action Models (VLA): The vision-language-action model, after receiving an image and language command, may plan a series of actions based on the language command (typically goal-oriented) and context observed in the image to achieve a task in an end-to-end manner.
7. Artificial Intelligence Generated Service (AIGS): For the AIGS, a service may be generated by AI. For example, in order to enhance user asset protection, a home security assistant may automatically determine valuable items inside a residence and generate a security strategy for the valuable items, and recommend the security strategy to the user. The security strategy may be effective upon user confirmation.
8. User Generated Service (UGS): The UGS may be designed by the user himself based on specific needs. For example, the user may develop a doorbell speech assistant based on localized accent characteristics to greet visitors. The doorbell speech assistant may be used personally or made available to other residents in a community.
9. Professionally Generated Service (PGS): The PGS may be a service designed by a professional company based on market insights. For example, a surveillance camera company develops a security mechanism and features based on understanding for a package protection scenario, and the security mechanism and features may be offered to users of the surveillance camera company.

Current Development Status of “Smart Home Assistant”: Innovation trends for the “smart home assistant” currently focus primarily on smart home systems. However, solutions and development specifically targeting home security or integrating home security with smart home capabilities remain relatively scarce.

While smart home technology significantly enhances household convenience and comfort, home security is an indispensable aspect, as the home security provides residents with essential safety: peace of mind, and a sense of security. Therefore, developing a comprehensive smart home management system that integrates smart home functions with home security measures has become particularly crucial.

Limitations of Traditional Smart Home Assistants Powered by Small Models: In the home security aspect, devices, such as cameras, video doorbells, and smart locks, are widely recognized. The above security products are driven by small models. The small models may have poor scalability and adaptability, and may only handle relatively simple tasks and exhibit limited accuracy and the decision-making capability. Consequently, the smart home assistant may offer services in limited scenarios with generally mediocre quality. The multimodal large model, however, may provide smarter, higher-quality services across more scenarios.

Accordingly, the present disclosure provides a home smart assistant (as described in the aforementioned security method) configured with four core capabilities: perception, cognition, decision-making, and execution. The home smart assistant may have the following capabilities.

Perception: The home smart assistant may proactively and passively structures and archives information about indoor/outdoor environments, people, pets, and valuables of the residence, so as to form comprehensive whole-house awareness.

Cognition: The home smart assistant may perform knowledge graph inference, behavior recognition, and intent identification on historical and real-time security videos, so as to understand a relational map of the whole family and past events, and to predict upcoming events.

Planning Capabilities: The home smart assistant may integrate perceived and cognized information to match predetermined scenario execution strategies (such as package guarding strategies). The home smart assistant may adjust the strategies based on common-sense knowledge from the multimodal large model to generate performing plans for theft prevention, fire protection, vandalism defense, and nuisance mitigation.

Execution Capability: The home smart assistant may execute strategies specifically for various scenarios through planning capabilities. The home smart assistant may deploy devices, including audio-visual alarms and smart home systems (including security cameras, robot vacuums, projectors, headphones, chargers, light strips, and door locks), to achieve household safety, peace of mind, convenience, and comfort.

Based on the above perception, cognition, planning capabilities, and execution capabilities, the smart home assistant may provide required services to the user, via three output models: the Professionally Generated Service (PGS), the Artificial Intelligence Generated Service (AIGS), and the User Generated Service (UGS). In order to enhance service quality: the smart home assistant may perform both proactive and reactive iterative approaches to improve the services. By discovering needs, providing services, and improving services, the smart home provides households with greater emotional value, including safety: peace of mind, convenience, and warmth.

### 1.1 Perception Capability:

A primary condition for the smart home assistant to manage the house and provide services is understanding the house and information about persons and objects inside the house. Therefore, the perception capabilities of the smart home assistant include establishing two core archives—an environmental archive and a person/pet/property archive. Contents of the archives and a method for establishing the archives will be described in detail.

### 1.1.1 Contents of the Archives

### 1.1.1.1 Environmental Archive:

The environmental archive may substantially include constructing a three-dimensional panoramic model of the house and structural information of the house.

1.1.1.1.1 Three-dimensional Panoramic Model of the house is shown in FIG. 3A.

### 1.1.1.1.2 Structural Information of the House:

(1) The structural information may include a surrounding environment of the house, a specific location of the house, and whether the house is located near a road.
(2) The structural information may include: an interior environment of the house; the number of floors of the house; the total ground area of the house; the number and types of rooms (bedrooms, living rooms, kitchen, bathroom, study room, and so on) of the house; an entrance type (description of stairs, hallway: foyer) of the house; presence of a front yard, a backyard, a garage, a pool; materials used for the house and the floor (bricks, wood, stones, glass, and so on).

### 1.1.1.1.3 Camera Information:

The camera information may include a device type: an installation location of the camera, a height of the camera, and an angle of the camera.

### 1.1.1.2 Person/Pet/Property Archive:

### 1.1.1.2.1 Primary Information:

### (1) Acquaintances and Key Details:

Identity: family members (including elderly and children), neighbors, friends, and relatives.
Attributes: gender, age, height, body shape, room assignment.
Recent State: Health condition, emotional state.
Image database: facial database, body figure database.
Accessing habits.

### (2) Strangers and Key Information:

Identity: Passersby, courier/salespeople, service technician.
Attributes: gender, age, height, body shape, and so on.
Recent state: work diligence (for the service technician).
Image database: facial database, body figure database.

### (3) Threat Individuals and Key Information:

Identity: thief, suspect.
Attributes: gender, age, height, body shape, room, and so on.
Image database: facial database, body figure database.

### (4) Pets and Key Information:

Type: cat, dog, parrot, turtle, and so on.
Attributes: color.
Accessing habits.
Image database: photos for the pet.

### (5) Vehicle Assets and Key Information:

Attributes: vehicle model, color.
License plate.
Price.
Entry/exit time points.

### (6) Parcel Assets and Key Information:

State: retrieved, to be retrieval (retention time), stolen.

### (7) Other General Assets:

State: secure, unsafe.
Attribute information: value (the large model may be applied to identify, based on common sense capabilities of the large model, most valuable articles to output a property table, which may be confirmed and supplemented by the user).
Location.

### 1.1.2 Method for Establishing the Archives:

The method for establishing the archives may include: establishing the archives by the user proactively and establishing the archives by the smart home assistant proactively. Specific implementations are as follows.

### 1.2.1 Establishing the Archives by the User Proactively:

### (1) Environmental Archive:

In a block 1, after installing the device, the user may carry a mobile phone to scan the entire interior and exterior of the house to create a preliminary three-dimensional panoramic map (scanning focuses on internal structural details and the location at which the camera is installed).

In a block 2, the device may be activated, the device may perform focused modeling on any accessible region and refine a three-dimensional panorama map of the accessible region, and the three-dimensional panoramic map of the accessible region may be updated in real time.

In a block 3, the smart home assistant may recommend the user to scan a blind spot; and the user may scan the blind spot to update the three-dimensional panoramic map.

In a block 4, external structural information of the house may be obtained via a map and may be integrated into the panoramic map for updating.

### (2) Person Archive:

The user may carry the mobile phone to record a video to provide real-time introduction to the smart home assistant. The introduction may include family members, pets, and valuable assets requiring special attention. The smart home assistant may query, based on the introduction, additional necessary information.

### 1.1.2.2 Establishing the Archives by the Smart Home Assistant Proactively:

The smart home assistant may recognize archive information of the environment and persons from historical monitoring data. When the user does not actively provide the entire house information during installation, the smart home assistant may supplement or update the entire house information based on scheduled video monitoring with user authorization. For example, when a new puppy appears in the house and the smart home assistant recognizes, based on scene understanding, the puppy as a new companion of a young owner of the house, the smart home assistant may update the new puppy to an archive database. The above process may include following blocks.

In a block 1, after receiving a video stream, the multimodal large model may analyze relationships, attributes, and behaviors of individuals in the video stream, and may store information in a database.

In a block 2, taking one week as a cycle, structural information of each video in the database may be gathered to serve as a prompt word to be input into the large language model, and potential family members and frequently occurring locations and behaviors of the potential family members may be output.

In a block 3, summarized information may be pushed to the user. The user may modify relevant information. After clicking for confirmation, the smart home assistant may proactively complete establishing the archive.

### 1.2 Cognition Capability:

A difference between the cognition capability and the perception capability may be that the perception capability involves collecting, preliminary processing, and processing multimodal information, whereas the cognition capability involves further processing of the perceived information. The cognition capability involves abilities of the smart home assistant, such as analysis, reasoning, and understanding. The cognition capability may include family relationship mapping (a person-to-person network, a belonging relationship network), event recognition, and intent inference. Specific implementations are as below.

### 1.2.1 Family Relationship Mapping Based on Knowledge Graph:

The family relationship mapping may construct an association between individuals and assets inside the house and may have two preliminary purposes as follows.

(1) The family relationship mapping may provide a holistic relational overview, which may be viewed by the user.

Monitoring Real-time State: location states of the family members and the pets, such as presence at home and entry/exiting records of vehicles, may be displayed on an interface of an application.

Interaction History: an interaction frequency and pattern between the family members and smart home appliances may be recorded, such as who frequently uses speech queries in a smart refrigerator.

(2) The family relationship mapping may provide an information processing core for the smart home assistant:

Data Integration: daily activity data and personal preferences, such as dietary choices and sleeping habits, may be integrated, so as to provide support for the smart home assistant to make decisions.

Personalized Services: after receiving user queries (such as performing the user-generated services as per 2.1.2 UGS), customized responses, such as recipe recommendation or indoor temperature adjustment, may be provided based on the family relationship mapping.

### 1.2.1.1 Content and Formats of the Family Relationship Mapping:

(1) Person-To-Person Network; fundamental relationships and social dynamics among the family members may be described in detail, and interactions with an external individual or groups may be recorded, such as a frequency of gathering with relatives and friends.
(2) Belonging Relationship Network; a usage history of each article may be recorded in detail, such as vehicle maintenance logs or a last usage time point for keys, and so on, such that an efficiency of managing articles may be improved.

### 1.2.1.2. Method for Establishing the Family Relationship Mapping

(1) Establishing based on User-Initiated Description: Speech recognition and natural language processing may be applied to enable the user to communicate naturally, and the smart home assistant may understand and record detailed description. For example. Wayne may inform the smart home assistant that a key with a panda belongs to Wayne, and a key belong to his brother Leon is a key with a jade.
(2) Establishing based on Recognition Initiated by Smart Home Assistant: the smart home assistant may in real time update, based on article recognition and an indoor locating system, locations and usage states of articles and may dynamically adjust the belonging relationship of each article. For example, the smart home assistant may notice that Wayne frequently carries the key with the panda, and Leon frequently carries the key with the jade, such that the smart home assistant may determine the belonging relationship for each article.

For example, as shown in FIG. 3B. FIG. 3B is a schematic diagram of the knowledge graph according to an embodiment of the present disclosure.

### 1.2.2 Event Recognition and Intent Recognition:

The smart home assistant may be configured with the multimodal large model to understand events that happened in the past in the house through retrospective or real-time analysis, such that event recognition may be performed. The smart home assistant may be configured with the multimodal large model to predict events that will happen in the future, so as to achieve the intent recognition.

### 1.2.2.1 Event Type:

### (1) Fire Safety Event:

Smoke and fire detection.

### (2) Security Event:

Theft (attempted or actual): targeting parcels, vehicles, or other articles.
Invasion: any unauthorized entry by a stranger into a private residential region, including scaling fences, breaking windows, picking locks, or intentionally obstructing/damaging/disabling security cameras or surveillance equipment.
Damages: Intentional damage to household property, such as breaking windows, damaging vehicles, destroying lawns, damaging furniture or other property, or any form of arson.
Threats or Violence: Threatening or performing violence against any family member or pet.
Harassment: loitering around the house or any unusual peeping behavior.

### (3) Safety Event:

Emergency Hazards: Prolonged immobility (for elderly people), falling, crying (for infants), face covering (for infants), falling into a pool (for children), prolonged absence (for family members/pets).
Daily Events: Returning home (for family members), doing homework (for children), visiting (for visitors), mowing the lawn (for service providers), delivering parcels (for couriers).
Heartwarming Events: Family birthday gatherings, parents playing with children, and so on (for home video editing).

### 1.2.2.2 Implementation for Behavior Recognition:

The behavior recognition may be performed, through a tiered strategy: combining a small model and a large model to progressively enhance accuracy in determining a behavior intent, so as to create a comprehensive system balancing efficiency and precision. The system has three phases. A phase I and a phase II of the system may be arranged with the small model. In the phase I, detection is triggered by personal property and a human body shape. In the phase II, a key action of the theft may be recognized. In a phase III, the multi-model large model may be applied, and a timing sequence may be considered, such that final accuracy of the behavior recognition may be improved.

### 1.2.2.3 Implementation of Intent Recognition:

When the security event occurs, the smart home assistant may recognize and quantify an intent of a subject. Taking parcel theft as an example, when a stranger approaches a parcel from a distance, the model may recognize the intent to steal the parcel being 50%. When the stranger bends toward the parcel, the intent to steal the parcel may be increased to reach 80%. When the stranger picks up the parcel, the intent to steal the parcel may be 90%. When the stranger puts the parcel down, the intent to steal the parcel may be 10%. When the stranger picks up the parcel and runs away immediately, the intent to steal the parcel may be 100%.

### 1.3 Decision-Making Capability:

The multimodal large model may make, based on common sense and perception and recognition of household, a series of strategies that reassure the user to prevent incidents.

The strategies for the fire safety event, the security event, and the safety event may differ from each other. Taking a parcel guarding strategy as an example:

As shown in FIG. 3C, when a pedestrian approaches from a distance, and when an ID can be identified, the pedestrian may be classified as a familiar person or a stranger. When the ID of the pedestrian is not detectable, the pedestrian may be classified as an unknown person.

When a family member (classified as the familiar person) approaches the parcel from a distance, the smart home assistant announces “Please take the parcel inside”. After the family member brings the parcel inside, the application receives a notification from the smart home assistant “Your family member has brought the parcel inside”.

When the stranger approaches the parcel from a distance, the smart home assistant may say “Hello”. When the stranger is a thief, the thief may be subjected to a deterrent. When the stranger continues approaching and picks up the parcel, the doorbell may issue a warning “Please leave my parcel. I'll be right out.” When the thief flees, a video may be pushed to the user with a notification “Your parcel has been successfully guarded.” When the thief picks up the package and leaves, the doorbell may issue “Please return the parcel, or I will call the police.” When the thief drops down the parcel and leaves, the user may receive a successful guarding notification. When the thief escapes with the parcel, the user may be notified that the parcel is stolen and may be advised to add the thief to a blacklist, and the incident may be shared to other users.

The above strategies may be partially developed by the multimodal large model assistant. Different strategies may be provided for different scenarios, such as for vehicle security.

### 1.4 Execution Capability:

The multimodal large model first recognizes a specific event through perception and cognition, then provides a strategy based on the decision-making capability; and finally executes the strategy based on the execution capability.

### 1.4.1 Security-Related Execution Actions:

### 1.4.1.1 Execution Actions of Security Surveillance Cameras Themselves:

Lighting-related: red/blue flashing lights, night vision lights.
Speaker-related: alarm sounds, speech prompt (such as expulsion warning, greeting).
Pan-tilted-camera-related: Pan-tilted-camera rotation, or drone arranged with a camera performing patrol.
   1.4.1.2 Execution actions linked with applications/police reporting centers:
Police reporting: contacting police/hospital/fire department.
Message pushing: pushing an application notification.

### 1.4.1.3 Execution Performed Cooperatively With Other Intelligent Entities:

Exchanging the blacklist with other HB smart home assistants.

Cooperation with other application agents of the mobile phone, such as scheduling via a system-level AI model of the mobile phone or interacting with other humanoid robots.

1.4.2 Non-security-related actions:

A robotic vacuum cleaner, a projector, a lawn mower, a 3D printer, a speaker, and a headphone may be included.

Taking the robotic vacuum cleaner as an example, when an overhead camera detects debris on the floor inside a field of view thereof, the overhead camera instructs the robotic vacuum cleaner to clean the specific region. Simultaneously: the overhead camera provides the robotic vacuum cleaner with a real-time overhead map to assist the robotic vacuum cleaner in planning an optimal cleaning path. When the robotic vacuum cleaner cannot locate a socket station thereof, the overhead camera provides the robotic vacuum cleaner a path towards the socket station.

Taking the lawn mower as an example, an outdoor overhead camera may provide a real-time map for the lawn mower, assisting the lawn mower in planning a lawn mowing path in which obstacles may be avoided, and preventing the lawn mower from moving out of a lawn mowing region.

### 1.4.3 Implementation of Execution Actions:

### 1.4.3.1 Activation Manner:

Proactive Activation by Smart Home Assistant: the execution actions may be initiated autonomously by the multimodal large model based on perception of the multimodal large model. In the above examples, after the multimodal large model detects the debris on the floor or noticing that the robotic vacuum cleaner cannot locate the socket station, the multimodal large model may design a strategy to direct the robotic vacuum cleaner to complete the task based on perception and cognition of the multimodal large model.

Activation Based On User Speech Interaction: the user directly provides a request to the smart home assistant via an application/a smart display/other microphone-configured device. Commands may be directly or indirectly provided. For example, the user may say to the application. “Please clean up the fresh poop of the puppy.” The smart home assistant detects the poop via all cameras inside the house, generates an execution strategy; and issues commands to the robotic vacuum cleaner to complete the task. After the robotic vacuum completes the task, the smart home assistant may detect whether the task is successfully performed. In regard to indirectly providing the commands, for example, the user may tell the smart home assistant that a sandstorm occurred in the past few days.” The smart home assistant may understand the intent of the user and may ask whether the user needs the mop the floor, and a task of mopping the floor may be performed when receiving user confirmation.

### 1.4.3.2 Basic Architecture:

As shown in FIG. 3D. FIG. 3D is an architecture diagram of the security method according to an embodiment of the present disclosure.

### Task Characteristics:

Queries to an intelligent agent may be generated based on input to the multimodal. In order to enable the VLM to control devices, an output thereof must be actions of the devices, i.e., (VLM→VLA).

### Perception Input:

Environment-adaptive perception may be applied. After the user sets a command, the system monitors, in real time, environmental changes. A corresponding action may be initiated based on the environmental changes fed back to the agent.

User-initiated input may be applied. When receiving a remote command from the application or a speech command from the user, the system may query a corresponding skill library and may execute an appropriate action based on environmental perception.

An intelligent command may be provided. The system converts the query into a format suitable for generating an appropriate action plan. This type of models may be used to generate the action plan of the agent. More specifically: the VLM may be used to transform a high-level task represented by the multimodal into a set of basic actions that are executable by the intelligent agent.

### 2. Smart Home Assistant Providing Customized Services:

The smart home assistant may provide, based on the four capabilities of the smart home assistant, customized intelligent services to the user. A specific providing manner and an iteration manner may be as follows.

### 2.1 Manner of Providing Services

### 2.1.1 Professionally Generated Service (PGS):

The smart home assistant displays and provides modularized standard services to all users in the application. For example, a family module displays services such as elderly falling detection and child arrival prompts: a visitor module displays services such as smart doorbell reception and visitor statistics: a property module displays services such as parcel guarding and vehicle guarding; and a general safety detection module displays services such as smoke and fire detection.

### 2.1.2 Artificial Intelligence Generated Service (AIGS):

The smart home assistant may take the large model, multimodal perception, and interaction capabilities to provide customized services for each user and provide customized service recommendations.

(1) The smart home assistant recommends services based on whole-home “perception” and “cognition” information, and the recommended services may be activated upon user confirmation.

Services may be recommended based on changes in the family members. The large model detects a new baby boy in the family and infers that the owner may need infant-related services. The large model may recommend automatic baby video editing and infant crying detection services via the application/the smart screen.

Services may be recommended based on attributes of the house. The large model detects the house being made of wood and may infer that fire detection may be needed. The large model may recommend a fire detection application to Wayne.

Services may be recommended based on the event recognition. The large model detects a recent parcel theft at the house of the user and may recommend a parcel theft prevention application.

(2) After receiving the recommendation from the smart home assistant, the user may adjust services according to actual circumstances.

For example, after the large model identifies that Wayne's grandfather stays at Wayne's home from April 6 to Apr. 8, 2024, and recommends an elderly-related application service. Wayne directly informs the smart home assistant that his grandfather may stay until the 15 Apr. 2024. In this case, the recommended elderly-related application service may be effective from April 8 to April 15, and a heartwarming video for this period of time may be generated.

### 2.1.3 User Generated Service (UGS):

### (1) User Generating Service for User Itself:

The user may describe needs to the large model via various interactions, such as via an application button, texts, or speech commands. The large model automatically extracts key information (such as an object and an event) from the multimodal information and recommends relevant services, which may be confirmed by the user to be activated.

In a scenario I, when the user inputs “I need to monitor whether my child arrives home at 6 PM daily” in a dialog box, the large model analyzes keywords, such as “child” and “arrives home” to push a family member home arriving detection service. Additionally: the system may recommend a series of child-related services, such as a homework monitoring service, a family member falling detection service, and a child crying detection service, for the user to select at will.

In a scenario II, the user may activate the large model by speeches and may provide an instruct to the large model. “Check a time point and a location for my parcel delivered by the courier today” The large model may parse “courier” and “parcel”, quickly retrieve a delivery event video, return a delivery record, and simultaneously recommend a “parcel guarding” service to the user.

In a scenario III, when the user types “Help me find my keys” in the dialog box, the smart home assistant first check the family relationship mapping to identify an appearance of the keys and then activates all cameras inside the house for real-time searching.

### (2) User Recommending Services for Others:

Given regionally specific needs, service requirements may vary across regions. In the present disclosure, the smart home assistant may allow the user to design and offer, based on local demands, his own service mode to other users in the same region.

In a scenario I, most residents in a region A are Indian descent speaking English with the Indian accent, and the smart doorbell greeting services provided by the AIGC and the PGC do not consider accent variation. A certain user may customize his smart doorbell greeting specifically for the Indian accent and may configure, based on Indian customs, an inquiry manner that is preferred by Indian visitors. In this case, the certain user may share his customized smart doorbell greeting service to a service co-creation section of the application, where other users may select and activate his customized smart doorbell greeting service.

### 2.2 Iteration And Upgrading for Smart Home Assistant Services:

### 2.2.1 Proactive Iteration Mode:

The security home assistant may autonomously replan service solutions by observing service quality, and the replanned service solutions may be adjusted and confirmed by the user.

For example, the parcel guarding service for the user is provided, and after the parcel guarding service is activated, the security home assistant detects that two recent parcel thefts at the house are not prevented due to delayed doorbell activation, and when video recording starts, the parcel has been already taken. Therefore, the security home assistant automatically increases sensitivity of the doorbell.

### 2.2.2 User-Initiated Iteration Mode:

The user may provide feedback about unexpected service settings via speeches or texts to the application or the terminal device (such as the doorbell), and the system may perform adjustment.

For example, when the user finds that an announcement voice of the doorbell is not soft enough, the user may activate the doorbell via speeches and customize a voice style of the doorbell.

Consequently, the aforementioned smart home assistant may perform following functions.
1. The smart home assistant may may have the perception capabilities and the cognition capabilities. The environmental archives may be shown in FIG. 3E, and the person archives and the family relationship mapping may be shown in FIG. 3F.
2. Human-AI interaction may be achieved via multimodal entry points (as shown in FIG. 3G).
3. Three service providing manners are as follows.

### (1) Professional Generated Services (PGS):

The visitor reception module (shown in FIG. 3H); the family guarding module (for children, for elderly people, for pets), shown in FIG. 3I.

The property guarding module (for parcels and vehicles) shown in FIG. 3J.

(2) Artificial Intelligence Generated Services (AIGS) as shown in FIG. 3K.

(3) User Generated Services (UGS) as shown in FIG. 3L.

The security method provided by the embodiments of the present disclosure combines edge hardware, terminal hardware, and lightweight small models. The smart home assistant may deeply notices key information about people, objects, and environments, as well as relationships therebetween. In this way, the smart home assistant may accurately establish comprehensive and detailed individual archives, providing support for the large model to provide timely: comprehensive, and customized services. By integrating multimodal and large model technologies, the smart home assistant may have capabilities to recognize various events and intents, which cannot be achieved by traditional small models. The above integration improves the cognition capability of the smart home assistant and provides the user with secure, reassuring, and warm protection and services. Scenario-based strategies and execution actions are provided. The smart home assistant may customize specific response strategies and execution actions for various scenarios (such as for parcel theft, vehicle theft). The scenario-based strategies and execution actions effectively prevent and mitigate adverse events, achieving safeguarding for family members and properties. The smart home assistant may provide, based on a plurality of interaction modes, diversified services with continuously updated service providing manners. The service providing manners include the professionally generated services (PGS), the user generated services (UGS), and the AI-generated services (AIGS). The smart home assistant of the present disclosure is the first one in the industry that has broad scenario coverage and full-aspect service capabilities. The smart home assistant provides full-aspect protection. The holistic security services covering personal safety, property protection, home surveillance, and environmental monitoring are provided to safeguard the family members and the properties. In regard to multimodal large-model algorithm integration, the system incorporates algorithms based on multimodal large models, so as to recognize and understand diverse common behaviors and intentions, accuracy of intelligent recognition and response may be improved. In regard to integration of security and a smart home device ecosystem, the system is connected with the security devices and works cooperatively with the smart home appliances, such that a cross-device interconnected security ecosystem is formed, improving the intelligence level of home safety. In regard to a community-level cooperation mechanism, the system introduces a concept of community cooperation, security information sharing and cooperative responses within the community may be achieved, such that overall safety protection capabilities of the community may be improved. In regard to cooperation among security devices, the system enables cooperation between large models and security devices, achieving more efficient security management. In regard to practical application logic and execution strategies, the system designs implementable logic and strategies, ensuring security measures to be performed efficiently and easily, such that the user experience is improved, and practicability of the system may be improved. Additionally, the aforementioned smart home assistant may have four capabilities: the perception capability; the cognition capability; the decision-making capability; and the execution capability. In regard to the perception capability; the smart home assistant may use the large-model multimodal perception to establish relationship archives, taking the house the center, between the house and people and properties associated with the house. In regard to the cognition capability; the smart home assistant constructs, based on the knowledge graph, the family relationship mapping among family entities (people, objects, environment) along with associated attribute information. The cognition capability includes the method for establishing the family relationship mapping/obtaining personal information (proactive recognition by the assistant/user-initiated description). The smart home assistant may recognize the event type (fire safety events, security events, safety events). The cognition capability includes methods and technologies for behavior recognition and intent recognition. In regard to the decision-making capability, the smart home assistant may make corresponding response logic and strategies based on recognition results of various event types. In regard to the execution capability; the smart home assistant may make execution actions based on results of perception, cognition, and decision-making to prevent adverse events. The execution actions include, but not limited to: providing a sound, providing a light, reporting to the police, pushing application notifications, interactions with base station large models or other application agents in the mobile phone, and interactions with smart home devices (lawn mowers, robotic vacuum cleaners, projectors, audio systems). The smart home assistant may have three manners to provide services: the professionally recommended services, the AI generated services, and the user generated services. In regard to service iteration and upgrading, the smart home assistant may proactively perform iteration, or the user may initiate the iteration.

Before introducing a dynamic response method for the security video, concepts involved therein will be described as follows.

The large language model (LLM) may be a natural language processing model based on deep learning. The LLM may understand, generate, and process human languages. The LLM may be trained based on massive text data and learn linguistic syntax, semantics, and contextual relationships through complex neural network architectures such as the Transformer model.

A core of the LLM may be predicting a next word in a text sequence, so as to generate a coherent and meaningful text. For the LLM, extensive linguistic knowledge may be accumulated through extensive pre-training, and fine-tuning may be performed to enhance domain-specific performance. The LLM may be broadly applied, including but not limited to automated text generation, machine translation, sentiment analysis, conversational systems, and question-answering systems. The LLM may answer questions and provide suggestions and may understand context and generate creative contents.

A feature vector may be a vector used in machine learning and data analysis to represent a data feature. The feature vector may transform raw data into a set of numerical features to be processed and analyzed by algorithms. The set of numerical features may be quantitative description of original data and may be in any type, such as images, texts, audios, and so on.

Construction of the feature vector typically includes data preprocessing, feature extraction, and feature selection. The data preprocessing may include noise removal, standardization, and normalization. The feature extraction may be a process of converting data into the feature vector, and a specific method thereof may be depending on a type of the data. During image processing, pixel values, edge detection results, or intermediate layer outputs from deep learning models may all serve as feature vectors. In a machine learning model, the feature vector may represent input data. The machine learning model may learn mapping between feature vectors and target outputs to perform prediction or classification.

Video understanding may be a research task in computer vision and artificial intelligence and may aim to enable the computer to comprehend and interpret video content like humans. Video understanding involves extracting meaningful information from videos, including recognizing objects, scenes, and activities, and involves understanding relationships therebetween and a timing sequence of events.

Achieving the video understanding typically involves deep learning, particularly convolutional neural networks (CNNs), recurrent neural networks (RNNs), and the Transformer model in recent years. These models may process both spatial and temporal information of a video and learn complex feature representations.

The video understanding is widely applied in autonomous driving, intelligent surveillance, video search and recommendation, entertainment, healthcare, and sports analysis, and so on, and the intelligence and automation level of related fields may be improved significantly.

A traditional security system may be substantially relied on basic surveillance and police reporting devices, and intelligent monitoring, real-time decision-making, and information-sharing capabilities may be lack. Therefore, growing security demands of modern households cannot be met. Systems in the art may detect only specific event types and may be unable to comprehensively monitor diverse home security incidents, such as theft, fire, or falling, resulting in insufficient monitoring coverage and inadequate protection. The systems in the art lack predictive capabilities for potential hazardous behaviors and may have a uniform response method. Differentiate processing based on event types (theft, fire, falling), such as triggering alarms, initiating conversations, or notifying the user, cannot be achieved, such that the response efficiency and effectiveness may be affected. The systems in the art may have limited information-sharing capabilities, the user may not conveniently view and manage historical records and may not efficiently share information with the family members or security service providers, resulting in poor user experience.

The embodiments disclosed herein may solve the above issues.

Specifically, the embodiments disclosed herein may be implemented using the following devices.
1. Smart Camera: The smart camera may have a high-definition video capturing capability and a night vision capability. The smart camera may monitor the environment of the house in real time and may us built-in AI (Artificial Intelligence) algorithms to recognize abnormal events and behaviors.
2. Smart Doorbell: The smart doorbell may be configured with a camera and speech interaction capability and may recognize visitors, conduct multi-round conversations, and trigger alarms or notify the user based on an instant situation.
3. Sensors: The sensors may include door/window sensors, smoke detectors, motion sensors, and so on, and may be configured to detect environmental changes and potential hazards.
4. Central Control System: The central control system may integrate data from all the smart devices and perform unified analysis, decision-making, and control on the integrated data. The central control system may interact with the user via a user application.
5. User App: The user application may be configured to receive notifications pushed from the system, view real-time surveillance videos and historical records, interact with the system, and trigger alarms when necessary.

The present disclosure may cover the following scenarios based on cooperation of information provided from the hardware devices and algorithms.
1. Home Security Monitoring: The system uses the smart cameras and the sensors to monitor an interior and surroundings of the house in real time, and recognizes potential security threats such as theft, fire, or intrusion of strangers.
2. Family Member Care: The system may detect events, such as a family member falling or a child arriving home, and may promptly notify the user to ensure safety and well-being.
3. Visitor Management: The smart doorbell may recognize and record visitor information, providing speech interaction with a visitor to assist the user in managing home visiting. For example, as shown in FIG. 4B. FIG. 4B is a schematic diagram of the method of generating an instruction for instructing performing a security response operation in the dynamic response method for the security video according to an embodiment of the present disclosure.
4. Emergency Event Processing: After detecting a high-risk event, the system triggers an alarm sound, pushes a video and information to the user, and provides a one-touch emergency police-reporting option to facilitate rapid response to an emergency situation.

As shown in FIG. 4C. FIG. 4C is a schematic diagram of user setting in the dynamic response method for the security video according to an embodiment of the present disclosure

### 1.1 User Setting and Learning:

### 1.1.1 User Setting 1-Person Register:

After connecting to the camera via the mobile phone application, the user may select a registration mode. A capturing tutorial displayed on an interface of the mobile phone may be followed, and the user may choose a person to be registered and walk for a full round in front of the camera for registration. During the above process, the system captures and records various appearance features of the person, including but not limited to: an age, a gender, a body shape, clothing, and facial features. The large model at a background analyzes and learns the features to generate a digital identity for the person. A purpose of the above process is to establish a relationship between entities in the knowledge graph (representing individuals, i.e., the aforementioned persons) and the person himself.

Once the registration is complete, the application generates corresponding person cards displaying basic information and photos of the person. The user may view and manage the cards within the application, and person detail may be updated at any time.

Based on the information input from the user and the knowledge graph, the system automatically generates a family network diagram. In the diagram, each family member is denoted as a node, and the relationship between the family members may be shown. The user may manually add or modify information of the family member to ensure accuracy and completeness of the family network diagram. Simultaneously, as the system continuously learns about additional persons during subsequent user interactions, the additional persons may be incorporated into the relevant relationship network, such that the relationship network of the user may be progressively refined.

### 1.1.2 User Setting 2-Preference Learning:

The user may set a personalized preference through speech input. By interacting with the application via speeches, the user may express demands and preferences across various scenarios.

For example, based on the knowledge graph, when a child arrives home, a notification may be pushed to parents at an upper layer in the knowledge graph, a speech prompt may be output. “Toy XX has been put away by YY”.

When expecting the courier to deliver a parcel, the doorbell may inform the courier at which location the parcel is to be placed and express gratitude to the courier. The user may need only provide speech input in the natural language to the system. The multimodal large model at the background may automatically understand and parse the instructions and execute the instructions autonomously in corresponding scenarios.

The system may automatically recommend scenario settings based on routine behaviors and habits of the user. For example, considering schedules and routines of the user, the system may suggest adjusting doorbell sound settings during a specific time period: remind the user of important tasks, or issue early warnings for potential hazards.

As shown in FIG. 4D, FIG. 4D is a schematic diagram of event recognition in the dynamic response method for the security video according to an embodiment of the present disclosure.

### 2. Event Recognition

The event recognition module automatically recognizes persons and events within videos based on real-time processing of video streams and text inputs; and generates detailed event description. An optimized process may be as follows.

### 1. Video Frame Selection:

Adaptive Dynamic Frame Extraction: After receiving a real-time video stream, an adaptive dynamic frame extraction algorithm may be applied to extract a key frame, which optimally represents household preferences, from the video stream. 8 key frames may be selected based on contents in the video and priority defined by the user.

### 2. Feature Extraction and Fusion:

Image Feature Extraction: The selected 8 key frames may be input into a pre-trained image encoder to extract image features from each of the 8 key frames, so as to generate eight 4096-dimensional image feature vectors.

Text Feature Extraction: A predefined question text (such as “Based on contents of the video frame, determine who appears in the video and what the person is currently doing?”) into a text encoder. Each character may be converted into a 4096-dimensional text feature vector, so as to generate twenty 4096-dimensional text feature vectors.

Feature concatenation: The image feature vectors and the text feature vectors may be concatenated to form thirty eight 4096-dimensional combined feature vectors.

### 3. Event Recognition and Labeling:

Large Language Model Processing: The combined feature vectors may be input into a large language model for processing. The large language model combines the image features and the text features to output identities of persons appearing in the video and events happening in the video.

Event Description Generation: Detailed event description may be generated based on information output by the large language model. The detailed event description may include contents of the event, persons involved in the event, and a time point at which the event happens.

Time and Person Labeling: The time point at which each event happens and each person involved in each event may be clearly labeled in the generated event description, enabling the user to intuitively understand details of the event.

### 4. Intelligent Filtering and Classification:

Filtering based on Event Priority: Events may be intelligently filtered and classified based on an urgency level of each event and user preference, and an important event may be pushed, in priority; to the user. Events of interest may be pushed, in priority; to the user, whereas events that the user is not concerned about may be pushed less.

Urgency Level: The urgency level for each event may be determined by systemic assessment and user setting.

### 5. User Feedback and Adaptive Adjustment:

Feedback Mechanism: The user may provide feedback on the video recognition result, such as labeling a mis-recognition or supplementing event information. The system continuously optimizes event recognition algorithms based on the feedback from the user. For example, the system may refine a parcel theft detection algorithm or may receive supplement for family member detail. The system further optimizes user determination of the video recognition result, learns a usage pattern of the user. In this way: accuracy of recognition may be improved.

Adaptive Adjustment: The system adaptively adjusts parameters for the event recognition and for filtering based on a priority level, based on the feedback from the user and the usage pattern of the user, so as to better meet user demands.

As shown in FIG. 4E. FIG. 4E is a schematic diagram of behavior prediction in the dynamic response method for the security video according to an embodiment of the present disclosure.

### 3. Behavior Prediction

### 3.1 Hazardous Behavior Prediction

1. Real-time Event Recognition and Hazard Severity Assessment: By integrating real-time event recognition from the block 1, the system may recognize who, where, and what occurred. The large model evaluates hazard severity of the event based on common sense and predicts a probability of a hazardous event happening based on a next state of a person in the video. When the predicted probability P reaches a threshold t defined by the system, the system may send signals to a decision-execution layer to enable a device to prevent the hazardous event from happening.

2. Threshold Setting and Adaptive Adjustment: The user may set a level corresponding to the threshold t (such as a high level, a medium level, a low level) via an application or voice control. Simultaneously, the system adaptively adjusts the threshold based on user satisfaction and feedback in regard to the event behavior prediction, such that prediction accuracy may be improved.

### 3.2 User Behavior Prediction

1. Routine Behavior Analysis and Pattern Recognition: The system may analyze a routine behavior of the user to recognize a behavior pattern of the user and to predict a next action of the user. The prediction may be applied in various scenarios, including smart home control and health monitoring. For example, after analyzing a routine behavior of an elderly user, the system recognizes that the elderly user needs to take medication timely and may send a reminder at specific time points.

2. Customized Recommendation and Optimization: The system may provide customized recommendation based on the behavior prediction. Some examples are as follows.

Health Management: The system may recommend a healthy lifestyle and meal plans based on exercise and dietary habits of the user, and may remind the user to take medical check-up regularly.

Smart Home Control: The system may automatically adjust lighting, temperatures, and security settings, by learning the routine behavior of the user. For example, when the system predicts that the user goes to bed at 10 PM daily, the system may turn down lights at 9:45 PM, adjust a room temperature, and ensure that all doors and windows are locked.

Departure Planning: The system may intelligently plan a departure route and departure time based on the routine behavior of the user and a calendar schedule and may notify the user when to depart to avoid traffic congestion.

3. Mental Care for the User: By continuously monitoring the behavior of the user and analyzing social interactions and emotional fluctuations of the user, the system may proactively recognize mental health issues such as depression or anxiety, and may provide psychological comfort measures for the user.

As shown in FIG. 4F. FIG. 4F is a schematic diagram of decision execution in the dynamic response method for the security video according to an embodiment of the present disclosure.

### 4. Decision Execution

1. Firstly: the recognized behavior and the predetermined user preference may be input into the large language model. The large language model may output, based on demands of the user and a risk level of the behavior, appropriate actions such as “Alarming.” “Conversation.” and “Pushing”. Some examples are as follows.

When an event at a high risk level, such as parcel theft, is detected, an alerting mode may be activated.

When a stranger coming for visiting is detected, a conversation mode may be activated.

When a family member falling or a child returning home is detected, a pushing mode may be activated.

2. The system may perform following specific actions, based on an execution mode output by the large language model.

When the system enters the conversation mode, the doorbell may emit a speech prompt: “May I assist you”? The system may have multi-round conversations with the visitor until the visitor leaves. Conversation summaries may be pushed to the app of the user, enabling the user to review information of the visitor and records of the conversation.

When the system enters the alarming mode, the doorbell, the cameras, and other audio-enabled devices may emit an alarm sound to expel suspicious persons. Simultaneously: the system may push a recorded video stream and a recognized dangerous behavior to the user. The user may receive a one-touch police-reporting option to quickly contact the police or security personnel.

When the system enters the pushing mode, the system may push the recorded video stream and the recognized behavior to the user. The user may view, in real time, contents of the video via the application to understand specific situations. For example, the user may see the family member falling and may take necessary actions promptly, or monitor the child returning home to ensure safety of the child.

3. The system may continuously optimize following aspects during execution.

Behavior recognition accuracy: The system may continuously update and train the model, so as to enhance the accuracy in the behavior recognition.

User Preference Setting: The system may adjust and optimize, based on the feedback from the user and an actual usage pattern, predetermined preferences, such as the threshold and restrictions.

Multi-round Conversations: The system may improve interactive experience in the conversation mode, so as to enable the conversation to be more natural and fluid.

Alarm response: An alarm response speed and accuracy in the alarming mode may be improved,

ensuring the user to receive prompt assistance in urgent situations.

The user may provide feedback via the application, and the system may continuously refine and optimize various functions based on the feedback to provide a safer and smarter usage experience for the user.

As shown in FIG. 4G. FIG. 4G is a schematic diagram of information sharing in the dynamic response method for the security video according to an embodiment of the present disclosure.

### 5. Information Sharing

### 5.1 Internal Family Information Sharing

1. Family Member State Sharing: Real-time Updating: The system may track a location and a state of each family member in real time, such as whether the family member is at home or away. One family member may the state of another family member via the application to be informed about details of the another family member.

Event Notification: When the system detects a critical event (such as the child returning home, the elderly person falling), the system immediately notifies all relevant family members to ensure the all relevant family members to be informed of prompt information.

### 2. Health and Activity Reminding:

Health Monitoring: By analyzing health data of the family member (such as a step count, a heart rate), the system generates a health report and provides customized recommendation. For example, the system may remind the elderly person to take medication on time or remind parents about exercises of the child. Activity Planning: The system may provide, based on a schedule and the behavior pattern of each family member, an activity reminder and a planning suggestion. For example, the system may remind the parents about pick-up/drop-off times based on study schedules of the child.

### 5.2 Community Security Information Sharing

### 1. Event Notification and Cooperation;

Emergency Event Notification: When an emergency occurs in a household within a community (such as parcel theft, vehicle theft), the system rapidly notifies all relevant families and community security persons via a short message, an app notification, and so on, so as to ensure a response measure to be taken in time.

Event Cooperation; The system shares detailed information of the security event (such as a suspect photo and video) to all households and surveillance systems within the community. In this way: all households may remain vigilant, and the security persons may be assisted in tracking and catching the suspect.

### 2. Information Sharing Platform:

Security Information Sharing: A resident may upload and share security-related information through the system, such as witnessed suspicious activities or theft incidents. The system may consolidate the information and notifies other residents in the community: so as to generate a cooperative protection mechanism.

Cooperative Prevention: When the resident uploads information (such as observing a suspicious individual), the system automatically pushes the information to other cameras and surveillance devices within the community. In this way, cooperative monitoring across the entire region may be achieved, increasing a success rate of catching the suspicious individual.

### 3. Intelligent Early Warning System:

Early Warning Mechanism: The system establishes an intelligent early warning mechanism based on historical event data within the community. Monitoring may be focusing on High-risk regions and time periods, and advance alarms may be provided, reminding the residents to stay vigilant.

Automatic Response: After recognizing a potential security threat, the system may automatically trigger a corresponding countermeasure, such as locking a main gate, activating an alarm, or notifying a security person, such that safety risks may be minimized.

It should be noted that, in addition to the above disclosure, the present embodiment may further includes technical features described in the preceding embodiments to achieve the technical effects of the dynamic response method for the security video as illustrated. Specific details may be referred to the preceding description. For brevity: the description is not repeated herein.

The dynamic response method based on the security video provided by the embodiments of the present disclosure is integrated with the event recognition capability. Compared to a traditional system that can recognize only one event, in the present embodiments, a plurality of sensors and intelligent cameras are provided, combined with advanced AI algorithms, so as to comprehensively recognize various home security events, including theft, fire, falling, and so on, such that broader security protection may be provided. The method of the present disclosure is integrated with an intelligent behavior prediction and decision-making capability; In the present disclosure, the large language model may be introduced for performing the behavior prediction, enabling early warning of potential hazards. Intelligent decisions and responses, such as triggering alarms, initiating conversations, or notifying the user, may be made based on event types. In this way, a responding efficiency and effectiveness of the system may be improved. The method of the present disclosure is integrated with an efficient information sharing capability. The system has the powerful information sharing capability. The user may conveniently view and manage real-time surveillance videos and historical records via the application, and may efficiently share information with other family members or the security service provider. The usage experience and the information processing capability may be improved. The method of the present disclosure is integrated with an LLM-based behavior prediction and decision execution capability. The large language model may be used to perform intelligent behavior prediction and decision execution on home security events. The system dynamically adjusts, based on the user preference and the detected event, the response mode (such as the alarming mode, the conversation mode, the notification pushing mode), conducts conversation with the user, uses the application of the mobile phone, provides feedback including “thumbs up/down.” being gentle with the child, providing normal owner interaction, or providing aggressive responses. In this way, flexibility and intelligence of the system may be improved. The method of the present disclosure is integrated with an intelligent information sharing and management capability. The central control system and the user application may enable more efficient information sharing and management. The user may view, in real time, the surveillance video, receive event notifications, manage historical records, and share information with family members or the security service provider, such that usage convenience and system cooperation may be improved.

As shown in FIG. 5E. FIG. 5E is a flow chart of the object behavior recognition method according to an embodiment of the present disclosure. The flow chart in FIG. 5E describes how the predetermined starting point and the predetermined endpoint are set and how the target object is recognized, by taking “returning home” behavior as the target behavior type as an example. As shown in FIG. 5E, the process may include the following blocks.

### 1. User Assistance—Home Door Localization Strategy Based on Returning-Home Path

The user may draw a returning-home path to assist an algorithm in locating a position of a home door. An application interface of the mobile phone may display the field of view of an outdoor overhead camera. The user first selects the starting point of the returning-home path within the displayed field of view, then double-clicks the screen to bring up a character avatar, which automatically retrieves a profile picture of an account of the application. Finally, the user drags the avatar to draw any path AB representing the returning-home path. A point A is the starting point and a point B is the endpoint. The above process is performed during a user setting phase. After completing the drawing, a background of the application records two parameters for the algorithmic to determine the home returning behavior at a subsequent stage.

(1) An essential length of the returning-home path may be recorded and may be a linear segment distance |AB| between the point A and the point B.

(2) An approximate position of the home door, i.e., the point B, may be recorded.

### 2. Home-Returning Behavior Recognition Algorithm Based on Trajectory Feature And Home Door Position

When the camera detects a movement event, determination of the home-returning behavior may be performed, as follows.

### 2.1 Visitor ID Recognition:

The algorithm first extracts human related features of a detected person, such as the face of the detected person, a posture of the detected person, and clothing of the detected person, so as to identify the ID information of the detected person. When an ID recognition result indicates that the detected person is a stranger, a process of the visitor id recognition is terminated. When the ID recognition result determines that the detected person is the family member set for protection in the mobile phone of the user, the algorithm may further determine whether the detected person is performing the home-returning behavior.

### 2.2. Extracting Complete Trajectory of Visitor:

Considering that a graph neural network has advantages in recognizing relationships between various nodes in an image and in modeling image spatial information, a spatial-temporal convolutional network (ST-TCN) model may be arranged in the present disclosure to capture spatial-temporal features in a video sequence, so as to model a movement and a trajectory of the visitor. Since recognizing the home returning behavior may be a relatively simple scenario, an edge weight may be eliminated in the model in the present disclosure, such that the number of parameters may be reduced by half, and complexity of the model may be effectively reduced. In a case that the algorithm uses the ST-TCN model to extract a trajectory segment A1B1 of the visitor from the field of view of the camera, a point AI may be a point at which the trajectory appears, a point B1 may be a point at which the trajectory disappears, and a distance between the point AI and the point B1 may be |A1B1|.

2.3 Trajectory Feature Analysis:

When setting features for the home-returning behavior, the user may provide reference information to the algorithm, the point B may be the position of the home door (the home door is visible within the field of view of the camera) or a position near the home door (the home door is not visible within the field of view of the camera), and the |AB| may be an essential length of the returning-home path. According to the reference information, the algorithm may analyze the following two aspects.

(1) The algorithm may analyze whether the trajectory originates from a distant location to reach the position of the home door (a process feature of the trajectory).

In the algorithm, a circle B is defined, where the point B may be taken as a center of the circle B, and the |AB| may be taken as a radius of the circle B. When the trajectory starts from any point on a circumference of the circle and reaches the center B, it may be determined that the trajectory originates from a distant location to reach the position of the home door. Therefore, in this case, the algorithm only needs to determine whether |A1B1|≥|AB|. When |A1B1|≥|AB|, the trajectory may be determined as originating from the distant location to reach the position of the home door.

The above feature represents a first feature of home-returning behavior. An advantage of the above feature is that events where the user temporarily perform activities, paces, lingers, or plays near the home door or in a front yard region before entering the house may be filtered out. For the above events, although the endpoint may be at the position of the home door (assuming a trajectory of A2B2), the trajectory A2B2 does not originate from the distant location approaching the home door, and that is. |A2B2|<|AB|. Therefore, the algorithm may not determine the above events by mistake.

(2) The algorithm may analyze whether the endpoint of the trajectory reaches the position of the home door (a result feature of the trajectory).

The position of the home door may be provided by the user via drawing the returning-home path. The algorithm determines whether a distance between the point AI and the point B1 is less than a threshold, i.e., determining whether |B1B|≤the threshold, so as to determine whether a disappearance point B1 of the trajectory (A1B1) is at the position B of the home door. When |B1B|≤the threshold, the endpoint of the trajectory may be determined as reaching the position of the home door.

The threshold may be calculated as follows. The algorithm uses the ST-TCN model as described in the section 2.2 to extract trajectories of the user within one week. The disappearance point of each trajectory may be denoted as Bn. A maximum value of the Bn and the B1 may be taken: the threshold=|Bn−B1|max. The above feature serves as a second feature of home-returning behavior. An advantage thereof is that the user does not need to define a standard returning-home path. The object behavior recognition in the art may have the following defect. When the user selects a returning-home path that is different from previous returning-home paths, the algorithm may fail. By contrast, in the present disclosure, it may be focused solely on whether the path of the user reaches the position of the home door, how the path extends to reach the position of the home door may not be considered. Therefore, even when the user changes the path from the front yard to the position of the home door, the algorithm remains functional as the algorithm does not rely on a single and fixed returning-home path.

### 2.4 Result Determination:

When all of the following conditions are met simultaneously: the ID of the detected person is the registered family member. |A1B1|≥|AB|, and |B1B|≤the threshold, the event may be determined as the family member returning home. Specifically, when the family member travels from any point on the circumference (or outside) of the circle B to the center of the circle B via any trajectory, the event may be determined as the family member returning home.

### 3. Notification Pushing:

### 3.1. In A Case That the Registered Family Member Fails Returning Home on Time

The user may set a “latest home returning time point” for each family member. When the system fails to detect the event of home returning before the latest home returning time point, the system may push a notification via the application to the user. In this way, a household may be notified about a home-returning state for the family member, and an early warning for potential contingency planning may be provided.

### 3.2 In A Case That A Child Is Detected Returning Home:

For an event of the child returning home, the system may recognize whether the child is accompanied by an adult and whether any stranger is following the child. When determining presence of the stranger following the child, the system may send alert information to the predetermined terminal.

The technical solution provided by the embodiments of the present disclosure may achieve the following advantages.
1. The home returning behavior may be determined based on a pure visual algorithm and may be determined independent of mobile device locating/GPS locating or any public infrastructure. Recognition of the home returning behavior may not be affected by a power of the mobile device, signal strength, or data connectivity.
2. The identity of the detected person may be recognized based on fusion of the facial feature and the body shape feature, so as to improve recognition accuracy.
3. Determining whether the person is “returning home” may be made by analyzing whether the trajectory progressively approaches the position of the home door. In this way: false determination, which is caused by the family member moving within the front yard or lingering before re-entering the house, may be effectively reduced.
4. Determining whether the person is “arriving home” may be made by analyzing whether the trajectory reaches the position of the home door. The home returning behavior may be determined without relying on a fixed returning-home trajectory: Therefore, failure to recognize the home returning behavior, caused by the user changing a usual returning-home path, may be prevented.

As shown in FIG. 5D. FIG. 5D is a structural schematic view of an object behavior recognition system according to an embodiment of the present disclosure. As shown in FIG. 5D, the object behavior recognition system 120 may include: a camera module 121, a base station 122, a terminal 123, a target object 124, and a predetermined region 125.

The camera module 121 may be a camera or any other device having an image capturing capability, such as a security camera or a doorbell camera, which is not limited herein. The camera module 121 may be configured to capture images for the predetermined region 125 and may be installed either within or outside the predetermined region, which is not limited herein.

The base station 122 may serve as a control hub, a communication hub, or a data processing hub that is communicating with the terminal 123, the camera module 121, and other home appliances (such as a cleaning robot). In an embodiment, the camera may determine the target behavior type locally at the camera end, and then the base station 122 may transmit the captured images to the terminal 123. Alternatively, the captured images may be transmitted to the base station 122, and the base station 122 recognizes the target behavior type and then transmits the captured images to the terminal 123.

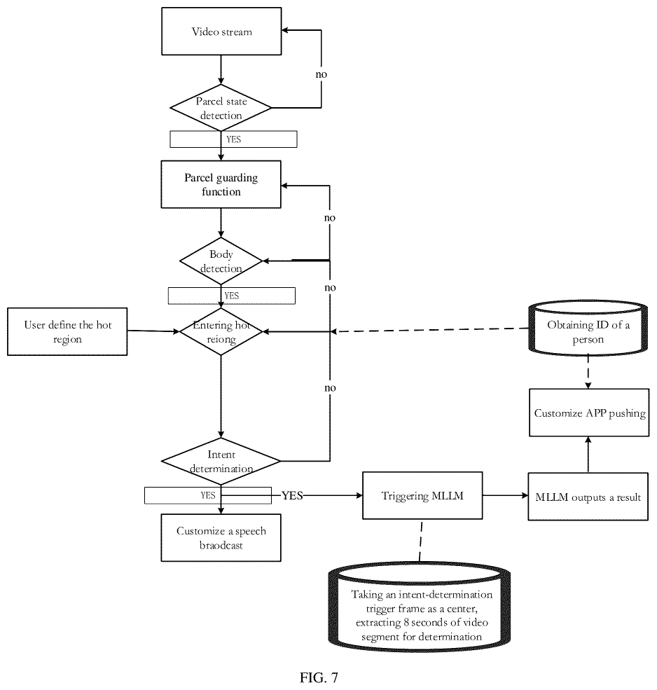

The terminal 123 may be a PC terminal or a mobile phone terminal, which is not limited herein. Furthermore, the terminal 123 may be installed with a corresponding application to set the predetermined starting point and the predetermined endpoint for the behavior corresponding to target behavior type in the method shown in FIGS. 7 and 10

In an embodiment, both the camera module 121 and the base station 122 may serve as the subject for performing the object behavior recognition method illustrated in FIGS. 2 to 13, so as to recognize a current behavior of the target object 124 within the predetermined region 125.

In an embodiment, the terminal 123 may serve as the subject for performing implement the behavior recognition setting method illustrated in FIGS. 7 and 10.

Accordingly: when the object behavior recognition system 120 is recognizing the behavior of the target object, the user may set, via an interface of the application installed in the terminal 123, the starting point and the endpoint of the movement for the behavior corresponding to the target behavior type.

In an embodiment, the terminal 123 may obtain a captured image for the predetermined region captured by the camera module 121 and display the captured image on a first page. The user may obtain the predetermined icon by clicking the captured image. For example, the user may double-click the terminal 123 to outputs a profile picture of an account that the user currently logs in.

Subsequently, the user may set the aforementioned starting point and the endpoint by moving or clicking the icon. Accordingly, the terminal 123 determines the predetermined starting point and the predetermined endpoint according to the clicking or moving performed by the user.

In an embodiment, the terminal 123 determines the distance threshold corresponding to the target behavior type based on the predetermined starting point and the predetermined endpoint and may send the distance threshold and the predetermined endpoint of the movement to the camera module 121 or the base station 122. In this way, the camera module 121 or the base station 122 may recognize, by following the method shown in FIG. 2, whether the current behavior of the target object belongs to the target behavior type based on the distance threshold and the predetermined endpoint of the movement

In another embodiment, the terminal 123 may directly transmit the predetermined starting point and the predetermined endpoint to the camera module 121 or the base station 122. In this way, the camera module 121 or the base station 122 may recognize, by following the method shown in FIG. 13, whether the current behavior of the target object belongs to the target behavior type based on the predetermined starting point and the predetermined endpoint.

In some embodiments the application installed on the aforementioned terminal 123 may further include a second page. The user may set the to-be-recognized target object based on the second page. After determining the target object, the terminal 123 transmits the object features of the target object to the camera module 121 or the base station 122. In this way, the camera module 121 or the base station 122 may recognize whether a detected object is the target object based on the object features. When the target object is detected, the camera module 121 or the base station 122 may recognize whether the current behavior of the target object belongs to the target behavior type.

In some embodiments, the application installed on the terminal 123 may further include a third page. When the object behavior recognition system 120 includes additional camera modules, the user may select, via the third page, the target camera module for recognizing the object. For example, the third page may output all camera modules included in the object behavior recognition system 120. Accordingly, the user may select the target camera module from the all camera modules. After receiving selection performed by the user, the terminal 123 may send a corresponding signal to the target camera module to enable the target camera module to perform the object behavior recognition method shown in FIGS. 2 to 13.

In some embodiments, the application installed on the terminal 123 may further include a fourth page. The user may input a target video through the fourth page. The target video captures a movement process of the predetermined object performing the behavior corresponding to the target behavior type. Accordingly, the terminal 123 may recognize the target video to determine the predetermined starting point and the predetermined endpoint corresponding to the target behavior type.

Furthermore, for a scenario of an inside of the house, the user may purchase a plurality of cameras (corresponding to the aforementioned security devices) to perform comprehensive monitoring for every corner of the house. Currently: a camera device may initiate recording and artificial intelligence (AI) detection tracking only when a target (i.e., the aforementioned target object) enters an observation region of the camera devices (i.e., the aforementioned monitoring region). Due to the field of view of the camera being limited (especially for a telephoto camera), an entire process from appearance to disappearance of the target cannot be fully captured. Therefore, missed recording and delayed triggering may be caused, resulting in incomplete and discontinuous recording of an event, and the target cannot be comprehensively observed from a plurality of angles.

Accordingly, in the present embodiments, user scene 3D modeling (i.e., the aforementioned three-dimensional model) may be performed based on three-dimensional (3D) videos of the house that is captured by the user, and a location of each camera may be labeled (i.e., the aforementioned first mapping pose and the second mapping pose). Coordinated camera recording may be achieved based on 3d basic maps and the location of each camera, enabling more intelligent camera cooperation for the target scene and providing more comprehensive security protection.

In related art, determination of the location (i.e., the aforementioned first mapping pose and second mapping pose) of the camera (i.e., the aforementioned security device) within a house model (i.e., the aforementioned three-dimensional model of the building) based on video modeling may not be performed, and determination of locations of other cameras based on a mutual relationship between cameras may not be performed.

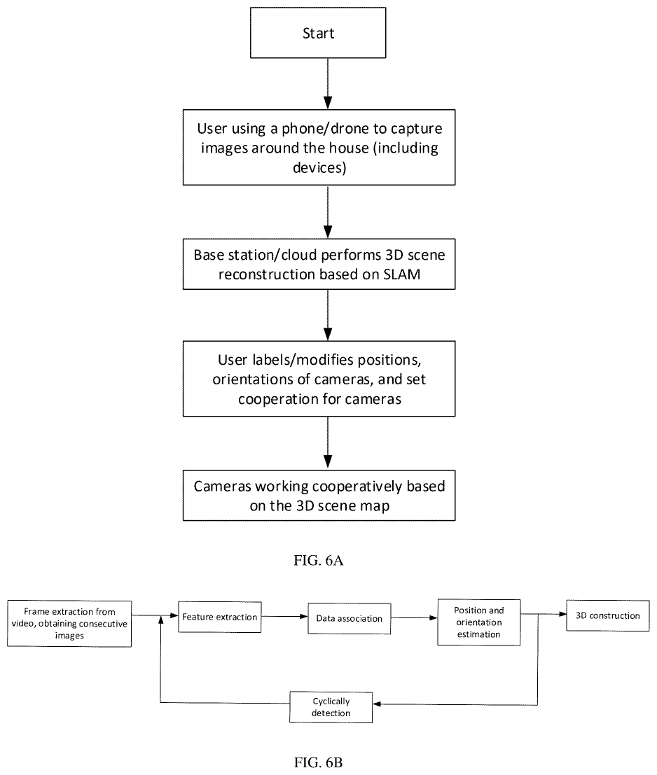

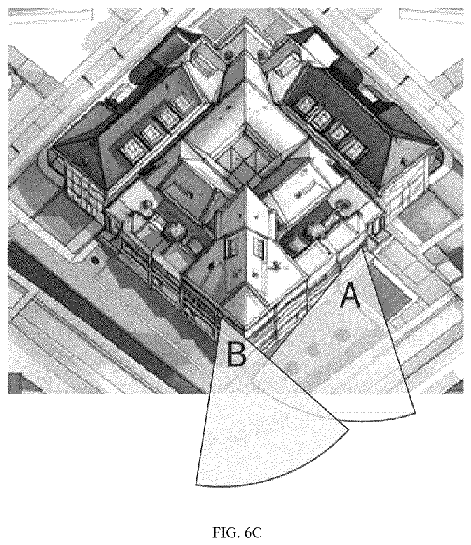

Specifically, as shown in FIG. 6A. FIG. 6A is a flow chart of a cross-device cooperation surveillance operation method according to an embodiment of the present disclosure

The present disclosure includes the following blocks.

1. The user may be guided to capture a video around the house (i.e., the aforementioned building) and the installation location of each device (i.e., the aforementioned first security device and the second security device) to comprehensively capture a home environment of the user.

2. 3D reconstruction of the user scene may be achieved based on SLAM or any other 3D reconstruction technology. Video data may be input, feature extraction, correlation, and pose estimation may be performed for coordinate system transformation to establish a three-dimensional model, i.e., the aforementioned three-dimensional model.

A process of 3D mapping (i.e., constructing the aforementioned three-dimensional model) may be illustrated in FIG. 6B.

3. The user manually marks and adjusts, through the interface of the application of the mobile phone, the installation location and the orientation (i.e., the first mapping pose and the second mapping pose) of each device (i.e., the first security device and second security device) within the 3D model. The orientation may be obtained from sensors of the camera to determine a relative position and angular information (i.e., the first mapping pose and the second mapping pose) of each device.

4. Detection, tracking paths (i.e., the aforementioned movement trajectory), and other information may be mapped onto the 3D model. Internal parameters and distortion parameters of each camera may be known. External parameters of each camera may be determined based on user calibration. A point in a camera coordinate system may be transformed, based on the pose of the camera (a rotation matrix and a translation vector), into a spatial coordinate system.

Specifically, the following Equation 1 may be used to convert image coordinates (u, v) to camera coordinates (Xc, Yc, Zc, 1):

$$[ \begin{matrix}{X}_{c} \\ {Y}_{c} \\ {Z}_{c} \\ 1\end{matrix} ] = K [ \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z} \\ 0 & 0 & 0 & 1\end{matrix} ] [ \begin{matrix}u \\ v \\ 1 \\ 1\end{matrix} ] \qquad Equation I$$

In the above Equation 1, the K denotes an internal parameter matrix of the camera. The

$$[ \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z} \\ 0 & 0 & 0 & 1\end{matrix} ]$$

denotes an extrinsic parameter matrix of the camera and is configured to describe a position and an orientation of the camera in a world coordinate system (also known as the spatial coordinate system). The position and the orientation of the camera in the world coordinate system may be determined by the rotation matrix

$$[ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ]$$

and the translation vector (tx, ty, tz).

Each of the r11, the r21, the r31, the r12, the r22, the r32, the r13, the r23, and the r33 may represent a matrix element in the rotation matrix. For example, one camera is rotated and translated relative to the world coordinate system in a three-dimensional space. When the camera rotates about an X-axis for an angle θ, a corresponding rotation matrix may be

$$[ \begin{matrix}1 & 0 & 0 \\ 0 & cos θ & - sin θ \\ 0 & sin θ & cos θ\end{matrix} ] .$$

When the camera rotates about a Y-axis for an angle Ø, the corresponding rotation matrix may be

$$[ \begin{matrix}cos ϕ & 0 & sin ϕ \\ 0 & 1 & 0 \\ - sin ϕ & 0 & cos ϕ\end{matrix} ] .$$

When the camera rotates about a Z-axis for an angle ψ, a corresponding rotation matrix may be

$$[ \begin{matrix}cos ψ & - sin ψ & 0 \\ sin ψ & cos ψ & 0 \\ 0 & 0 & 1\end{matrix} ] .$$

Each of the tx, the ty, and the tz may represent a respective vector element of the translation vector. The tx denotes a unit length that the camera is translated along the X-direction. The ty denotes a unit length that the camera is translated along the Y-direction. The tz denotes a unit length that the camera is translated along the Z-direction.

Subsequently; the Equation II in the following may be used to transform camera coordinates (Xc, Yc, Zc, 1) into spatial coordinates (Xw, Yw, Zw, 1)

$$[ \begin{matrix}{X}_{w} \\ {Y}_{w} \\ {Z}_{w} \\ 1\end{matrix} ] = [ \begin{matrix}{r}_{11} & {r}_{21} & {r}_{31} & {t}_{x} \\ {r}_{12} & {r}_{22} & {r}_{32} & {t}_{y} \\ {r}_{13} & {r}_{23} & {r}_{33} & {t}_{z} \\ 0 & 0 & 0 & 1\end{matrix} ] [ \begin{matrix}{X}_{c} \\ {Y}_{c} \\ {Z}_{c} \\ 1\end{matrix} ] \qquad Equation II$$

Identical parameters (symbols) in the Equation 2 and in the Equation 1 may denote the same meaning and will not be repeated here.

5. The common field of view may be automatically determined (i.e., the aforementioned overlapping region), a walking path pattern of the user may be captured, and cooperation across devices may be performed automatically.

After the 3D model is established and the position and the orientation of each camera are marked within the 3D model, an inter-camera relationship may be established by calculating a distance and a viewing angle between cameras. When two cameras have the common field of view, the inter-camera relationship between the two cameras may be established. As shown in FIG. 6C, a field of view (when viewed from above) and a visible distance (assuming that a clear human shape can be recognized at 15 m) of a camera A may be determined. It may be calculated, based on a relative position of the camera A and a camera B, whether visible sectors of the two cameras has an overlapping region, so as to determine whether cooperation is feasible.

It should be noted that, in addition to the above-described content, the present embodiment may further include technical features described in the preceding embodiments to achieve the technical effects of the cross-device cooperation monitoring operation method illustrated above. Specific details may be referred to the preceding descriptions. For brevity, the details will not be repeated herein.

For the cross-device cooperation monitoring operation method provided by the embodiments of the present disclosure, the 3D model of the home environment of the user may be constructed based on the video captured by the user. The mapping pose of each device onto the 3D model may be determined. By integrating the positional information from the 3D model, more effective cooperation among the plurality of devices may be achieved, such that enhanced user experience may be achieved.

Before introducing a method for recognizing a theft intent, concepts relevant to the embodiments of the present disclosure are explained as follows.

An “Edge computing+smart terminal” model (hereinafter referred to as “edge+terminal”) refers to using both computing resources at a network edge and a local processing capability of a smart device. The “edge+terminal” mode may aim to improve a data processing speed, reduce network bandwidth requirements, and enhance system real-time performance and reliability: such that user experience may be improved. The edge computing may be a network architecture that shifts data processing from a data center to the network edge that is closer to a data source. In this way: latency may be reduced, bandwidth consumption may be reduced, reliability may be improved, and privacy protection may be improved. The smart terminal refers to a device having computing power, a storage capacity, and network connectivity. The smart terminal may perform local data processing, provide customized services, and support offline operations.

An object detection algorithm may be an algorithm in computer vision to recognize and localize a specific target (such as a person, a vehicle, an object) within an image. The algorithm may determine a location of the target (typically by drawing a rectangular box or a box in a more complex shape) and may perform classification on the target.

Determining the intent refers to enabling a computer system to understand and recognize a purpose or a goal of languages or actions of a user.

The LLM may be an artificial intelligence model configured to understand and generate a human language. The LLM may be trained based on a large amount of text data, and may perform a wide range of tasks including text summarization, translation, sentiment analysis, and so on. The LLM may be in a massive scale, typically including billions of parameters.

The MLLM combines language comprehension of the LLM with an ability of understanding other modality information, so as to comprehend and generate a content involving a plurality of types of data. The “modality” refers to various types of input data, such as texts, images, audios, and videos. By training based on massive data, the MLLM may learn complementarity and correlation between various modalities.

The convolutional neural network (CNN) may be a deep learning architecture that is widely applied in visual computing tasks, such as image and video recognition, image classification, object detection, facial recognition, and medical image analysis. The CNN may be a feedforward neural network having a convolutional structure and may extract complex features from images to be used in recognition tasks of various patterns.

Object-verse detection (OVOD) may be an object detection technique, enabling a model to detect and recognize a novel object category that is not encountered during training. For a traditional detection method, the training data may need to include all to-be-detected object categories, whereas the OVOD may achieve generalized target detection.

In the present disclosure, by understanding video surveillance data, security monitoring and crime prediction in the home environment may be improved, private properties of the user may be protected. The method may be performed by the following devices.
1. Smart cameras: Smart cameras may be installed inside or around the house to monitor and record videos in real time. The smart cameras may have high resolution and wide-angle views to cover major activity regions of the house. In the present disclosure, the smart cameras may collect target images and the first security video.
2. Edge computing device: The edge computing device may process video data (including the target images and the first security video) obtained from the smart cameras. The edge computing device may have a computing capability to perform real-time customized target property detection and human shape detection. The edge computing device may include a microphone and audio-visual components to expel any threat against the properties and to play welcoming messages to family members or whitelisted persons. In the present disclosure, the edge computing device may serve as the subject or a part of the subject for performing the aforementioned method for recognizing the theft intent.
3. Home Smart Control System: The home smart control system may serve as a computing center and an intelligence center and may be arranged with a high-performance computing chip to establish a plurality of video streams and to perform real-time processing on behaviors in the plurality of video streams. In the embodiments of the present disclosure, the home smart control system may serve as a second device in the aforementioned method for recognizing the theft intent.
4. Mobile Device (such as a smart phone and a tablet computer): The user may customize, via the mobile device, setting for assets in the home environment that needs protection. The user may provide feedback on behavior recognition learned by the system. The system may perform iterate self-learning based on setting customized by the user. When the system detects asset-threatening behavior, the smart device may push notifications or directly trigger police reporting services. In the embodiments of the present disclosure, the mobile device may serve as the predetermined terminal for performing the aforementioned method for 20) recognizing the theft intent.

The embodiments of the present disclosure may be applied in the following scenarios.

Home Security Monitoring: The smart cameras continuously monitor the home environment. The edge computing device may recognize the theft intent based on an alert region (i.e., the aforementioned predetermined region) defined by the user and the whitelists (i.e., the aforementioned collection of the personal information). For example, when a stranger (i.e., the aforementioned target person) is detected approaching and performing an abnormal behavior (e.g., stealing a parcel, picking a car lock), the system rapidly recognizes the intent, immediately triggers an expulsion alarm, and notifies the user.

Smart Home Appliance Cooperation; The edge computing device may process, based on the video information captured by the cameras of the house, the video streams in real time and responds promptly to simple situations. For example, when the family member enters a hot region (i.e., the predetermined region), the device may instantly recognizes the presence and plays a speech of “Welcome home”.

For complex situations, the central control system may use the LLM and more intricate logic to perform centralized computing. For example, when the edge computing device detects a stranger entering the hot region and performing an action indicative of potential theft, the edge computing device transmits relevant video frames (i.e., the aforementioned associated video frame sequence) to the central control system for further analysis, such that prediction accuracy may be improved.

Specifically, the embodiments of the present disclosure may include the following blocks.

### I. User Setting:

1. The user sets, in the application, the hot region (i.e., the aforementioned predetermined region) near the home door or the vehicle.
2. The user inputs physical appearance and facial features of each family member into the system and adds trusted relatives and friends and the courier to the whitelist to establish the collection of personnel information.
3. The user adds persons requiring vigilance or having prior misconduct records to a blacklist. An alarm may be triggered when the person on the blacklist is detected in the video frame.
4. The user sets customized speeches, providing distinct messages for the stranger, the family member, and the courier. The speeches may be recorded by the user itself.

### II. Algorithm Logic:

As shown in FIG. 7. FIG. 7 is a flow chart of a method of recognizing a theft intent according to an embodiment of the present disclosure. As shown in FIG. 7, the method includes the following.
1. Function Triggered: The edge computing device performs parcel detection in real time. When the parcel is detected, a parcel guarding function may be activated.
2. In a phase I, the edge device performs person detection in real time and determines whether a person enters the hot region R. When it is the stranger that enters the hot region, a corresponding greeting speech may be emitted based on an ID result (the family member, the courier, the stranger, an unknown identity).
3. In a phase II, when a person enters the hot region, the system determines the intent of the person. When it is determined that the stranger has the theft intent, the system expels the stranger. When it is the family member that is detected, the system may remind the family member to take the parcel inside the house. When it is the courier that is detected, the system may remind the courier to place the parcel at a designated location. When the identity of the person is unknown, a speech of “Visitor detected. Please wait. I'm on my way” may be played.

The intent determination involves analyzing historical information of videos to assess whether the current frame indicates the theft intent. Specific implementation logic of the intent determination may include a lightweight solution 1 and a solution 2, according to computing requirements. The lightweight solution 1 may be a single frame image in combination with logic determination. The solution 2 may have higher algorithmic demands and may involve multi-frame image end-to-end achievement. Considering the lightweight nature and practicality of the intent determination of the system, the present disclosure may be described by focusing on the single-frame image in combination with logic determination. Specific blocks are as follows.
a. The user designates a hot region R0 (i.e., the aforementioned predetermined region) and records a current state of the parcel (i.e., the target object) as Z0 (i.e., the first state information).
b. Parcel detection may be performed on a real-time video stream. When a bbox parcel (i.e., the first detection box) of the parcel is detected. P0 may be recorded.
c. Human detection may be performed on the real-time video stream. When a bbox_person (i.e., the second detection box) of a person is detected. P1 may be recorded.
d. An overlapping region (IOU) between the P0 and the P1 may be determined and recorded as Q (i.e., the extent of overlapping). When both the person and the parcel are within the hot region R and the Q exceeds Q0 (i.e., the predetermined threshold), key action determination may be performed on the P1. When the P1 matches a key action, where the key action for stealing the parcel may be defined as bending over (i.e., the theft behavior), it may be determined that the person has the theft intent. In the entire system, key frame extraction may be performed based on a frame containing the P1 (i.e., the target image) and both historical and future video frames (i.e., the associated video frame sequence). Consecutive frames (i.e., the associated video frame sequence) may be fed into the multimodal large model for determining a continuous behavior sequence.
c. At last, final determination (i.e., the theft determination information) may be made based on the parcel state Z1 (i.e., the second state information) and a result of the multimodal large model (i.e., the initial theft determination information). When the state of the parcel changes (for example, a state indicated by the first state information differs from a state indicated by the second state information) and the large model determines presence of the theft behavior, it may be determined that the theft behavior is performed.

Taking the parcel as an example, the above technical solution may be extended to protecting any property (i.e., the target article mentioned above). Specific blocks are as follows.
a. The user specifics a hot region RA0 (i.e., the predetermined region) and records a current state of a property requiring protection as ZA0 (i.e., the first state information).
b. Any property detection may be performed on the real-time video stream. When a bbox A of the property (i.e., the first detection box) is detected. PA0 may be recorded.
c. Human detection may be performed on the real-time video stream. When the bbox_person (i.e., the second detection box) of a person is detected. PA1 may be recorded.
d. An overlapping region (IOU) between the PA0 and the PA1 may be determined and recorded as QA (i.e., the extent of overlapping). When both the person and the property are within the hot region RA0 and the QA exceeds QA0 (i.e., the predetermined threshold), key action determination may be performed on the PA1. When the PA1 matches a key action, it may be determined that the person has the theft intent. In the entire system, key frame extraction may be performed based on a frame containing the PA1 (i.e., the target image) and both historical and future video frames (i.e., the associated video frame sequence). Consecutive frames (i.e., the associated video frame sequence) may be fed into the multimodal large model for determining a continuous behavior sequence.
c. At last, final determination (i.e., the theft determination information) may be made based on the property state ZAI (i.e., the second state information) and a result of the multimodal large model (i.e., the initial theft determination information). When the state of the property changes (for example, a state indicated by the first state information differs from a state indicated by the second state information) and the large model determines presence of the theft behavior, it may be determined that the theft behavior is performed.

4. When the intent determination in the Phase II is Yes (i.e., the final theft determination information indicates that the target person has the intent to steal the target article), a phase III may be entered. In the phase III, the multimodal large model may analyze a behavioral action of the person, a trajectory of the person, and interaction between the person and the article; and may push event information to the user, i.e., send alert information to the predetermined terminal.

5. The same logic may be applied to vehicle protection and any property protection.

### III. User Interaction

1. In a phase I, customized setting may be made corresponding to user identity. A speech of “Welcome home” may be played for the family member, and a speech of “May I help you?” to the stranger, the courier, and any person with an unknown identity.

2. In a phase II, a customized speech matching the identity may be made based on the intent determination result and the identity information. A speech of “Please collect your parcel promptly” may be played to the family member. A speech of “Place my parcel down. I'll be out shortly” may be played to the stranger. A speech of “Thank you for the delivery” may be played to the courier. A speech of “Hold on a moment. I'll be out shortly” may be played to the person with the unknown identity.

3. In a phase III, a customized pushing information may be made based on the result from the multimodal large model (i.e., the initial theft determination information), the original state of the parcel (i.e., the first state information), and a state of the parcel after a time period is terminated (i.e., the second state information). For example, for the stranger, when the parcel is present initially but disappears after a time period, a warning message stating “Your parcel has been stolen” may be pushed to the user.

It should be noted that, in addition to the content described above, the present embodiment may further include the technical features described in the preceding embodiments to achieve the technical effects of the method for recognizing the theft intent illustrated above. Specific details may be referred to the preceding description. For brevity: the specific details will not be repeated herein.

For the method for recognizing the theft intent provided in the embodiments of the present disclosure, customized setting may be performed for diverse scenarios. The user may customize, within the application, the hot region near the home door or the vehicle. The system may learn property definition and guarding regions based on the behavior pattern of the user. The system may provide customized response based on the user setting. For example, when the stranger enters the alert region and performs behaviors, such as the parcel theft or picking the vehicle lock, the system emits the speech for expulsion, performs automatic police reporting, and notifies the user. In this way, the user experience may be improved, and practicability of the system may be improved. Furthermore, in the present disclosure, real-time processing and rapid responding may be achieved. Specifically, an “edge+ terminal” computing approach may be applied, such that utilization of the computing resource may be maximized. A video classification micro-model may be used to perform a primary screening. When the micro-model determines an abnormal behavior in the current frame, the multimodal large model may be triggered to perform detailed logical determination. In this way, computing resources may be saved, the response speed may be ensured, and an efficiency and accuracy may be improved. The video stream may be analyzed and processed in real time, and information may be pushed promptly to the user. In addition, in the present disclosure, the multimodal large model may be applied. The MLLM may be pre-trained based on over billion internet images and texts, fine-tuning may be performed based on security-specific domain data. By integrating the large amount of internet knowledge with the reasoning capability of the LLM, various behavior patterns may be understood, information may be pushed precisely to the user. Based on the identity of the person approaching the camera, the customized welcoming speech may be emitted precisely. When the intent determination is triggered, the MLLM model may perform inference based on frames before and after the intent determination, so as to precisely analyze the user behavior and to push notifications customizedly. A hybrid “edge+ terminal” multi-model system is integrated with end-to-end processing of multimodal large models and video classification small models. In this way, the video streams may be processed in real time. Multi-step determination and understanding may be performed based on video contents. In this way, the information may be pushed highly precisely to the user while maintaining peak performance. In regard to unique home security demands, the AI-based “edge+ terminal” architecture solution for predicting the theft intent may be provided. The above solution deeply integrates high-precision sensors (such as the cameras, depth sensors, LiDAR), smart cameras, and deep learning algorithms. The system may continuously learn the surrounding environment, achieving precise recognition of the abnormal behavior. Furthermore. “customized security protection” may be achieved, and that is, algorithms may be optimized, and interfaces may be customized, based on a specific environment of each household. In this way: “one strategy per home” may be provided, and a “customized experience for each household” for safeguarding properties may be achieved. The “edge+ terminal” architecture may be applied. The edge computing is integrated with a real-time and highly efficient target detection algorithm to perform the intent determination, and rapid responses may be provided to human-environment interactions. Customized speech prompts may be provided to guide or expel potential actions. The intelligent terminal may be configured with the high-performance computing chip and the MLLM having the inference capability; so as to process the video stream in real time. The MLLM may have strong generalization in behavioral understanding, due to being trained based on the large amount of pre-training data. The hybrid architecture combining the CNN small models with the MLLM, such that system performance may be maximized. Furthermore, compared to CNN small models, the hybrid architecture may have significant improvements in behavior understanding accuracy: the generalization capability; and precision. By providing “Customized strategy for each home”, integrated with open vocabulary object detection (OVOD), the MLLM performing structured analysis of the behavior of each family member, and the user setting, customized protection for designated properties of each family member may be provided.

Before introducing the video frame extraction method, relevant concepts in the present disclosure are explained as follows.

Video understanding may be a branch of computer vision and artificial intelligence and aims to enable a computer to comprehend and interpret the video content like humans. The video understanding involves extracting and analyzing visual, audio, and other information from video data to recognize and understand scenes, objects, actions, events, and relationships. Tasks included in the video understanding may be: video classification, action recognition, object detection, scene segmentation, and video summarization. The video understanding may be widely applied, including: video surveillance, autonomous driving, smart home systems, and entertainment media analysis. Achieving the video understanding requires integrating complex algorithms, such as deep learning techniques, convolutional neural networks, and recurrent neural networks, so as to effectively process and parse the large amount of information in the videos.

The video understanding may rely on video frame extraction. The video frame extraction refers to a process of extracting a specific frame (static image) from the video for analysis, processing, or storage. Each video may be formed by a sequence of video frames (i.e., images), and a purpose of the video frame extraction is to select a representative or critical frame to simplify data processing or to extract important information.

The video frame extraction may be applied widely, including video content analysis, generating surveillance video thumbnails, video compression, and action recognition. For instance, in the surveillance video, the video frame extraction may enable rapid reviewing of a lengthy video, and a critical moment at which the event occurs may be extracted. During video editing, the video frame extraction simplifies processing and saves a storage space. In summary: the video frame extraction may be a crucial step in video processing and analysis. By extracting a key frame, the video information may be efficiently obtained and utilized.

After performing the video frame extraction, a behavior understanding model or a multimodal large model may be used to recognize a result of the video frame extraction.

The multimodal large model refers to the artificial intelligence model that is capable of processing and understanding a plurality of types of data, such as texts, images, audios, and videos. Unlike the traditional model that typically focuses on one modality (such as processing only texts or images), the multimodal large model integrates information from various data sources to achieve more comprehensive and accurate understanding and decision-making. An essence of the multimodal large model is to fuse data of the various modalities based on deep learning, particularly based on neural networks.

The multimodal large model is widely applied, including generating texts and images and description, for example, textual description for an image may be generated, or an image may be generated based on a text. The multimodal large model may be applied in multimedia search, for example, an image or a video may be searched based on textual queries. The multimodal large model may be applied in human-machine interaction, for example, an intelligent assistant may understand and respond, via speeches, to a user request in a form of an image or a video. In summary: the multimodal large model may integrate information from the plurality of types of data, so as to achieve a more intelligent and more comprehensive AI application to provide innovation and transformation across various technical fields.

The device described in the present embodiment may include the following.

1. Smart cameras: The smart cameras may be installed inside or around the house to monitor and record videos in real time (i.e., the aforementioned target video). The smart cameras may have high resolution and wide-angle views to cover major activity regions of the house.

2. Home server or edge computing device: The home server or the edge computing device may process the video data obtained from the smart cameras, such as images contained in the aforementioned target video. The home server or the edge computing device may have certain computing power to perform video analysis and a frame extraction algorithm.

3. Home smart control system: The home smart control system may integrate various smart devices within the home, coordinate and manage the processing and storage of the video data, such as storing the aforementioned image description data set. The home smart control system may include smart speakers, home smart gateways, and so on.

4. Mobile device (such as the mobile phone and the tablet computer): The user may access and manage the extracted video frame through the mobile device, such as performing the aforementioned adjustment operation and receiving notifications for important events.

The present embodiment of the disclosure may be applied in the following scenarios.

Home Security Monitoring: The smart cameras continuously monitor the home environment. The edge computing device may dynamically extract the key frame based on predetermined contexts (such as an activity pattern of the family member, a common daily scenario), so as to obtain the aforementioned result of the video frame extraction. For example, after detecting the abnormal activity (such as stranger intrusion), the system may extract and store a relevant frame (i.e., the result of the video frame extraction) and may immediately notify the user.

Family Activity Logging: In a scenario of family gathering or children activities, the system dynamically extracts frames based on the contexts to generate a video summarization of a video highlight (i.e., the video segment), i.e., the aforementioned video information. In this way, the user may quickly review memorable moments without reviewing the entire video.

Smart Home Cooperation; By combining state information from other smart home devices (such as the door lock, the lights, the temperature controllers, and so on) or controlling the other devices based on the result of the video frame extraction, the system may intelligently determine a time point of the extracted frame. For instance, after detecting the door lock being opened or the light being turned on suddenly, video frames at these time points may be automatically extracted to assist the user in recording and analyzing household activities.

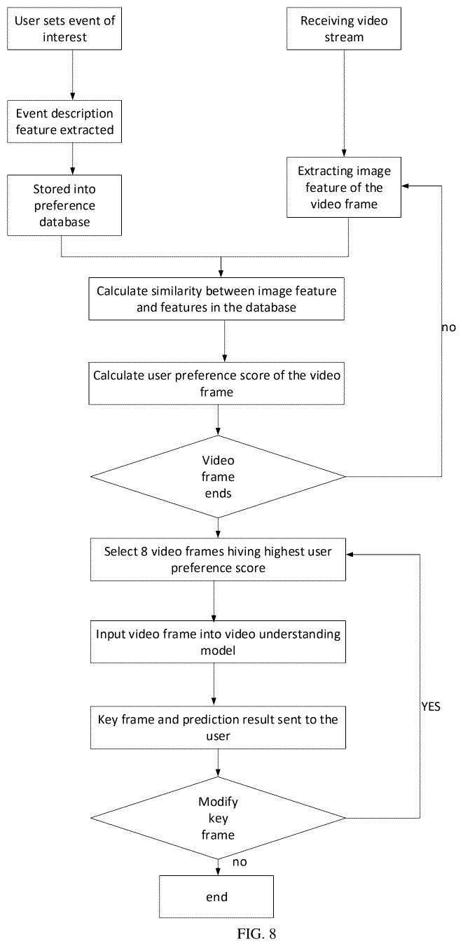

Specifically: as shown in FIG. 8, an implementation process of the present embodiment may include the following.

### I. User Setting

1. The user sets events of interest within the application, such as the elderly falling, the stranger loitering, or the courier delivering the parcel (i.e., the aforementioned event description). The user may input up to 10 simple event descriptions, and each of the 10 event descriptions has up to 100 words.

2. After receiving the input from the user, a background may extract an event description feature via a text embedding model and may convert the textual description of each event into 4096-dimensional text feature vectors. A feature vector corresponding to each event description may be denoted as v_e (i.e., the image description data within the aforementioned image description data set). The feature vectors may be stored in a user preference database.

### II. Dynamic Video Frame Extraction

3. After receiving a real-time video stream (i.e., the target video), an image embedding model may convert a video frame f_i into a 4096-dimensional image feature vector v_i. A cosine similarity between the image feature and each feature vector in the user preference database (i.e., the image description data in the aforementioned image description data set) may be calculated

4. A user preference score s_i for the video frame f_i may be calculated. The s_i may be a maximum cosine similarity from all cosine similarities between the image feature vector v_i and all feature vectors in the user preference database, and that is, the s_i may be the aforementioned target similarity.

5. The blocks 3 and 4 may be repeated until the real-time stream is terminated. At this moment, a user preference score for each video frame may be obtained.

6. 8 video frames (i.e., the first quantity mentioned above) having highest user preference scores may be selected. The 8 selected frames may be sequentially, based on timing, input into the video understanding model to obtain the behavior predicted by the model occurring in the video. For example, when a video frame 1 and a text of “turn on lights” (i.e., the event description) have the highest user preference score, and a video frame 2 and a text of “elderly person falls” (i.e., the event description) have the highest user preference score. III. User Preference Calibration

7. One or more behaviors predicted by the model may be pushed to the application, all video frames of the video may be sequentially displayed. The selected 8 frames may be displayed in highlight. When the user determines that the prediction of the model is inaccurate, the user may manually modify (i.e., by performing the adjustment operation) 8 key frames (i.e., the second quantity mentioned above) from all video frames (i.e., all images within the target video).

8. After the background receiving the 8 modified video frames from the user, the selected 8 frames may be re-input into the video understanding model. A new prediction result (e.g., a behavior represented by the 8 frames selected by the user) may then be pushed to the application.

9. An average value of image feature vectors corresponding to the 8 video frames selected by the user may be stored in the user preference database. The user preference database may store a maximum of 30 image features. When more image features are to be stored, a feature vector that is saved earliest (i.e., earliest added) may be deleted.

It should be noted that, in addition to the content described above, the present embodiment may further include the technical features described in the preceding embodiments to achieve the technical effects of the video frame extraction method illustrated above. Specific details may be referred to the preceding descriptions. For brevity, the specific details may not be repeated herein.

In related art, in home security scenarios, the video understanding model may be needed to predict the event occurring or about to occur within the video. In the art, key video frames may be selected from the video and input into the video understanding model. Therefore, the selected frames may significantly influence the results. However, each user may have distinct requirements for key information, and therefore, one uniform key frame selection strategy may not be unsuitable for all users.

For the video frame extraction method provided by the embodiments of the present disclosure, setting input by the user and long-term usage records may be integrated, interest of the user and the user preferences may be continuously learnt, such that key frames that better meet demands of the user may be extracted, and prediction results that satisfy all users may be obtained. By adaptively extracting the key video frames based on the user preference, the behavior of greatest interest to the user may be more accurately predicted. The user preference database may be continuously updated based on user feedback during usage, such that accuracy of dynamic frame extraction may be progressively improved. The user may set events of interest within the application, and the events may be scenarios closely related to home security and daily life, such as elderly falling, the stranger loitering, or the courier delivering a parcel. The system may perform customized monitoring and processing according to specific user requirements, such that user experience and system practicability may be improved. The system dynamically extracts key frames that are highly relevant to the user preference from the real-time video stream. In this way, computing resources may be saved, and it is ensured that only the most related frames are processed, such that the efficiency and accuracy may be improved. When the user determines that the prediction is inaccurate, the user may manually modify the key frame, the post-modification frame may be converted into the new user preference to be stored in the database. The above feedback mechanism allows the user to participate in system calibration, ensuring the prediction to better meet actual demands of the user. Therefore, in the embodiments of the present disclosure, household habits of the user and the usage preferences may be continuously learnt, such that the adaptive and dynamic video frame extraction may be provided for various households, and therefore, the efficiency and intelligence of video processing in home environments may be improved.

Before introducing the information pushing method, technical terms relevant to the embodiments of the present disclosure may be described as follows.
Multimodal: The multimodal refers to a form in which data exists, such as a text, an audio, an image, a video, and other file formats.
Key frame: The key frame refers to a frame containing a crucial action during movement or changes of a character or an object.
Transformer: The transformer is a sequence-based deep learning model.
Attention Mechanism: In deep learning, the attention mechanism is a method for mimicking human visual and a cognitive system of the human. The attention mechanism enables the neural network to focus on relevant parts when processing input data.
Text Vector: The Text vector may be a feature vector representing a text that is mapped into a high-dimensional space via a deep learning model.
Highlight moment: The highlight moment may be a most compelling segment of a video.
Currently: the user may have demands for family diaries in four aspects, as follows.

In a first aspect, family diaries may be shown in a text format to assist the user in quickly obtaining key daily events during busy periods.

In a second aspect, the family diaries may be shown in a video format to enable the user to immerse himself in reliving/appreciating significant moments during leisure time.

In a third aspect. “event-triggered reminding” may be achieved by setting a tag in advance to ensure the user to respond to important family events in time.

In a fourth aspect, a high-quality short video integrated with images, texts, and audios may be automatically generated from text diaries and video diaries, and the highlight moment may be captured. An adaptive playing speed may be set for the highlight moment. In this way: immersive experience may be provided, and a low-cost life documentation may be achieved.

In addition, no solution is currently available for displaying family security diaries in the text format. In certain scenarios (such as performing busy outdoor activities), the user may need to quickly understand, by texts, major daily family events happening in a day. Pure “video highlight reel” diaries lack conciseness, and concise event summaries may not be provided. Later retrieval and evidence collection may be not be easily achieved based on a diary format of the video highlight reel. The generated video may lack immersive experience, for example, the generated video may not flexibly match background music, and the highlight moment thereof cannot be played at a slow speed.

Accordingly, the present disclosure provides following modules to solve the aforementioned technical problems.

Natural Language Instruction Setting Module: When the user inputs “Remind me when the child arrives home tomorrow”, the system converts the text into a text vector (i.e., the first feature data).

Event Key frame Extraction Module: The event key frame extraction module is configured with the large model (i.e., the large language model, corresponding to the aforementioned event extraction model) to generate a description text for a large scale of multi-event video data, and the description text may have a template of “starting time point-end time point-event.” The starting time point and the end time point correspond to the event time point as described in the above. The time point corresponds to the event label as described in the above. The generated data may be used to train the large model, enhancing an ability of the large model to perceive a temporal boundary for each event within videos, such that a starting frame and an end frame of each event may be more accurately extracted.

### Speech/Text/Image Understanding Module:

(1) One or more key frames (i.e., the aforementioned event frame) may be input into the image understanding module (a multimodal model), and the number of words in a text output from the image understanding module may be set. The module may generate a description text for the image or an image set. For example, a video of a child returning home with his mother may be input into the image understanding module, and the number of words in the text output from the image understanding module may be set to be no more than 30 words. The description text includes information such as time, location, persons and attributes thereof, and actions. The module may output: “At 11:30 today, a boy wearing blue clothes seen at the door returning home with his mother.”

(2) When the event is determined as being over, an image or a video may be converted into an image vector, and the image vector may be matched with the text vector of the natural language instruction setting module. When a similarity exceeds the threshold, the application may be triggered to push a notification (i.e., the aforementioned video information) to notify the user.

Diary Auto-Editing and Highlight Capturing Module: The diary auto-editing and highlight capturing module may sequentially stitch all relevant events during the day and may automatically understand the video content based on the multimodal model to generate background music and captions for video segments at various time periods. The diary auto-editing and highlight capturing module may capture the highlight moment and adaptively provide a playing speed for the highlight moment.

(1) The present module may be configured with a text encoder, a speech encoder, and an image encoder to extract texts, audios, and images features from the video, respectively, corresponding to the aforementioned second feature data. A transformer-based multimodal fusion network may be used to generate a multimodal representation that integrates texts, audios, and image information. In order to better understand and fusc multimodal information, a squeeze-and-excitation attention mechanism may be introduced to compute correlation among features within a same modality but across different channels, and features in different modalities. In this way, attention of the model on relevant features may be improved, achieving feature enhancement. At last, the video content may be understood based on fused features, background music matching a topic of the video may be added, and the description text may be generated. In addition, in the present method, self-supervised contrastive learning may be applied to measure inter-frame image similarity in the image encoder and audio similarity across a time sequence. Video segments with a significant similarity difference may be determined as the highlight/key moment (corresponding to the aforementioned highlight video frame), and a playing speed for the highlight/key moment may be adaptively reduced, such that the immersive experience of the family diaries may be improved.

Sharing Manner: The short video generated by editing may be directly shared to a short-video social application.

Typical application scenarios are as follows.

### Scenario I: Child Returning Home

The user inputs a text or a speech into a notification box of the application, such as “Remind me when my child returns home starting from tomorrow” (i.e., the aforementioned natural language). The system converts the text into a text vector (i.e., the first feature data). Since the day after the command is set, captured images and videos may be segmented based on the event. The system may understand various events and generates description texts. When the similarity between the event vector and the text vector exceeds a predetermined threshold, the application pushes a notification (i.e., the video information) to the user for reminding. At 24:00 daily, the system analyzes all event happening during the day, edits an event video for each event, and generates corresponding text description for each event, such that a multimedia family diary may be generated to be saved and shared by the user.

### Scenario II: Pet Activity:

When the user inputs a text or a speech of “Remind me when my cat wakes up tomorrow” (i.e., the aforementioned natural language) into the notification box of the application, the system converts the text into a text vector (i.e., the first feature data). Since the day after the command is set, captured images and videos may be segmented based on the event. The system may understand various events and generates description texts. When a similarity between the event vector of the event happened in the video and the text vector described in the notification instruction exceeds the threshold, the application pushes the notification (i.e., the aforementioned video information). At 24:00, the system may count the number of events happened during the day: stitch chronologically all videos of activities of the cat after the cat wakes up, and generate corresponding text descriptions, such as “at 9:00, the cat starts walking (playing at a normal speed)”: “at 12:00, the cat wakes up again and drinks water” (playing at a normal speed): “at 15:00, the cat jumps off from the sofa” (playing at a speed of ⅗ of the normal speed). The system may then add a warm and relaxed background music for the video. Notably: the video corresponding to “at 15:00, the cat jumps off from the sofa” may be determined by the system as the highlight moment (corresponding to the aforementioned highlight video frame). Therefore, the playing speed for the video may be switched to ⅗ of the normal speed. In this way, an immersive multimedia family diary may be generated and may be saved and shared by the user.

To be noted that, in addition to the content described above, the present embodiment may also include technical features described in the preceding embodiments to achieve the technical effects of the information pushing method. Specific details may be referred to the preceding description. For brevity, the specific details may not be repeated herein.

For the information pushing method provided by the embodiments of the present disclosure, the multimodal large model may be used to convert the natural language into the information push command. In this way, prompt tasks may be set flexibly. The triggering mechanism may be achieved by comparing the text vector and the image/video vector. The large model may be configured to enhance perception of temporal boundaries where various events occur and are over within the videos, such that the key frames associated with relevant events (i.e., the aforementioned event frame) may be more accurately extracted. The multimodal model summarizes videos captured by the home security cameras into texts, edits the videos into family video highlights based on events, and generates the multimedia family diaries integrating the images, the texts, the audios, and the videos. By capturing the highlight moment and adaptively adjusting the playing speed of the multimedia family diaries, the immersive user experience may be improved, and an effort to document the daily life may be reduced. Events happening on every day of the family may be recorded in texts, images, and videos. Therefore, simplicity and searchability of text-based diaries may be combined with vividness and emotional resonance of the videos. The advanced video understanding integrates three modalities of data, the highlight moment within the videos may be automatically recognized, and the playing speed may be adjusted adaptively, such that the immersive user experience may be provided.

As shown in FIG. 10B. FIG. 10B is a flow chart of the cross-device control strategy generation method according to an embodiment of the present disclosure. As shown in FIG. 10B, it may be illustrated how the target cross-device cooperation control strategy is generated from both a user performance perspective and a device performance perspective. As shown in FIG. 10B, the process may include the following blocks.

Firstly: a process of the user configuring a cross-device cooperation control strategy may include the following blocks.

1. User Performance: The user may launch an application at a control terminal, enter a cross-device cooperation scenario setting page, and add a cross-device cooperation button.

2. User Performance: After entering a cross-device cooperation adding page, the user long-presses a speech input button to set cross-device cooperation via a speech command, such as, “Please secure the backyard on weekdays”. “When any stranger lingers at my door, warn and expel the stranger”, or “I want my home cleaned before I arrive daily”, and various functional requests.

Accordingly, the device performance may include the following blocks.
(1) Device performance: The application obtains a content of the speech of the user, communicates with a cloud-based large language model for confirmation, and generates a semantically analyzed content.
(2) Device performance: A localized base station integrates bound device group information, user-defined parameters for each device, environmental data, locations, policy configurations, and daily triggered device behaviors; and uses self-learning algorithms to summarize routine behavior patterns for the user and all devices.
(3) Device performance: The device may retrieve a full set of various physical model capabilities and predefined cross-device cooperation rule format specifications.
(4) Device performance: The corresponding target cross-device cooperation control strategy may be generated based on the semantically analyzed content of the user, the routine behavior patterns, the full set of physical model capabilities, and the cross-device cooperation rule format specifications.

3. User performance: After waiting for a period of time, the cross-device cooperation adding page automatically generate a suitable cross-device cooperation configuration condition, such as “When the human motion sensors at the backyard are triggered or a person walks to reach that triggers detection of the camera, the camera A in the backyard starts recording, and the camera B performs patrol and provides the light flash, cooperatively: An effective time period is from Monday to Friday and is weekly cycled”. The page simultaneously notifies the user to confirm and save the configuration.

4. User performance: The user confirms and saves the content of the cross-device cooperation strategy, the cross-device cooperation strategy may be saved successfully.

For the technical solution provided by the embodiments of the present disclosure, the large language model may be configured to set cross-device cooperation for the entire house for various scenarios. Based on localized AI analysis and processing of information of the entire house-home information at the base station, the user behavior pattern may be generated, such that the targeted cross-device cooperation control strategy may be generated based on a cross-device cooperation intent of the user. In this way, a barrier to establishing the cross-device cooperation rule may be significantly reduced, a user effort may be reduced, an efficiency of the user to obtain information may be improved, the user experience may be improved.

Before introducing the control method for the security device, the technical terms involved in the embodiments of the present disclosure are explained as follows.

A master controller may be a hardware device that is used to achieve connection, to receive and forward information, to process information, and to perform controlling for security monitoring devices (such as the aforementioned security devices), including cameras, sensors, alarm devices, and so on, within a region.

The security device refers to a collective term for various devices, such as cameras, sensors, and alarm devices, that are used for regional security protection.

A security record, such as a video recording and an event alert, refers to a content collection that is generated by various security devices for transmitting security information.

A PTZ camera refers to a camera capable of rotating a lens horizontally and vertically.

Artificial Intelligence (AI) target recognition refers to technology that detects a moving target and analyzes target features to recognize the same target, based on computer vision and AI algorithms.

Multimodal refers to using various types of media or modes to convey information or for communication.

A shared or common field of view refers to an overlapping region of monitoring regions covered by a plurality of cameras.

An initial field of view angle refers to a lens rotation angle at which the PTZ camera begins detecting a target within a frame.

A limit field of view angle refers to a lens rotation angle at which the PTZ camera can no longer be rotated to track the target.

Calibration refers to automatically establishing cooperation between security devices by performing a series of tests and adjustments on both the security devices and the master controller.

Demands of the user in security may substantially include three aspects as follows.
1. A security coverage area may be maximized.
2. As much detailed information as possible may be obtained.
3. Security records having logical association with each other may be associated with each other, so as to improve understanding and analysis.

In the art, the above demands may be achieved based on cross-device cooperation functions that are configured by manual operations of the user, and current cross-device cooperation functions may include following.
1. The user may manually create a building model, manually group the plurality of cameras, and set physical encoding to represent that the plurality of cameras are installed at location adjacent to each other or the plurality of cameras have the shared field of view.
2. The user may define cross-device cooperation rules based on device locations and other information. When one device is triggered for monitoring or detects movement of an object, the one device activates another device to capture a video in cooperation. For example, a front door camera detects a movement, a front yard camera may be activated for capturing a video.
3. When the cross-device cooperation rule is triggered, associated devices generate recordings and send notifications to the user. The user may stitch the captured videos based on the association among the devices and timestamps of the captured videos, such that an event that happened may be confirmed.

The manually configured cross-device cooperation functions may have following limitations.
1. The user needs to create the building model by himself and determine device installation locations, and therefore, the user at the home environment may not perform the above configuration alone.
2. Designing the cross-device cooperation rules requires strong logical thinking and spatial visualization skills, and the user needs to independently determine the association among the devices, and therefore, a high usage barrier is present.
3. Only videos captured by the associated devices may be stitched together, secondary image processing, such as extracting key information such as facial images, license plate numbers, or intrusion trajectories, may not be performed, such that the user may not efficiently obtain information from the images. Accordingly, the present disclosure provides the following solution.

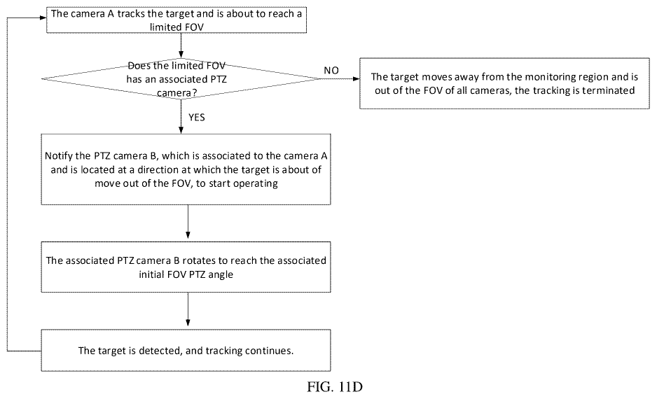

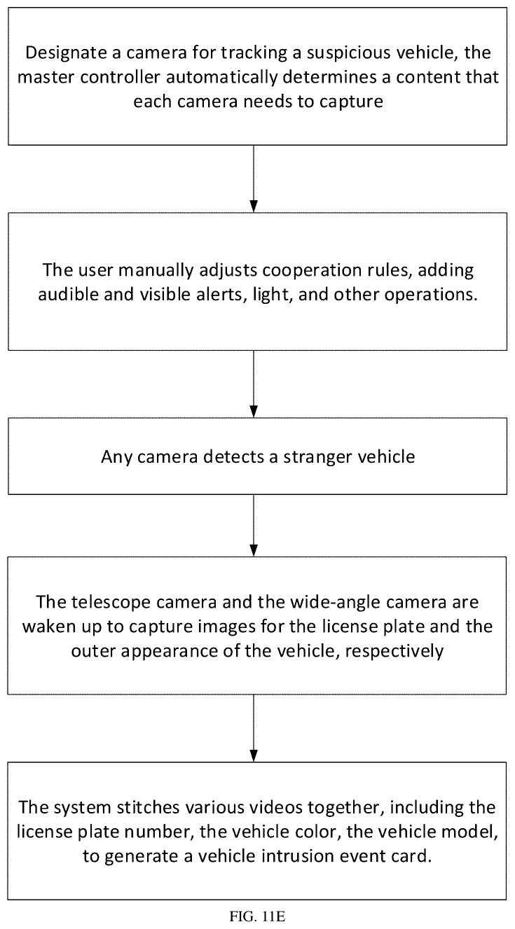

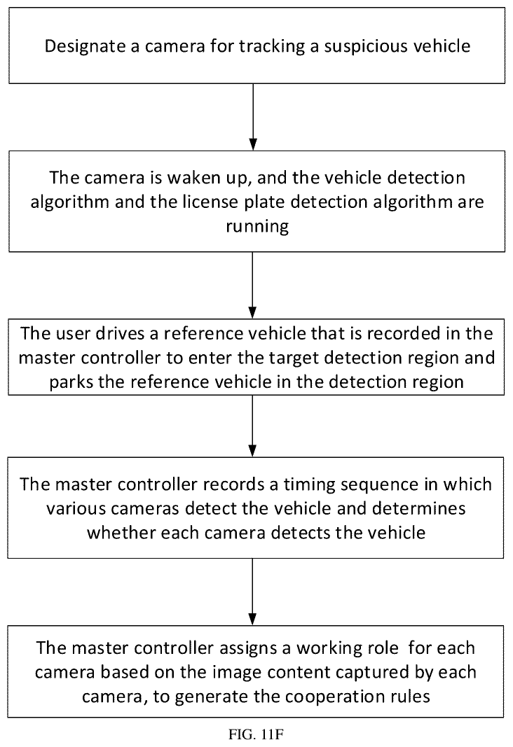

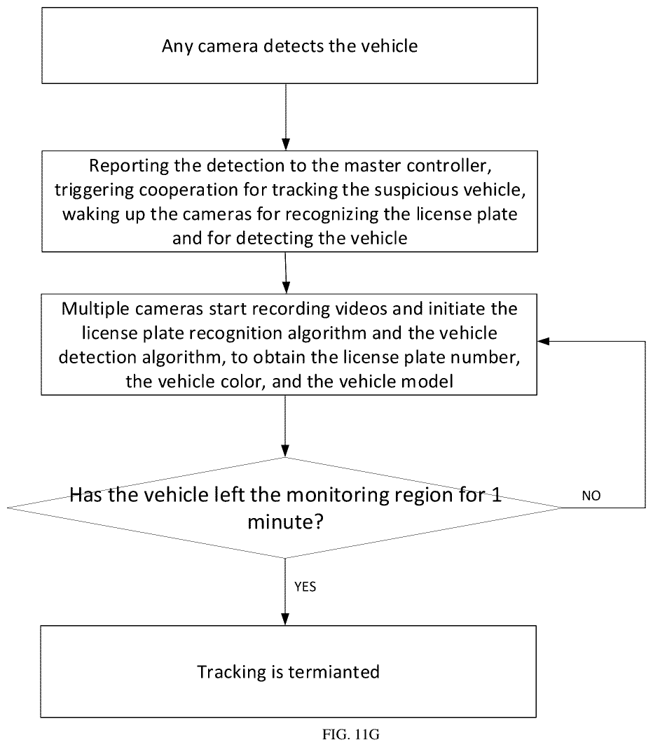

As shown in FIG. 11A. FIG. 11A is a flow chart of the control method for the security devices according to an embodiment of the present disclosure.

1. The master controller (a local control base station connected to the plurality of cameras) uses the target recognition algorithm to recognize the target image (i.e., the aforementioned target image set) stored in the master controller.

According to the timing sequence of the target (i.e., the reference object) appearing across the plurality of cameras (i.e., the security devices), contents in the captured images, and the recognized target information, the association relationship among the plurality of cameras may be automatically determined. The association relationship may include: cameras being adjacent to each other, cameras sharing the common field of view, and the telephoto camera and the wide-angle camera that work cooperatively.

For example, the reference object appears simultaneously in the field of view of the camera A and the field of view of the camera B at a first location, and at another moment, the reference object appears simultaneously in the field of view of the camera A and the field of view of the camera C at a second location.

It may be indicated that the camera A and the camera B share the common field of view at the first location, and the camera A and the camera C share the common field of view at the second location.

Accordingly, seamless tracking without any blind spot may be achieved. When a suspicious target is about to exit the field of view of the camera A, and it is determined based on the target information that suspicious target is about to enter the monitoring region of the camera B, the camera B takes over recording the video. At this moment, the camera C remains in the sleep mode to save power. When the target is about to exit field of view of the camera A and it is determined that the target is about to enter the monitoring region of the camera C, the camera C is awakened for recording the video, and the camera B enters the sleep mode.

In another example, both the camera A and the camera B capture a vehicle target, the camera A captures a clear image about a license plate of the vehicle target, and the camera B captures an image about an outer appearance of the vehicle. In this case, the camera A and the camera B serve as the telephoto camera and the wide-angle camera that work cooperatively at this viewing angle. The camera A serves as the telephoto camera, and the camera B serves as the wide-angle camera. They work cooperatively to achieve vehicle tracking, where the telephoto camera recognizes the license plate and the wide-angle camera captures outer appearance features of the vehicle.

2. The user may select a predetermined cross-device cooperation application scenario and select an associated device group (i.e., the aforementioned cross-device cooperation security devices) to work cooperatively: The master controller automatically generates, based on requirements of the application scenario and the association relationship among the devices (represented by the aforementioned association relationship), cross-device cooperation rules that are determined based on a multimodal condition.

For the cross-device cooperation rules that are determined based on the multimodal condition, after the cross-device cooperation is activated, various actions may be executed based on various AI recognition results or trigger times. Compared to simple trigger-and-execute cross-device cooperation, the above method may meet user demands more flexibly.

For example, when the user selects a “Front Yard Guarding” application scenario and selects an associated security device group at the front yard to work cooperatively, and the associated security device group includes a front yard gate camera, a front yard camera, and a front doorbell.

The requirements of the above scenario include the following. When the courier enters the front yard, the courier may be notified via a speaker to place the parcel at a designated location near the front door. When the parcel is placed at the front door, the user may be notified. When the user or family members return home, all indoor cameras may be shut off, so as to protect privacy.

According to the above requirements and the association relationship among the devices, the master controller generates the cross-device cooperation rules that are determined based on the multimodal condition. The field of view of the front yard gate camera/front yard camera may be wider, and the field of view of the front doorbell may be narrower. Therefore, the front yard gate camera/front yard camera may detect and recognize a human shape. The front doorbell may be supplied with power by the battery and may need to enter the sleep mode for energy saving. Therefore, only when the master controller determines that the front yard gate camera/front yard camera recognizes the courier, the front doorbell may be awakened for parcel detection. In this way: when the courier is detected at the front yard and the parcel is detected at the door, a parcel-arrival notification may be sent to the user. When the user or the family member is detected in the front yard, the doorbell may not be wakened, and the indoor cameras may be turned off to protect privacy.

3. The user manually fine-tunes the cross-device cooperation rules and customizinly add a plurality of cooperated responses, such as audible-visual alarms or lighting, into the cross-device cooperation rules. The finalized cross-device cooperation rules may be stored in the master controller.

4. When any device detects a monitored target (i.e., the aforementioned target object, such as a stranger), the device reports the recognized target type and the identity ID (such as a stranger or a specific acquaintance) to the master controller. The master controller checks a list of the cross-device cooperation rules, determines an ID of the reporting device and the recognized target type and the identity ID, determines which one rule of the cross-device cooperation rules is triggered, and controls the rest devices in the associated security device group to perform corresponding operations (i.e., the aforementioned monitoring operation).

After determining the cross-device cooperation rule to be executed, the master controller wakes up the corresponding associated security device group to perform operations defined within the cross-device cooperation rule, such as recording a video, performing recognition, or emitting an alarm, and so on.

For example, when the front door camera detects a courier entering the front yard and sends an event message to the master controller. The master controller searches the list of the cross-device cooperation rules for trigger conditions of the front door camera and the courier being recognized, and a “front yard parcel guarding” cross-device cooperation rule may be found matching the trigger conditions. The found cross-device cooperation rule stipulates that, when a courier enters the front yard, the front yard camera broadcasts a notification instructing the courier to “place the parcel at the front door” and activates the front doorbell for parcel detection. Consequently, the master controller sends a broadcast to the front yard camera and wakes up the front doorbell for recording a video for parcel detection. In this way, cross-device cooperation may be achieved.

5. The master controller may extract key information, such as facial screenshots, license plate numbers, and intrusion trajectories, from security records generated by the security devices; and may stitch, based on the association relationship, the key information together to generate an associated record.

Two typical application scenarios are as follows.

FIGS. 11B-11D show application scenarios of stranger tracking and expulsion involved in the control method for the security devices according to an embodiment of the present disclosure. A process for the application scenarios is as follows.
1. The user inputs an ID of the user himself into the master controller, initiates a calibration process, and slowly walks around the house for one round.
2. The master controller determines a relative positional relationship among the plurality of cameras, based on a timing sequence that the plurality of cameras recognize the user and a pan-tilt angle of each camera.
3. The master controller automatically generates the cross-device cooperation rules based on the relative positional relationship.
4. The user manually adjusts settings, selects “stranger” as the target type for tracking, and adds expulsion operations, such as audible and visual alarms.
5. A comprehensive cross-device cooperation rule for tracking and expelling the stranger may be established.

A cross-device cooperation effect may be as follows.
1. When the stranger enters a perimeter of the house, and when any camera detects the stranger, the cross-device cooperation rule for tracking and expelling the stranger may be triggered, and a notification may be pushed to the user.
2. The master controller collects images from all cameras and determines, by using AI image algorithms and based on a movement direction and a movement speed of the stranger, a region in which the stranger is about to enter. The master controller then wakes up cameras in the determined region to perform video tracking and to emit audible and visual alarms.
3. When the stranger moves away from the perimeter of the house, cameras may stop recording videos and stop emitting the alarms.
4. The master controller collects videos from the plurality of cameras and extracts, based on an AI facial detection algorithm, clear a facial portrait from the recorded a plurality of videos. The master controller draws an intrusion trajectory of the stranger based on a chronological order in which the stranger appears across the cameras.
5. The master controller generates an event card to be reviewed by the user, by combining multimodal key information, including the plurality of videos, the facial portrait, the intrusion trajectory: the first appearance time point, the first appearance location, the departure time point, and the departure location.

FIGS. 11E-11G show application scenarios of a suspicious vehicle being tracked and expulsed involved in the control method for the security devices according to an embodiment of the present disclosure. As shown in the drawings, the process for the application scenario may include the following.
1. A user vehicle ID may be stored in the master controller to initiate the calibration process, and the vehicle may be parked at a location where any suspicious vehicle may appear.
2. The master controller collects videos captured by all cameras and automatically assigns, based on conditions such as whether the target vehicle is present in a video and whether a license plate can be recognized, a working role for each of the plurality of cameras for recognizing the license plate and for recording the video for the vehicle.
3. The master controller automatically generates the cross-device cooperation rule based on the above role assignment.
4. The user manually adjusts a time period during which the cross-device cooperation rule needs to be performed; and manually adds the expulsion operation, such as the audible and visual alarms.
5. A comprehensive cross-device cooperation rule for tracking and expelling the suspicious vehicle may be established.

A cross-device cooperation effect may be as follows.
1. When a vehicle parks near the house, and when any camera detects the vehicle and recognizes the vehicle as a stranger vehicle, the cross-device cooperation rule for tracking and expelling the suspicious vehicle may be established may be triggered.
2. The master controller wakes up a camera configured to capture the license plate, the camera may be rotated for an angle to capture a clear image for the license plate. A license plate recognition algorithm may be operating to read license plate information. The master controller further wakes up a camera configured to capture other features of the vehicle to obtain an action video of the vehicle. Additionally, the master controller activates the alarm device to emit a warning sound to expel the vehicle away.
3. Once the vehicle leaves the monitoring region and when the target is lost for 1 minute, the alarm device may stop operating, and video capturing may be terminated, and the alarm device may enter the sleep mode.
4. The master controller extracts information of the vehicle, including a license plate number, a vehicle color, and a vehicle model. The master controller stitches the videos from the plurality of cameras to generate an event card of suspicious vehicle tracking, enabling the user to quickly obtain key event details.

It should be noted that, in addition to the above-described content, the present embodiment may also incorporate technical features described in the preceding embodiments to achieve the technical effects of the security device control method illustrated above. Specific details may be referred to the preceding description. For brevity: the specific details will not be repeated.

For the security device control method provided in the present disclosure, a barrier for establishing the cross-device cooperation rules may be reduced, saving the user effort. By generating association records, an efficiency for the user to obtain information may be improved, and the user experience may be improved. Furthermore, the association relationship among the devices may be automatically determined based on the AI target recognition algorithm, and the cross-device cooperation rules may be generated automatically. The master controller may use the AI target recognition algorithm and the AI target detection algorithm to extract key information from the videos and may stitch multimodal information together and display the stitched information.

It should be noted that, in addition to the content described above, the present embodiment may also incorporate technical features described in the preceding embodiments to achieve the technical effects of the security device control method illustrated above. Specific details may be referred to the preceding description. For brevity: the specific details will not be repeated.

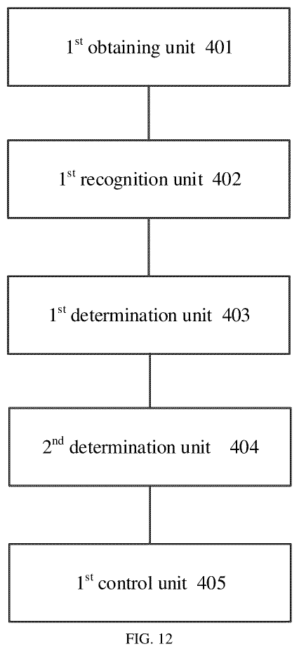

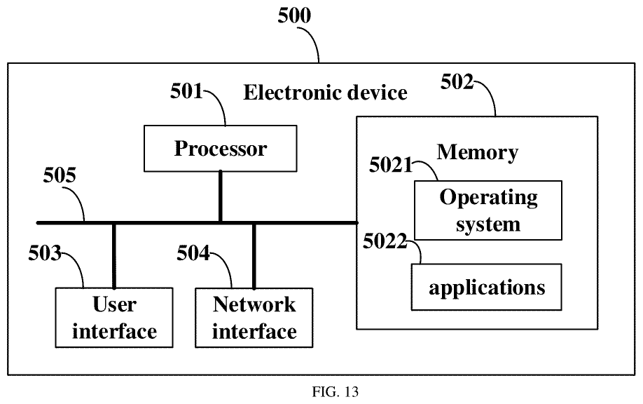

FIG. 12 is a structural schematic view of a security apparatus according to an embodiment of the present disclosure. Specifically: the security apparatus may include the following.

A first obtaining unit 401 may be configured to obtain the first security video and the predetermined security preference information.

A first recognition unit 402 may be configured to recognize the first security video to obtain the video identification result of the first security video.

A first determination unit 403 may be configured to determine the security response operation matching the first security video based on the video recognition result and the security preference information, so as to obtain the first security response operation.

A second determination unit 404 may be configured to determine the security device for performing the first security response operation.

A first control unit 405 may be configured to control the security device to perform the first security response operation.

The security apparatus provided in the present embodiment may be the security device shown in FIG. 12 and may execute all blocks of the aforementioned security method. In addition to the content described in the present embodiment, the present embodiment may further include corresponding technical features described in the above method embodiments, so as to achieve the technical effects of the aforementioned security method. Specific details may be referred to the preceding description. For brevity: the specific details will not be repeated.

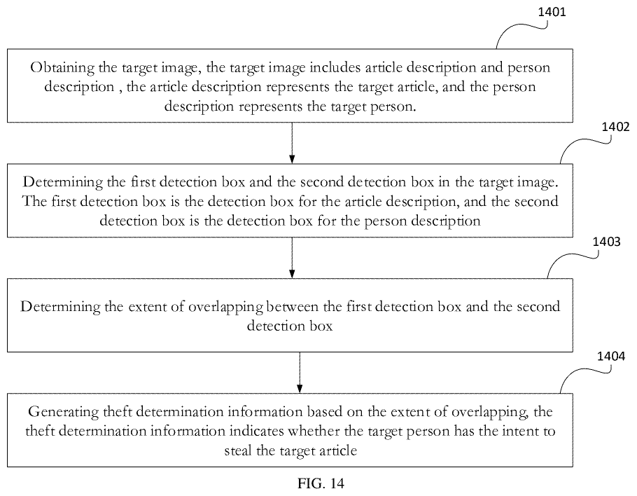

FIG. 14 is a flow chart a method for recognizing the theft intent according to an embodiment of the present disclosure.

As shown in FIG. 14, the method specifically includes following blocks.

In a block 1041, the target image may be obtained. The target image includes the article description and the person description. The article description represents the target article, and the person description represents the target person.

In the present embodiment, the target image may be any image containing both the article description and the person description. For example, the target image may be the video frame extracted from the video containing both the article description and the person description. In another example, the target image may be a video frame extracted from the video containing both the article description and the person description, where the target article represented by the article description and the target person represented by the person description are both located within the predetermined region.

The predetermined region may be a region, which satisfies a predetermined condition and is set by the user or other objectives or is determined by the subject for performing the method or other electronic devices.

For example, the predetermined condition may be that the region includes a predetermined article. In this case, the predetermined article may represent the same article as the target article.

The predetermined region may be a positionally fixed region or a positionally variable region. For example, when the predetermined condition is that the region contains the predetermined article, and when the predetermined article (such as a robotic vacuum cleaner, a pet, and so on) is movable, the predetermined region may be the positionally variable region.

The target article may be the article represented by the article description, and the target person may be the person represented by the person description.

In a block 1042, the first detection box and the second detection box may be determined in the target image. The first detection box may be the detection box for the article description, and the second detection box may be the detection box for the person description.

In the present embodiment, the target detection algorithm may be applied to perform object detection on the target image, so as to determine the first detection box and the second detection box within the target image.

The target detection algorithm refers to an algorithm used in the computer vision to recognize and locate a specific target (such as the target article or the target person) within an image (including the aforementioned target image). The algorithm may determine a position of the target (typically by drawing a rectangular box or a box in a more complex shape) and may include performing classification on the target.

The open vocabulary object detection (OVOD) may be applied for performing target detection. The OVOD enables the model to detect and recognize a new object type that is not encountered during training, such that generalized target detection may be achieved.

In a block 1043, the extent of overlapping between the first detection box and the second detection box may be determined.

In the present embodiment, the extent of overlapping may represent a proportion or a level of the overlapping region between the first detection box and the second detection box with respect to an overall image.

For example, the extent of overlapping may be represented by at least one of the following: the number of pixels overlapping between an image region corresponding to the first detection box and an image region corresponding to the second detection box: a ratio of an area of the overlapping region between the image regions corresponding to the first detection box and the second detection box: or an intersection-over-union ratio between the image regions corresponding to the first detection box and the second detection box.

In a block 1044, the theft determination information may be generated based on the extent of overlapping, and the theft determination information indicates whether the target person has the intent to steal the target article.

In the present embodiment, the theft determination information may be generated in various ways based on the extent of overlapping.

For example, when the extent of overlapping is greater than or equal to the predetermined threshold, the theft determination information indicating that the target person has the intent to steal the target article may be generated. When the extent of overlapping is less than the predetermined threshold, the theft determination information indicating that the target person does not have the intent to steal the target article may be generated. The predetermined threshold may be set by the user or other objectives, or determined by analyzing correlation between the extent of overlapping and the theft determination information.

In another example, when the extent of overlapping is greater than or equal to the predetermined threshold and both the target person and the target article are located within the predetermined region, the theft determination information indicating the target person has the intent to steal the target article may be generated. When the extent of overlapping is less than the predetermined threshold, or when at least one of the target person and the target article is not located within the predetermined region, the theft determination information indicating that the target person does not have the intent to steal the target article may be generated.

In some embodiments, the theft determination information may be generated based on the extent of overlapping as follows.

In a block 1, it may be determined whether the extent of overlapping is greater than or equal to the predetermined threshold.

The predetermined threshold may be set by the user or other objectives, or may be determined by analyzing the correlation between the extent of overlapping and the theft determination information.

In a block 2, when the extent of overlapping is greater than or equal to the predetermined threshold, it may be determined whether the behavior of the target person represented by the person description is the theft behavior, so as to obtain the first determination result.

The first determination result indicates whether the behavior of the target person represented in the person description is the theft behavior.

The theft behavior may be one or more behaviors indicative of theft. For example, the theft behavior may include bending over, a hand reaching out while glancing sideways, or walking quickly or running after the hand reaching out and glancing sideways.

In a block 3, the theft determination information may be generated based on the first determination result.

The theft determination information may be generated in various ways based on the first determination result.

For example, when the first determination result indicates that the behavior of the target person represented in the person description is the theft behavior, the theft determination information indicating that the target person has the intent to steal the target article may be generated. When the first determination result indicates that the behavior of the target person represented by the person description is not the theft behavior, the theft determination information indicating that the target person does not have the intent to steal the target article may be generated.

In addition, other methods may be performed to generate the theft determination information based on the first determination result, which will be described in detail at a later section.

It should be understood that in the above embodiments, the theft determination information may be be generated by determining whether the behavior of the target person represented by the person description is the theft behavior. In this way, accuracy in recognizing the theft intent may be improved.

In some embodiments, the theft determination information may be generated based on the extent of overlapping as follows.

In a block 1, it may be determined whether both the target person and the target article are located within the predetermined region, so as to obtain the second determination result.

The second determination result indicates whether both the target person and the target article are within the predetermined region.

The predetermined region may be a region, which satisfies a predetermined condition and is set by the user or other objectives or is determined by the subject for performing the method or other electronic devices. For example, the predetermined condition may be that the region includes the predetermined article. In this case, the predetermined article may represent the same article as the target article. The predetermined region may be a positionally fixed region or a positionally variable region. For example, when the predetermined condition is that the region contains the predetermined article, and when the predetermined article (such as a robotic vacuum cleaner, a pet, and so on) is movable, the predetermined region may be the positionally variable region.

In a block 2, the theft determination information may be generated based on the second determination result and the extent of overlapping.

The theft determination information may be generated based on the second determination result and the extent of overlapping in various ways.

For example, when the second determination result indicates that both the target person and the target article are located within the predetermined region, and the extent of overlapping is greater than or equal to the predetermined threshold, the theft determination information indicating that the target person has the intent to steal the target article may be generated. When the second determination result indicates that at least one of the target person and the target article is not located within the predetermined region, or when the extent of overlapping is less than the predetermined threshold, the theft determination information indicating that the target person does not have the intent to steal the target article may be generated.

In another example, when the second determination result indicates that both the target person and the target article are located within the predetermined region, and the extent of overlapping is greater than or equal to the predetermined threshold, it may be further determined whether the behavior of the target person represented by the person description is the theft behavior, so as to obtain the first determination result. The first determination result may indicate whether the behavior of the target person represented by the person description is the theft behavior. Subsequently, the theft determination information may be generated based on the first determination result.

Additionally, the theft determination information may be generated based on the second determination result and the extent of overlapping in other manners. Specific details will be described at a later section.

It should be understood that in the above embodiments, the theft determination information may be generated based on both the second determination result and the extent of overlapping. In this way, the accuracy of recognizing the theft intent may be improved.

In some embodiments, before determining the extent of overlapping between the first detection box and the second detection and, following blocks may be performed.

In a block 1, a pre-recorded collection of personnel information may be obtained.

The collection of personnel information may represent a certain family member and a relative or friend of the family member.

In practice, the personnel information may be recorded by capturing an image for the family member.

In a block 2, it may be determined whether the target person information of the target person is included in the collection of personnel information.

Accordingly, the extent of overlapping between the first detection box and the second detection box may be determined when the target person information is not included in the collection of personnel information.

In some embodiments, when the target person information is included in the collection of personnel information, the extent of overlapping between the first detection box and the second detection box may not need to be determined. Furthermore, the theft determination information indicating that the target individual does not have the intent to steal the target article may be generated.

It should be understood that in the above embodiments, when the target individual information is not included in the collection of personnel information, determination of whether the target person has the intent to steal the target article may be made solely based on the extent of overlapping between the detection box of the article description and the detection box of the person description in the image. In this way, the accuracy in recognizing the theft intent may be improved. Moreover, in the case that the target person is determined as having the intent to steal the target article and an alarm prompt is required, by performing the above embodiment, disturbance to the user, caused by frequent alarm prompts, may be reduced.

In some embodiments, after generating the theft determination information, when the theft determination information indicates the target person has the theft intent, the system may further control the expulsion device to perform the expulsion operation and/or send the prompt information to the predetermined terminal.

The expulsion device may be an audio output device, a mobile robot, and so on.

When the expulsion device is the audio output device, the expulsion operation may output an alarm audio. The alarm audio may be set by the user or other objectives.

When the expulsion device is the mobile robot, the expulsion operation may be moving towards the target person.

The predetermined terminal may be a device that is associated, in advance, with the aforementioned subject for performing the method. For example, the terminal may be a terminal logged in with an administrator account.

It should be understood that in the above embodiments, by controlling the expulsion device to perform the expulsion operation, the probability of the target article being stolen may be reduced. By sending the prompt information to the predetermined terminal, the user of the predetermined terminal may be timely notified that the target item may be or is about to be stolen.

It should be noted that, when there is no conflict, technical features described in various embodiments may be included in the same technical solution. For brevity, combination of embodiments is not described herein.

For the theft intent recognition method provided by the embodiments of the present disclosure, the target image may be obtained. The target image includes the article description and the person description. The article description represents the target article, and the person description represents the target person. Subsequently, the first detection box and the second detection box may be determined within the target image. The first detection box may be the detection box for the article description, and the second detection box is the detection box for the person description. The extent of overlapping between the first detection box and the second detection box may be determined. The theft determination information may be generated based on the extent of overlapping. The theft determination information indicates whether the target person has the intent to steal the target article. Therefore, in some cases, the extent of overlapping between the detection box of the article description and the detection box of the person description in one image may be used to determine whether the target person has the intent to steal the target article, such that the efficiency and accuracy in recognizing the theft intent may be improved.

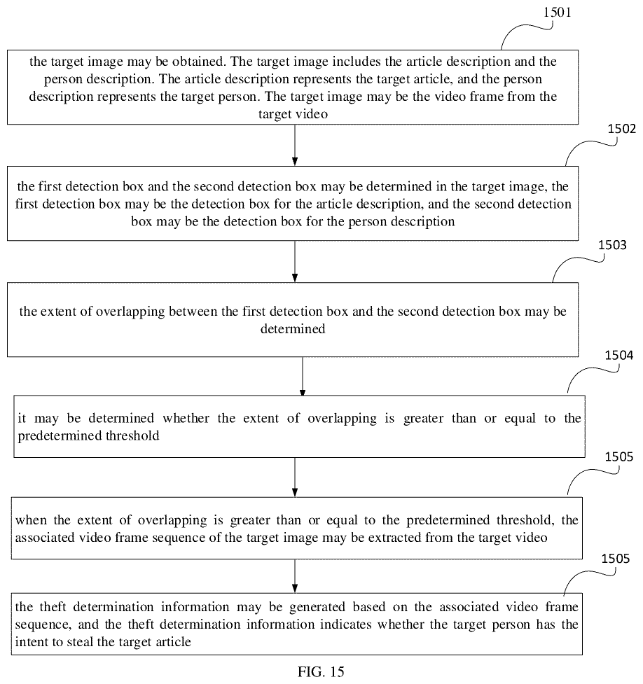

FIG. 15 is a flow chart another method for recognizing the theft intent according to an embodiment of the present disclosure. As shown in FIG. 15, the method specifically includes following blocks.

In a block 1501, the target image may be obtained. The target image includes the article description and the person description. The article description represents the target article, and the person description represents the target person. The target image may be the video frame from the target video.

In the present embodiment, the target image may be the video frame from the target video. Specifically, the target image may be the video frame extracted from the video that includes both the article description and the person description. Furthermore, the block 1501 may be substantially consistent with the block 1041 in the corresponding embodiment of FIG. 1 and will not be repeated here.

In a block 1502, the first detection box and the second detection box may be determined in the target image, the first detection box may be the detection box for the article description, and the second detection box may be the detection box for the person description.

In the present embodiment, the block 1502 may be substantially consistent with the block 1042 in the embodiment corresponding to FIG. 1 and is not described in detail here.

In a block 1503, the extent of overlapping between the first detection box and the second detection box may be determined.

In the present embodiment, the block 1503 may be substantially consistent with the block 1043 in the corresponding embodiment of FIG. 1 and is not described in detail here.

In a block 1504, it may be determined whether the extent of overlapping is greater than or equal to the predetermined threshold.

In the present embodiment, the predetermined threshold may be set by the user or other objectives, or determined by analyzing correlation between the extent of overlapping and the theft determination information.

In a block 1505, when the extent of overlapping is greater than or equal to the predetermined threshold, the associated video frame sequence of the target image may be extracted from the target video.

In the present embodiment, the associated video frame sequence may be formed of video frames within the target video that have an association relationship with the target image.

For example, the associated video frame sequence may include: the target image. N preceding video frames before the target image, and M subsequent video frames after the target image.

In another example, the associated video frame sequence may include: N preceding video frames before the target image, and M subsequent video frames after the target image

In the above examples, the N and the M are positive integers, and the N may be equal or unequal to the M. The preceding video frames are video frames occurring in the target video before the target image, and the subsequent video frames are video frames occurring in the target video after the target image.

In another example, the associated video frame sequence may include: the video frame containing the article description of the target article within the target video, and/or the video frame containing the person description of the target person within the target video.

In a block 1506, the theft determination information may be generated based on the associated video frame sequence, and the theft determination information indicates whether the target person has the intent to steal the target article.

In the present embodiment, the theft determination information may be generated in various ways based on the associated video frame sequence.

For example, the associated video frame sequence may be input into a pre-trained large language model (LLM) to generate the theft determination information. The large language model may represent correspondence between prompt words, the associated video frame sequence, and the theft determination information.

The LLM may be a natural language processing model based on deep learning and having a significantly large number of parameters and strong language understanding and generation capabilities.

In an example, the aforementioned large language model may be a multimodal large language model (MLLM). Details thereof may be referred to the above description for the MLLM.

Additionally, generating the theft determination information based on the associated video frame sequence may be performed in other ways. Specific details will be described at a later section.

In some embodiments, the method may be performed by the first device. The data processing volume of the target image may be smaller than the data processing volume of the video frames in the associated video frame sequence.

Accordingly, the theft determination information may be generated based on the associated video frame sequence as follows.

In a block 1, the associated video frame sequence may be sent to the second device.

The second device may be configured to generate the theft determination information based on the associated video frame sequence. The computing power of the second device may be greater than that of the first device.

For example, the first device may be the edge computing device. The first device may process video data (such as the target image) obtained from the smart cameras. The first device may have a certain computing capability to perform real-time customized target property detection and human shape detection. The first device may include the microphone and some audio and visual components to expel threats to properties and may play welcoming messages for family members or persons on the whitelist.

The second device may be the home smart control system (the server). The second device may serve as a computing center and an intelligence center and may be configured with the high-performance computing chip, capable of establishing a plurality of video streams and processing the plurality of video stream in real time.

The second device may input the associated video frame sequence into the pre-trained large language model to generate the theft determination information. Alternatively, the second device may generate the theft determination information based on the associated video frame sequence, the state information of the target article in the preceding video frame, and the state information of the target article in the subsequent video frame.

In a block 2, the theft determination information returned from the second device may be received, so as to generate the theft determination information.

It should be understood that in the above embodiments, the first device having the lower computing power may process video frames in the smaller data processing volume, and the second device having the higher computing power may process a plurality of video frames in the larger data processing volume. In this way, the efficiency in recognizing the theft intent may be improved.

In some embodiments, the associated video frame sequence includes: the preceding video frame of the target image and the subsequent video frame of the target image. The preceding video frame of the target image may be the video frame occurring in the target video before the target image. The subsequent video frame of the target image may be the video frame occurring in the target video after the target image.

Accordingly, the theft determination information may be generated based on the associated video frame sequence as follows.

In a block 1, the first state information of the target article in the preceding video frame may be determined.

The first state information may represent the state of the target article in the preceding video frame. For example, the first state information may indicate the location of the target article in the preceding video frame, or indicate whether the target article represented by the article description in the preceding video frame is located within a predetermined region.

In a block 2, the second state information of the target article in the subsequent video frame may be determined.

The second state information may represent the state of the target article in the subsequent video frame. For example, the second state information may indicate the location of the target article in the subsequent video frame, or indicate whether the target article represented by the article description in the subsequent video frame is located within a predetermined region.

In a block 3, the theft determination information may be generated based on the first state information, the second state information, and the associated video frame sequence.

The theft determination information may be generated in various ways based on the first state information, the second state information, and the associated video frame sequence.

For example, the first state information indicates the location of the target article in the preceding video frame and the second state information indicates the location of the target article in the subsequent video frame. When the distance between the location indicated by the first state information and the location indicated by the second state information is greater than or equal to a predetermined distance threshold, the theft determination information may be further generated based on the associated video frame sequence. When the distance between the location indicated by the first state information and the location indicated by the second state information is less than the predetermined distance threshold, the theft determination information indicating that the target person does not have the intent to steal the target article may be generated.

Additionally, the theft determination information may be generated based on the first state information, the second state information, and the associated video frame sequence, in other ways. Specific details will be described at a later section.

It should be understood that in the above embodiments, the theft determination information may be generated based on the first state information, the second state information, and the associated video frame sequence. In this way, the accuracy in recognizing the theft intent.

In some application scenarios of the above embodiments, the first state information indicates whether the target article represented by the article description in the preceding video frame is located within the first region, and the second state information indicates whether the target article represented by the article description in the subsequent video frame is located within the first region.

The first region may represent the aforementioned predetermined region, or may be a region that has a predetermined size and shape and is positionally variable.

Accordingly, the theft determination information may be generated based on the first state information, the second state information, and the associated video frame sequence, as follows.

In a block 1, when the first state information indicates that the target article represented by the article description in the preceding video frame is located within the first region, the initial theft determination information may be generated based on the associated video frame sequence.

The initial theft determination information may be generated based on the associated video frame sequence, in various ways.

For example, the associated video frame sequence may be input into the pre-trained large language model to generate the initial theft determination information. The large language model may represent correspondence among prompt words, associated video frame sequences, and initial theft determination information.

In another example, the initial theft determination information may be generated based on the associated video frame sequence and based on whether both the target person and the target article are located within the predetermined region.

The initial state information indicates whether the target person has the intent to steal the target article.

In a block 2, the final theft determination information indicating the target person has the intent to steal the target article may be generated, when the initial theft determination information indicates the target person has the intent to steal the target article, and when the second state information indicates that the target article represented by the article description in the subsequent video frame is not located within the first region.

It should be understood that in the above application scenario, the target person may be determined as having the intent to steal the target article only when the target article changes from being located in the first region to not being located in the first region, and when the initial state information indicates that the target person has the intent to steal the target article. In this way, the accuracy in recognizing the theft intent may be improved.

It should be noted that, in addition to the above-described content, the present embodiment may further include corresponding technical features described in the embodiment corresponding to FIG. 1, such that the technical effects of the theft intent recognition method shown in FIG. 1 may be achieved. Specific details may be referred to the relevant description in FIG. 1. For brevity: the specific details are not repeated herein.

For the method for recognizing the theft intent provided by the present embodiment, the theft determination information may be generated based on the associated video frame sequence of the target article when the extent of overlapping between the first detection box and the second detection box is greater than or equal to the predetermined threshold. In this way, the efficiency and accuracy in recognizing the theft intent may be improved.

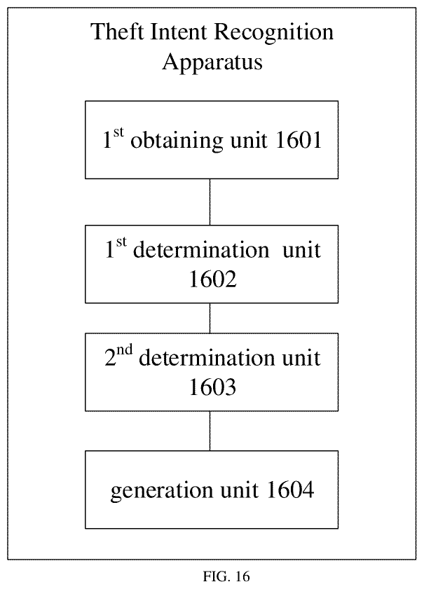

FIG. 16 is a structural schematic diagram of a theft intent recognition apparatus provided by an embodiment of the present disclosure. The theft intent recognition apparatus may include the following.

A first obtaining unit 1601 may be configured to obtain the target image, and the target image includes the article description and the person description. The article description represents the target article, and the person description represents the target person.

A first determination unit 1602 may be configured to determine the first detection box and the second detection box in the target image. The first detection box may be the detection box of the article description, and the second detection box may be the detection box of the person description.

A second determination unit 1603 may be configured to determine the extent of overlapping between the first detection box and the second detection box.

A generation unit 1604 may be configured to generate the theft determination information based on the extent of overlapping, and the theft determination information indicates whether the target person has the intent to steal the target article.

In an embodiment, generating the theft determination information based on the extent of overlapping may include following.

It may be determined whether the extent of overlapping is greater than or equal to the predetermined threshold.

When the extent of overlapping is greater than or equal to the predetermined threshold, it may be determined whether the behavior of the target person represented by the person description is the theft behavior, so as to obtain the first determination result.

The theft determination information may be generated based on the first determination result.

In an embodiment, the target image may be the video frame from the target video.

Generating the theft determination information based on the extent of overlapping may include the following.

It may be determined whether the extent of overlapping is greater than or equal to the predetermined threshold.

When the extent of overlapping is greater than or equal to the predetermined threshold, the associated video frame sequence of the target image may be extracted from the target video.

The theft determination information may be generated based on the associated video frame sequence.

In an embodiment, the above apparatus may be configured in the first device. The data processing volume of the target image may be less than the data processing volume of the video frames in the associated video frame sequence.

Generating the theft determination information based on the associated video frame sequence may include the following.

The associated video frame sequence may be sent to the second device. The second device may be configured to generate the theft determination information based on the associated video frame sequence. The computing power of the second device may be greater than that of the first device.

The theft determination information returned by the second device may be received, so as to generate the theft determination information.

In an embodiment, the associated video frame sequence includes: the preceding video frame of the target image and the subsequent video frame of the target image. The preceding video frame of the target image may be the video frame occurring in the target video located before the target image, and the subsequent video frame of the target image may be the video frame occurring in the target video after the target image. Generating the theft determination information based on the associated video frame sequence may include the following.

The first state information of the target article in the preceding video frame may be determined.

The second state information of the target article in the subsequent video frame may be determined.

The theft determination information may be generated based on the first state information, the second state information, and the associated video frame sequence.

In an embodiment, the first state information indicates whether the target article represented by the article description in the preceding video frame is located within the first region, and the second state information indicates whether the target article represented by the article description in the subsequent video frame is located within the first region.

Generating the theft determination information based on the first state information, the second state information, and the associated video frame sequence, may include the following.

The initial theft determination information may be generated based on the associated video frame sequence when the first state information indicates that the target article represented by the article description in the preceding video frame is located within the first region.

The final theft determination information indicating that the target person has the intent to steal the target article may be generated, when the initial theft determination information indicates that the target person has the intent to steal the target article and the second status information indicates that the target article represented by the article description in the subsequent video frame is not located in the first region.

In an embodiment, generating the theft determination information based on the extent of overlapping may include the following.

It may be determined whether both the target person and the target article are located within the predetermined region, so as to obtain the second determination result.

The theft determination information may be generated based on the second determination result and the extent of overlapping.

In an embodiment, before determining the extent of overlapping between the first detection box and the second detection box, the apparatus further includes the following.

A second obtaining unit (not shown in the drawing) may be configured to obtain the pre-recorded collection of personnel information.

A third determination unit (not shown in the drawing) may be configured determine whether the target person information representing the target person is included in the collection of personnel information.

Determining the extent of overlapping between the first detection box and the second detection box may include the following.

The extent of overlapping between the first detection box and the second detection box may be determined when the target person information is not included in the collection of personnel information.

In an embodiment, after generating the theft determination information, the apparatus further includes at least one of the following.

A control unit (not shown in the drawing) may be configured to control the expulsion device to perform the expulsion operation when the theft determination information indicates that the target person has the theft intent.

A sending unit (not shown in the drawing) may be configured to send the prompt information to the predetermined terminal when the theft determination information indicates that the target person has the theft intent.

The theft intent recognition apparatus provided in the present embodiment may be the theft intent recognition device shown in FIG. 16, and may execute all blocks of the aforementioned theft intent recognition method to achieve the technical effects described above. Specific details may be referred to the relevant descriptions above: for brevity, the specific details are not repeated.

FIG. 13 is a schematic diagram of an electronic device provided by an embodiment of the present disclosure. The electronic device 500 shown in FIG. 13 includes: at least one processor 501, a memory 502, at least one network interface 504, and other user interfaces 503. Various components within the electronic device 500 may be coupled together via a bus system 505. The bus system 505 may be configured to enable connection and communication between the various components. In addition to a data bus, the bus system 505 further includes a power bus, a control bus, and a state signal bus. However, for clarity, all buses are labeled as the bus system 505 in FIG. 13.

The user interfaces 503 may include a display, a keyboard, or a pointing device (such as a mouse, a trackball, a touchpad, or a touchscreen).

It should be understood that the memory 502 in the embodiments of the present disclosure may be a volatile memory or a non-volatile memory: or may include both the volatile memory and the non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which serves as an external cache. By way of example but not limitation, various forms of RAM may be available, such as a static RAM (SRAM), a dynamic RAM (DRAM), a synchronous DRAM (SDRAM), a double data rate SDRAM (Double Data Rate SDRAM, DDRSDRAM), an enhanced SDRAM (ESDRAM), a synch link DRAM (SLDRAM), and a direct rambus RAM (DRRAM). The memory 502 described herein may include, but not limited to, the above or any other suitable types of memories.

In some embodiments, the memory 502 may store executable units of an operating system 5021 and an application 5022, or data structures of the operating system 5021 and the application 5022, or a subset of the operating system 5021 and the application 5022, or an extended set of the operating system 5021 and the application 5022.

The operating system 5021 may include various system programs, such as a framework layer, a core library layer, a driver layer, and so on, so as to implement various fundamental operations and handle hardware-based tasks. The application 5022 may include various applications, such as a media player, a browser, and so on, so as to implement various application operations. Programs for implementing the methods of the present disclosure may be included in the application 5022.

In the present embodiment, by invoking programs or instructions stored in memory 502, which may be programs or instructions stored in the application 5022, the processor 501 performs the blocks of the security method or the theft intent recognition method provided by each method embodiment. The blocks may include the following.

The first security video and the predetermined security preference information may be obtained.

Recognition on the first security video may be performed, so as to obtain the video recognition result for the first security video.

The security response operation matching the first security video may be determined based on the video recognition result and the security preference information, so as to obtain the first security response operation.

The security device for performing the first security response operation may be determined.

The security device may be controlled to perform the first security response operation.

Alternatively, following blocks may be performed.

The target image set corresponding to the security device set may be obtained.

The reference object may be extracted from the target image set.

The association relationship among the security devices may be established based on the reference object.

When detecting the target object within the security region monitored by the security device set, one or more cross-device cooperation security devices may be determined from the security device set based on the association relationship and the target information of the target object.

The one or more cross-device cooperation security devices may be controlled to perform the monitoring operation on the target object.

Alternatively, following blocks may be performed.

The configuration requirement information may be received.

The configuration requirement information may be parsed by the predetermined. The configuration requirement information includes the target scene and the configuration requirements.

The target security device relevant to the configuration requirements may be determined from the device capability set of the plurality of security devices, and the behavior pattern of the target security device in the target scene may be determined.

The cross-device cooperation control strategy may be determined based on the behavior pattern and the device capability set of each target security device, so as to control the target security device according to the cross-device cooperation control strategy in the target scene to achieve the configuration requirements.

Alternatively, following blocks may be performed.

The natural language and the first security video may be obtained. The natural language may be configured to determine the to-be-pushed video.

The feature data of the natural language may be determined, so as to obtain the first feature data.

The first video may be determined based on the first security video; and it may be determined, based on at least two types of feature data of the first video and the first feature data, whether the first video matches the natural language.

When the first video matches the natural language, the first video may be determined as the to-be-pushed video and the video information of the to-be-pushed video may be pushed. The video information represents information of the to-be-pushed video.

Alternatively; following blocks may be performed.

Images of the target object within the predetermined region may be obtained. The movement distance and the endpoint of the movement of the target object within the predetermined region may be determined based on the images.

It may be determined whether the movement distance is greater than or equal to the predetermined first distance threshold, and may be determined whether the endpoint of the movement is located within the predetermined endpoint region.

When it is determined that the movement distance is greater than or equal to the first distance threshold and the endpoint of the movement is located within the predetermined endpoint region, it may be determined that the current behavior of the target object belongs to the target behavior type.

Alternatively, following blocks may be performed.

The three-dimensional model of the building may be obtained. The building may be arranged with the first security device and the second security device.

The first mapping pose of the first security device within the three-dimensional model and the second mapping pose of the second security device within the three-dimensional model may be determined. The first mapping pose represents the pose of the first security device mapped onto the three-dimensional model, and the second mapping pose represents the pose of the second security device mapped onto the three-dimensional model.

It may be determined whether the first monitoring region of the first security device and the second monitoring region of the second security device have the overlapping region, based on the first mapping pose and the second mapping pose, so as to obtain the determination result.

It may be determined whether the first security device and the second security device are cross-device cooperation devices, based on the determination result.

When the first security device and the second security device are the cross-device cooperation devices, the movement information of the target object detected by the first security device may be determined.

The second security device may be controlled, based on the movement information, to perform the monitoring operation on the target object.

Alternatively, following blocks may be performed.

The image description data set and the target video may be obtained. The image description data in the image description data set describes the content of the target image, and the target video includes the image sequence.

Similarities between the image in the image sequence and each of all image description data in the image description data set may be calculated, so as to obtain the target similarity corresponding to the image.

The first quantity of target similarities may be selected from all of the similarities obtained from the calculation.

The first image set corresponding to the first quantity of target similarities may be determined. The images in the first image set may be in one-to-one correspondence with the first quantity of target similarities.

The frame extraction result of the target video may be determined based on the first image set.

Alternatively, following blocks may be performed.

The target image may be obtained. The target image includes the article description and the person description. The article description represents the target article, and the person description represents the target person.

The first detection box and the second detection box within the target image may be determined. The first detection box may be the detection box for the article description, and the second detection box may be the detection box for the person description.

The extent of overlapping between the first detection box and the second detection box may be determined.

The theft determination information may be generated based on the extent of overlapping. The theft determination information indicates whether the target person has the intent to steal the target article.

Alternatively; following blocks may be performed.

The first security video and the predetermined security preference information may be obtained.

Recognition may be performed on the first security video to obtain the event recognition result for the first security video. The event recognition result represents the event represented in the first security video.

The security response operation matching the first security video may be determined based on the event recognition result and the security preference information, so as to obtain the first security response operation.

The first security response operation may be performed.

Alternatively, following blocks may be performed.

The image of the target object within the predetermined region may be obtained. The movement distance and the endpoint of the movement of the target object within the predetermined region may be determined based on the image.

It may be determined whether the movement distance is greater than or equal to the predetermined first distance threshold, and may be determined whether the endpoint of the movement is located within the predetermined endpoint region.

When the movement distance is determined to be greater than or equal to the first distance threshold and the endpoint of the movement is located within the predetermined endpoint region, it may be determined that the current behavior of the target object belongs to the target behavior type.

Alternatively; following blocks may be performed.

The image of the target object within the predetermined region may be obtained. The starting point of the movement and the endpoint of the movement of the target object within the predetermined region may be determined based on the image.

When the starting point of the movement is determined as being located within the predetermined starting point region and the endpoint of the movement is determined as being located within the predetermined endpoint region, it may be determined that the current behavior of the target object belongs to the target behavior type.

Alternatively, following blocks may be performed.

The captured image of the predetermined region may be obtained and displayed.

The predetermined starting point and the endpoint of the target behavior type set for the captured image may be determined.

The distance threshold corresponding to the target behavior type may be determined based on the predetermined starting point and the predetermined endpoint. It may be recognized, based on the distance threshold and the predetermined endpoint, whether the behavior of the object belongs to the target behavior type.

Alternatively; following blocks may be performed.

The captured image for the predetermined region may be obtained and displayed.

The movement trajectory for the target behavior type set for the captured image may be determined.

The distance threshold and the endpoint region corresponding to the target behavior type may be determined based on the movement trajectory. It may be recognized, based on the distance threshold and the endpoint region, whether the behavior of the object belongs to the target behavior type.

Alternatively, following blocks may be performed.

The captured image for the predetermined region may be obtained and displayed.

The predetermined starting point and the predetermined endpoint for the target behavior type set for the captured image may be determined.

The starting point region and the endpoint region may be determined based on the predetermined starting point and the predetermined endpoint. It may be recognized, based on the starting point region and the endpoint region, whether the behavior of the object belongs to the target behavior type.

Alternatively, following blocks may be performed.

The target image may be obtained. The target image includes the article description and the person description the article description represents the target article, and the person description represents the target person.

The first detection box and the second detection box within the target image may be determined. The first detection box may be the detection box for the article description, and the second detection box may be the detection box for the person description.

The extent of overlapping between the first detection box and the second detection box may be determined.

The theft determination information may be generated based on the extent of overlapping. The theft determination information indicates whether the target person has the intent to steal the target article.

The method in the present disclosure may be applied in the processor 501 or by implemented by the processor 501. The processor 501 may be an integrated circuit chip having a signal processing capability. During implementation, the blocks of the method may be performed by integrated logic circuits of the processor 501 or by software instructions. The processor 501 may be a general-purpose processor, a digital signal processor (DSP), an application-specific integrated circuit (ASIC), a field-programmable gate array (FPGA), or other programmable logic devices, discrete gate or transistor logic devices, or discrete hardware components. The chip may achieve or execute the methods, the blocks, and the logic flow charts disclosed in the embodiments of the present disclosure. The general-purpose processor may be a microprocessor or any conventional processor. The blocks of the methods disclosed in the embodiments of the present disclosure may be directly embodied as being executed by a hardware decoding processor, or executed by a combination of hardware and software units within the decoding processor. The software units may reside in an established storage medium in the art, such as a random access memory, a flash memory, a read-only memory, a programmable read-only memory, an electrically erasable programmable read-only memory, or a register. The storage medium may be configured in the memory 502. The processor 501 reads information from the memory 502 and works cooperatively with hardware components of the memory 502 to complete the blocks of the above method.

It should be understood that the embodiments described herein may be implemented by hardware, software, firmware, middleware, microcode, or combinations thereof. For hardware implementation, a processing unit may be implemented in one or more application specific integrated circuits (ASICs), a digital signal processor (DSP), a digital signal processing device (DSPD), a programmable logic device (PLD), a field-programmable gate array (FPGA), a general-purpose processor, a controller, a microcontroller, a microprocessor, other electronic units, or a combination thereof, so as to execute the aforementioned functions of the present disclosure.

For software implementation, the above-described technology may be achieved through units executing the functions described herein. Software codes may be stored in a memory and executed by a processor. The memory may be implemented inside the processor or externally to the processor.

The electronic device provided in the present embodiment may be the electronic device shown in FIG. 13, which may perform all blocks of the aforementioned security methods or the method for recognizing the theft intent, such that the technical effects of the aforementioned security methods may be achieved. Specific details may be referred to the relevant descriptions above. For brevity: the specific details may not be repeated.

The present disclosure further provides a storage medium (computer-readable storage medium). The storage medium stores one or more programs. The storage medium may include a volatile memory: such as a random access memory (RAM); and may further include a non-volatile memory: such as a read-only memory (ROM), a flash memory, hard disk drives (HDDs), or solid-state drives (SSDs): or may include a combination of the aforementioned memories.

When one or more programs stored in the storage medium is executable by one or more processors, the aforementioned security method executed on the electronic device may be performed.

The aforementioned processor may be used to execute a security program stored in the memory to implement following blocks of the security method or the method for recognizing the theft intent during security that is executed on the electronic device.

The security method may include following blocks.

The first security video and the pre-determined security preference information may be obtained.

Recognition on the first security video may be performed, so as to obtain the video recognition result for the first security video.

The security response operation matching the first security video may be determined based on the video recognition result and the security preference information, so as to obtain the first security response operation.

The security device for performing the first security response operation may be determined.

The security device may be controlled to perform the first security response operation.

Alternatively, following blocks may be performed.

The target image set corresponding to the security device set may be obtained.

The reference object may be extracted from the target image set.

The association relationship among the security devices may be established based on the reference object.

When detecting the target object within the security region monitored by the security device set, one or more cross-device cooperation security devices may be determined from the security device set based on the association relationship and the target information of the target object.

The one or more cross-device cooperation security devices may be controlled to perform the monitoring operation on the target object.

Alternatively, following blocks may be performed.

The configuration requirement information may be received.

The configuration requirement information may be parsed by the predetermined. The configuration requirement information includes the target scene and the configuration requirements.

The target security device relevant to the configuration requirements may be determined from the device capability set of the plurality of security devices, and the behavior pattern of the target security device in the target scene may be determined.

The cross-device cooperation control strategy may be determined based on the behavior pattern and the device capability set of each target security device, so as to control the target security device according to the cross-device cooperation control strategy in the target scene to achieve the configuration requirements.

Alternatively, following blocks may be performed.

The natural language and the first security video may be obtained. The natural language may be configured to determine the to-be-pushed video.

The feature data of the natural language may be determined, so as to obtain the first feature data.

The first video may be determined based on the first security video; and it may be determined, based on at least two types of feature data of the first video and the first feature data, whether the first video matches the natural language.

When the first video matches the natural language, the first video may be determined as the to-be-pushed video and the video information of the to-be-pushed video may be pushed. The video information represents information of the to-be-pushed video.

Alternatively, following blocks may be performed.

Images of the target object within the predetermined region may be obtained. The movement distance and the endpoint of the movement of the target object within the predetermined region may be determined based on the images.

It may be determined whether the movement distance is greater than or equal to the predetermined first distance threshold, and may be determined whether the endpoint of the movement is located within the predetermined endpoint region.

When it is determined that the movement distance is greater than or equal to the first distance threshold and the endpoint of the movement is located within the predetermined endpoint region, it may be determined that the current behavior of the target object belongs to the target behavior type.

Alternatively, following blocks may be performed.

The three-dimensional model of the building may be obtained. The building may be arranged with the first security device and the second security device.

The first mapping pose of the first security device within the three-dimensional model and the second mapping pose of the second security device within the three-dimensional model may be determined. The first mapping pose represents the pose of the first security device mapped onto the three-dimensional model, and the second mapping pose represents the pose of the second security device mapped onto the three-dimensional model.

It may be determined whether the first monitoring region of the first security device and the second monitoring region of the second security device have the overlapping region, based on the first mapping pose and the second mapping pose, so as to obtain the determination result.

It may be determined whether the first security device and the second security device are cross-device cooperation devices, based on the determination result.

When the first security device and the second security device are the cross-device cooperation devices, the movement information of the target object detected by the first security device may be determined.

The second security device may be controlled, based on the movement information, to perform the monitoring operation on the target object.

Alternatively, following blocks may be performed.

The image description data set and the target video may be obtained. The image description data in the image description data set describes the content of the target image, and the target video includes the image sequence.

Similarities between the image in the image sequence and each of all image description data in the image description data set may be calculated, so as to obtain the target similarity corresponding to the image.

The first quantity of target similarities may be selected from all of the similarities obtained from the calculation.

The first image set corresponding to the first quantity of target similarities may be determined. The images in the first image set may be in one-to-one correspondence with the first quantity of target similarities. The frame extraction result of the target video may be determined based on the first image set.

Alternatively, following blocks may be performed.

The target image may be obtained. The target image includes the article description and the person description. The article description represents the target article, and the person description represents the target person.

The first detection box and the second detection box within the target image may be determined. The first detection box may be the detection box for the article description, and the second detection box may be the detection box for the person description.

The extent of overlapping between the first detection box and the second detection box may be determined.

The theft determination information may be generated based on the extent of overlapping. The theft determination information indicates whether the target person has the intent to steal the target article.

Alternatively, following blocks may be performed.

The first security video and the predetermined security preference information may be obtained.

Recognition may be performed on the first security video to obtain the event recognition result for the first security video. The event recognition result represents the event represented in the first security video.

The security response operation matching the first security video may be determined based on the event recognition result and the security preference information, so as to obtain the first security response operation.

The first security response operation may be performed.

Alternatively, following blocks may be performed.

The image of the target object within the predetermined region may be obtained. The movement distance and the endpoint of the movement of the target object within the predetermined region may be determined based on the image.

It may be determined whether the movement distance is greater than or equal to the predetermined first distance threshold, and may be determined whether the endpoint of the movement is located within the predetermined endpoint region.

When the movement distance is determined to be greater than or equal to the first distance threshold and the endpoint of the movement is located within the predetermined endpoint region, it may be determined that the current behavior of the target object belongs to the target behavior type.

Alternatively, following blocks may be performed.

The captured image for the predetermined region may be obtained and displayed.

The movement trajectory for the target behavior type set for the captured image may be determined.

The distance threshold and the endpoint region corresponding to the target behavior type may be determined based on the movement trajectory. It may be recognized, based on the distance threshold and the endpoint region, whether the behavior of the object belongs to the target behavior type.

Alternatively, following blocks may be performed.

The image of the target object within the predetermined region may be obtained. The starting point of the movement and the endpoint of the movement of the target object within the predetermined region may be determined based on the image.

When the starting point of the movement is determined as being located within the predetermined starting point region and the endpoint of the movement is determined as being located within the predetermined endpoint region, it may be determined that the current behavior of the target object belongs to the target behavior type.

Alternatively, following blocks may be performed.

The captured image for the predetermined region may be obtained and displayed.

The predetermined starting point and the predetermined endpoint for the target behavior type set for the captured image may be determined.

The starting point region and the endpoint region may be determined based on the predetermined starting point and the predetermined endpoint. It may be recognized, based on the starting point region and the endpoint region, whether the behavior of the object belongs to the target behavior type.

Alternatively, following blocks may be performed.

The captured image for the predetermined region may be obtained and displayed.

The movement trajectory for the target behavior type set for the captured image may be determined.

The distance threshold and the endpoint region corresponding to the target behavior type may be determined based on the movement trajectory. It may be recognized, based on the distance threshold and the endpoint region, whether the behavior of the object belongs to the target behavior type.

Alternatively, following blocks may be performed.

The captured image for the predetermined region may be obtained and displayed.

The predetermined starting point and the predetermined endpoint for the target behavior type set for the captured image may be determined.

The starting point region and the endpoint region may be determined based on the predetermined starting point and the predetermined endpoint. It may be recognized, based on the starting point region and the endpoint region, whether the behavior of the object belongs to the target behavior type.

Alternatively, the method for recognizing the theft intent in the security video may include following blocks.

The target image may be obtained. The target image includes the article description and the person description, the article description represents the target article, and the person description represents the target person.

The first detection box and the second detection box within the target image may be determined. The first detection box may be the detection box for the article description, and the second detection box may be the detection box for the person description.

The extent of overlapping between the first detection box and the second detection box may be determined.

The theft determination information may be generated based on the extent of overlapping. The theft determination information indicates whether the target person has the intent to steal the target article.

Any skilled artisan shall understand that units and algorithmic steps described in the embodiments disclosed herein may be implemented using electronic hardware, computer software, or a combination thereof. In order to clearly illustrate interchangeability between the hardware and the software, composition and blocks of each embodiment have been described in terms of general functions in the above description. Performing the above functions in the hardware or the software may be determined based on each specific application and design constraints of the technical solution. Any skilled artisan may perform various methods to implement the described functions for various specific applications, and the implementations shall not be considered outside the scope of the present disclosure.

The blocks of the methods or algorithms described in the embodiments disclosed herein may be implemented using hardware, software modules executed by a processor, or a combination thereof. The software modules may reside in a random access memory (RAM), memory, a read-only memory (ROM), an electrically programmable ROM, an electrically erasable programmable ROM, a register, hard disks, removable disks. CD-ROMs, or any other form of storage medium known in the art.

It should be understood that the terminology used herein is intended solely for the purpose of describing specific exemplary embodiments and is not intended to limit the present disclosure. Unless otherwise explicitly stated in the context, singular forms such as “one”. “a”, and “the” as used herein may also indicate inclusion of plural forms. The terms “comprising”. “including”. “containing”, and “having” are inclusive and indicate presence of the stated features, blocks, operations, elements, and/or components, but do not exclude presence or addition of one or more other features, blocks, operations, elements, components, and/or combinations thereof.

The blocks, processes, and operations of each method described herein shall not be interpreted as execution in a specific order, unless the execution order is explicitly stated. It should also be understood that additional or alternative blocks may be performed.

The foregoing describes only specific embodiments of the present disclosure to enable any skilled artisan to understand or practice the present disclosure. Various modifications to these embodiments may be performed by any skilled artisan, and the general principles defined herein may be implemented in other embodiments without departing from the spirit or scope of the present disclosure. Therefore, the present disclosure is not intended to be limited to the embodiments shown herein, but may be interpreted as the broadest scope consistent with the principles and novel features claimed herein.

What is claimed is:

1. A security method, comprising:
obtaining a first security video and predetermined security preference information;
performing recognition on the first security video to obtain a video recognition result;
determining a security response operation matching the first security video based on the video recognition result and the security preference information, so as to obtain a first security response operation;
determining a security device for performing the first security response operation;
controlling the security device to perform the first security response operation.

2. The method according to claim 1, wherein, the video recognition result is an event recognition result of the first security video, the event recognition result represents an event represented by the first security video; and
the determining a security response operation matching the first security video based on the video recognition result and the security preference information, comprises:
determining an urgency level of the event represented by the first security video based on the event recognition result; and
determining the security response operation matching the first security video based on the urgency level and the security preference information.

3. The method according to claim 1, wherein, after the performing recognition on the first security video to obtain a video recognition result, the method further comprises:
obtaining first feedback information in regard to the video recognition result; wherein the first feedback information indicates adjusting a recognition strategy for a second security video; the second security video is either the first security video or a security video obtained after the first security video; the recognition strategy comprises at least one of: a recognition efficiency and a recognition manner;
determining a post-adjustment recognition strategy that is adjusted as being indicated by the first feedback information;
performing recognition on the second security video according to the post-adjustment recognition strategy that is adjusted as indicated by the first feedback information, so as to obtain a video recognition result for the second security video;
determining a security response operation matching the second security video based on the video recognition result for the second security video and the security preference information, so as to obtain a second security response operation;
performing the second security response operation.

4. The method according to claim 1, wherein, after the controlling the security device to perform the first security response operation, the method further comprises:
obtaining third feedback information in regard to the first security response operation, wherein the third feedback information indicates adjusting a performing strategy of the security response operation, the execution strategy comprises at least one of: a performing efficiency and a performing manner;
determining a post-adjustment performing strategy that is adjusted as being indicated by the third feedback information;
performing a fourth security response operation according to the post-adjustment performing strategy that is adjusted as being indicated by the third feedback information, wherein the fourth security response operation is a security response operation performed after the first security response operation.

5. The method according to claim 1, wherein, the determining a security response operation matching the first security video based on the video recognition result and the security preference information, comprises:
determining a response probability of the first security video based on the video recognition result;
determining whether the response probability is greater than or equal to a predetermined threshold;
in a case that the response probability is greater than or equal to the predetermined threshold, determining the security response operation matching the first security video based on the security preference information.

6. The method according to claim 1, wherein
the first security video comprises a target image, wherein the target image comprises article description and person description, the article description represents a target article and the person description represents a target person; and
the performing recognition on the first security video to obtain a video recognition result, comprises:
recognizing the first security video to determine a first detection box and a second detection box within the target image, wherein the first detection box is a detection box for the article description; and the second detection box is a detection box for the person description;
determining an extent of overlapping between the first detection box and the second detection box;
generating theft determination information based on the extent of overlapping, wherein the theft determination information indicates whether the target person has an intent to steal the target article;
determining the video recognition result of the first security video based on the theft determination information.

7. The method according to claim 1, wherein the first security video is a frame extraction result of the target video; and the frame extraction result is generated performing following operations:
obtaining an image description data set and the target video, wherein image description data in the image description data set is configured to describe a content in the target image, and the target video is formed of an image sequence;
calculating similarities between each image in the image sequence and each image description data in the image description data set to obtain a target similarity corresponding to each image;
selecting a first quantity of target similarities from all target similarities obtained from the calculating;
determining a first image set corresponding to the first quantity of target similarities, wherein images in the first image set is in one-to-one correspondence with target similarities of the first quantity of target similarities;
determining the frame extraction result of the target video based on the first image set.

8. The method according to claim 6, wherein, the determining the frame extraction result of the target video based on the first image set, comprises:
displaying the first image set;
determining whether an adjustment operation is performed on the images in the first image set; wherein the adjustment operation is configured to adjust the images in the first image set to obtain a second image set;
in a case that the adjustment operation is detected, determining the second image set as the frame extraction result of the target video.

9. The method according to claim 1, wherein the security device for performing the first security response operation comprises a first security device and a second security device; and before the controlling the security device to perform the first security response operation, the method further comprises: obtaining a three-dimensional model of a building, wherein the first security device and the second security device are installed on the building;
the controlling the security device to perform the first security response operation, comprises:
determining a first mapping pose of the first security device within the three-dimensional model and a second mapping pose of the second security device within the three-dimensional model, wherein the first mapping pose represents a pose of the first security device mapped onto the three-dimensional model, and the second mapping pose represents a pose of the second security device mapped onto the three-dimensional model;
determining, based on the first mapping pose and the second mapping pose, whether a first monitoring region of the first security device and a second monitoring area of the second security device have an overlapping region, so as obtain a determination result;
determining, based on the determination result, whether the first security device and the second security device belong to cross-device cooperation devices;
in a case that the first security device and the second security device are the cross-device cooperation devices, determining movement information of a target object detected by the first security device; and
controlling, based on the movement information, the second security device to perform a monitoring operation on the target object.

10. The method according to claim 9, wherein, the first mapping pose comprises a first position and a first orientation of the first security device mapped onto the three-dimensional model; the second mapping pose comprises a second position and a second orientation of the second security device mapped onto the three-dimensional model;
the determining, based on the first mapping pose and the second mapping pose, whether a first monitoring region of the first security device and a second monitoring area of the second security device have an overlapping region, comprises:
determining the first monitoring region of the first security device mapped to the three-dimensional model based on the first position, the first orientation, and a first monitoring parameter of the first security device;
determining the second monitoring region of the second security device mapped to the three-dimensional model based on the second position, the second orientation, and a second monitoring parameter of the second security device; and
determining whether the first monitoring region and the second monitoring region have the overlapping region;
the determining, based on the determination result, whether the first security device and the second security device belong to cross-device cooperation devices, comprises:
in a case that the determination result indicates that the first monitoring region and the second monitoring region have the overlapping region, determining that the first security device and the second security device are the cross-device cooperation devices;
in a case that the determination result indicates that the first monitoring region and the second monitoring region do not have the overlapping region, determining that the first security device and the second security device are not the cross-device cooperation devices.

11. The method according to claim 9, wherein the determining a first mapping pose of the first security device within the three-dimensional model and a second mapping pose of the second security device within the three-dimensional model, comprises:
displaying the three-dimensional model;
detecting a first operation and a second operation performed on the displayed three-dimensional model, wherein the first operation is configured to determine a mapping pose of the first security device in the three-dimensional model, and the second operation is configured to determine a mapping pose of the second security device in the three-dimensional model;
in a case that the first operation is detected, determining the mapping pose indicated by the first operation as the first mapping pose of the first security device within the three-dimensional model;
in a case that the second operation is detected, determining the mapping pose indicated by the second operation as the second mapping pose of the second security device within the three-dimensional model.

12. The method according to claim 9, wherein the second security device is a pan-tilt camera, the movement information comprises a movement trajectory of the security object; and
the controlling, based on the movement information, the second security device to perform a monitoring operation on the target object, comprises:
determining an initial position of the target object within the monitoring region of the second security device based on the movement trajectory comprised in the movement information;
controlling a field of view of the second security device to move to cover the initial position, to enable the second security device to perform the monitoring operation on the target object.

13. A method for recognizing a theft intent in a security system, comprising:
obtaining a target image, wherein the target image comprises article description and person description, the article description represents a target article, and the person description represents a target person;
determining a first detection box and a second detection box within the target image, wherein the first detection frame is a detection frame for the article description, and the second detection frame is a detection frame for the person description;
determining an extent of overlapping between the first detection box and the second detection box;
generating theft determination information based on the extent of overlapping, wherein the theft determination information indicates whether the target person has an intent to steal the target article.

14. The method according to claim 13, wherein the generating theft determination information based on the extent of overlapping, comprises:
determining whether the extent of overlapping is greater than or equal to a predetermined threshold;
in a case that the extent of overlapping is greater than or equal to the predetermined threshold, determining whether a behavior of the target person represented by the person description is a theft behavior, so as to obtain a first determination result; and
generating the theft determination information based on the first determination result.

15. The method according to claim 13, wherein, the target image is a video frame from a target video; and the generating theft determination information based on the extent of overlapping comprises:
determining whether the extent of overlapping is greater than or equal to a predetermined threshold;
in a case that the extent of overlapping is greater than or equal to the predetermined threshold, extracting, from the target video, an associated video frame sequence associated to the target image;
generating the theft determination information based on the associated video frame sequence.

16. The method according to claim 15, wherein, the method is performed by a first device, wherein a data processing volume of the target image is less than a data processing volume of video frames in the associated video frame sequence; and the generating the theft determination information based on the associated video frame sequence, comprises:
sending the associated video frame sequence to a second device; wherein the second device is configured to generate the theft determination information based on the associated video frame sequence; a computing power of the second device is greater than that of the first device; and
receiving the theft determination information returned from the second device, so as to generate the theft determination information.

17. The method according to claim 15, wherein, the associated video frame sequence comprises: a preceding video frame of the target image and a subsequent video frame of the target image; wherein the preceding video frame of the target image is a video frame occurring in the target video before the target image, and the subsequent video frame of the target image is a video frame occurring in the target video after the target image; and
the generating the theft determination information based on the associated video frame sequence, comprises:
determining first state information of the target article in the preceding video frame;
determining second state information of the target article in the subsequent video frame;
generating the theft determination information based on the first state information, the second state information, and the associated video frame sequence.

18. The method according to claim 17, wherein, the first state information indicates whether the target article represented by the article description in the preceding video frame is located within a first region; the second state information indicates whether the target article represented by the article description in the subsequent video frame is located in the first region; and
the generating the theft determination information based on the first state information, the second state information, and the associated video frame sequence, comprises:
generating initial theft determination information based on the associated video frame sequence in a case that the first state information indicates that the target article represented by the article description represented in the preceding video frame is located within the first region;
generating final theft determination information indicating that the target person has an intent to steal the target article, in a case that the initial theft determination information indicates that the target person has the intent to steal the target article, and the second state information indicates that the target article represented by the article description in the subsequent video frame is not located in the first region.

19. An electronic device, comprising:
a memory, configured to store a computer program;
a processor, configured to execute the computer program stored in the memory, wherein the computer program, when being executed, is configured to perform the security method according to claim 1.

20. An electronic device, comprising:
a memory, configured to store a computer program;
a processor, configured to execute the computer program stored in the memory, wherein the computer program, when being executed, is configured to perform the method for recognizing the theft intent according to claim 13.
